(19) United States
(12) Patent Application Publication
(10) Pub. No.: US 2023/0418827 A1
(43) Pub. Date: Dec. 28, 2023

(54) PROCESSING MULTI-COLUMN STREAMS DURING QUERY EXECUTION VIA A DATABASE SYSTEM

(71) Applicant: Ocient Holdings LLC, Chicago, IL (US)

(72) Inventors: George Kondiles, Chicago, IL (US); Ellis Mihalko Saupe, University City, MO (US); Greg R. Dhuse, Chicago, IL (US)

(73) Assignee: Ocient Holdings LLC, Chicago, IL (US)

(21) Appl. No.: 18/322,688

(22) Filed: May 24, 2023

Related U.S. Application Data
(60) Provisional application No. 63/367,147, filed on Jun. 28, 2022.

(51) Int. Cl. G06F 16/2455; G06F 16/22; G06F 16/23; G06F 16/2453

(52) U.S. Cl. CPC G06F 16/24568; G06F 16/221; G06F 16/2379; G06F 16/24542

(57) ABSTRACT

A database system is operable to determine a query operator execution flow that includes a plurality of operators for execution of a corresponding query against a database having a schema that includes a plurality of columns. The query operator execution flow is executed in conjunction with executing the corresponding query against the database based on generating a first plurality of data blocks of a multi-column data stream as first output of a first operator of the plurality of operators, where each data block of the multi-column data stream includes column values for each of the plurality of columns. Executing the query operator execution flow is further based on processing the multi-column data stream as input of a second operator of the plurality of operators serially after the first operator to generate a second plurality of data blocks as second output of the second operator.

### CROSS-REFERENCE TO RELATED APPLICATIONS

The present U.S. Utility Patent Application claims priority pursuant to 35 U.S.C. § 119(e) to U.S. Provisional Application No. 63/367,147, entitled “EFFICIENT MEMORY UTILIZATION DURING QUERY EXECUTION”, filed Jun. 28, 2022, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networking and more particularly to database system and operation.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system in accordance with the present invention;

FIG. 1A is a schematic block diagram of an embodiment of a database system in accordance with the present invention;

FIG. 2 is a schematic block diagram of an embodiment of an administrative sub-system in accordance with the present invention;

FIG. 3 is a schematic block diagram of an embodiment of a configuration sub-system in accordance with the present invention;

FIG. 4 is a schematic block diagram of an embodiment of a parallelized data input sub-system in accordance with the present invention;

FIG. 5 is a schematic block diagram of an embodiment of a parallelized query and response (Q&R) sub-system in accordance with the present invention;

FIG. 6 is a schematic block diagram of an embodiment of a parallelized data store, retrieve, and/or process (IO& P) sub-system in accordance with the present invention;

FIG. 7 is a schematic block diagram of an embodiment of a computing device in accordance with the present invention;

FIG. 8 is a schematic block diagram of another embodiment of a computing device in accordance with the present invention;

FIG. 9 is a schematic block diagram of another embodiment of a computing device in accordance with the present invention;

FIG. 10 is a schematic block diagram of an embodiment of a node of a computing device in accordance with the present invention;

FIG. 11 is a schematic block diagram of an embodiment of a node of a computing device in accordance with the present invention;

FIG. 12 is a schematic block diagram of an embodiment of a node of a computing device in accordance with the present invention;

FIG. 13 is a schematic block diagram of an embodiment of a node of a computing device in accordance with the present invention;

FIG. 14 is a schematic block diagram of an embodiment of operating systems of a computing device in accordance with the present invention;

FIGS. 15-23 are schematic block diagrams of an example of processing a table or data set for storage in the database system in accordance with the present invention;

FIG. 24A is a schematic block diagram of a query execution plan in accordance with various embodiments;

FIGS. 24B-24D are schematic block diagrams of embodiments of a node that implements a query processing module in accordance with various embodiments;

FIG. 24E is an embodiment is schematic block diagrams illustrating a plurality of nodes that communicate via shuffle networks in accordance with various embodiments;

FIG. 24F is a schematic block diagram of a database system communicating with an external requesting entity in accordance with various embodiments;

FIG. 24G is a schematic block diagram of a query processing system in accordance with various embodiments;

FIG. 24H is a schematic block diagram of a query operator execution flow in accordance with various embodiments;

FIG. 24I is a schematic block diagram of a plurality of nodes that utilize query operator execution flows in accordance with various embodiments;

FIG. 24J is a schematic block diagram of a query execution module that executes a query operator execution flow via a plurality of corresponding operator execution modules in accordance with various embodiments;

FIG. 24K illustrates an example embodiment of a plurality of database tables stored in database storage in accordance with various embodiments;

FIG. 24L is a schematic block diagram of a query execution module that implements a plurality of column data streams in accordance with various embodiments;

FIG. 24M illustrates example data blocks of a column data stream in accordance with various embodiments;

FIG. 25A is a schematic block diagram of a database system executing a join process based on a join expression of a query request in accordance with various embodiments;

FIG. 25B is a schematic block diagram of a query execution module executing a join process via multiple parallel processes in accordance with various embodiments;

FIG. 25C is a schematic block diagram of a query execution module executing a join operator based on utilizing a hasp map generated from right input rows in accordance with various embodiments;

FIG. 26A is a schematic block diagram of a query execution module that spills data items to disk memory resources of disk memory in accordance with various embodiments;

FIG. 26B is a schematic block diagram of a query execution module includes a plurality of nodes that each implement their own disk memory resources and their own query execution memory resources in accordance with various embodiments;

FIG. 26C is a schematic block diagram of a query execution processing resources 3045 that include a plurality of fixed-sized memory resources and of disk memory resources that include a plurality of fixed-size disk pages in accordance with various embodiments;

FIG. 26D is a schematic block diagram of a memory management module that implements a disk spill facilitation module to spill a data item to disk when a disk spill condition is met in accordance with various embodiments;

FIG. 26E is a schematic block diagram of a memory management module that implements a data retrieval module to read a data item from disk when a data retrieval condition is met in accordance with various embodiments;

FIG. 27A is a schematic block diagram of a data spill facilitation module that implements a compression module to spill compressed data items to disk in accordance with various embodiments;

FIG. 27B illustrates a logical flow of a data spill compression procedure implemented by a data spill facilitation module in accordance with various embodiments;

FIG. 27C is a schematic block diagram of an example data spill performed in accordance with a first data spill procedure in accordance with various embodiments;

FIG. 27D-27E are schematic block diagram of an example data spill performed in accordance with a second data spill procedure in accordance with various embodiments;

FIG. 27F is a schematic block diagram of an example data spill performed in accordance with a third data spill procedure in accordance with various embodiments;

FIG. 27G is a schematic block diagram of a data spill facilitation module that generates disk spill metadata for data items spilled to disk in accordance with various embodiments;

FIGS. 27H-27I is a schematic block diagram of a data retrieval module that retrieves and decompresses a data item from disk memory in accordance with various embodiments;

FIG. 27J is a logic diagram illustrating a method for execution in accordance with various embodiments;

FIG. 28A is a schematic block diagram of a database system that executes a query operator execution flow that includes a match-based operation in accordance with various embodiments;

FIG. 28B is a schematic block diagram of executing a match-based operation by implementing a probabilistic filter data structure in accordance with various embodiments;

FIG. 28C is a schematic block diagram of executing a match-based operation by storing a probabilistic filter data structure and a hash map via query execution memory resources in accordance with various embodiments;

FIG. 28D is a schematic block diagram of a filter populating module that adds values to an example probabilistic filter data structure in accordance with various embodiments;

FIG. 28E is a schematic block diagram of a filter populating module that generates a union-based probabilistic filter data structure from existing probabilistic filter data structures in accordance with various embodiments;

FIGS. 28F and 28G are schematic block diagrams of a child operator implementing a union-based probabilistic filter data structures in accordance with various embodiments;

FIG. 28H is a schematic block diagrams of peer operators adding values to probabilistic filter data structures based on applying a union to probabilistic filter data structures of other peer operators in accordance with various embodiments;

FIG. 28I is a schematic block diagram of a query execution module that implements a filter removal determination module in accordance with various embodiments;

FIG. 28J is a schematic block diagram of a match-based operation that foregoes use of a removed probabilistic filter data structure in accordance with various embodiments;

FIG. 28K is a schematic block diagram of a plurality of child operators implementing a match-based operation in accordance with various embodiments;

FIG. 28L is a logic diagram illustrating a method for execution in accordance with various embodiments;

FIG. 29A is a schematic block diagram of a query execution module that implements a multi-column data stream in accordance with various embodiments;

FIG. 29B illustrates example layout of data blocks of a multi-column data stream in accordance with various embodiments;

FIG. 29C is a schematic block diagram of a query execution module that implements a multi-column data stream for fixed-length columns and another multi-column data stream for variable-length columns in accordance with various embodiments;

FIG. 29D is a schematic block diagram of an operator execution module that allocates memory for a multi-column data stream in query execution memory resources in accordance with various embodiments;

FIG. 29E is a schematic block diagram of an operator execution module that writes values to a multi-column data stream in query execution memory resources in accordance with various embodiments;

FIG. 29F is a schematic block diagram of an operator execution module that reads values from a multi-column data stream in query execution memory resources in accordance with various embodiments;

FIG. 29G is a schematic block diagram of operator execution modules that write multi-column data streams in accordance with various embodiments;

FIG. 29H is a schematic block diagram of an operator execution module that implements a multi-column forwarding and/or updating module in accordance with various embodiments;

FIG. 29I is a schematic block diagram of an operator execution module that implements a column update module to generate column update metadata in accordance with various embodiments;

FIG. 29J is a schematic block diagram of a column update module that generates column update metadata in accordance with various embodiments;

FIG. 29K is a schematic block diagram of a column update module that generates subsequent column update metadata in accordance with various embodiments;

FIG. 29L is a schematic block diagram of a column update module that generates column update metadata based on column update parameters in accordance with various embodiments;

FIG. 29M is a schematic block diagram of an operator execution module that implements inclusion of a new column in accordance with various embodiments;

FIG. 29N is a schematic block diagram of an operator execution module that implements forwarding of a new column in accordance with various embodiments;

FIG. 29O is a schematic block diagram of a network serialization module in accordance with various embodiments;

FIG. 29P is a schematic diagram of an operator execution module that stores an exception map structure in column update metadata in accordance with various embodiments;

FIG. 30 is a logic diagram illustrating a method for execution in accordance with various embodiments;

FIG. 31A is a schematic block diagram of a query processing system that implements an expression map structure in accordance with various embodiments;

FIG. 31B is a schematic block diagram of a query execution module that executes an expression evaluation operator by generating a map entry for an exception map structure in accordance with various embodiments;

FIG. 31C is a schematic block diagram of a query execution module that executes an expression evaluation operator on a stream of input rows by generating a stream of map entries for an exception map structure in accordance with various embodiments;

FIG. 31D is a schematic block diagram of a query execution module that executes an expression evaluation operator on an example input data set to generate an example expression map structure for an example new column in accordance with various embodiments;

FIG. 31E is a schematic block diagram of a query execution module that executes an exception checking process based on accessing an exception map structure in accordance with various embodiments;

FIG. 31F is a schematic block diagram of a query execution module that executes an executes an expression evaluation operator to generate serialized map data stored in first memory resources in accordance with various embodiments;

FIG. 31G is a schematic block diagram of a map storage module that stores serialized map data from first memory resources as an exception map structure in second memory resources in accordance with various embodiments.

### DETAILED DESCRIPTION OF THE INVENTION

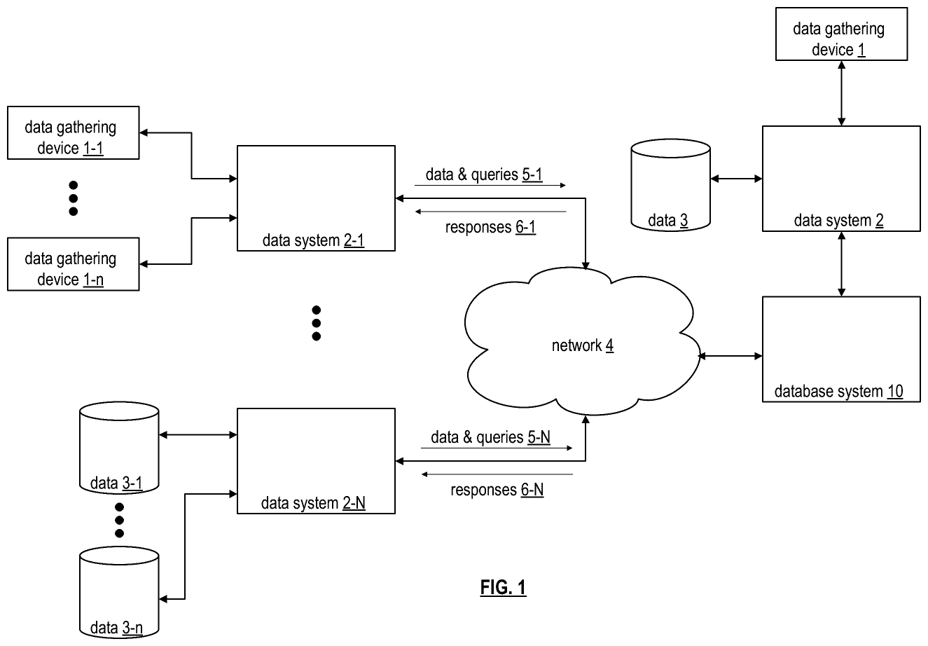

FIG. 1 is a schematic block diagram of an embodiment of a large-scale data processing network that includes data gathering devices (1, 1-1 through 1-n), data systems (2, 2-1 through 2-N), data storage systems (3, 3-1 through 3-n), a network 4, and a database system 10. The data gathering devices are computing devices that collect a wide variety of data and may further include sensors, monitors, measuring instruments, and/or other instrument for collecting data. The data gathering devices collect data in real-time (i.e., as it is happening) and provides it to data system 2-1 for storage and real-time processing of queries 5-1 to produce responses 6-1. As an example, the data gathering devices are computing in a factory collecting data regarding manufacturing of one or more products and the data system is evaluating queries to determine manufacturing efficiency, quality control, and/or product development status.

The data storage systems 3 store existing data. The existing data may originate from the data gathering devices or other sources, but the data is not real time data. For example, the data storage system stores financial data of a bank, a credit card company, or like financial institution. The data system 2-N processes queries 5-N regarding the data stored in the data storage systems to produce responses 6-N.

Data system 2 processes queries regarding real time data from data gathering devices and/or queries regarding non-real time data stored in the data storage system 3. The data system 2 produces responses in regard to the queries. Storage of real time and non-real time data, the processing of queries, and the generating of responses will be discussed with reference to one or more of the subsequent figures.

FIG. 1A is a schematic block diagram of an embodiment of a database system 10 that includes a parallelized data input sub-system 11, a parallelized data store, retrieve, and/or process sub-system 12, a parallelized query and response sub-system 13, system communication resources 14, an administrative sub-system 15, and a configuration sub-system 16. The system communication resources 14 include one or more of wide area network (WAN) connections, local area network (LAN) connections, wireless connections, wireline connections, etc. to couple the sub-systems 11, 12, 13, 15, and 16 together.

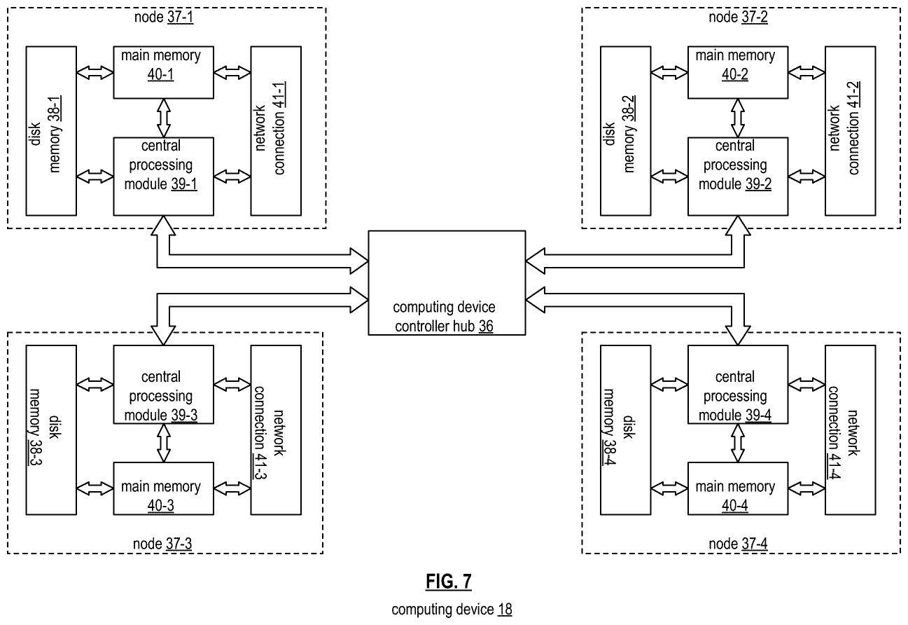

Each of the sub-systems 11, 12, 13, 15, and 16 include a plurality of computing devices; an example of which is discussed with reference to one or more of FIGS. 7-9. Hereafter, the parallelized data input sub-system 11 may also be referred to as a data input sub-system, the parallelized data store, retrieve, and/or process sub-system may also be referred to as a data storage and processing sub-system, and the parallelized query and response sub-system 13 may also be referred to as a query and results sub-system.

In an example of operation, the parallelized data input sub-system 11 receives a data set (e.g., a table) that includes a plurality of records. A record includes a plurality of data fields. As a specific example, the data set includes tables of data from a data source. For example, a data source includes one or more computers. As another example, the data source is a plurality of machines. As yet another example, the data source is a plurality of data mining algorithms operating on one or more computers.

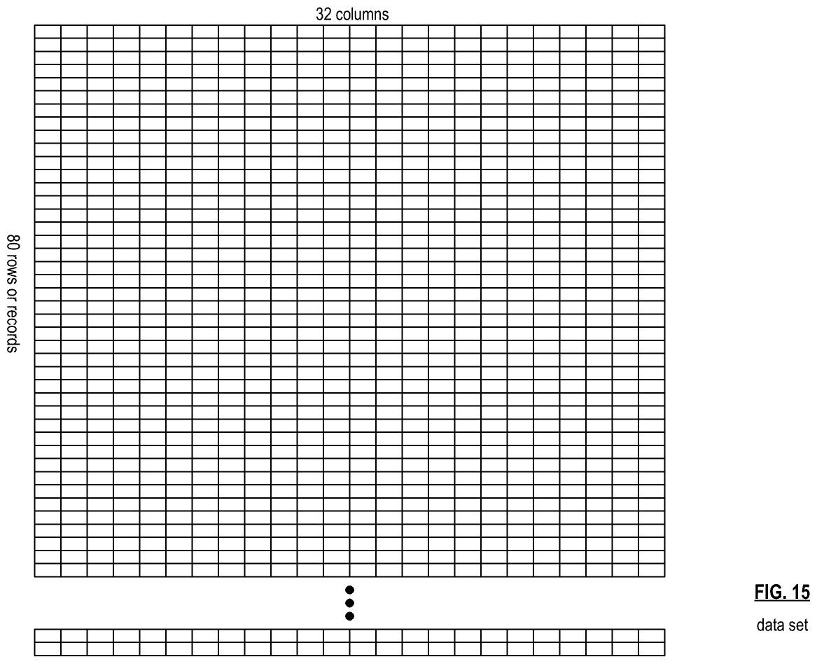

As is further discussed with reference to FIG. 15, the data source organizes its records of the data set into a table that includes rows and columns. The columns represent data fields of data for the rows. Each row corresponds to a record of data. For example, a table include payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data set into a plurality of data partitions. For each partition, the parallelized data input sub-system 11 divides it into a plurality of data segments based on a segmenting factor. The segmenting factor includes a variety of approaches for dividing a partition into segments. For example, the segment factor indicates a number of records to include in a segment. As another example, the segmenting factor indicates a number of segments to include in a segment group. As another example, the segmenting factor identifies how to segment a data partition based on storage capabilities of the data store and processing sub-system. As a further example, the segmenting factor indicates how many segments for a data partition based on a redundancy storage encoding scheme.

As an example of dividing a data partition into segments based on a redundancy storage encoding scheme, assume that it includes a 4 of 5 encoding scheme (meaning any 4 of 5 encoded data elements can be used to recover the data). Based on these parameters, the parallelized data input sub-system 11 divides a data partition into 5 segments: one corresponding to each of the data elements).

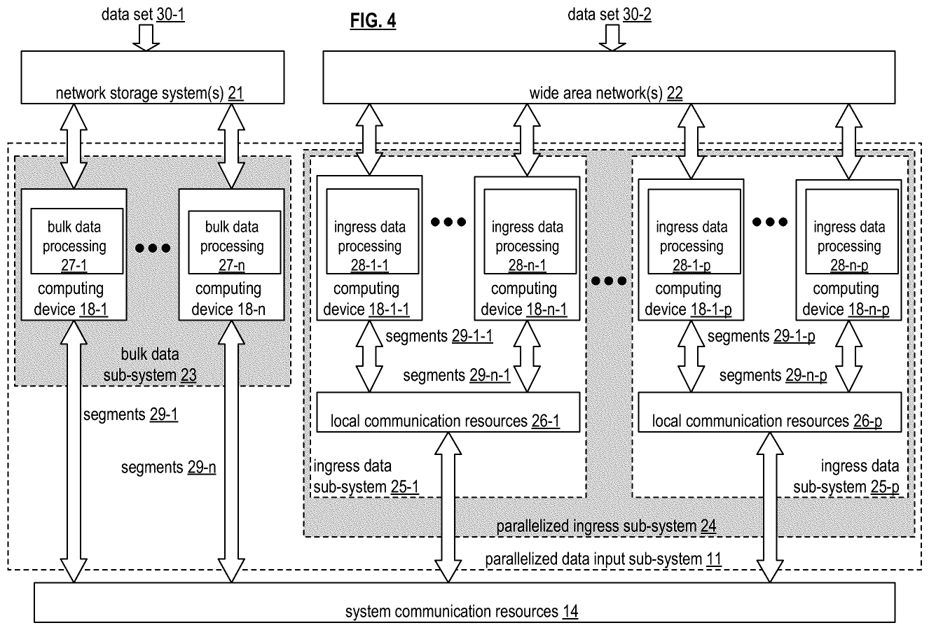

The parallelized data input sub-system 11 restructures the plurality of data segments to produce restructured data segments. For example, the parallelized data input sub-system 11 restructures records of a first data segment of the plurality of data segments based on a key field of the plurality of data fields to produce a first restructured data segment. The key field is common to the plurality of records. As a specific example, the parallelized data input sub-system 11 restructures a first data segment by dividing the first data segment into a plurality of data slabs (e.g., columns of a segment of a partition of a table). Using one or more of the columns as a key, or keys, the parallelized data input sub-system 11 sorts the data slabs. The restructuring to produce the data slabs is discussed in greater detail with reference to FIG. 4 and FIGS. 16-18.

The parallelized data input sub-system 11 also generates storage instructions regarding how sub-system 12 is to store the restructured data segments for efficient processing of subsequently received queries regarding the stored data. For example, the storage instructions include one or more of: a naming scheme, a request to store, a memory resource requirement, a processing resource requirement, an expected access frequency level, an expected storage duration, a required maximum access latency time, and other requirements associated with storage, processing, and retrieval of data.

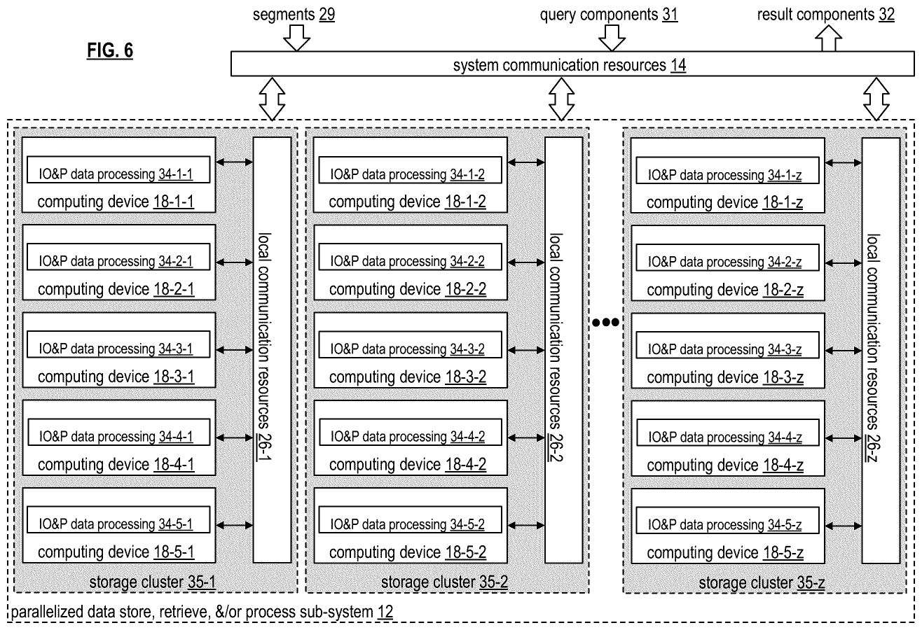

A designated computing device of the parallelized data store, retrieve, and/or process sub-system 12 receives the restructured data segments and the storage instructions. The designated computing device (which is randomly selected, selected in a round robin manner, or by default) interprets the storage instructions to identify resources (e.g., itself, its components, other computing devices, and/or components thereof) within the computing device's storage cluster. The designated computing device then divides the restructured data segments of a segment group of a partition of a table into segment divisions based on the identified resources and/or the storage instructions. The designated computing device then sends the segment divisions to the identified resources for storage and subsequent processing in accordance with a query. The operation of the parallelized data store, retrieve, and/or process sub-system 12 is discussed in greater detail with reference to FIG. 6.

The parallelized query and response sub-system 13 receives queries regarding tables (e.g., data sets) and processes the queries prior to sending them to the parallelized data store, retrieve, and/or process sub-system 12 for execution. For example, the parallelized query and response sub-system 13 generates an initial query plan based on a data processing request (e.g., a query) regarding a data set (e.g., the tables). Sub-system 13 optimizes the initial query plan based on one or more of the storage instructions, the engaged resources, and optimization functions to produce an optimized query plan.

For example, the parallelized query and response sub-system 13 receives a specific query no. 1 regarding the data set no. 1 (e.g., a specific table). The query is in a standard query format such as Open Database Connectivity (ODBC), Java Database Connectivity (JDBC), and/or SPARK. The query is assigned to a node within the parallelized query and response sub-system 13 for processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Structured Query Language) statement into a database instruction set. The assigned node then validates the abstract syntax tree. If not valid, the assigned node generates a SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

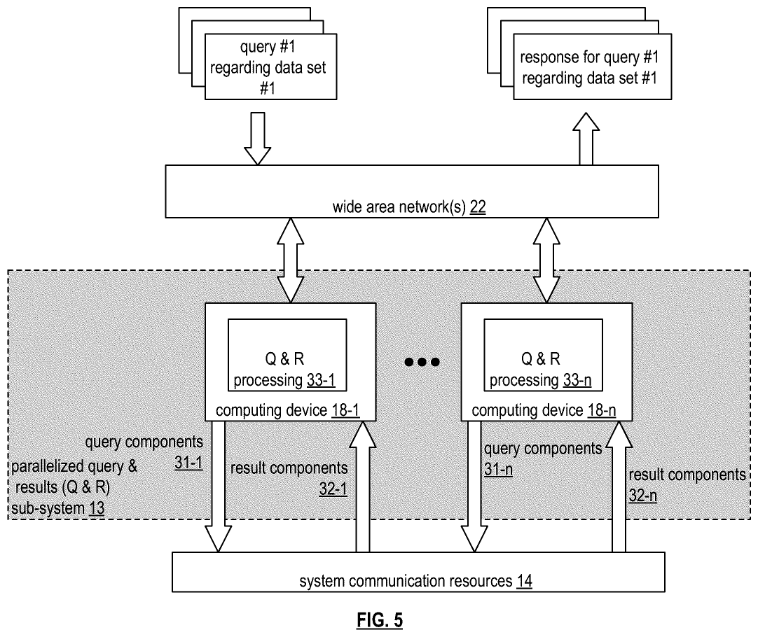

The assigned node then creates an initial query plan from the annotated abstract syntax tree. The assigned node optimizes the initial query plan using a cost analysis function (e.g., processing time, processing resources, etc.) and/or other optimization functions. Having produced the optimized query plan, the parallelized query and response sub-system 13 sends the optimized query plan to the parallelized data store, retrieve, and/or process sub-system 12 for execution. The operation of the parallelized query and response sub-system 13 is discussed in greater detail with reference to FIG. 5.

The parallelized data store, retrieve, and/or process sub-system 12 executes the optimized query plan to produce resultants and sends the resultants to the parallelized query and response sub-system 13. Within the parallelized data store, retrieve, and/or process sub-system 12, a computing device is designated as a primary device for the query plan (e.g., optimized query plan) and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan.

The primary device of the parallelized data store, retrieve, and/or process sub-system 12 provides the resulting response (e.g., resultants) to the assigned node of the parallelized query and response sub-system 13. For example, the assigned node determines whether further processing is needed on the resulting response (e.g., joining, filtering, etc.). If not, the assigned node outputs the resulting response as the response to the query (e.g., a response for query no. 1 regarding data set no. 1). If, however, further processing is determined, the assigned node further processes the resulting response to produce the response to the query. Having received the resultants, the parallelized query and response sub-system 13 creates a response from the resultants for the data processing request.

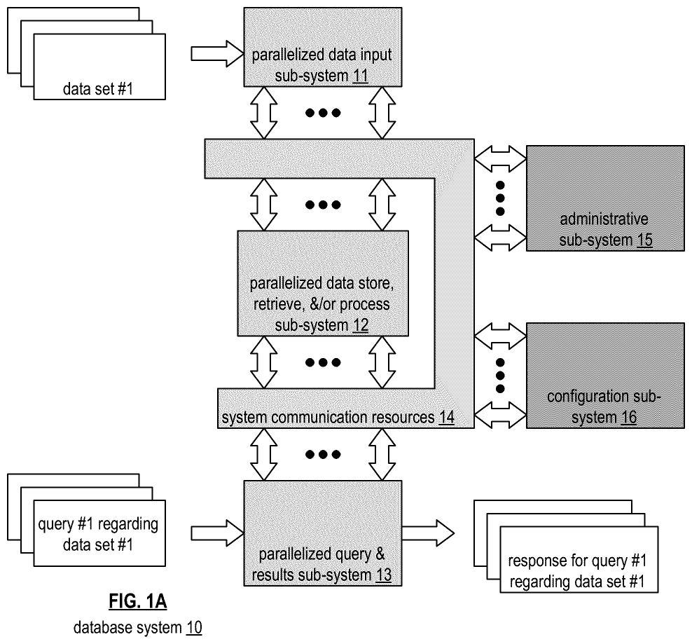

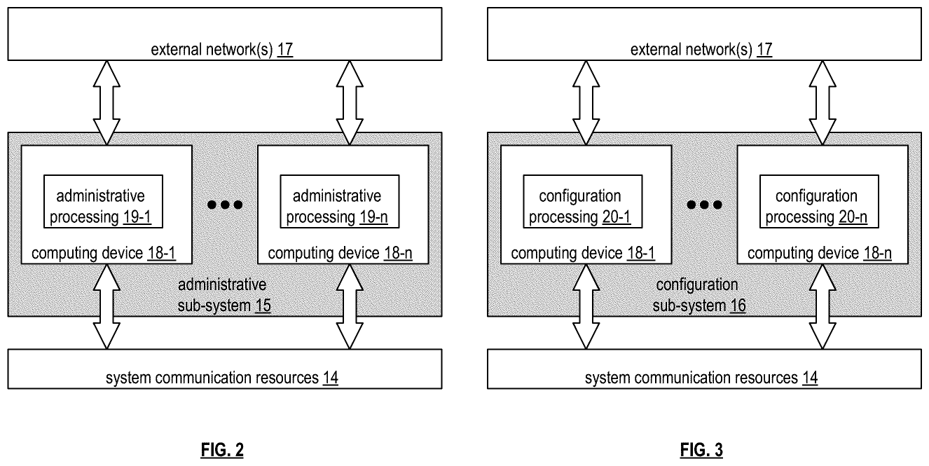

FIG. 2 is a schematic block diagram of an embodiment of the administrative sub-system 15 of FIG. 1A that includes one or more computing devices 18-1 through 18-n. Each of the computing devices executes an administrative processing function utilizing a corresponding administrative processing of administrative processing 19-1 through 19-n (which includes a plurality of administrative operations) that coordinates system level operations of the database system. Each computing device is coupled to an external network 17, or networks, and to the system communication resources 14 of FIG. 1A.

As will be described in greater detail with reference to one or more subsequent figures, a computing device includes a plurality of nodes and each node includes a plurality of processing core resources. Each processing core resource is capable of executing at least a portion of an administrative operation independently. This supports lock free and parallel execution of one or more administrative operations.

The administrative sub-system 15 functions to store metadata of the data set described with reference to FIG. 1A. For example, the storing includes generating the metadata to include one or more of an identifier of a stored table, the size of the stored table (e.g., bytes, number of columns, number of rows, etc.), labels for key fields of data segments, a data type indicator, the data owner, access permissions, available storage resources, storage resource specifications, software for operating the data processing, historical storage information, storage statistics, stored data access statistics (e.g., frequency, time of day, accessing entity identifiers, etc.) and any other information associated with optimizing operation of the database system 10.

FIG. 3 is a schematic block diagram of an embodiment of the configuration sub-system 16 of FIG. 1A that includes one or more computing devices 18-1 through 18-n. Each of the computing devices executes a configuration processing function 20-1 through 20-n (which includes a plurality of configuration operations) that coordinates system level configurations of the database system. Each computing device is coupled to the external network 17 of FIG. 2, or networks, and to the system communication resources 14 of FIG. 1A.

FIG. 4 is a schematic block diagram of an embodiment of the parallelized data input sub-system 11 of FIG. 1A that includes a bulk data sub-system 23 and a parallelized ingress sub-system 24. The bulk data sub-system 23 includes a plurality of computing devices 18-1 through 18-n. A computing device includes a bulk data processing function (e.g., 27-1) for receiving a table from a network storage system 21 (e.g., a server, a cloud storage service, etc.) and processing it for storage as generally discussed with reference to FIG. 1A.

The parallelized ingress sub-system 24 includes a plurality of ingress data sub-systems 25-1 through 25-p that each include a local communication resource of local communication resources 26-1 through 26-p and a plurality of computing devices 18-1 through 18-n. A computing device executes an ingress data processing function (e.g., 28-1) to receive streaming data regarding a table via a wide area network 22 and processing it for storage as generally discussed with reference to FIG. 1A. With a plurality of ingress data sub-systems 25-1 through 25-p, data from a plurality of tables can be streamed into the database system 10 at one time.

In general, the bulk data processing function is geared towards receiving data of a table in a bulk fashion (e.g., the table exists and is being retrieved as a whole, or portion thereof). The ingress data processing function is geared towards receiving streaming data from one or more data sources (e.g., receive data of a table as the data is being generated). For example, the ingress data processing function is geared towards receiving data from a plurality of machines in a factory in a periodic or continual manner as the machines create the data.

FIG. 5 is a schematic block diagram of an embodiment of a parallelized query and results sub-system 13 that includes a plurality of computing devices 18-1 through 18-n. Each of the computing devices executes a query (Q) & response (R) processing function 33-1 through 33-n. The computing devices are coupled to the wide area network 22 to receive queries (e.g., query no. 1 regarding data set no. 1) regarding tables and to provide responses to the queries (e.g., response for query no. 1 regarding the data set no. 1). For example, a computing device (e.g., 18-1) receives a query, creates an initial query plan therefrom, and optimizes it to produce an optimized plan. The computing device then sends components (e.g., one or more operations) of the optimized plan to the parallelized data store, retrieve, &/or process sub-system 12.

Processing resources of the parallelized data store, retrieve, &/or process sub-system 12 processes the components of the optimized plan to produce results components 32-1 through 32-n. The computing device of the Q&R sub-system 13 processes the result components to produce a query response.

The Q&R sub-system 13 allows for multiple queries regarding one or more tables to be processed concurrently. For example, a set of processing core resources of a computing device (e.g., one or more processing core resources) processes a first query and a second set of processing core resources of the computing device (or a different computing device) processes a second query.

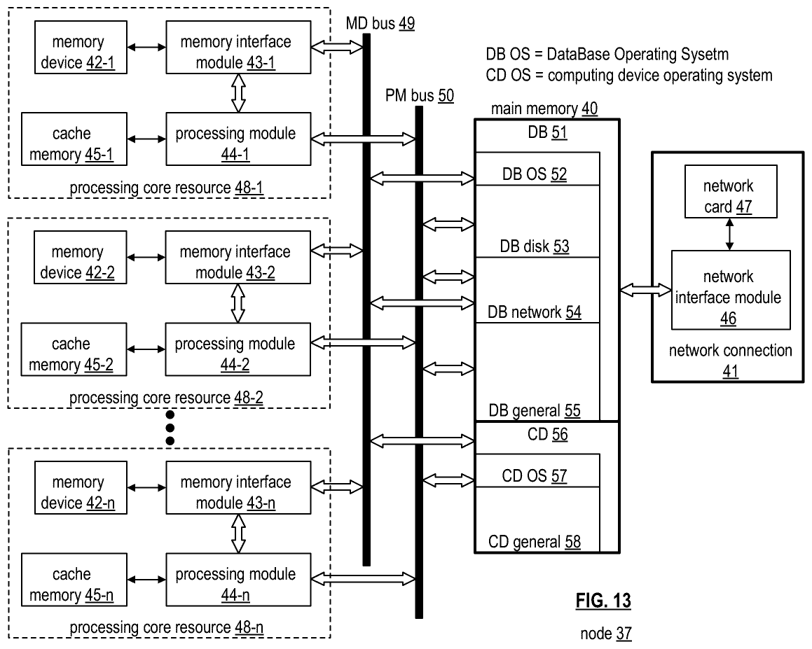

As will be described in greater detail with reference to one or more subsequent figures, a computing device includes a plurality of nodes and each node includes multiple processing core resources such that a plurality of computing devices includes pluralities of multiple processing core resources A processing core resource of the pluralities of multiple processing core resources generates the optimized query plan and other processing core resources of the pluralities of multiple processing core resources generates other optimized query plans for other data processing requests. Each processing core resource is capable of executing at least a portion of the Q & R function. In an embodiment, a plurality of processing core resources of one or more nodes executes the Q & R function to produce a response to a query. The processing core resource is discussed in greater detail with reference to FIG. 13.

FIG. 6 is a schematic block diagram of an embodiment of a parallelized data store, retrieve, and/or process sub-system 12 that includes a plurality of computing devices, where each computing device includes a plurality of nodes and each node includes multiple processing core resources. Each processing core resource is capable of executing at least a portion of the function of the parallelized data store, retrieve, and/or process sub-system 12. The plurality of computing devices is arranged into a plurality of storage clusters. Each storage cluster includes a number of computing devices.

In an embodiment, the parallelized data store, retrieve, and/or process sub-system 12 includes a plurality of storage clusters 35-1 through 35-z. Each storage cluster includes a corresponding local communication resource 26-1 through 26-z and a number of computing devices 18-1 through 18-5. Each computing device executes an input, output, and processing (IO &P) processing function 34-1 through 34-5 to store and process data.

The number of computing devices in a storage cluster corresponds to the number of segments (e.g., a segment group) in which a data partitioned is divided. For example, if a data partition is divided into five segments, a storage cluster includes five computing devices. As another example, if the data is divided into eight segments, then there are eight computing devices in the storage clusters.

To store a segment group of segments 29 within a storage cluster, a designated computing device of the storage cluster interprets storage instructions to identify computing devices (and/or processing core resources thereof) for storing the segments to produce identified engaged resources. The designated computing device is selected by a random selection, a default selection, a round-robin selection, or any other mechanism for selection.

The designated computing device sends a segment to each computing device in the storage cluster, including itself. Each of the computing devices stores their segment of the segment group. As an example, five segments 29 of a segment group are stored by five computing devices of storage cluster 35-1. The first computing device 18-1-1 stores a first segment of the segment group; a second computing device 18-2-1 stores a second segment of the segment group; and so on. With the segments stored, the computing devices are able to process queries (e.g., query components from the Q&R sub-system 13) and produce appropriate result components.

While storage cluster 35-1 is storing and/or processing a segment group, the other storage clusters 35-2 through 35-n are storing and/or processing other segment groups. For example, a table is partitioned into three segment groups. Three storage clusters store and/or process the three segment groups independently. As another example, four tables are independently stored and/or processed by one or more storage clusters. As yet another example, storage cluster 35-1 is storing and/or processing a second segment group while it is storing/or and processing a first segment group.

FIG. 7 is a schematic block diagram of an embodiment of a computing device 18 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4 (e.g., volatile memory), a disk memory 38-1 through 38-4 (non-volatile memory), and a network connection 41-1 through 41-4. In an alternate configuration, the nodes share a network connection, which is coupled to the computing device controller hub 36 or to one of the nodes as illustrated in subsequent figures.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

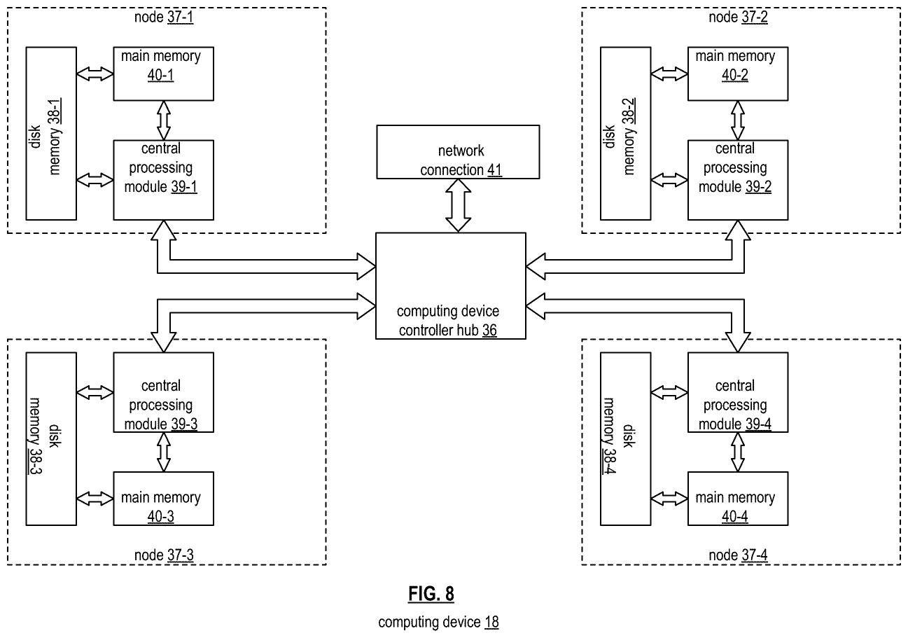

FIG. 8 is a schematic block diagram of another embodiment of a computing device similar to the computing device of FIG. 7 with an exception that it includes a single network connection 41, which is coupled to the computing device controller hub 36. As such, each node coordinates with the computing device controller hub to transmit or receive data via the network connection.

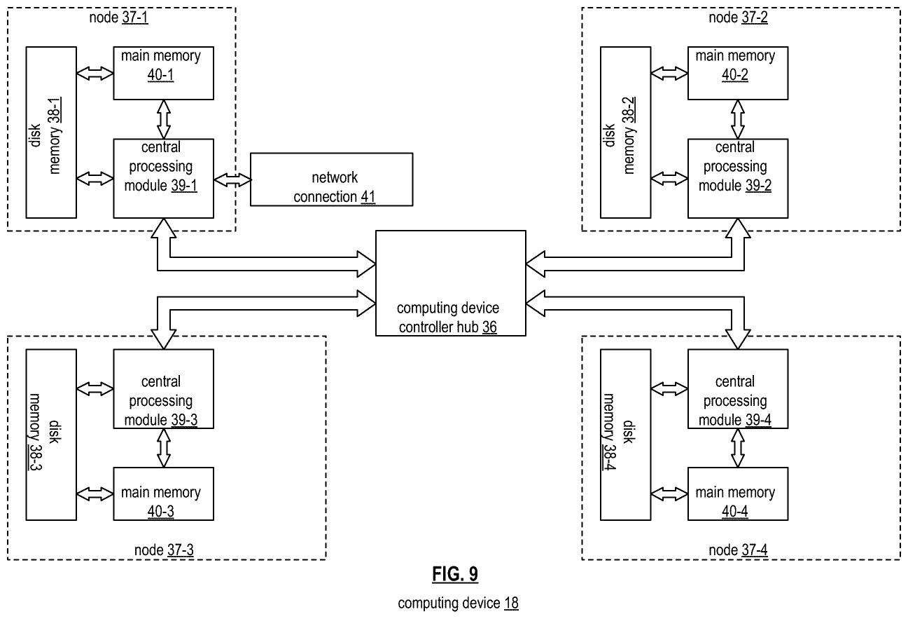

FIG. 9 is a schematic block diagram of another embodiment of a computing device is similar to the computing device of FIG. 7 with an exception that it includes a single network connection 41, which is coupled to a central processing module of a node (e.g., to central processing module 39-1 of node 37-1). As such, each node coordinates with the central processing module via the computing device controller hub 36 to transmit or receive data via the network connection.

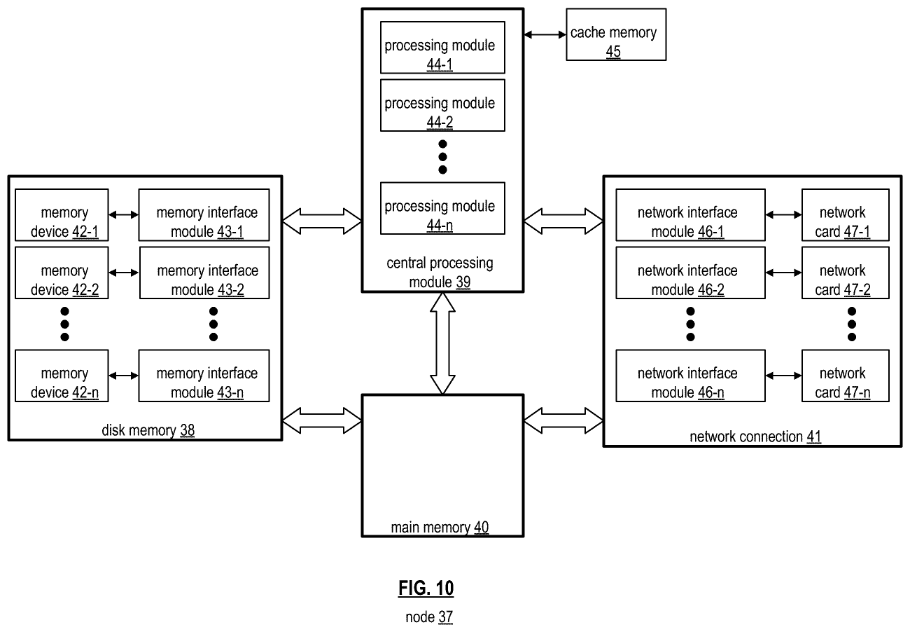

FIG. 10 is a schematic block diagram of an embodiment of a node 37 of computing device 18. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n and an associated one or more cache memory 45. A processing module is as defined at the end of the detailed description.

The disk memory 38 includes a plurality of memory interface modules 43-1 through 43-n and a plurality of memory devices 42-1 through 42-n (e.g., non-volatile memory). The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card includes a wireless LAN (WLAN) device (e.g., an IEEE 802.11n or another protocol), a LAN device (e.g., Ethernet), a cellular device (e.g., CDMA), etc. The corresponding network interface modules 46-1 through 46-n include a software driver for the corresponding network card and a physical connection that couples the network card to the central processing module 39 or other component(s) of the node.

The connections between the central processing module 39, the main memory 40, the disk memory 38, and the network connection 41 may be implemented in a variety of ways. For example, the connections are made through a node controller (e.g., a local version of the computing device controller hub 36). As another example, the connections are made through the computing device controller hub 36.

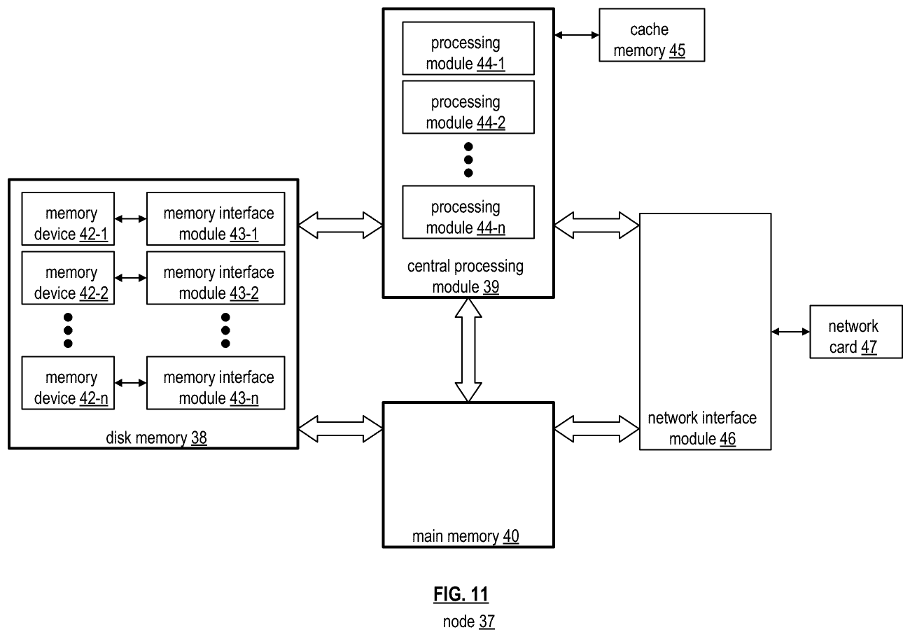

FIG. 11 is a schematic block diagram of an embodiment of a node 37 of a computing device 18 that is similar to the node of FIG. 10, with a difference in the network connection. In this embodiment, the node 37 includes a single network interface module 46 and a corresponding network card 47 configuration.

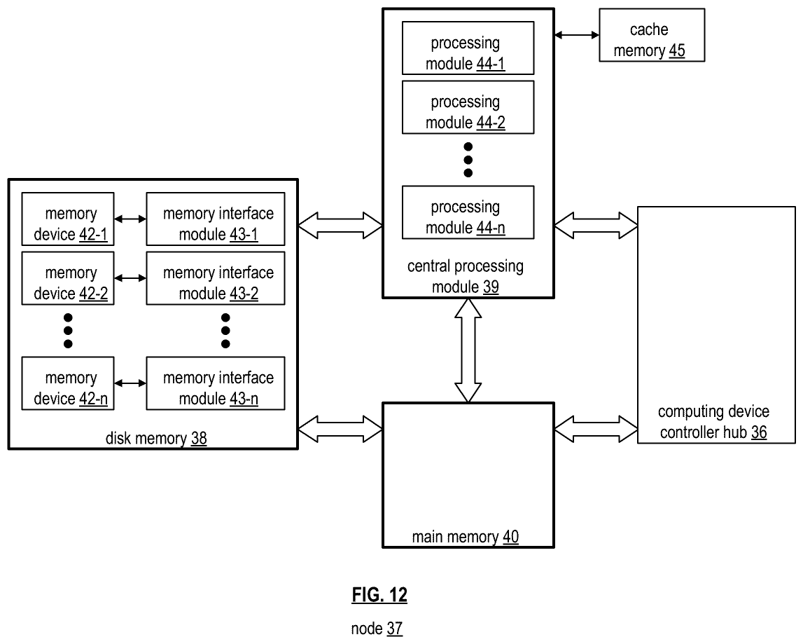

FIG. 12 is a schematic block diagram of an embodiment of a node 37 of a computing device 18 that is similar to the node of FIG. 10, with a difference in the network connection. In this embodiment, the node 37 connects to a network connection via the computing device controller hub 36.

FIG. 13 is a schematic block diagram of another embodiment of a node 37 of computing device 18 that includes processing core resources 48-1 through 48-n, a memory device (MD) bus 49, a processing module (PM) bus 50, a main memory 40 and a network connection 41. The network connection 41 includes the network card 47 and the network interface module 46 of FIG. 10. Each processing core resource 48 includes a corresponding processing module 44-1 through 44-n, a corresponding memory interface module 43-1 through 43-n, a corresponding memory device 42-1 through 42-n, and a corresponding cache memory 45-1 through 45-n. In this configuration, each processing core resource can operate independently of the other processing core resources. This further supports increased parallel operation of database functions to further reduce execution time.

The main memory 40 is divided into a computing device (CD) 56 section and a database (DB) 51 section. The database section includes a database operating system (OS) area 52, a disk area 53, a network area 54, and a general area 55. The computing device section includes a computing device operating system (OS) area 57 and a general area 58. Note that each section could include more or less allocated areas for various tasks being executed by the database system.

In general, the database OS 52 allocates main memory for database operations. Once allocated, the computing device OS 57 cannot access that portion of the main memory 40. This supports lock free and independent parallel execution of one or more operations.

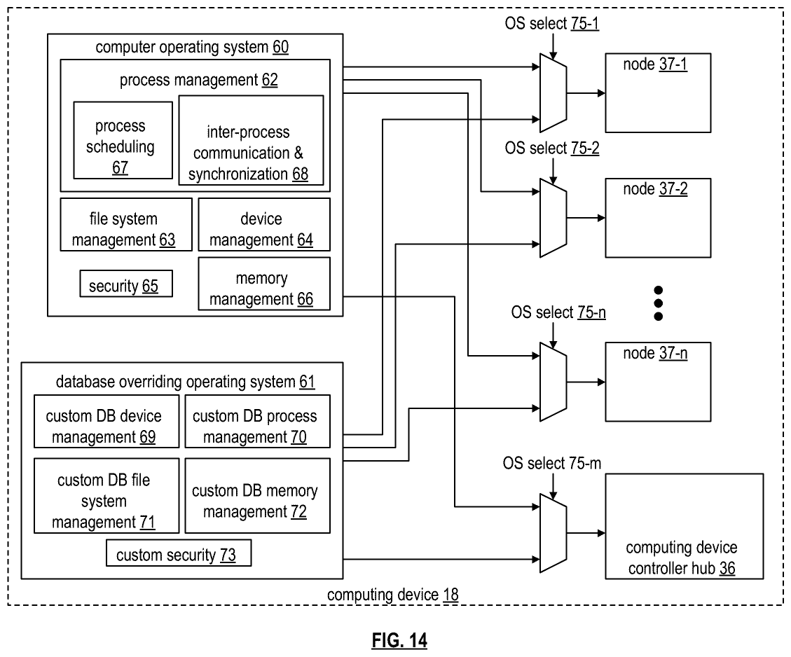

FIG. 14 is a schematic block diagram of an embodiment of operating systems of a computing device 18. The computing device 18 includes a computer operating system 60 and a database overriding operating system (DB OS) 61. The computer OS 60 includes process management 62, file system management 63, device management 64, memory management 66, and security 65. The processing management 62 generally includes process scheduling 67 and inter-process communication and synchronization 68. In general, the computer OS 60 is a conventional operating system used by a variety of types of computing devices. For example, the computer operating system is a personal computer operating system, a server operating system, a tablet operating system, a cell phone operating system, etc.

The database overriding operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database overriding OS 61 provides hardware components of a node for more direct access to memory, more direct access to a network connection, improved independency, improved data storage, improved data retrieval, and/or improved data processing than the computing device OS.

In an example of operation, the database overriding OS 61 controls which operating system, or portions thereof, operate with each node and/or computing device controller hub of a computing device (e.g., via OS select 75-1 through 75-n when communicating with nodes 37-1 through 37-n and via OS select 75-m when communicating with the computing device controller hub 36). For example, device management of a node is supported by the computer operating system, while process management, memory management, and file system management are supported by the database overriding operating system. To override the computer OS, the database overriding OS provides instructions to the computer OS regarding which management tasks will be controlled by the database overriding OS. The database overriding OS also provides notification to the computer OS as to which sections of the main memory it is reserving exclusively for one or more database functions, operations, and/or tasks. One or more examples of the database overriding operating system are provided in subsequent figures.

The database system 10 can be implemented as a massive scale database system that is operable to process data at a massive scale. As used herein, a massive scale refers to a massive number of records of a single dataset and/or many datasets, such as millions, billions, and/or trillions of records that collectively include many Gigabytes, Terabytes, Petabytes, and/or Exabytes of data. As used herein, a massive scale database system refers to a database system operable to process data at a massive scale. The processing of data at this massive scale can be achieved via a large number, such as hundreds, thousands, and/or millions of computing devices 18, nodes 37, and/or processing core resources 48 performing various functionality of database system 10 described herein in parallel, for example, independently and/or without coordination.

Such processing of data at this massive scale cannot practically be performed by the human mind. In particular, the human mind is not equipped to perform processing of data at a massive scale. Furthermore, the human mind is not equipped to perform hundreds, thousands, and/or millions of independent processes in parallel, within overlapping time spans. The embodiments of database system 10 discussed herein improves the technology of database systems by enabling data to be processed at a massive scale efficiently and/or reliably.

In particular, the database system 10 can be operable to receive data and/or to store received data at a massive scale. For example, the parallelized input and/or storing of data by the database system 10 achieved by utilizing the parallelized data input sub-system 11 and/or the parallelized data store, retrieve, and/or process sub-system 12 can cause the database system 10 to receive records for storage at a massive scale, where millions, billions, and/or trillions of records that collectively include many Gigabytes, Terabytes, Petabytes, and/or Exabytes can be received for storage, for example, reliably, redundantly and/or with a guarantee that no received records are missing in storage and/or that no received records are duplicated in storage. This can include processing real-time and/or near-real time data streams from one or more data sources at a massive scale based on facilitating ingress of these data streams in parallel. To meet the data rates required by these one or more real-time data streams, the processing of incoming data streams can be distributed across hundreds, thousands, and/or millions of computing devices 18, nodes 37, and/or processing core resources 48 for separate, independent processing with minimal and/or no coordination. The processing of incoming data streams for storage at this scale and/or this data rate cannot practically be performed by the human mind. The processing of incoming data streams for storage at this scale and/or this data rate improves database system by enabling greater amounts of data to be stored in databases for analysis and/or by enabling real-time data to be stored and utilized for analysis. The resulting richness of data stored in the database system can improve the technology of database systems by improving the depth and/or insights of various data analyses performed upon this massive scale of data.

Additionally, the database system 10 can be operable to perform queries upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to retrieve stored records at a massive scale and/or to and/or filter, aggregate, and/or perform query operators upon records at a massive scale in conjunction with query execution, where millions, billions, and/or trillions of records that collectively include many Gigabytes, Terabytes, Petabytes, and/or Exabytes can be accessed and processed in accordance with execution of one or more queries at a given time, for example, reliably, redundantly and/or with a guarantee that no records are inadvertently missing from representation in a query resultant and/or duplicated in a query resultant. To execute a query against a massive scale of records in a reasonable amount of time such as a small number of seconds, minutes, or hours, the processing of a given query can be distributed across hundreds, thousands, and/or millions of computing devices 18, nodes 37, and/or processing core resources 48 for separate, independent processing with minimal and/or no coordination. The processing of queries at this massive scale and/or this data rate cannot practically be performed by the human mind. The processing of queries at this massive scale improves the technology of database systems by facilitating greater depth and/or insights of query resultants for queries performed upon this massive scale of data.

Furthermore, the database system 10 can be operable to perform multiple queries concurrently upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to perform multiple queries concurrently, for example, in parallel, against data at this massive scale, where hundreds and/or thousands of queries can be performed against the same, massive scale dataset within a same time frame and/or in overlapping time frames. To execute multiple concurrent queries against a massive scale of records in a reasonable amount of time such as a small number of seconds, minutes, or hours, the processing of a multiple queries can be distributed across hundreds, thousands, and/or millions of computing devices 18, nodes 37, and/or processing core resources 48 for separate, independent processing with minimal and/or no coordination. A given computing devices 18, nodes 37, and/or processing core resources 48 may be responsible for participating in execution of multiple queries at a same time and/or within a given time frame, where its execution of different queries occurs within overlapping time frames. The processing of many, concurrent queries at this massive scale and/or this data rate cannot practically be performed by the human mind. The processing of concurrent queries improves the technology of database systems by facilitating greater numbers of users and/or greater numbers of analyses to be serviced within a given time frame and/or over time.

FIGS. 15-23 are schematic block diagrams of an example of processing a table or data set for storage in the database system 10. FIG. 15 illustrates an example of a data set or table that includes 32 columns and 80 rows, or records, that is received by the parallelized data input-subsystem. This is a very small table, but is sufficient for illustrating one or more concepts regarding one or more aspects of a database system. The table is representative of a variety of data ranging from insurance data, to financial data, to employee data, to medical data, and so on.

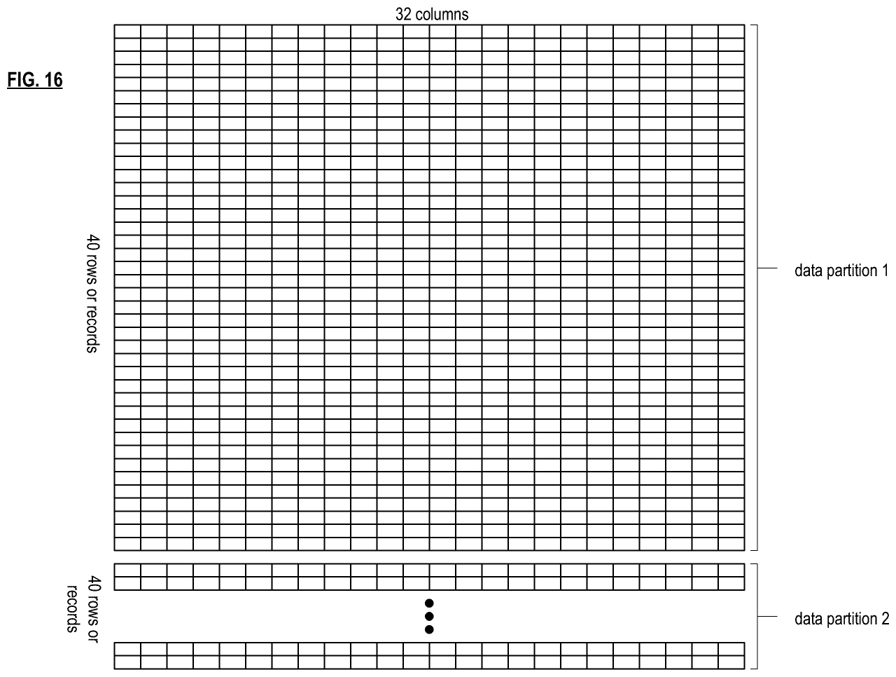

FIG. 16 illustrates an example of the parallelized data input-subsystem dividing the data set into two partitions. Each of the data partitions includes 40 rows, or records, of the data set. In another example, the parallelized data input-subsystem divides the data set into more than two partitions. In yet another example, the parallelized data input-subsystem divides the data set into many partitions and at least two of the partitions have a different number of rows.

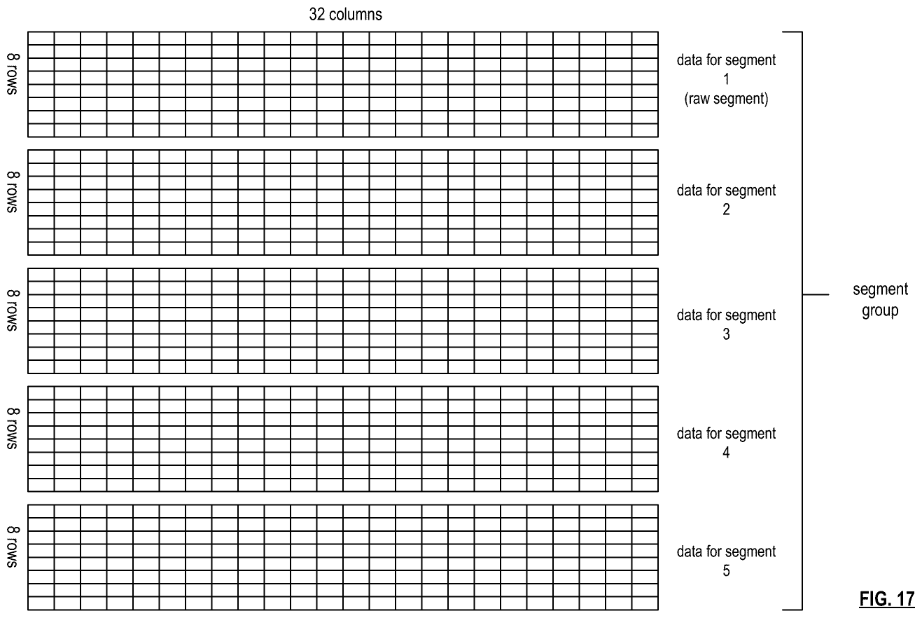

FIG. 17 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created. In another example, the data redundancy encoding is a two parity encoding from four data pieces; thus, six segments are created. In yet another example, the data redundancy encoding is single parity encoding from seven data pieces; thus, eight segments are created.

FIG. 18 illustrates an example of data for segment 1 of the segments of FIG. 17. The segment is in a raw form since it has not yet been key column sorted. As shown, segment 1 includes 8 rows and 32 columns. The third column is selected as the key column and the other columns stored various pieces of information for a given row (i.e., a record). The key column may be selected in a variety of ways. For example, the key column is selected based on a type of query (e.g., a query regarding a year, where a data column is selected as the key column). As another example, the key column is selected in accordance with a received input command that identified the key column. As yet another example, the key column is selected as a default key column (e.g., a date column, an ID column, etc.)

As an example, the table is regarding a fleet of vehicles. Each row represents data regarding a unique vehicle. The first column stores a vehicle ID, the second column stores make and model information of the vehicle. The third column stores data as to whether the vehicle is on or off. The remaining columns store data regarding the operation of the vehicle such as mileage, gas level, oil level, maintenance information, routes taken, etc.

With the third column selected as the key column, the other columns of the segment are to be sorted based on the key column. Prior to being sorted, the columns are separated to form data slabs. As such, one column is separated out to form one data slab.

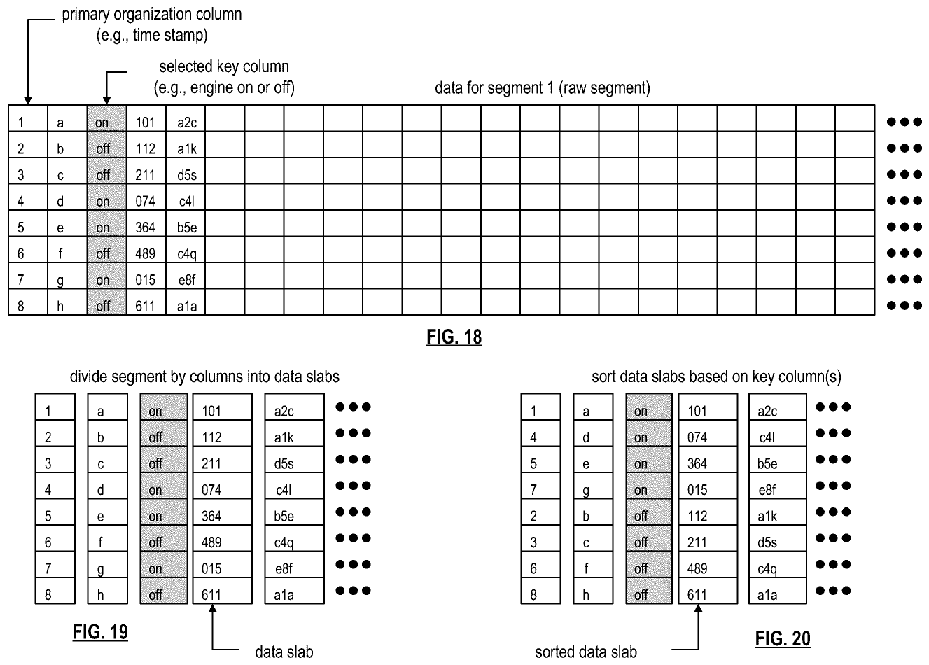

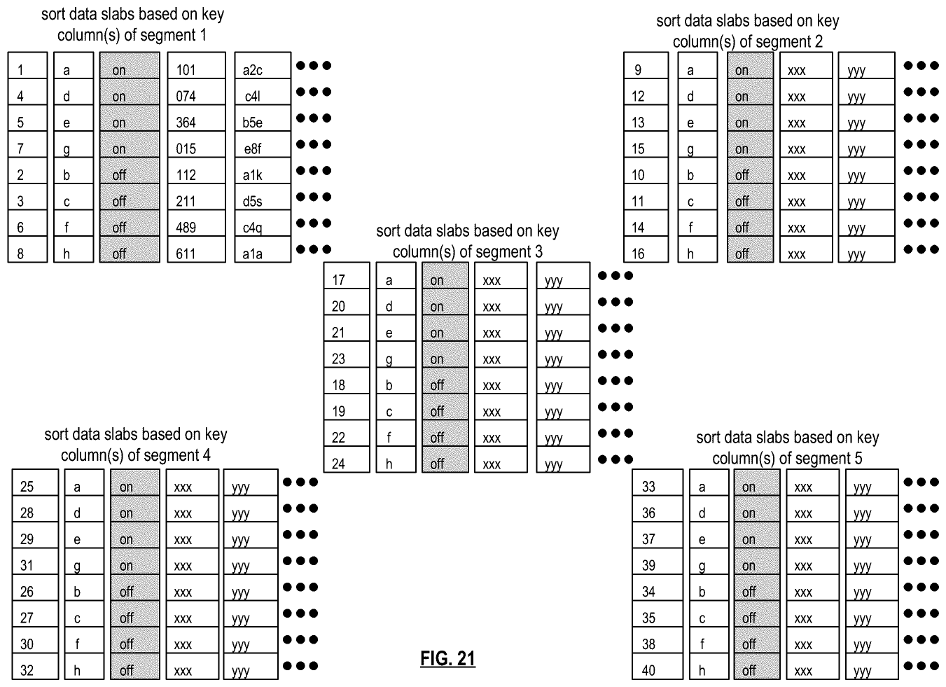

FIG. 19 illustrates an example of the parallelized data input-subsystem dividing segment 1 of FIG. 18 into a plurality of data slabs. A data slab is a column of segment 1. In this figure, the data of the data slabs has not been sorted. Once the columns have been separated into data slabs, each data slab is sorted based on the key column. Note that more than one key column may be selected and used to sort the data slabs based on two or more other columns.

FIG. 20 illustrates an example of the parallelized data input-subsystem sorting the each of the data slabs based on the key column. In this example, the data slabs are sorted based on the third column which includes data of “on” or “off”. The rows of a data slab are rearranged based on the key column to produce a sorted data slab. Each segment of the segment group is divided into similar data slabs and sorted by the same key column to produce sorted data slabs.

FIG. 21 illustrates an example of each segment of the segment group sorted into sorted data slabs. The similarity of data from segment to segment is for the convenience of illustration. Note that each segment has its own data, which may or may not be similar to the data in the other sections.

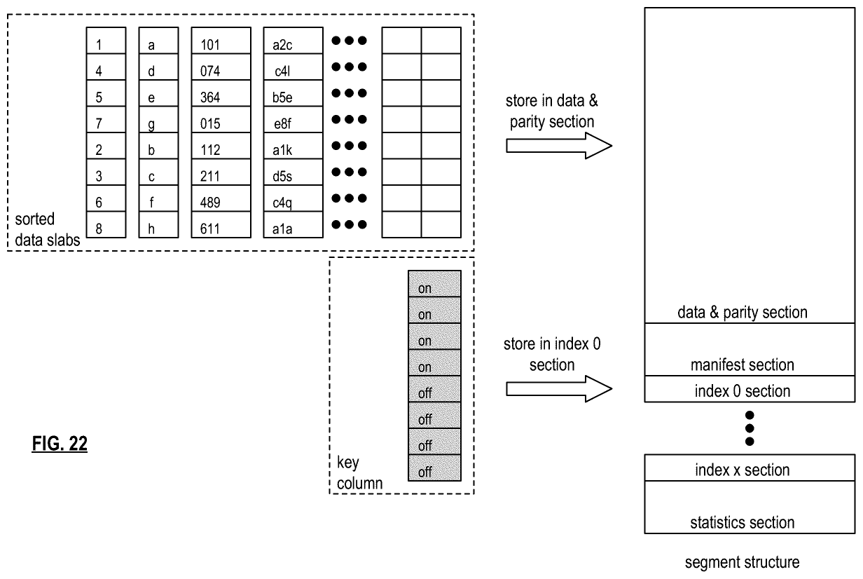

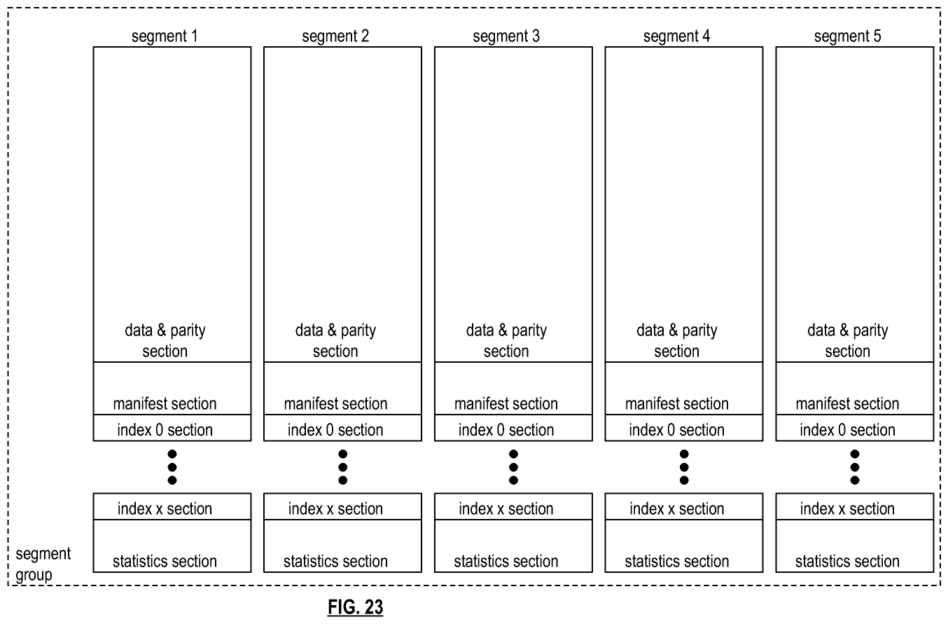

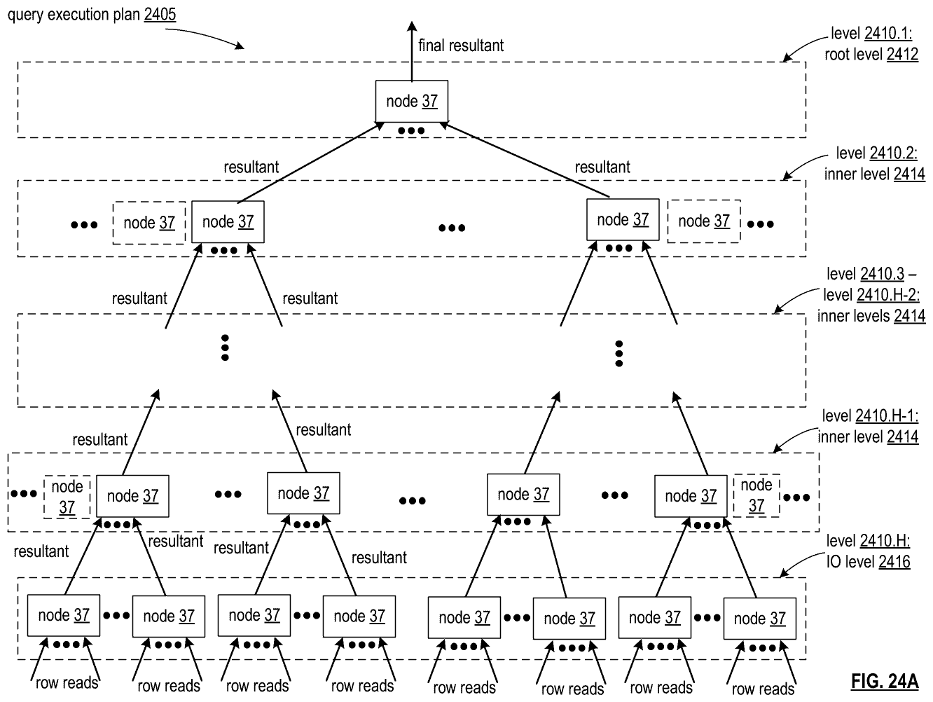

FIG. 22 illustrates an example of a segment structure for a segment of the segment group. The segment structure for a segment includes the data & parity section, a manifest section, one or more index sections, and a statistics section. The segment structure represents a storage mapping of the data (e.g., data slabs and parity data) of a segment and associated data (e.g., metadata, statistics, key column(s), etc.) regarding the data of the segment. The sorted data slabs of FIG. 16 of the segment are stored in the data & parity section of the segment structure. The sorted data slabs are stored in the data & parity section in a compressed format or as raw data (i.e., non-compressed format). Note that a segment structure has a particular data size (e.g., 32 Giga-Bytes) and data is stored within coding block sizes (e.g., 4 Kilo-Bytes).

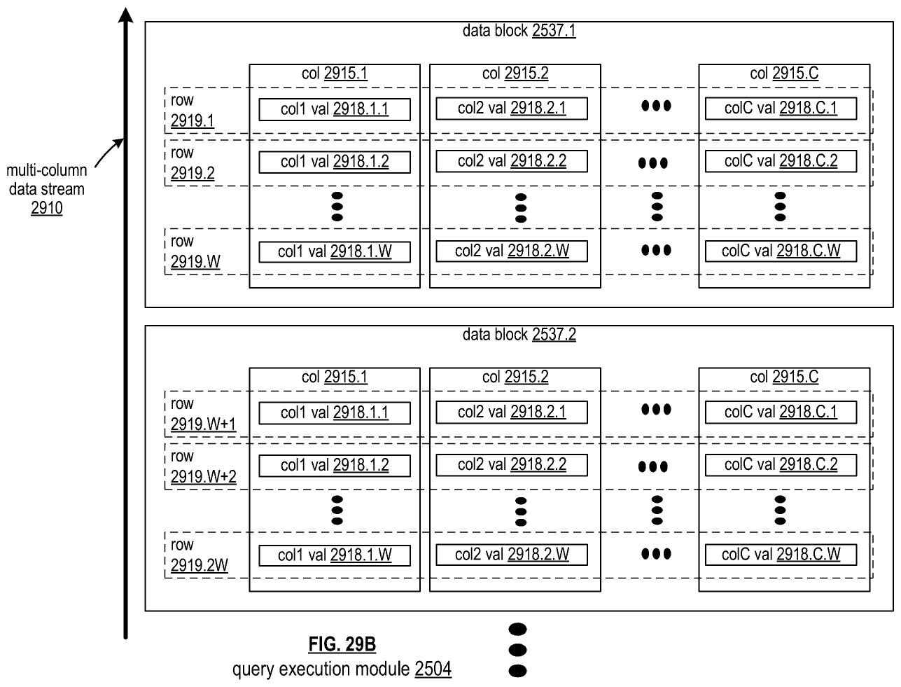

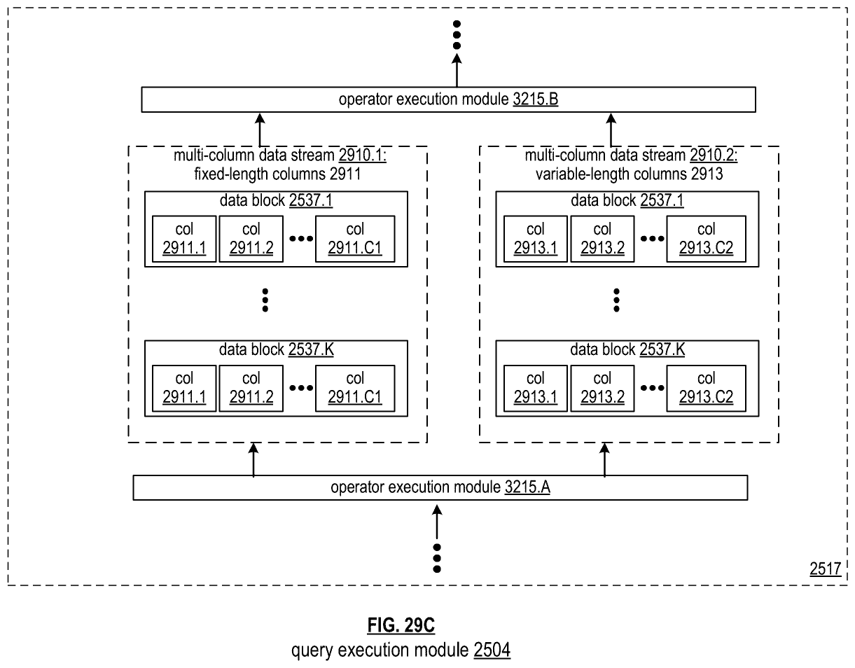

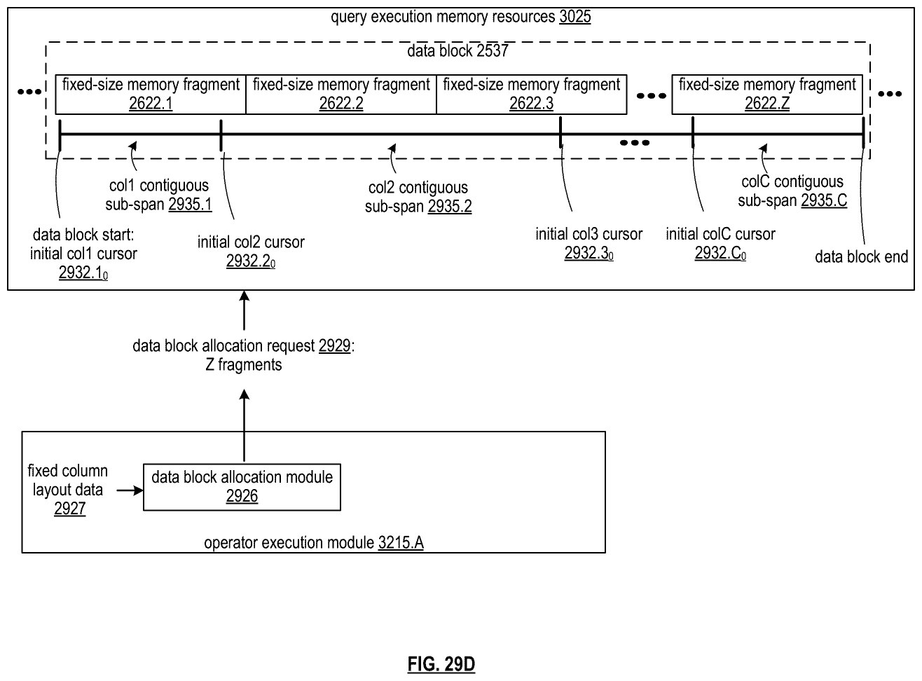

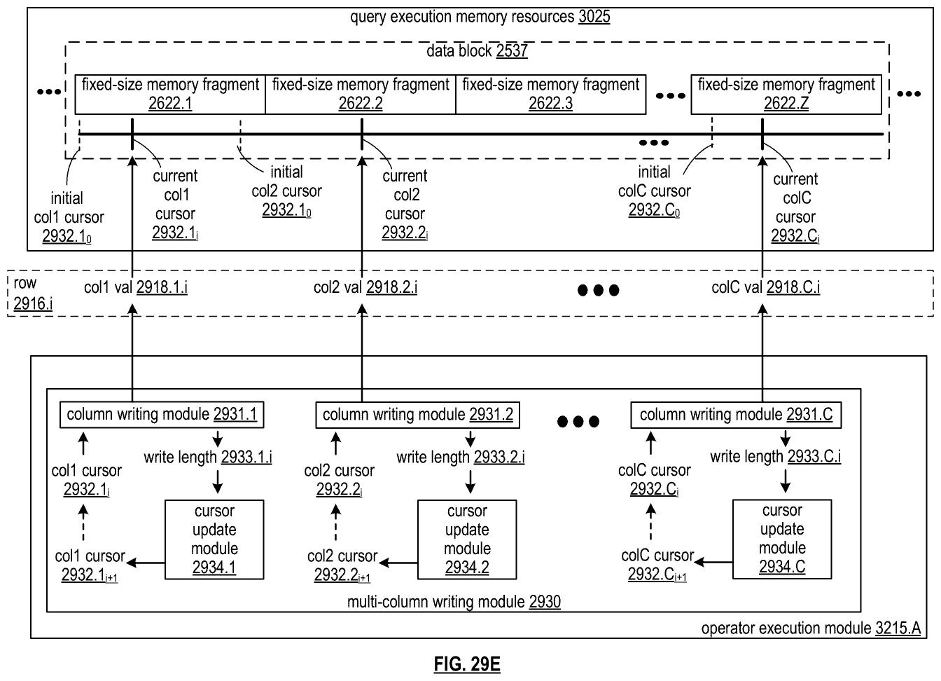

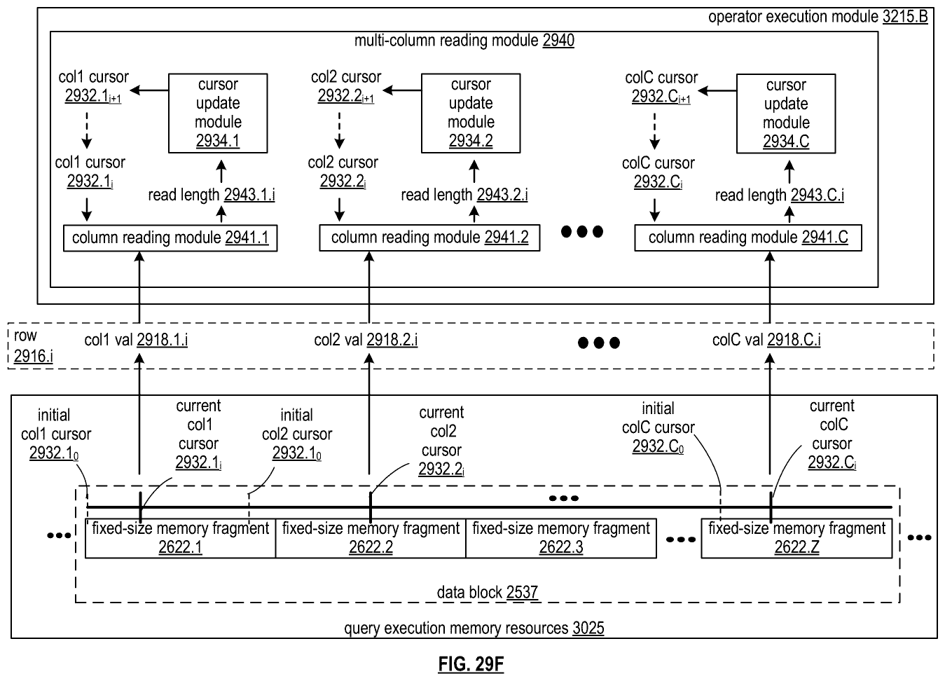

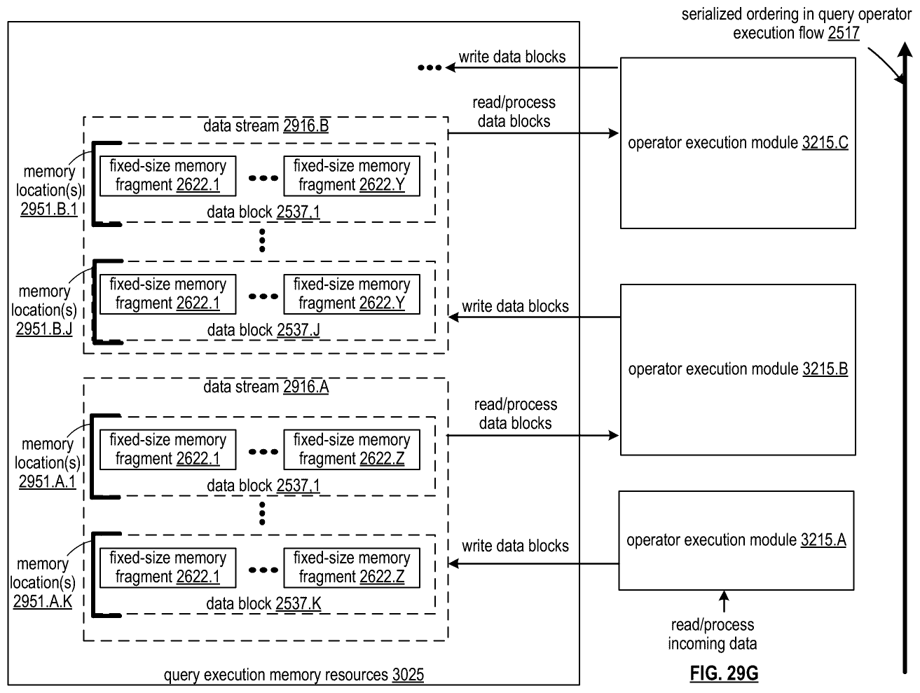

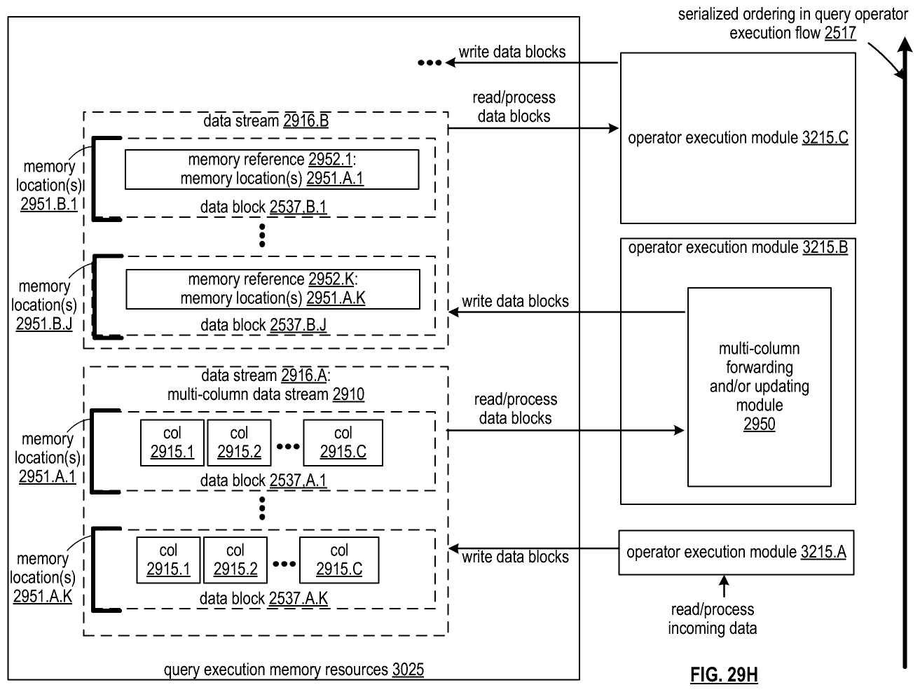

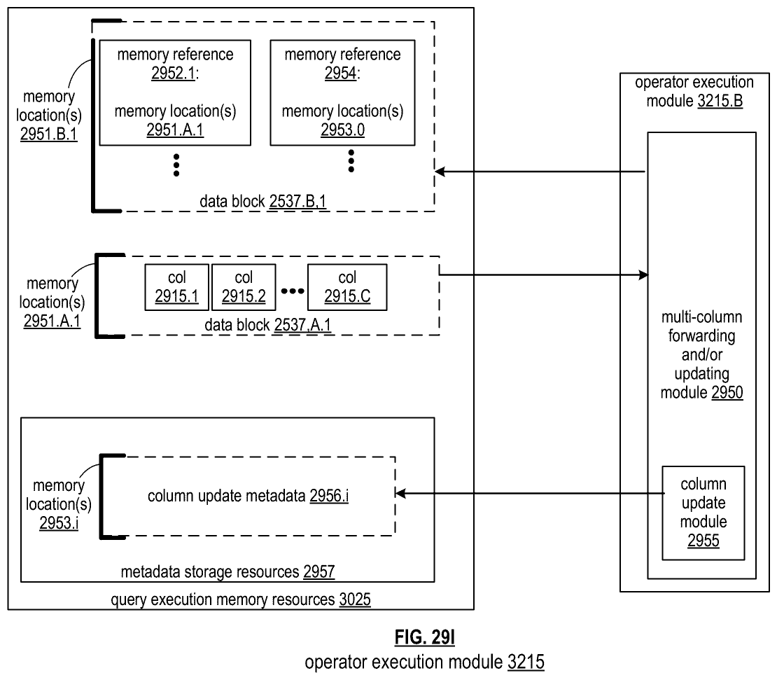

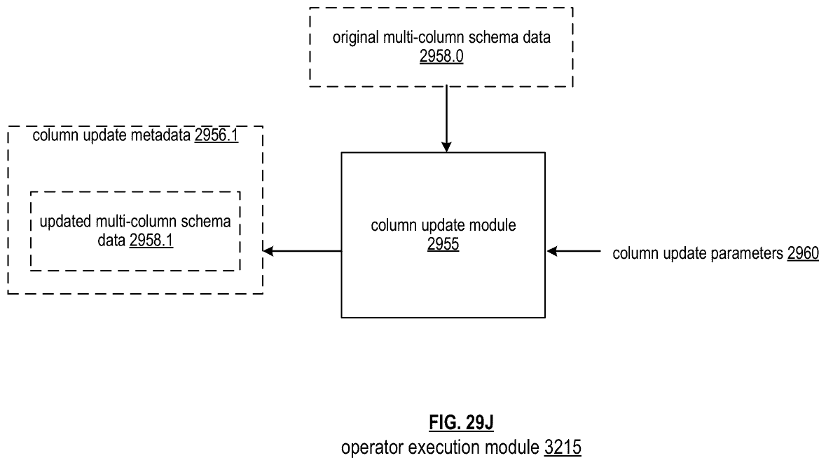

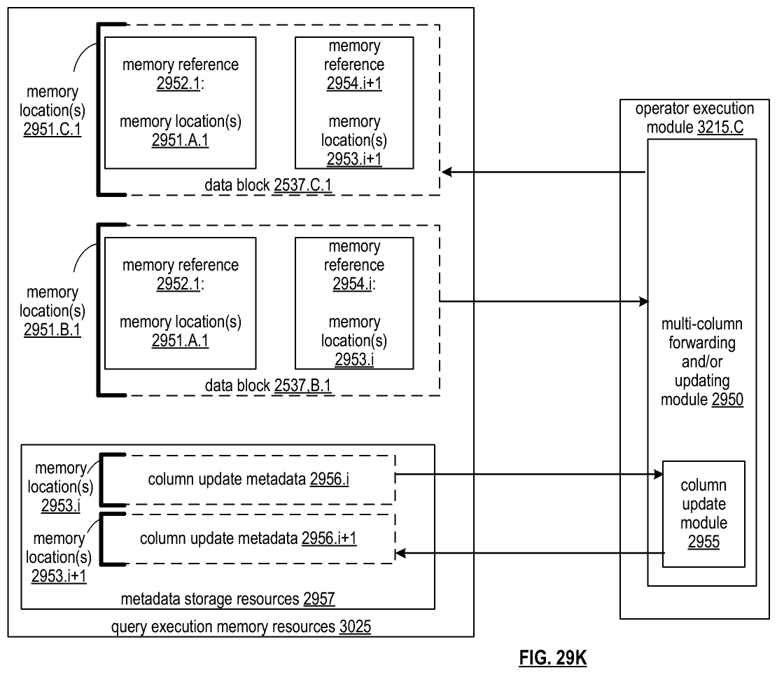

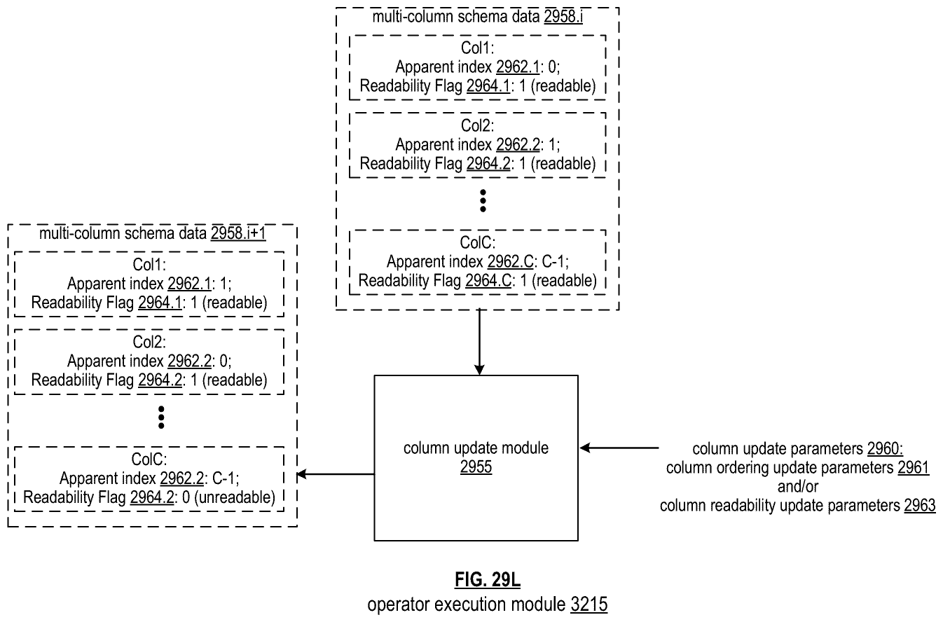

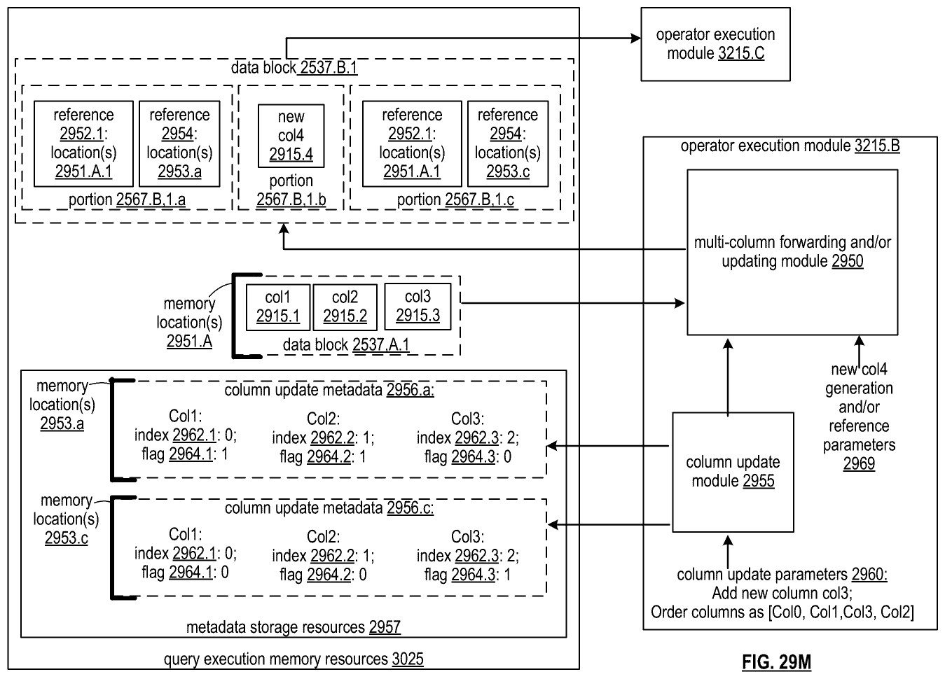

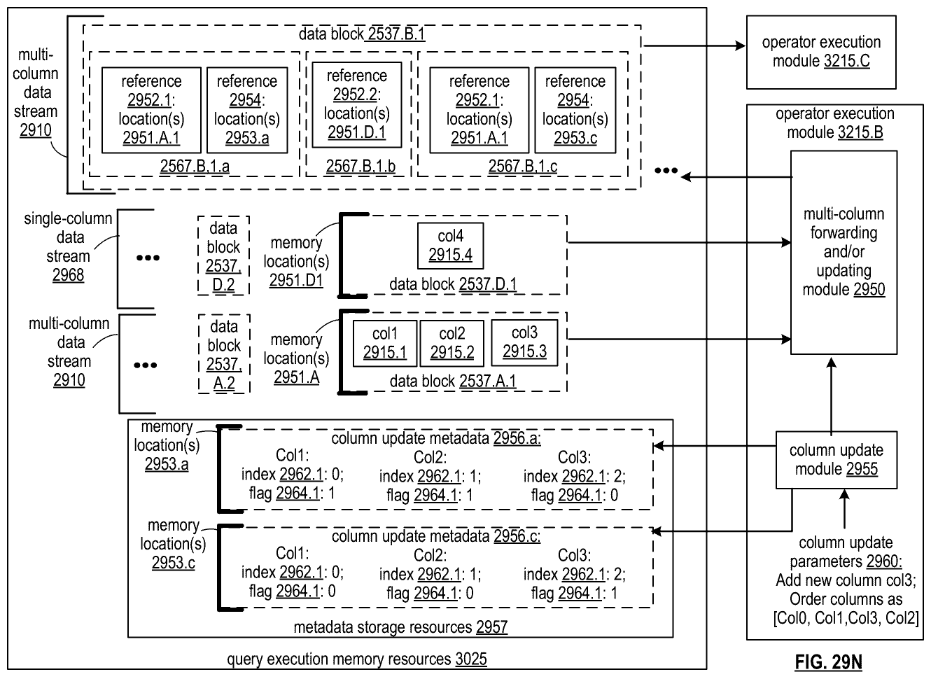

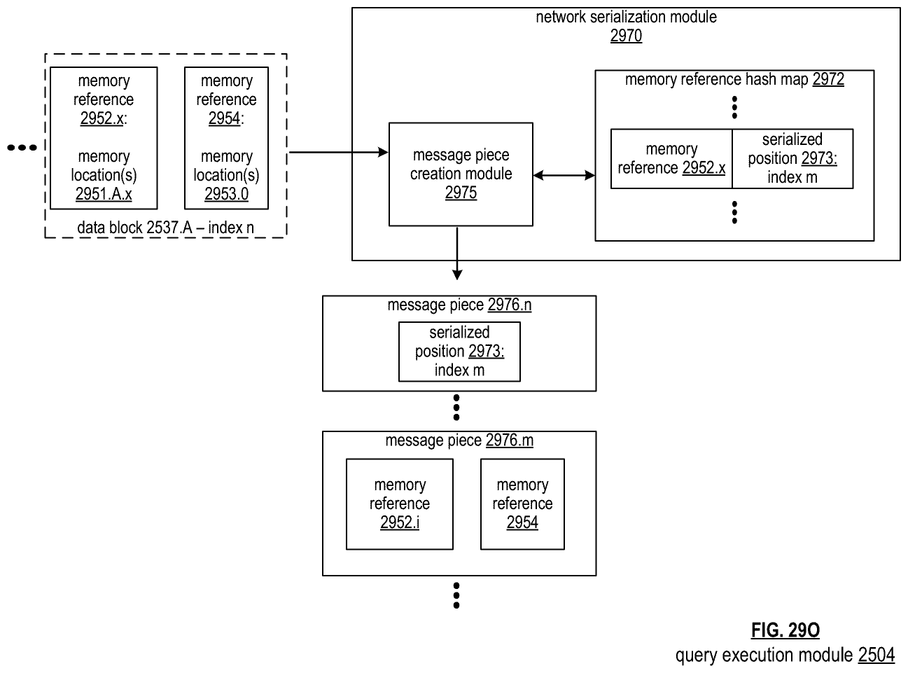

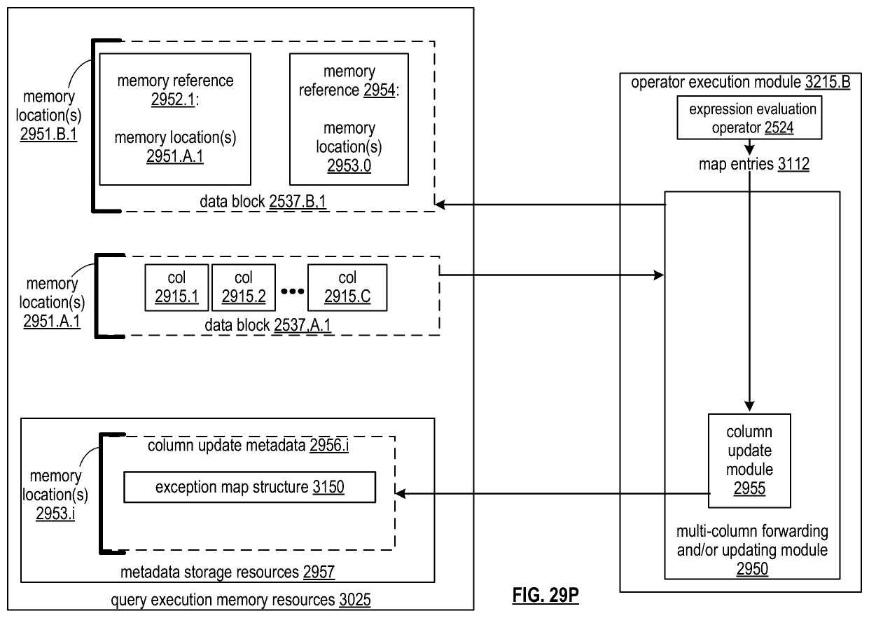

Before the sorted data slabs are stored in the data & parity section, or concurrently with storing in the data & parity section, the sorted data slabs of a segment are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). An example of redundancy encoding is discussed in greater detail with reference to one or more of FIGS. 29-36.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

FIG. 23 illustrates the segment structures for each segment of a segment group having five segments. Each segment includes a data & parity section, a manifest section, one or more index sections, and a statistic section. Each segment is targeted for storage in a different computing device of a storage cluster. The number of segments in the segment group corresponds to the number of computing devices in a storage cluster. In this example, there are five computing devices in a storage cluster. Other examples include more or less than five computing devices in a storage cluster.

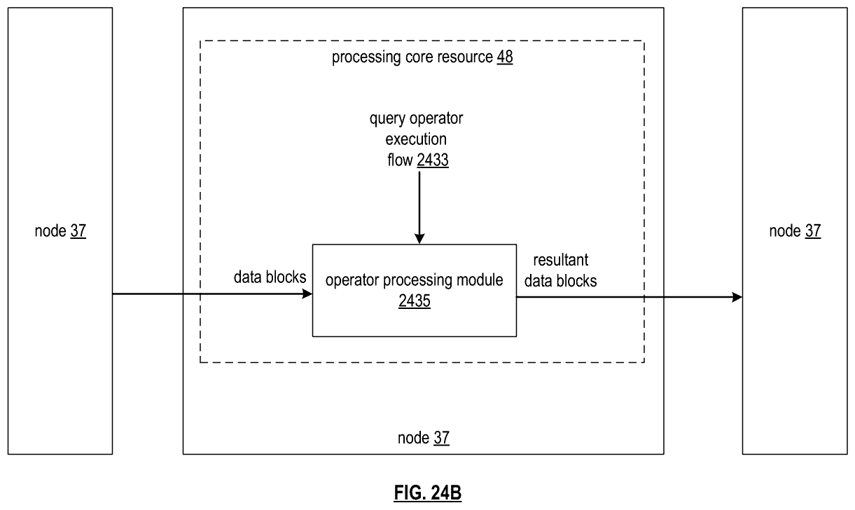

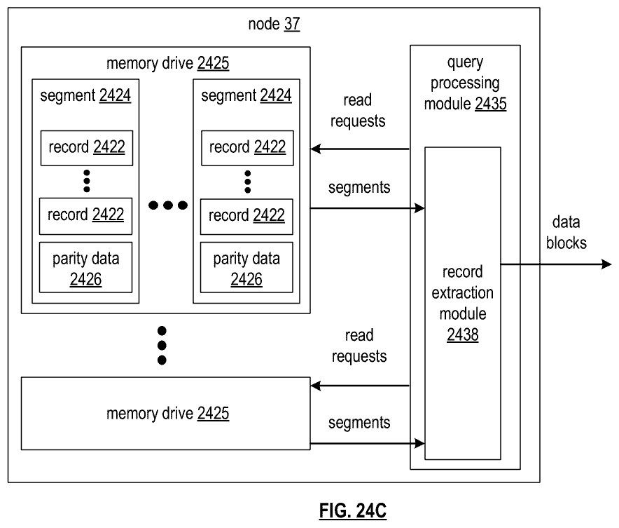

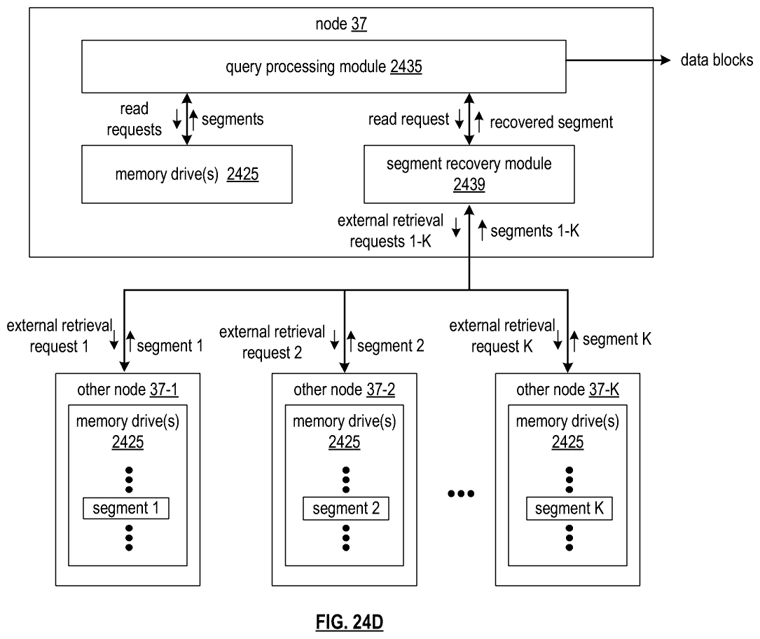

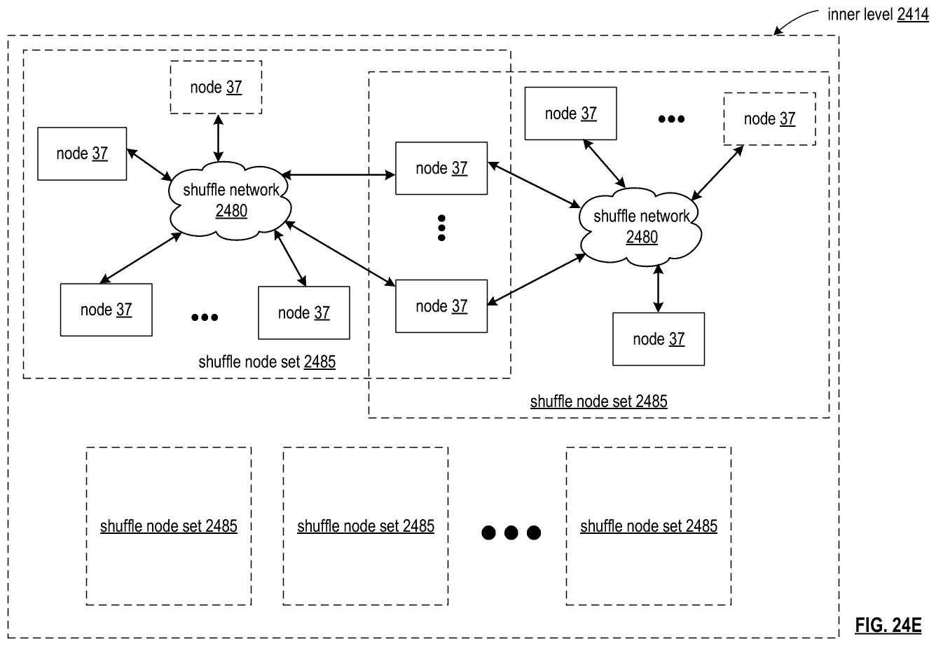

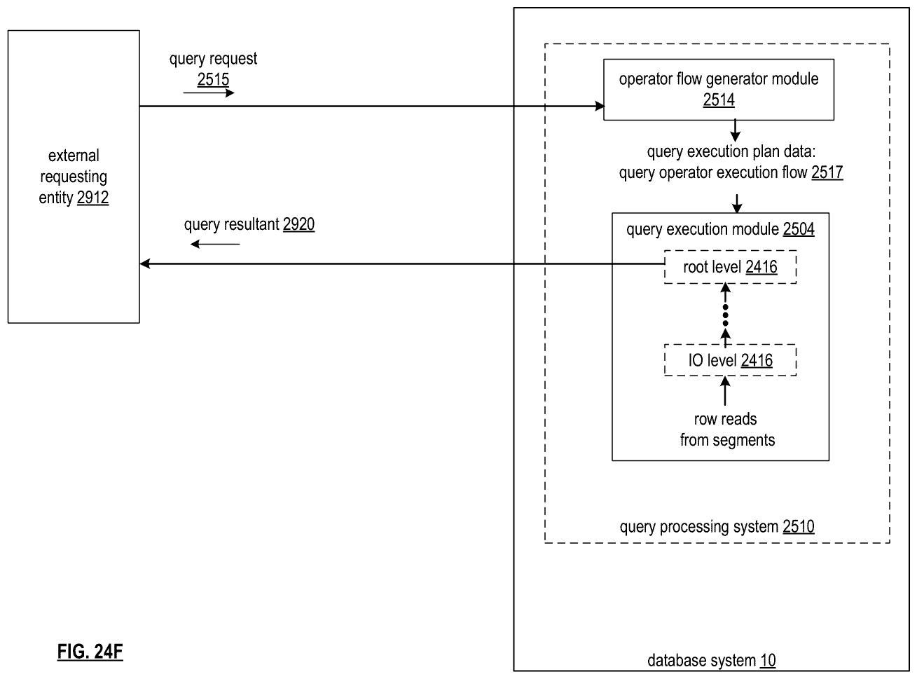

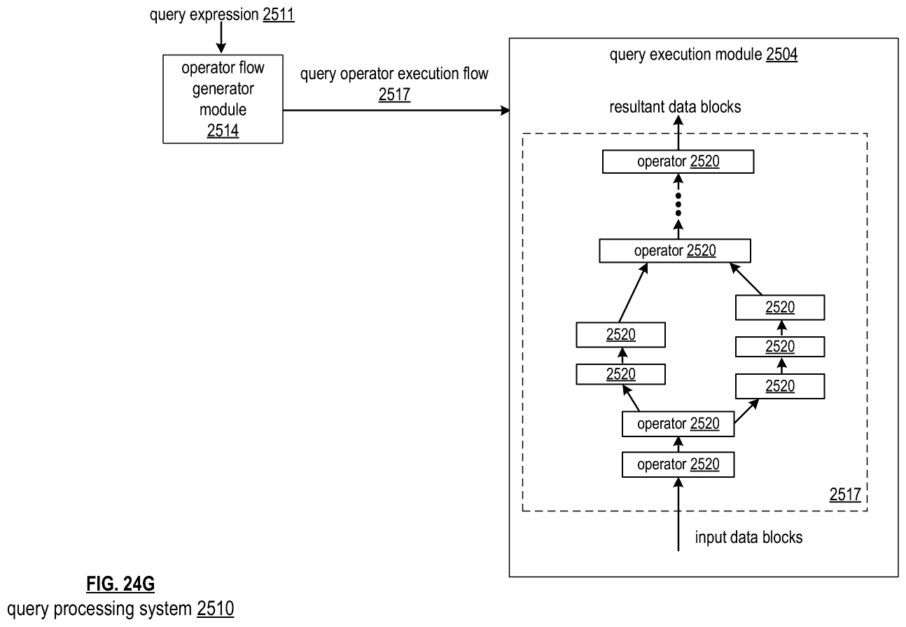

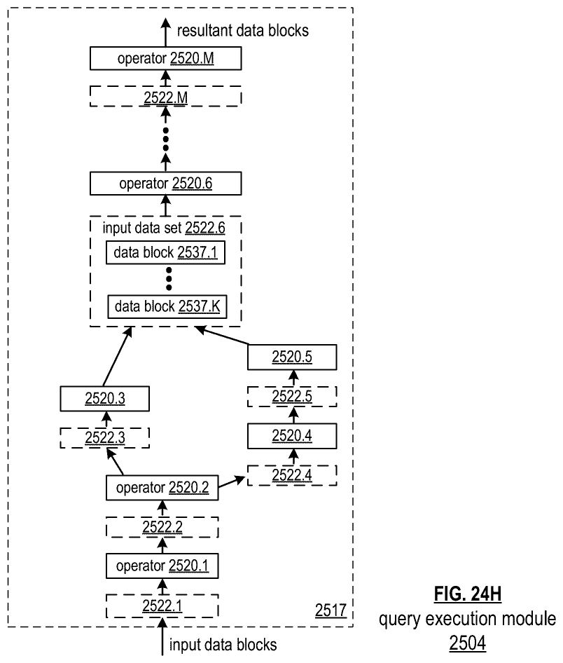

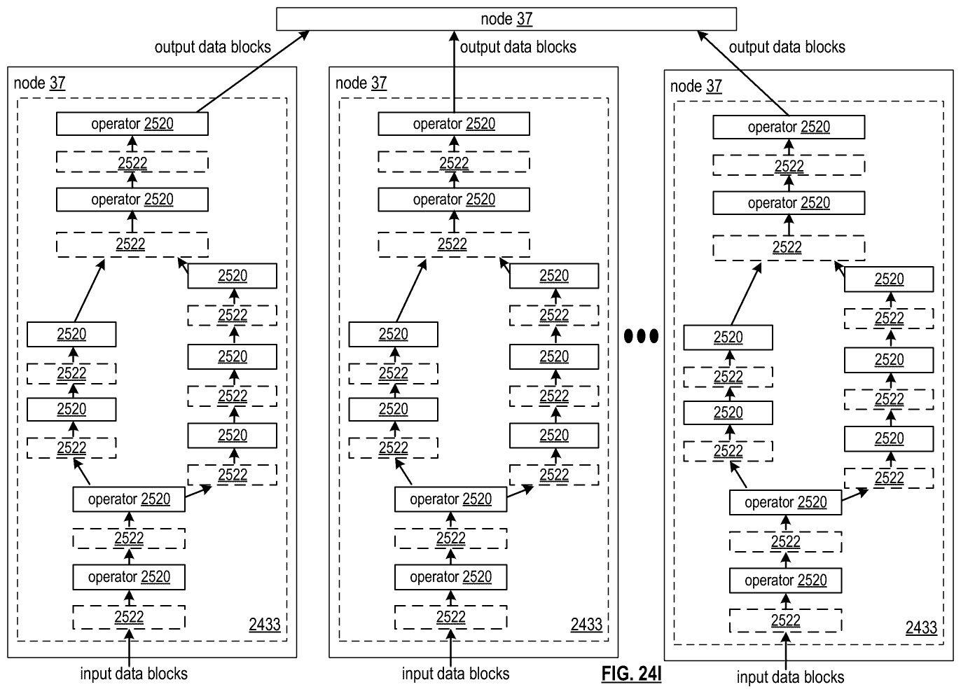

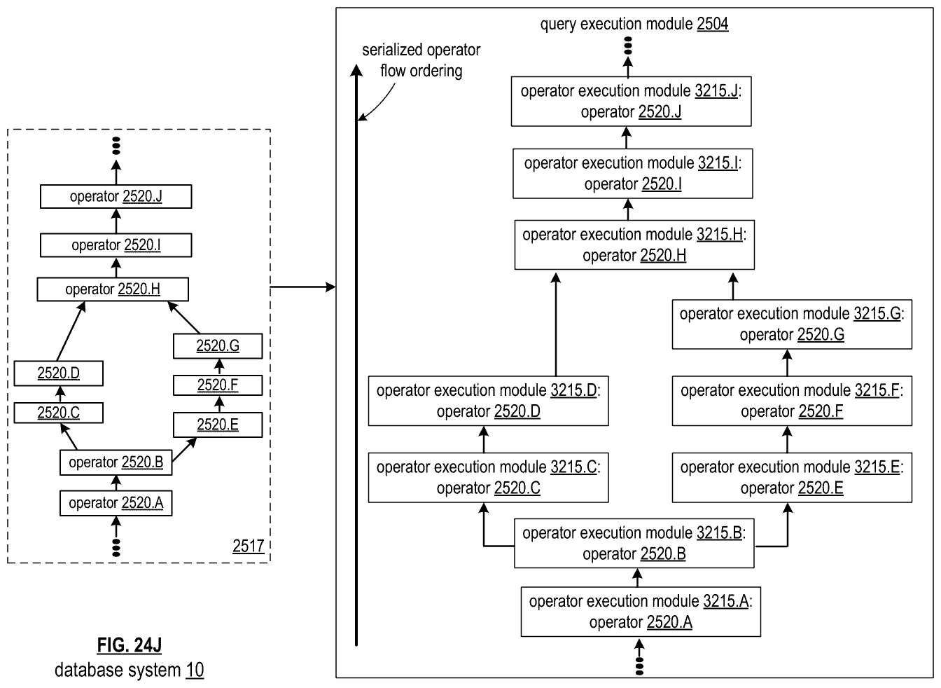

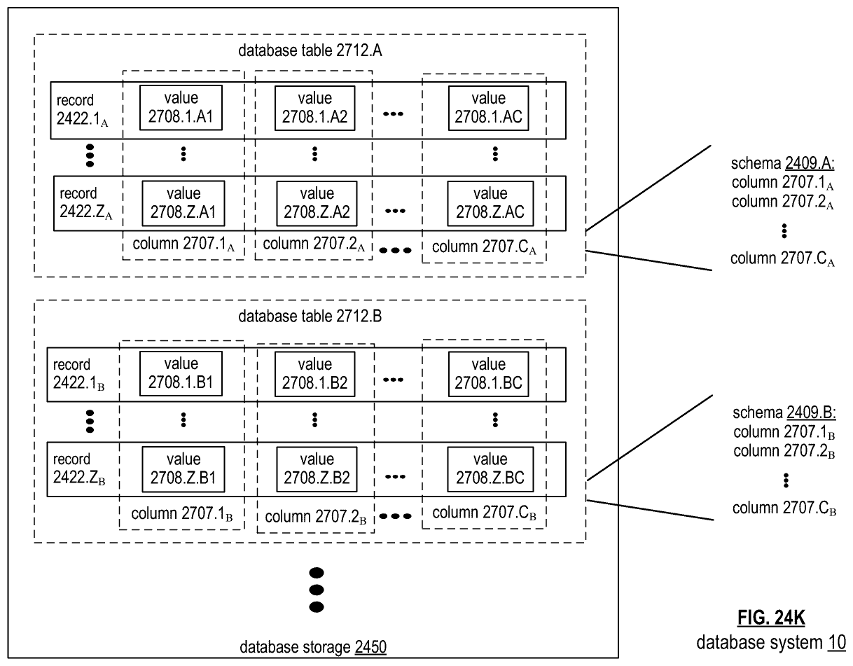

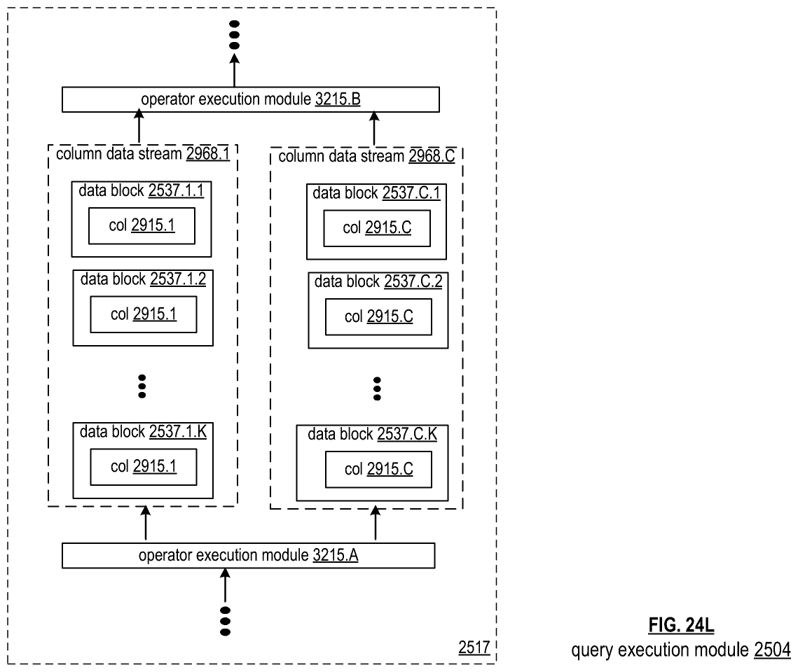

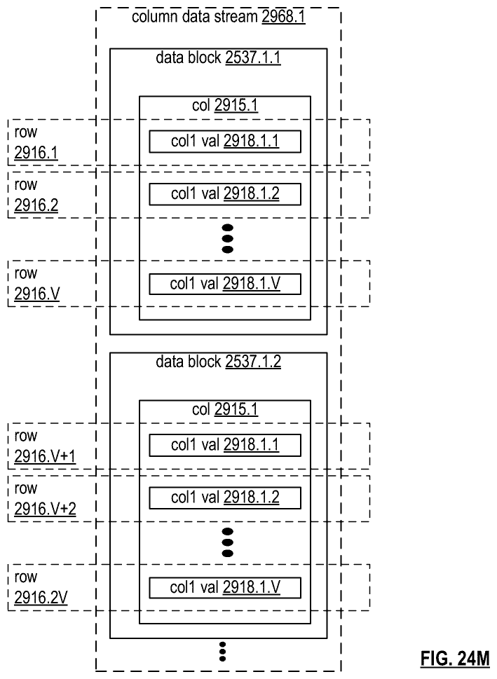

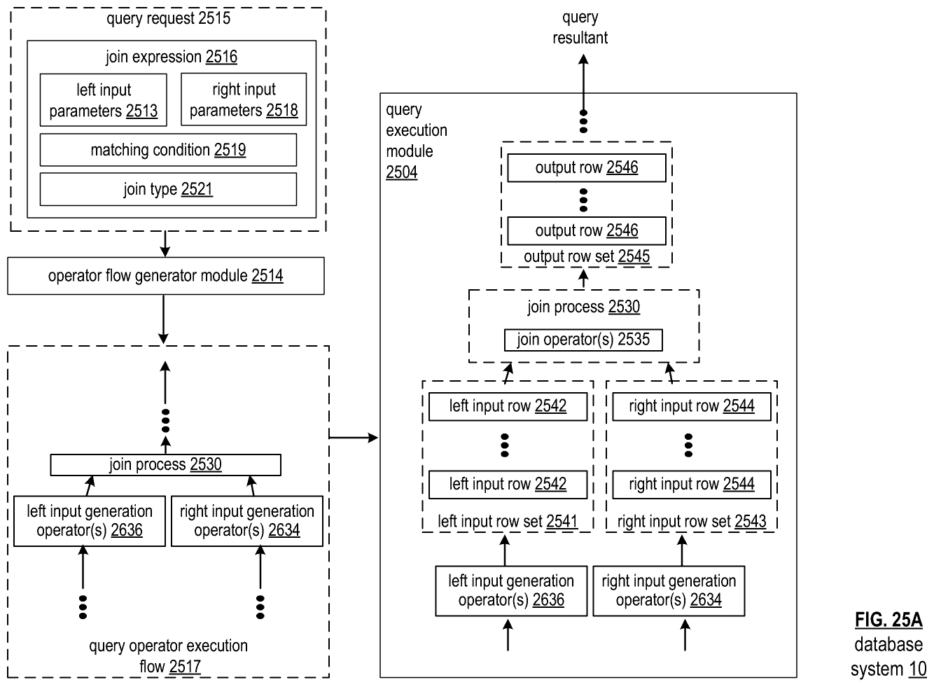

FIG. 24A illustrates an example of a query execution plan 2405 implemented by the database system 10 to execute one or more queries by utilizing a plurality of nodes 37. Each node 37 can be utilized to implement some or all of the plurality of nodes 37 of some or all computing devices 18-1-18-n, for example, of the of the parallelized data store, retrieve, and/or process sub-system 12, and/or of the parallelized query and results sub-system 13. The query execution plan can include a plurality of levels 2410. In this example, a plurality of H levels in a corresponding tree structure of the query execution plan 2405 are included. The plurality of levels can include a top, root level 2412; a bottom, IO level 2416, and one or more inner levels 2414. In some embodiments, there is exactly one inner level 2414, resulting in a tree of exactly three levels 2410.1, 2410.2, and 2410.3, where level 2410.H corresponds to level 2410.3. In such embodiments, level 2410.2 is the same as level 2410.H−1, and there are no other inner levels 2410.3-2410.H−2. Alternatively, any number of multiple inner levels 2414 can be implemented to result in a tree with more than three levels.

This illustration of query execution plan 2405 illustrates the flow of execution of a given query by utilizing a subset of nodes across some or all of the levels 2410. In this illustration, nodes 37 with a solid outline are nodes involved in executing a given query. Nodes 37 with a dashed outline are other possible nodes that are not involved in executing the given query, but could be involved in executing other queries in accordance with their level of the query execution plan in which they are included.

Each of the nodes of IO level 2416 can be operable to, for a given query, perform the necessary row reads for gathering corresponding rows of the query. These row reads can correspond to the segment retrieval to read some or all of the rows of retrieved segments determined to be required for the given query. Thus, the nodes 37 in level 2416 can include any nodes 37 operable to retrieve segments for query execution from its own storage or from storage by one or more other nodes; to recover segment for query execution via other segments in the same segment grouping by utilizing the redundancy error encoding scheme; and/or to determine which exact set of segments is assigned to the node for retrieval to ensure queries are executed correctly.

IO level 2416 can include all nodes in a given storage cluster 35 and/or can include some or all nodes in multiple storage clusters 35, such as all nodes in a subset of the storage clusters 35-1-35-z and/or all nodes in all storage clusters 35-1-35-z. For example, all nodes 37 and/or all currently available nodes 37 of the database system 10 can be included in level 2416. As another example, IO level 2416 can include a proper subset of nodes in the database system, such as some or all nodes that have access to stored segments and/or that are included in a segment set 35. In some cases, nodes 37 that do not store segments included in segment sets, that do not have access to stored segments, and/or that are not operable to perform row reads are not included at the IO level, but can be included at one or more inner levels 2414 and/or root level 2412.

The query executions discussed herein by nodes in accordance with executing queries at level 2416 can include retrieval of segments; extracting some or all necessary rows from the segments with some or all necessary columns; and sending these retrieved rows to a node at the next level 2410.H−1 as the query resultant generated by the node 37. For each node 37 at IO level 2416, the set of raw rows retrieved by the node 37 can be distinct from rows retrieved from all other nodes, for example, to ensure correct query execution. The total set of rows and/or corresponding columns retrieved by nodes 37 in the IO level for a given query can be dictated based on the domain of the given query, such as one or more tables indicated in one or more SELECT statements of the query, and/or can otherwise include all data blocks that are necessary to execute the given query.

Each inner level 2414 can include a subset of nodes 37 in the database system 10. Each level 2414 can include a distinct set of nodes 37 and/or some or more levels 2414 can include overlapping sets of nodes 37. The nodes 37 at inner levels are implemented, for each given query, to execute queries in conjunction with operators for the given query. For example, a query operator execution flow can be generated for a given incoming query, where an ordering of execution of its operators is determined, and this ordering is utilized to assign one or more operators of the query operator execution flow to each node in a given inner level 2414 for execution. For example, each node at a same inner level can be operable to execute a same set of operators for a given query, in response to being selected to execute the given query, upon incoming resultants generated by nodes at a directly lower level to generate its own resultants sent to a next higher level. In particular, each node at a same inner level can be operable to execute a same portion of a same query operator execution flow for a given query. In cases where there is exactly one inner level, each node selected to execute a query at a given inner level performs some or all of the given query's operators upon the raw rows received as resultants from the nodes at the IO level, such as the entire query operator execution flow and/or the portion of the query operator execution flow performed upon data that has already been read from storage by nodes at the IO level. In some cases, some operators beyond row reads are also performed by the nodes at the IO level. Each node at a given inner level 2414 can further perform a gather function to collect, union, and/or aggregate resultants sent from a previous level, for example, in accordance with one or more corresponding operators of the given query.

The root level 2412 can include exactly one node for a given query that gathers resultants from every node at the top-most inner level 2414. The node 37 at root level 2412 can perform additional query operators of the query and/or can otherwise collect, aggregate, and/or union the resultants from the top-most inner level 2414 to generate the final resultant of the query, which includes the resulting set of rows and/or one or more aggregated values, in accordance with the query, based on being performed on all rows required by the query. The root level node can be selected from a plurality of possible root level nodes, where different root nodes are selected for different queries. Alternatively, the same root node can be selected for all queries.

As depicted in FIG. 24A, resultants are sent by nodes upstream with respect to the tree structure of the query execution plan as they are generated, where the root node generates a final resultant of the query. While not depicted in FIG. 24A, nodes at a same level can share data and/or send resultants to each other, for example, in accordance with operators of the query at this same level dictating that data is sent between nodes.

In some cases, the IO level 2416 always includes the same set of nodes 37, such as a full set of nodes and/or all nodes that are in a storage cluster 35 that stores data required to process incoming queries. In some cases, the lowest inner level corresponding to level 2410.H−1 includes at least one node from the IO level 2416 in the possible set of nodes. In such cases, while each selected node in level 2410.H−1 is depicted to process resultants sent from other nodes 37 in FIG. 24A, each selected node in level 2410.H−1 that also operates as a node at the IO level further performs its own row reads in accordance with its query execution at the IO level, and gathers the row reads received as resultants from other nodes at the IO level with its own row reads for processing via operators of the query. One or more inner levels 2414 can also include nodes that are not included in IO level 2416, such as nodes 37 that do not have access to stored segments and/or that are otherwise not operable and/or selected to perform row reads for some or all queries.

The node 37 at root level 2412 can be fixed for all queries, where the set of possible nodes at root level 2412 includes only one node that executes all queries at the root level of the query execution plan. Alternatively, the root level 2412 can similarly include a set of possible nodes, where one node selected from this set of possible nodes for each query and where different nodes are selected from the set of possible nodes for different queries. In such cases, the nodes at inner level 2410.2 determine which of the set of possible root nodes to send their resultant to. In some cases, the single node or set of possible nodes at root level 2412 is a proper subset of the set of nodes at inner level 2410.2, and/or is a proper subset of the set of nodes at the IO level 2416. In cases where the root node is included at inner level 2410.2, the root node generates its own resultant in accordance with inner level 2410.2, for example, based on multiple resultants received from nodes at level 2410.3, and gathers its resultant that was generated in accordance with inner level 2410.2 with other resultants received from nodes at inner level 2410.2 to ultimately generate the final resultant in accordance with operating as the root level node.

In some cases where nodes are selected from a set of possible nodes at a given level for processing a given query, the selected node must have been selected for processing this query at each lower level of the query execution tree. For example, if a particular node is selected to process a node at a particular inner level, it must have processed the query to generate resultants at every lower inner level and the IO level. In such cases, each selected node at a particular level will always use its own resultant that was generated for processing at the previous, lower level, and will gather this resultant with other resultants received from other child nodes at the previous, lower level. Alternatively, nodes that have not yet processed a given query can be selected for processing at a particular level, where all resultants being gathered are therefore received from a set of child nodes that do not include the selected node.

The configuration of query execution plan 2405 for a given query can be determined in a downstream fashion, for example, where the tree is formed from the root downwards. Nodes at corresponding levels are determined from configuration information received from corresponding parent nodes and/or nodes at higher levels, and can each send configuration information to other nodes, such as their own child nodes, at lower levels until the lowest level is reached. This configuration information can include assignment of a particular subset of operators of the set of query operators that each level and/or each node will perform for the query. The execution of the query is performed upstream in accordance with the determined configuration, where IO reads are performed first, and resultants are forwarded upwards until the root node ultimately generates the query result.

FIG. 24B illustrates an embodiment of a node 37 executing a query in accordance with the query execution plan 2405 by implementing an operator processing module 2435. The operator processing module 2435 can be operable to execute a query operator execution flow 2433 determined by the node 37, where the query operator execution flow 2433 corresponds to the entirety of processing of the query upon incoming data assigned to the corresponding node 37 in accordance with its role in the query execution plan 2405. This embodiment of node 37 that utilizes an operator processing module 2435 can be utilized to implement some or all of the plurality of nodes 37 of some or all computing devices 18-1-18-n, for example, of the of the parallelized data store, retrieve, and/or process sub-system 12, and/or of the parallelized query and results sub-system 13.

As used herein, execution of a particular query by a particular node 37 can correspond to the execution of the portion of the particular query assigned to the particular node in accordance with full execution of the query by the plurality of nodes involved in the query execution plan 2405. This portion of the particular query assigned to a particular node can correspond to execution plurality of operators indicated by a query operator execution flow 2433. In particular, the execution of the query for a node 37 at an inner level 2414 and/or root level 2416 corresponds to generating a resultant by processing all incoming resultants received from nodes at a lower level of the query execution plan 2405 that send their own resultants to the node 37. The execution of the query for a node 37 at the IO level corresponds to generating all resultant data blocks by retrieving and/or recovering all segments assigned to the node 37.

Thus, as used herein, a node 37's full execution of a given query corresponds to only a portion of the query's execution across all nodes in the query execution plan 2405. In particular, a resultant generated by an inner node 37's execution of a given query may correspond to only a portion of the entire query result, such as a subset of rows in a final result set, where other nodes generate their own resultants to generate other portions of the full resultant of the query. In such embodiments, a plurality of nodes at this inner level can fully execute queries on different portions of the query domain independently in parallel by utilizing the same query operator execution flow 2433. Resultants generated by each of the plurality of nodes at this inner level 2412 can be gathered into a final result of the query, for example, by the node 37 at root level 2412 if this inner level is the top-most inner level 2414 or the only inner level 2414. As another example, resultants generated by each of the plurality of nodes at this inner level 2412 can be further processed via additional operators of a query operator execution flow 2433 being implemented by another node at a consecutively higher inner level 2414 of the query execution plan 2405, where all nodes at this consecutively higher inner level 2414 all execute their own same query operator execution flow 2433.

As discussed in further detail herein, the resultant generated by a node 37 can include a plurality of resultant data blocks generated via a plurality of partial query executions. As used herein, a partial query execution performed by a node corresponds to generating a resultant based on only a subset of the query input received by the node 37. In particular, the query input corresponds to all resultants generated by one or more nodes at a lower level of the query execution plan that send their resultants to the node. However, this query input can correspond to a plurality of input data blocks received over time, for example, in conjunction with the one or more nodes at the lower level processing their own input data blocks received over time to generate their resultant data blocks sent to the node over time. Thus, the resultant generated by a node's full execution of a query can include a plurality of resultant data blocks, where each resultant data block is generated by processing a subset of all input data blocks as a partial query execution upon the subset of all data blocks via the query operator execution flow 2433.

As illustrated in FIG. 24B, the operator processing module 2435 can be implemented by a single processing core resource 48 of the node 37, for example, by utilizing a corresponding processing module 44. In such embodiments, each one of the processing core resources 48-1-48-n of a same node 37 can be executing at least one query concurrently via their own query processing module 2435, where a single node 37 implements each of set of operator processing modules 2435-1-2435-n via a corresponding one of the set of processing core resources 48-1-48-n. A plurality of queries can be concurrently executed by the node 37, where each of its processing core resources 48 can each independently execute at least one query within a same temporal period by utilizing a corresponding at least one query operator execution flow 2433 to generate at least one query resultant corresponding to the at least one query. Alternatively, the operator processing module 2435 can be implemented can be implemented via multiple processing core resources 48 and/or via one or more other processing modules of the node 37.

FIG. 24C illustrates a particular example of a node 37 at the IO level 2416 of the query execution plan 2405 of FIG. 24A. A node 37 can utilize its own memory resources, such as some or all of its disk memory 38 and/or some or all of its main memory 40 to implement at least one memory drive 2425 that stores a plurality of segments 2424. Memory drives 2425 of a node 37 can be implemented, for example, by utilizing disk memory 38 and/or main memory 40. In particular, a plurality of distinct memory drives 2425 of a node 37 can be implemented via the plurality of memory devices 42-1-42-n of the node 37's disk memory 38.

Each segment 2424 stored in memory drive 2425 can be generated as discussed previously in conjunction with FIGS. 15-23. A plurality of records 2422 can be included in and/or extractable from the segment, for example, where the plurality of records 2422 of a segment 2424 correspond to a plurality of rows designated for the particular segment 2424 prior to applying the redundancy storage coding scheme as illustrated in FIG. 17. The records 2422 can be included in data of segment 2424, for example, in accordance with a column-format and/or another structured format. Each segments 2424 can further include parity data 2426 as discussed previously to enable other segments 2424 in the same segment group to be recovered via applying a decoding function associated with the redundancy storage coding scheme, such as a RAID scheme and/or erasure coding scheme, that was utilized to generate the set of segments of a segment group.

Thus, in addition to performing the first stage of query execution by being responsible for row reads, nodes 37 can be utilized for database storage, and can each locally store a set of segments in its own memory drives 2425. In some cases, a node 37 can be responsible for retrieval of only the records stored in its own one or more memory drives 2425 as one or more segments 2424. Executions of queries corresponding to retrieval of records stored by a particular node 37 can be assigned to that particular node 37. In other embodiments, a node 37 does not use its own resources to store segments. A node 37 can access its assigned records for retrieval via memory resources of another node 37 and/or via other access to memory drives 2425, for example, by utilizing system communication resources 14.

The query processing module 2435 of the node 37 can be utilized to read the assigned by first retrieving or otherwise accessing the corresponding redundancy-coded segments 2424 that include the assigned records its one or more memory drives 2425. Query processing module 2435 can include a record extraction module 2438 that is then utilized to extract or otherwise read some or all records from these segments 2424 accessed in memory drives 2425, for example, where record data of the segment is segregated from other information such as parity data included in the segment and/or where this data containing the records is converted into row-formatted records from the column-formatted row data stored by the segment. Once the necessary records of a query are read by the node 37, the node can further utilize query processing module 2435 to send the retrieved records all at once, or in a stream as they are retrieved from memory drives 2425, as data blocks to the next node 37 in the query execution plan 2405 via system communication resources 14 or other communication channels.

FIG. 24D illustrates an embodiment of a node 37 that implements a segment recovery module 2439 to recover some or all segments that are assigned to the node for retrieval, in accordance with processing one or more queries, that are unavailable. Some or all features of the node 37 of FIG. 24D can be utilized to implement the node 37 of FIGS. 24B and 24C, and/or can be utilized to implement one or more nodes 37 of the query execution plan 2405 of FIG. 24A, such as nodes 37 at the IO level 2416. A node 37 may store segments on one of its own memory drives 2425 that becomes unavailable, or otherwise determines that a segment assigned to the node for execution of a query is unavailable for access via a memory drive the node 37 accesses via system communication resources 14. The segment recovery module 2439 can be implemented via at least one processing module of the node 37, such as resources of central processing module 39. The segment recovery module 2439 can retrieve the necessary number of segments 1-K in the same segment group as an unavailable segment from other nodes 37, such as a set of other nodes 37-1-37-K that store segments in the same storage cluster 35. Using system communication resources 14 or other communication channels, a set of external retrieval requests 1-K for this set of segments 1-K can be sent to the set of other nodes 37-1-37-K, and the set of segments can be received in response. This set of K segments can be processed, for example, where a decoding function is applied based on the redundancy storage coding scheme utilized to generate the set of segments in the segment group and/or parity data of this set of K segments is otherwise utilized to regenerate the unavailable segment. The necessary records can then be extracted from the unavailable segment, for example, via the record extraction module 2438, and can be sent as data blocks to another node 37 for processing in conjunction with other records extracted from available segments retrieved by the node 37 from its own memory drives 2425.

Note that the embodiments of node 37 discussed herein can be configured to execute multiple queries concurrently by communicating with nodes 37 in the same or different tree configuration of corresponding query execution plans and/or by performing query operations upon data blocks and/or read records for different queries. In particular, incoming data blocks can be received from other nodes for multiple different queries in any interleaving order, and a plurality of operator executions upon incoming data blocks for multiple different queries can be performed in any order, where output data blocks are generated and sent to the same or different next node for multiple different queries in any interleaving order. IO level nodes can access records for the same or different queries any interleaving order. Thus, at a given point in time, a node 37 can have already begun its execution of at least two queries, where the node 37 has also not yet completed its execution of the at least two queries.

A query execution plan 2405 can guarantee query correctness based on assignment data sent to or otherwise communicated to all nodes at the IO level ensuring that the set of required records in query domain data of a query, such as one or more tables required to be accessed by a query, are accessed exactly one time: if a particular record is accessed multiple times in the same query and/or is not accessed, the query resultant cannot be guaranteed to be correct. Assignment data indicating segment read and/or record read assignments to each of the set of nodes 37 at the IO level can be generated, for example, based on being mutually agreed upon by all nodes 37 at the IO level via a consensus protocol executed between all nodes at the IO level and/or distinct groups of nodes 37 such as individual storage clusters 35. The assignment data can be generated such that every record in the database system and/or in query domain of a particular query is assigned to be read by exactly one node 37. Note that the assignment data may indicate that a node 37 is assigned to read some segments directly from memory as illustrated in FIG. 24C and is assigned to recover some segments via retrieval of segments in the same segment group from other nodes 37 and via applying the decoding function of the redundancy storage coding scheme as illustrated in FIG. 24D.

Assuming all nodes 37 read all required records and send their required records to exactly one next node 37 as designated in the query execution plan 2405 for the given query, the use of exactly one instance of each record can be guaranteed. Assuming all inner level nodes 37 process all the required records received from the corresponding set of nodes 37 in the IO level 2416, via applying one or more query operators assigned to the node in accordance with their query operator execution flow 2433, correctness of their respective partial resultants can be guaranteed. This correctness can further require that nodes 37 at the same level intercommunicate by exchanging records in accordance with JOIN operations as necessary, as records received by other nodes may be required to achieve the appropriate result of a JOIN operation. Finally, assuming the root level node receives all correctly generated partial resultants as data blocks from its respective set of nodes at the penultimate, highest inner level 2414 as designated in the query execution plan 2405, and further assuming the root level node appropriately generates its own final resultant, the correctness of the final resultant can be guaranteed.

In some embodiments, each node 37 in the query execution plan can monitor whether it has received all necessary data blocks to fulfill its necessary role in completely generating its own resultant to be sent to the next node 37 in the query execution plan. A node 37 can determine receipt of a complete set of data blocks that was sent from a particular node 37 at an immediately lower level, for example, based on being numbered and/or have an indicated ordering in transmission from the particular node 37 at the immediately lower level, and/or based on a final data block of the set of data blocks being tagged in transmission from the particular node 37 at the immediately lower level to indicate it is a final data block being sent. A node 37 can determine the required set of lower level nodes from which it is to receive data blocks based on its knowledge of the query execution plan 2405 of the query. A node 37 can thus conclude when a complete set of data blocks has been received each designated lower level node in the designated set as indicated by the query execution plan 2405. This node 37 can therefore determine itself that all required data blocks have been processed into data blocks sent by this node 37 to the next node 37 and/or as a final resultant if this node 37 is the root node. This can be indicated via tagging of its own last data block, corresponding to the final portion of the resultant generated by the node, where it is guaranteed that all appropriate data was received and processed into the set of data blocks sent by this node 37 in accordance with applying its own query operator execution flow 2433.

In some embodiments, if any node 37 determines it did not receive all of its required data blocks, the node 37 itself cannot fulfill generation of its own set of required data blocks. For example, the node 37 will not transmit a final data block tagged as the “last” data block in the set of outputted data blocks to the next node 37, and the next node 37 will thus conclude there was an error and will not generate a full set of data blocks itself. The root node, and/or these intermediate nodes that never received all their data and/or never fulfilled their generation of all required data blocks, can independently determine the query was unsuccessful. In some cases, the root node, upon determining the query was unsuccessful, can initiate re-execution of the query by re-establishing the same or different query execution plan 2405 in a downward fashion as described previously, where the nodes 37 in this re-established query execution plan 2405 execute the query accordingly as though it were a new query. For example, in the case of a node failure that caused the previous query to fail, the new query execution plan 2405 can be generated to include only available nodes where the node that failed is not included in the new query execution plan 2405.

FIG. 24E illustrates an embodiment of an inner level 2414 that includes at least one shuffle node set 2485 of the plurality of nodes assigned to the corresponding inner level. A shuffle node set 2485 can include some or all of a plurality of nodes assigned to the corresponding inner level, where all nodes in the shuffle node set 2485 are assigned to the same inner level. In some cases, a shuffle node set 2485 can include nodes assigned to different levels 2410 of a query execution plan. A shuffle node set 2485 at a given time can include some nodes that are assigned to the given level, but are not participating in a query at that given time, as denoted with dashed outlines and as discussed in conjunction with FIG. 24A. For example, while a given one or more queries are being executed by nodes in the database system 10, a shuffle node set 2485 can be static, regardless of whether all of its members are participating in a given query at that time. In other cases, shuffle node set 2485 only includes nodes assigned to participate in a corresponding query, where different queries that are concurrently executing and/or executing in distinct time periods have different shuffle node sets 2485 based on which nodes are assigned to participate in the corresponding query execution plan. While FIG. 24E depicts multiple shuffle node sets 2485 of an inner level 2414, in some cases, an inner level can include exactly one shuffle node set, for example, that includes all possible nodes of the corresponding inner level 2414 and/or all participating nodes of the of the corresponding inner level 2414 in a given query execution plan.

While FIG. 24E depicts that different shuffle node sets 2485 can have overlapping nodes 37, in some cases, each shuffle node set 2485 includes a distinct set of nodes, for example, where the shuffle node sets 2485 are mutually exclusive. In some cases, the shuffle node sets 2485 are collectively exhaustive with respect to the corresponding inner level 2414, where all possible nodes of the inner level 2414, or all participating nodes of a given query execution plan at the inner level 2414, are included in at least one shuffle node set 2485 of the inner level 2414. If the query execution plan has multiple inner levels 2414, each inner level can include one or more shuffle node sets 2485. In some cases, a shuffle node set 2485 can include nodes from different inner levels 2414, or from exactly one inner level 2414. In some cases, the root level 2412 and/or the IO level 2416 have nodes included in shuffle node sets 2485. In some cases, the query execution plan 2405 includes and/or indicates assignment of nodes to corresponding shuffle node sets 2485 in addition to assigning nodes to levels 2410, where nodes 37 determine their participation in a given query as participating in one or more levels 2410 and/or as participating in one or more shuffle node sets 2485, for example, via downward propagation of this information from the root node to initiate the query execution plan 2405 as discussed previously.

The shuffle node sets 2485 can be utilized to enable transfer of information between nodes, for example, in accordance with performing particular operations in a given query that cannot be performed in isolation. For example, some queries require that nodes 37 receive data blocks from its children nodes in the query execution plan for processing, and that the nodes 37 additionally receive data blocks from other nodes at the same level 2410. In particular, query operations such as JOIN operations of a SQL query expression may necessitate that some or all additional records that were access in accordance with the query be processed in tandem to guarantee a correct resultant, where a node processing only the records retrieved from memory by its child IO nodes is not sufficient.

In some cases, a given node 37 participating in a given inner level 2414 of a query execution plan may send data blocks to some or all other nodes participating in the given inner level 2414, where these other nodes utilize these data blocks received from the given node to process the query via their query processing module 2435 by applying some or all operators of their query operator execution flow 2433 to the data blocks received from the given node. In some cases, a given node 37 participating in a given inner level 2414 of a query execution plan may receive data blocks to some or all other nodes participating in the given inner level 2414, where the given node utilizes these data blocks received from the other nodes to process the query via their query processing module 2435 by applying some or all operators of their query operator execution flow 2433 to the received data blocks.

This transfer of data blocks can be facilitated via a shuffle network 2480 of a corresponding shuffle node set 2485. Nodes in a shuffle node set 2485 can exchange data blocks in accordance with executing queries, for example, for execution of particular operators such as JOIN operators of their query operator execution flow 2433 by utilizing a corresponding shuffle network 2480. The shuffle network 2480 can correspond to any wired and/or wireless communication network that enables bidirectional communication between any nodes 37 communicating with the shuffle network 2480. In some cases, the nodes in a same shuffle node set 2485 are operable to communicate with some or all other nodes in the same shuffle node set 2485 via a direct communication link of shuffle network 2480, for example, where data blocks can be routed between some or all nodes in a shuffle network 2480 without necessitating any relay nodes 37 for routing the data blocks. In some cases, the nodes in a same shuffle set can broadcast data blocks.

In some cases, some nodes in a same shuffle node set 2485 do not have direct links via shuffle network 2480 and/or cannot send or receive broadcasts via shuffle network 2480 to some or all other nodes 37. For example, at least one pair of nodes in the same shuffle node set cannot communicate directly. In some cases, some pairs of nodes in a same shuffle node set can only communicate by routing their data via at least one relay node 37. For example, two nodes in a same shuffle node set do not have a direct communication link and/or cannot communicate via broadcasting their data blocks. However, if these two nodes in a same shuffle node set can each communicate with a same third node via corresponding direct communication links and/or via broadcast, this third node can serve as a relay node to facilitate communication between the two nodes. Nodes that are “further apart” in the shuffle network 2480 may require multiple relay nodes.

Thus, the shuffle network 2480 can facilitate communication between all nodes 37 in the corresponding shuffle node set 2485 by utilizing some or all nodes 37 in the corresponding shuffle node set 2485 as relay nodes, where the shuffle network 2480 is implemented by utilizing some or all nodes in the nodes shuffle node set 2485 and a corresponding set of direct communication links between pairs of nodes in the shuffle node set 2485 to facilitate data transfer between any pair of nodes in the shuffle node set 2485. Note that these relay nodes facilitating data blocks for execution of a given query within a shuffle node sets 2485 to implement shuffle network 2480 can be nodes participating in the query execution plan of the given query and/or can be nodes that are not participating in the query execution plan of the given query. In some cases, these relay nodes facilitating data blocks for execution of a given query within a shuffle node sets 2485 are strictly nodes participating in the query execution plan of the given query. In some cases, these relay nodes facilitating data blocks for execution of a given query within a shuffle node sets 2485 are strictly nodes that are not participating in the query execution plan of the given query.

Different shuffle node sets 2485 can have different shuffle networks 2480. These different shuffle networks 2480 can be isolated, where nodes only communicate with other nodes in the same shuffle node sets 2485 and/or where shuffle node sets 2485 are mutually exclusive. For example, data block exchange for facilitating query execution can be localized within a particular shuffle node set 2485, where nodes of a particular shuffle node set 2485 only send and receive data from other nodes in the same shuffle node set 2485, and where nodes in different shuffle node sets 2485 do not communicate directly and/or do not exchange data blocks at all. In some cases, where the inner level includes exactly one shuffle network, all nodes 37 in the inner level can and/or must exchange data blocks with all other nodes in the inner level via the shuffle node set via a single corresponding shuffle network 2480.

Alternatively, some or all of the different shuffle networks 2480 can be interconnected, where nodes can and/or must communicate with other nodes in different shuffle node sets 2485 via connectivity between their respective different shuffle networks 2480 to facilitate query execution. As a particular example, in cases where two shuffle node sets 2485 have at least one overlapping node 37, the interconnectivity can be facilitated by the at least one overlapping node 37, for example, where this overlapping node 37 serves as a relay node to relay communications from at least one first node in a first shuffle node sets 2485 to at least one second node in a second first shuffle node set 2485. In some cases, all nodes 37 in a shuffle node set 2485 can communicate with any other node in the same shuffle node set 2485 via a direct link enabled via shuffle network 2480 and/or by otherwise not necessitating any intermediate relay nodes. However, these nodes may still require one or more relay nodes, such as nodes included in multiple shuffle node sets 2485, to communicate with nodes in other shuffle node sets 2485, where communication is facilitated across multiple shuffle node sets 2485 via direct communication links between nodes within each shuffle node set 2485.

Note that these relay nodes facilitating data blocks for execution of a given query across multiple shuffle node sets 2485 can be nodes participating in the query execution plan of the given query and/or can be nodes that are not participating in the query execution plan of the given query. In some cases, these relay nodes facilitating data blocks for execution of a given query across multiple shuffle node sets 2485 are strictly nodes participating in the query execution plan of the given query. In some cases, these relay nodes facilitating data blocks for execution of a given query across multiple shuffle node sets 2485 are strictly nodes that are not participating in the query execution plan of the given query.

In some cases, a node 37 has direct communication links with its child node and/or parent node, where no relay nodes are required to facilitate sending data to parent and/or child nodes of the query execution plan 2405 of FIG. 24A. In other cases, at least one relay node may be required to facilitate communication across levels, such as between a parent node and child node as dictated by the query execution plan. Such relay nodes can be nodes within a and/or different same shuffle network as the parent node and child node, and can be nodes participating in the query execution plan of the given query and/or can be nodes that are not participating in the query execution plan of the given query.

FIG. 24F illustrates an embodiment of a database system that receives some or all query requests from one or more external requesting entities 2912. The external requesting entities 2912 can be implemented as a client device such as a personal computer and/or device, a server system, or other external system that generates and/or transmits query requests 2515. A query resultant 2920 can optionally be transmitted back to the same or different external requesting entity 2912. Some or all query requests processed by database system 10 as described herein can be received from external requesting entities 2912 and/or some or all query resultants generated via query executions described herein can be transmitted to external requesting entities 2912.

For example, a user types or otherwise indicates a query for execution via interaction with a computing device associated with and/or communicating with an external requesting entity. The computing device generates and transmits a corresponding query request 2515 for execution via the database system 10, where the corresponding query resultant 2920 is transmitted back to the computing device, for example, for storage by the computing device and/or for display to the corresponding user via a display device.

FIG. 24G illustrates an embodiment of a query processing system 2510 that generates a query operator execution flow 2517 from a query expression 2511 for execution via a query execution module 2504. The query processing system 2510 can be implemented utilizing, for example, the parallelized query and/or response sub-system 13 and/or the parallelized data store, retrieve, and/or process subsystem 12. The query processing system 2510 can be implemented by utilizing at least one computing device 18, for example, by utilizing at least one central processing module 39 of at least one node 37 utilized to implement the query processing system 2510. The query processing system 2510 can be implemented utilizing any processing module and/or memory of the database system 10, for example, communicating with the database system 10 via system communication resources 14.

As illustrated in FIG. 24G, an operator flow generator module 2514 of the query processing system 2510 can be utilized to generate a query operator execution flow 2517 for the query indicated in a query expression 2511. This can be generated based on a plurality of query operators indicated in the query expression and their respective sequential, parallelized, and/or nested ordering in the query expression, and/or based on optimizing the execution of the plurality of operators of the query expression. This query operator execution flow 2517 can include and/or be utilized to determine the query operator execution flow 2433 assigned to nodes 37 at one or more particular levels of the query execution plan 2405 and/or can include the operator execution flow to be implemented across a plurality of nodes 37, for example, based on a query expression indicated in the query request and/or based on optimizing the execution of the query expression.

In some cases, the operator flow generator module 2514 implements an optimizer to select the query operator execution flow 2517 based on determining the query operator execution flow 2517 is a most efficient and/or otherwise most optimal one of a set of query operator execution flow options and/or that arranges the operators in the query operator execution flow 2517 such that the query operator execution flow 2517 compares favorably to a predetermined efficiency threshold. For example, the operator flow generator module 2514 selects and/or arranges the plurality of operators of the query operator execution flow 2517 to implement the query expression in accordance with performing optimizer functionality, for example, by perform a deterministic function upon the query expression to select and/or arrange the plurality of operators in accordance with the optimizer functionality. This can be based on known and/or estimated processing times of different types of operators. This can be based on known and/or estimated levels of record filtering that will be applied by particular filtering parameters of the query. This can be based on selecting and/or deterministically utilizing a conjunctive normal form and/or a disjunctive normal form to build the query operator execution flow 2517 from the query expression. This can be based on selecting a determining a first possible serial ordering of a plurality of operators to implement the query expression based on determining the first possible serial ordering of the plurality of operators is known to be or expected to be more efficient than at least one second possible serial ordering of the same or different plurality of operators that implements the query expression. This can be based on ordering a first operator before a second operator in the query operator execution flow 2517 based on determining executing the first operator before the second operator results in more efficient execution than executing the second operator before the first operator. For example, the first operator is known to filter the set of records upon which the second operator would be performed to improve the efficiency of performing the second operator due to being executed upon a smaller set of records than if performed before the first operator. This can be based on other optimizer functionality that otherwise selects and/or arranges the plurality of operators of the query operator execution flow 2517 based on other known, estimated, and/or otherwise determined criteria.

A query execution module 2504 of the query processing system 2510 can execute the query expression via execution of the query operator execution flow 2517 to generate a query resultant. For example, the query execution module 2504 can be implemented via a plurality of nodes 37 that execute the query operator execution flow 2517. In particular, the plurality of nodes 37 of a query execution plan 2405 of FIG. 24A can collectively execute the query operator execution flow 2517. In such cases, nodes 37 of the query execution module 2504 can each execute their assigned portion of the query to produce data blocks as discussed previously, starting from IO level nodes propagating their data blocks upwards until the root level node processes incoming data blocks to generate the query resultant, where inner level nodes execute their respective query operator execution flow 2433 upon incoming data blocks to generate their output data blocks. The query execution module 2504 can be utilized to implement the parallelized query and results sub-system 13 and/or the parallelized data store, receive and/or process sub-system 12.

FIG. 24H presents an example embodiment of a query execution module 2504 that executes query operator execution flow 2517. Some or all features and/or functionality of the query execution module 2504 of FIG. 24H can implement the query execution module 2504 of FIG. 24G and/or any other embodiment of the query execution module 2504 discussed herein. Some or all features and/or functionality of the query execution module 2504 of FIG. 24H can optionally be utilized to implement the query processing module 2435 of node 37 in FIG. 24B and/or to implement some or all nodes 37 at inner levels 2414 of a query execution plan 2405 of FIG. 24A.

The query execution module 2504 can execute the determined query operator execution flow 2517 by performing a plurality of operator executions of operators 2520 of the query operator execution flow 2517 in a corresponding plurality of sequential operator execution steps. Each operator execution step of the plurality of sequential operator execution steps can correspond to execution of a particular operator 2520 of a plurality of operators 2520-1-2520-M of a query operator execution flow 2433.

In some embodiments, a single node 37 executes the query operator execution flow 2517 as illustrated in FIG. 24H as their operator execution flow 2433 of FIG. 24B, where some or all nodes 37 such as some or all inner level nodes 37 utilize the query processing module 2435 as discussed in conjunction with FIG. 24B to generate output data blocks to be sent to other nodes 37 and/or to generate the final resultant by applying the query operator execution flow 2517 to input data blocks received from other nodes and/or retrieved from memory as read and/or recovered records. In such cases, the entire query operator execution flow 2517 determined for the query as a whole can be segregated into multiple query operator execution sub-flows 2433 that are each assigned to the nodes of each of a corresponding set of inner levels 2414 of the query execution plan 2405, where all nodes at the same level execute the same query operator execution flows 2433 upon different received input data blocks. In some cases, the query operator execution flows 2433 applied by each node 37 includes the entire query operator execution flow 2517, for example, when the query execution plan includes exactly one inner level 2414. In other embodiments, the query processing module 2435 is otherwise implemented by at least one processing module the query execution module 2504 to execute a corresponding query, for example, to perform the entire query operator execution flow 2517 of the query as a whole.

A single operator execution by the query execution module 2504, such as via a particular node 37 executing its own query operator execution flows 2433, by executing one of the plurality of operators of the query operator execution flow 2433. As used herein, an operator execution corresponds to executing one operator 2520 of the query operator execution flow 2433 on one or more pending data blocks 2537 in an operator input data set 2522 of the operator 2520. The operator input data set 2522 of a particular operator 2520 includes data blocks that were outputted by execution of one or more other operators 2520 that are immediately below the particular operator in a serial ordering of the plurality of operators of the query operator execution flow 2433. In particular, the pending data blocks 2537 in the operator input data set 2522 were outputted by the one or more other operators 2520 that are immediately below the particular operator via one or more corresponding operator executions of one or more previous operator execution steps in the plurality of sequential operator execution steps. Pending data blocks 2537 of an operator input data set 2522 can be ordered, for example as an ordered queue, based on an ordering in which the pending data blocks 2537 are received by the operator input data set 2522. Alternatively, an operator input data set 2522 is implemented as an unordered set of pending data blocks 2537.

If the particular operator 2520 is executed for a given one of the plurality of sequential operator execution steps, some or all of the pending data blocks 2537 in this particular operator 2520's operator input data set 2522 are processed by the particular operator 2520 via execution of the operator to generate one or more output data blocks. For example, the input data blocks can indicate a plurality of rows, and the operation can be a SELECT operator indicating a simple predicate. The output data blocks can include only proper subset of the plurality of rows that meet the condition specified by the simple predicate.

Once a particular operator 2520 has performed an execution upon a given data block 2537 to generate one or more output data blocks, this data block is removed from the operator's operator input data set 2522. In some cases, an operator selected for execution is automatically executed upon all pending data blocks 2537 in its operator input data set 2522 for the corresponding operator execution step. In this case, an operator input data set 2522 of a particular operator 2520 is therefore empty immediately after the particular operator 2520 is executed. The data blocks outputted by the executed data block are appended to an operator input data set 2522 of an immediately next operator 2520 in the serial ordering of the plurality of operators of the query operator execution flow 2433, where this immediately next operator 2520 will be executed upon its data blocks once selected for execution in a subsequent one of the plurality of sequential operator execution steps.

Operator 2520.1 can correspond to a bottom-most operator 2520 in the serial ordering of the plurality of operators 2520.1-2520.M. As depicted in FIG. 24G, operator 2520.1 has an operator input data set 2522.1 that is populated by data blocks received from another node as discussed in conjunction with FIG. 24B, such as a node at the IO level of the query execution plan 2405. Alternatively these input data blocks can be read by the same node 37 from storage, such as one or more memory devices that store segments that include the rows required for execution of the query. In some cases, the input data blocks are received as a stream over time, where the operator input data set 2522.1 may only include a proper subset of the full set of input data blocks required for execution of the query at a particular time due to not all of the input data blocks having been read and/or received, and/or due to some data blocks having already been processed via execution of operator 2520.1. In other cases, these input data blocks are read and/or retrieved by performing a read operator or other retrieval operation indicated by operator 2520.

Note that in the plurality of sequential operator execution steps utilized to execute a particular query, some or all operators will be executed multiple times, in multiple corresponding ones of the plurality of sequential operator execution steps. In particular, each of the multiple times a particular operator 2520 is executed, this operator is executed on set of pending data blocks 2537 that are currently in their operator input data set 2522, where different ones of the multiple executions correspond to execution of the particular operator upon different sets of data blocks that are currently in their operator queue at corresponding different times.

As a result of this mechanism of processing data blocks via operator executions performed over time, at a given time during the query's execution by the node 37, at least one of the plurality of operators 2520 has an operator input data set 2522 that includes at least one data block 2537. At this given time, one more other ones of the plurality of operators 2520 can have input data sets 2522 that are empty. For example, a given operator's operator input data set 2522 can be empty as a result of one or more immediately prior operators 2520 in the serial ordering not having been executed yet, and/or as a result of the one or more immediately prior operators 2520 not having been executed since a most recent execution of the given operator.

Some types of operators 2520, such as JOIN operators or aggregating operators such as SUM, AVERAGE, MAXIMUM, or MINIMUM operators, require knowledge of the full set of rows that will be received as output from previous operators to correctly generate their output. As used herein, such operators 2520 that must be performed on a particular number of data blocks, such as all data blocks that will be outputted by one or more immediately prior operators in the serial ordering of operators in the query operator execution flow 2517 to execute the query, are denoted as “blocking operators.” Blocking operators are only executed in one of the plurality of sequential execution steps if their corresponding operator queue includes all of the required data blocks to be executed. For example, some or all blocking operators can be executed only if all prior operators in the serial ordering of the plurality of operators in the query operator execution flow 2433 have had all of their necessary executions completed for execution of the query, where none of these prior operators will be further executed in accordance with executing the query.

Some operator output generated via execution of an operator 2520, alternatively or in addition to being added to the input data set 2522 of a next sequential operator in the sequential ordering of the plurality of operators of the query operator execution flow 2433, can be sent to one or more other nodes 37 in a same shuffle node set as input data blocks to be added to the input data set 2522 of one or more of their respective operators 2520. In particular, the output generated via a node's execution of an operator 2520 that is serially before the last operator 2520.M of the node's query operator execution flow 2433 can be sent to one or more other nodes 37 in a same shuffle node set as input data blocks to be added to the input data set 2522 of a respective operators 2520 that is serially after the last operator 2520.1 of the query operator execution flow 2433 of the one or more other nodes 37.

As a particular example, the node 37 and the one or more other nodes 37 in a shuffle node set all execute queries in accordance with the same, common query operator execution flow 2433, for example, based on being assigned to a same inner level 2414 of the query execution plan 2405. The output generated via a node's execution of a particular operator 2520.i this common query operator execution flow 2433 can be sent to the one or more other nodes 37 in a same shuffle node set as input data blocks to be added to the input data set 2522 the next operator 2520.i+1, with respect to the serialized ordering of the query of this common query operator execution flow 2433 of the one or more other nodes 37. For example, the output generated via a node's execution of a particular operator 2520.i is added input data set 2522 the next operator 2520.i+1 of the same node's query operator execution flow 2433 based on being serially next in the sequential ordering and/or is alternatively or additionally added to the input data set 2522 of the next operator 2520.i+1 of the common query operator execution flow 2433 of the one or more other nodes in a same shuffle node set based on being serially next in the sequential ordering.

In some cases, in addition to a particular node sending this output generated via a node's execution of a particular operator 2520.i to one or more other nodes to be input data set 2522 the next operator 2520.i+1 in the common query operator execution flow 2433 of the one or more other nodes 37, the particular node also receives output generated via some or all of these one or more other nodes' execution of this particular operator 2520.i in their own query operator execution flow 2433 upon their own corresponding input data set 2522 for this particular operator. The particular node adds this received output of execution of operator 2520.i by the one or more other nodes to the be input data set 2522 of its own next operator 2520.i+1.

This mechanism of sharing data can be utilized to implement operators that require knowledge of all records of a particular table and/or of a particular set of records that may go beyond the input records retrieved by children or other descendants of the corresponding node. For example, JOIN operators can be implemented in this fashion, where the operator 2520.i+1 corresponds to and/or is utilized to implement JOIN operator and/or a custom-join operator of the query operator execution flow 2517, and where the operator 2520.i+1 thus utilizes input received from many different nodes in the shuffle node set in accordance with their performing of all of the operators serially before operator 2520.i+1 to generate the input to operator 2520.i+1.

FIG. 24I illustrates an example embodiment of multiple nodes 37 that execute a query operator execution flow 2433. For example, these nodes 37 are at a same level 2410 of a query execution plan 2405, and receive and perform an identical query operator execution flow 2433 in conjunction with decentralized execution of a corresponding query. Each node 37 can determine this query operator execution flow 2433 based on receiving the query execution plan data for the corresponding query that indicates the query operator execution flow 2433 to be performed by these nodes 37 in accordance with their participation at a corresponding inner level 2414 of the corresponding query execution plan 2405 as discussed in conjunction with FIG. 24G. This query operator execution flow 2433 utilized by the multiple nodes can be the full query operator execution flow 2517 generated by the operator flow generator module 2514 of FIG. 24G. This query operator execution flow 2433 can alternatively include a sequential proper subset of operators from the query operator execution flow 2517 generated by the operator flow generator module 2514 of FIG. 24G, where one or more other sequential proper subsets of the query operator execution flow 2517 are performed by nodes at different levels of the query execution plan.

Each node 37 can utilize a corresponding query processing module 2435 to perform a plurality of operator executions for operators of the query operator execution flow 2433 as discussed in conjunction with FIG. 24H. This can include performing an operator execution upon input data sets 2522 of a corresponding operator 2520, where the output of the operator execution is added to an input data set 2522 of a sequentially next operator 2520 in the operator execution flow, as discussed in conjunction with FIG. 24H, where the operators 2520 of the query operator execution flow 2433 are implemented as operators 2520 of FIG. 24H. Some or operators 2520 can correspond to blocking operators that must have all required input data blocks generated via one or more previous operators before execution. Each query processing module can receive, store in local memory, and/or otherwise access and/or determine necessary operator instruction data for operators 2520 indicating how to execute the corresponding operators 2520.

FIG. 24J illustrates an embodiment of a query execution module 2504 that executes each of a plurality of operators of a given operator execution flow 2517 via a corresponding one of a plurality of operator execution modules 3215. The operator execution modules 3215 of FIG. 32A can be implemented to execute any operators 2520 being executed by a query execution module 2504 for a given query as described herein.

In some embodiments, a given node 37 can optionally execute one or more operators, for example, when participating in a corresponding query execution plan 2405 for a given query, by implementing some or all features and/or functionality of the operator execution module 3215, for example, by implementing its operator processing module 2435 to execute one or more operator execution modules 3215 for one or more operators 2520 being processed by the given node 37. For example, a plurality of nodes of a query execution plan 2405 for a given query execute their operators based on implementing corresponding query processing modules 2435 accordingly.

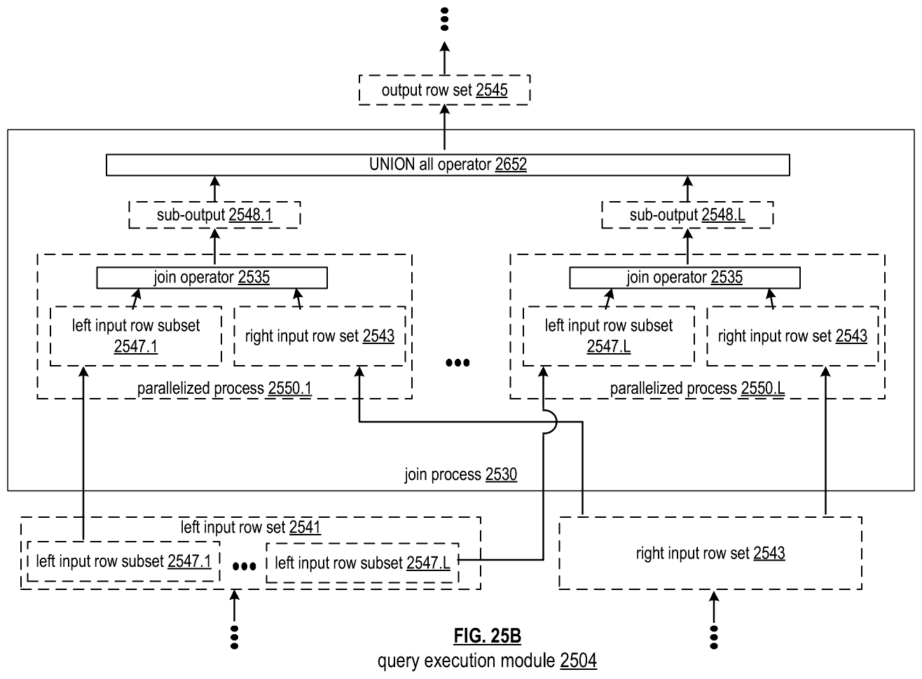

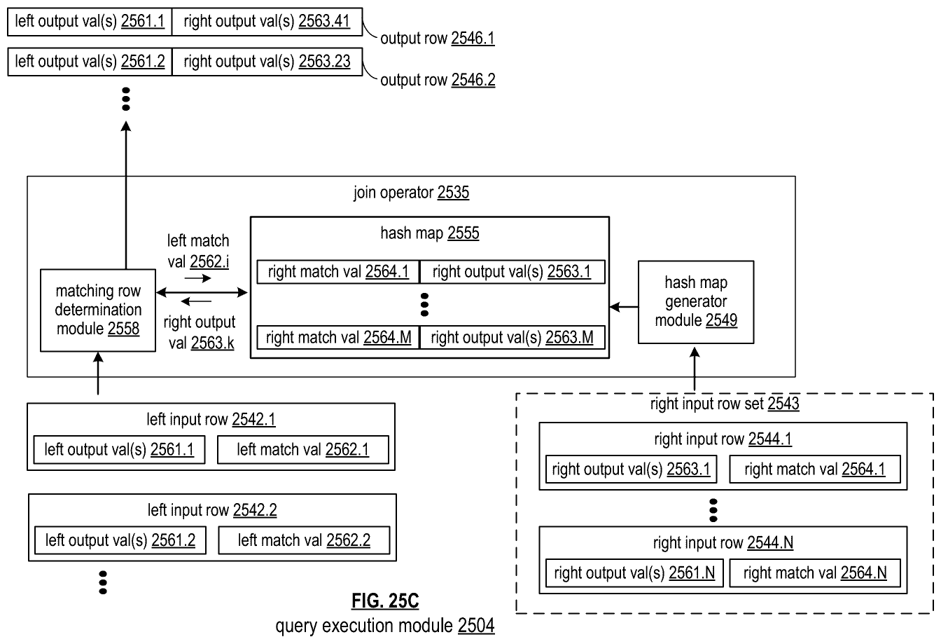

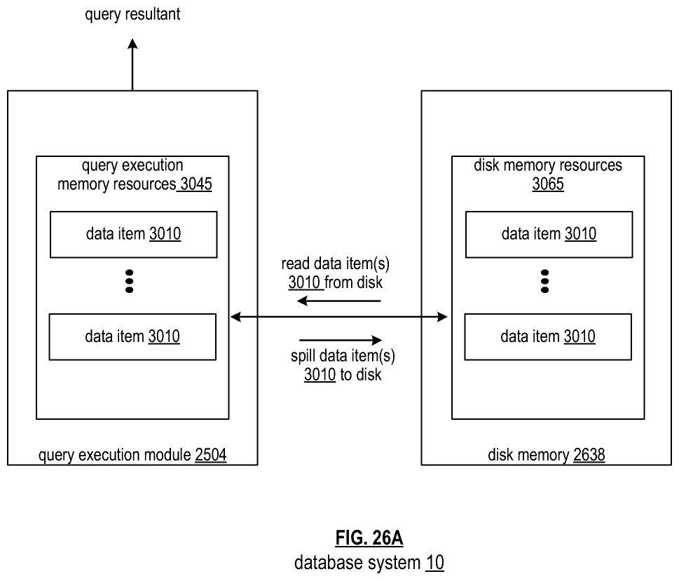

FIG. 24K illustrates an embodiment of database storage 2450 operable to store a plurality of database tables 2712, such as relational database tables or other database tables as described previously herein. Database storage 2450 can be implemented via the parallelized data store, retrieve, and/or process sub-system 12, via memory drives 2425 of one or more nodes 37 implementing the database storage 2450, and/or via other memory and/or storage resources of database system 10. The database tables 2712 can be stored as segments as discussed in conjunction with FIGS. 15-23 and/or FIGS. 25C-24D. A database table 2712 can be implemented as one or more datasets and/or a portion of a given dataset, such as the dataset of FIG. 15.

A given database table 2712 can be stored based on being received for storage, for example, via the parallelized ingress sub-system 24 and/or via other data ingress. Alternatively or in addition, a given database table 2712 can be generated and/or modified by the database system 10 itself based on being generated as output of a query executed by query execution module 2504, such as a Create Table As Select (CTAS) query or Insert query.

A given database table 2712 can be accordance with a schema 2409 defining columns of the database table, where records 2422 correspond to rows having values 2708 for some or all of these columns. Different database tables can have different numbers of columns and/or different datatypes for values stored in different columns. For example, the set of columns 2707.1_{A}-2707.C_{A} of schema 2709.A for database table 2712.A can have a different number of columns than and/or can have different datatypes for some or all columns of the set of columns 2707.1_{B}-2707.C_{B} of schema 2709.B for database table 2712.B. The schema 2409 for a given n database table 2712 can denote same or different datatypes for some or all of its set of columns. For example, some columns are variable-length and other columns are fixed-length. As another example, some columns are integers, other columns are binary values, other columns are Strings, and/or other columns are char types.

Row reads performed during query execution, such as row reads performed at the IO level of a query execution plan 2405, can be performed by reading values 2708 for one or more specified columns 2707 of the given query for some or all rows of one or more specified database tables, as denoted by the query expression defining the query to be performed. Filtering, join operations, and/or values included in the query resultant can be further dictated by operations to be performed upon the read values 2708 of these one or more specified columns 2707.

FIGS. 24L-24M illustrates an example embodiment of a query execution module 2405 of a database system 10 that executes queries via generation, storage, and/or communication of a plurality of column data streams 2968 corresponding to a plurality of columns. Some or all features and/or functionality of query execution module 2405 of FIGS. 24L-24M can implement any embodiment of query execution module 2405 described herein and/or any performance of query execution described herein. Some or all features and/or functionality of column data streams 2968 of FIGS. 24L-24M can implement any embodiment of data blocks 2537 and/or other communication of data between operators 2520 of a query operator execution flow 2517 when executed by a query execution module 2405, for example, via a corresponding plurality of operator execution modules 3215.

As illustrated in FIG. 24L, in some embodiments, data values of each given column 2915 are included in data blocks of their own respective column data stream 2968. Each column data stream 2968 can correspond to one given column 2915, where each given column 2915 is included in one data stream included in and/or referenced by output data blocks generated via execution of one or more operator execution module 3215, for example, to be utilized as input by one or more other operator execution modules 3215. Different columns can be designated for inclusion in different data streams. For example, different column streams are written do different portions of memory, such as different sets of memory fragments of query execution memory resources.

As illustrated in FIG. 24M, each data block 2537 of a given column data stream 2968 can include values 2918 for the respective column for one or more corresponding rows 2919. In the example of FIG. 24M, each data block includes values for V corresponding rows, where different data blocks in the column data stream include different respective sets of V rows, for example, that are each a subset of a total set of rows to be processed. In other embodiments, different data blocks can have different numbers of rows. The subsets of rows across a plurality of data blocks 2537 of a given column data stream 2968 can be mutually exclusive and collectively exhaustive with respect to the full output set of rows, for example, emitted by a corresponding operator execution module 3215 as output.

Values 2918 of a given row utilized in query execution are thus dispersed across different A given column 2915 can be implemented as a column 2707 having corresponding values 2918 implemented as values 2708 read from database table 2712 read from database storage 2450, for example, via execution of corresponding IO operators. Alternatively or in addition, a given column 2915 can be implemented as a column 2707 having new and/or modified values generated during query execution, for example, via execution of an extend expression and/or other operation. Alternatively or in addition, a given column 2915 can be implemented as a new column generated during query execution having new values generated accordingly, for example, via execution of an extend expression and/or other operation. The set of column data streams 2968 generated and/or emitted between operators in query execution can correspond to some or all columns of one or more tables 2712 and/or new columns of an existing table and/or of a new table generated during query execution.

Additional column streams emitted by the given operator execution module can have their respective values for the same full set of output rows across for other respective columns. For example, the values across all column streams are in accordance with a consistent ordering, where a first row's values 2918.1.1-2918.1.C for columns 2915.1-2915.C are included first in every respective column data stream, where a second row's values 2918.2.1-2918.2.C for columns 2915.1-2915.C are included second in every respective column data stream, and so on. In other embodiments, rows are optionally ordered differently in different column streams. Rows can be identified across column streams based on consistent ordering of values, based on being mapped to and/or indicating row identifiers, or other means.

As a particular example, for every fixed-length column, a huge block can be allocated to initialize a fixed length column stream, which can be implemented via mutable memory as a mutable memory column stream, and/or for every variable-length column, another huge block can be allocated to initialize a binary stream, which can be implemented via mutable memory as a mutable memory binary stream. A given column data stream 2968 can be continuously appended with fixed length values to data runs of contiguous memory and/or may grow the underlying huge page memory region to acquire more contiguous runs and/or fragments of memory.

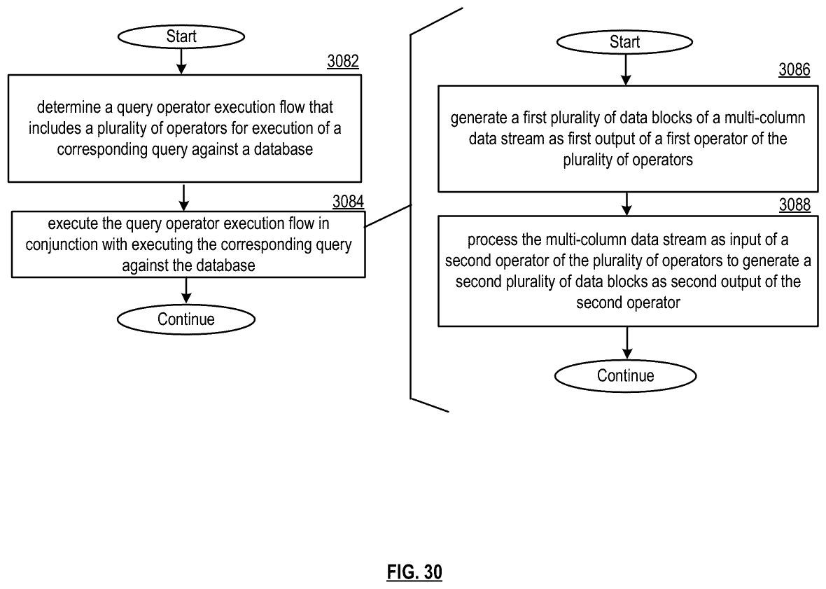

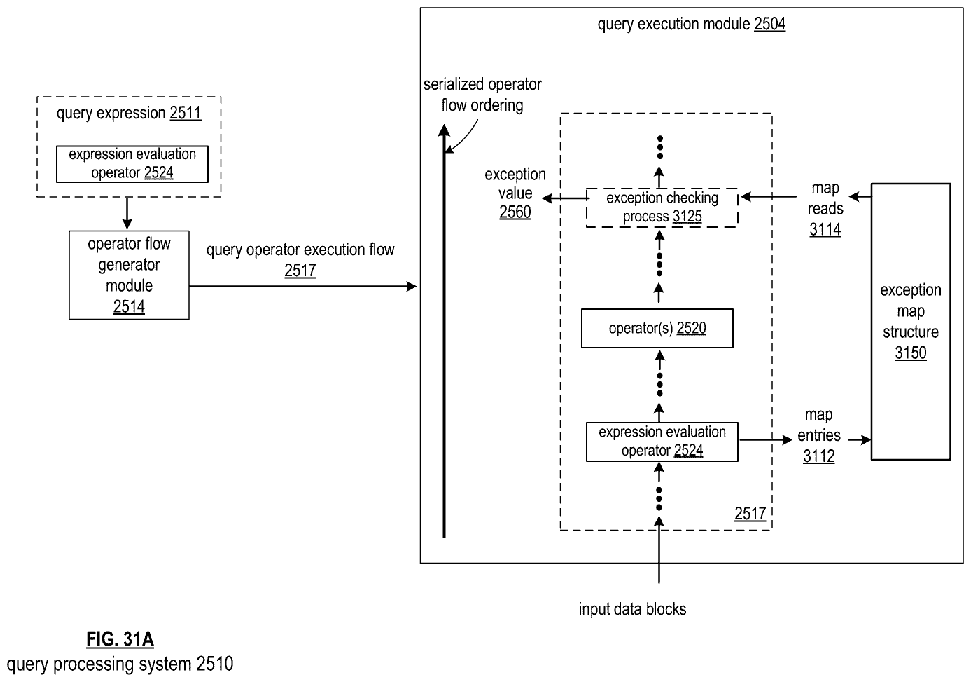

In other embodiments, rather than emitting data blocks with values 2918 for different columns in different column streams, values 2918 for a set of multiple column can be emitted in a same multi-column data stream. Such embodiments are discussed in further detail in conjunction with FIGS. 29A-30.

FIGS. 25A-25C illustrate embodiments of a database system 10 operable to execute queries indicating join expressions based on implementing corresponding join processes via one or more join operators. Some or all features and/or functionality of FIGS. 25A-25C can be utilized to implement the database system 10 of FIGS. 24A-241 when executing queries indicating join expressions. Some or all features and/or functionality of FIGS. 25A-25C can be utilized to implement any embodiment of the database system 10 described herein.

FIG. 25A illustrates an example of processing a query request 2515 that indicates a join expression 2516. The join expression 2516 can indicate that columns from one or more tables, for example, indicated by left input parameters 2513 and/or right input parameters 2518, be combined into a new table based on particular criteria, such as matching condition 2519 and/or a join type 2521 of the join operation. For example, the join expression 2516 can be implemented as a SQL JOIN clause, or any other type of join operation in any query language.

The join expression 2516 can indicate left input parameters 2513 and/or right input parameters 2518, denoting how the left input rows and/or right input rows be selected and/or generated for processing, such as which columns of which tables be selected. The left input and right input are optionally not distinguished as left and right, for example, where the join expression 2516 simply denotes input values for two input row sets. The join expression can optionally indicate performance of a join across three or more sets of rows, and/or multiple join expressions can be indicated to denote performance of joins across three or more sets of rows. In the case of a self-join, the join expression can optionally indicate performance of a join across a single set of input rows.

The join expression 2516 can indicate a matching condition 2519 denoting what condition constitutes a left input row being matched with a right input row in generating output of the join operation, which can be based on characteristics of the left input row and/or the right input row, such as a function of values of one or more columns of the left input row and/or the right input row. For example, the matching condition 2519 requires equality between a value of a first column value of the left input rows and a second column value of the right input rows. The matching condition 2519 can indicate any conditional expression between values of the left input rows and right input rows, which can require equality between values, inequality between values, one value being less than another value, one value being greater than another value, one value being less than or equal to another value, one value being greater than or equal to another value, one value being a substring of another value, one value being an array element of an array, or other criteria. In some embodiments, the matching condition 2519 indicates all left input rows be matched with all right input rows. Two values and/or two corresponding rows can meet matching condition 2519 based on comparing favorably to one another and/or based on comparing favorably to the matching condition 2519.

The join expression 2516 can indicate a join type 2521 indicating the type of join to be performed to produce the output rows. For example, the join type 2521 can indicate the join be performed as a one of: a full outer join, a left outer join, a right outer join, an inner join, a cross join, a cartesian product, a self-join, an equi-join, a natural join, a hash join, or any other type of join, such as any SQL join type and/or any relational algebra join operation.

The query request 2515 can further indicate other portions of a corresponding query expression indicating performance of other operators, for example, to define the left input rows and/or the right input rows, and/or to further process output of the join expression.

The operator flow generator module 2514 can generate the query operator execution flow 2517 to indicate performance of a join process 2530 via one or more corresponding operators. The operators of the join process 2530 can be configured based on the matching condition 2519 and/or the join type 2521. The join process can be implemented via one or more serialized operators and/or multiple parallelized branches of operators 2520 configured to execute the corresponding join expression.

The operator flow generator module 2514 can generate the query operator execution flow 2517 to indicate performance of the join process 2530 upon output data blocks generated via one or more left input generation operators 2636 and one or more right input generation operators 2634. For example, the left input generation operators 2636 include one or more serialized operators and/or multiple parallelized branches of operators 2520 utilized to retrieve a set of rows from memory, for example, to perform IO operations, to filter the set of rows, to manipulate and/or transform values of the set of rows to generate new values of a new set of rows for performing the join, or otherwise retrieve and/or generate the left input rows, in accordance with the left input parameters 2513. Similarly, the right input generation operators 2634 include one or more serialized operators and/or multiple parallelized branches of operators utilized to retrieve a set of rows from memory, for example, via IO operators, to filter the set of rows, to manipulate and/or transform values of the set of rows to generate new values of a new set of rows for performing the join, or otherwise retrieve and/or generate the right input rows, in accordance with the right input parameters 2518. The left input generation operators 2636 and right input generation operators 2634 can optionally be distinct and performed in parallel to generate respective left and right input row sets separately. Alternatively, one or more of the left input generation operators 2636 and right input generation operators 2634 can optionally be shared operators between left input generation operators 2636 and right input generation operators 2634 to aid in generating both the left and right input row sets.

The query execution module 2504 can be implemented to execute the query operator execution flow 2517 to facilitate performance of the corresponding join expression 2516. This can include executing the left input generation operators 2636 to generate a left input row set 2541 that includes a plurality of left input rows 2542 determined in accordance with the left input parameters 2513, and/or executing the right input generation operators 2634 to generate a right input row set 2543 that includes a plurality of right input rows 2544 determined in accordance with the right input parameters 2518. The plurality of left input rows 2542 of the left input row set 2541 can be generated via the left input generation operators 2636 as a stream of data blocks sent to the join process 2530 for processing, and/or the plurality of right input rows 2544 of the right input row set 2543 can be generated via the right input generation operators 2634 as a stream of data blocks sent to the join process 2530 for processing.

The join process 2530 can implement one or more join operators 2535 to process the left input row set 2541 and the right input row set 2543 to generate an output row set 2545 that includes a plurality of output rows 2546. The one or more join operators 2535 can be implemented as one or more operators 2520 configured to execute some or all of the corresponding join process. The output rows 2546 of the output row set 2545 can be generated via the join process 2530 as a stream of data blocks emitted as a query resultant of the query request 2515 and/or sent to other operators serially after the join process 2530 for further processing.

Each output rows 2546 can be generated based on matching a given left input row 2542 with a given right input row 2544 based on the matching condition 2519 and/or the join type 2521, where one or more particular columns of this left input row are combined with one or more particular columns of this given right input row 2544 as specified in the left input parameters 2513 and/or the right input parameters 2518 of the join expression 2516. A given left input row 2542 can be included in no output rows based on matching with no right input rows 2544. A given left input row 2542 can be included in one or more output rows based on matching with one or more right input rows 2544 and/or being padded with null values as the right column values. A given right input row 2544 can be included in no output rows based on matching with no left input rows 2542. A given right input row 2544 can be included in one or more output rows based on matching with one or more left input rows 2542 and/or being padded with null values as the left column values.

The query execution module 2504 can execute the query operator execution flow 2517 via a plurality of nodes 37 of a query execution plan 2405, for example, in accordance with nodes 37 participating across different levels of the plan. For example, the left input generation operators 2636 and/or the right input generation operators 2634 are implemented via nodes at a first one or more levels of the query execution plan 2405, such as an IO level and/or one or more inner levels directly above the IO level.

The left input generation operators 2636 and the right input generation operators 2634 can be implemented via a common set of nodes at these one or more levels. Alternatively some or all of the left input generation operators 2636 are processed via a first set of nodes of these one or more levels, and the right input generation operators 2634 are processed via a second set of nodes that have a non-null difference with and/or that are mutually exclusive with the first set of nodes.

The join process 2530 can be implemented via a nodes at a second one or more levels of the query execution plan 2405, such as one or more inner levels directly above the first one or more levels, and/or the root level. For example, one or more nodes at the second one or more levels implementing the join process 2530 receive left input rows 2542 and/or right input rows 2544 for processing from child nodes implementing the left input generation operators 2636 and/or child nodes implementing the right input generation operators 2634. The one or more nodes implementing the join process 2530 at the second one or more levels can optionally belong to a same shuffle node set 2485, and can laterally exchange left input rows and/or right input rows with each other via one or more shuffle operators and/or broadcast operators via a corresponding shuffle network 2480.

FIG. 25B illustrates an embodiment of a query execution module 2504 executing a join process 2530 via a plurality of parallelized processes 2550.1-2550.L. Some or all features and/or functionality of the query execution module 2504 can be utilized to implement the query execution module 2504 of FIG. 25A, and/or any other embodiment of the query execution module 2504 described herein. In other embodiments, the query execution module 2504 of FIG. 25A implements the join process 2530 via a single join operator of a single processes rather than the plurality of parallelized processes 2550.

In some embodiments, the plurality of parallelized processes 2550.1-2550.L are implemented via a corresponding plurality of nodes 37.1-37.L of a same level, such as a given inner level, of a query execution plan 2405 executing the given query. The plurality of parallelized processes 2550.1-2550.L can be implemented via any other set of parallelized and/or distinct memory and/or processing resources.

Each parallelized process 2550 can be responsible for generating its own sub-output 2548 based on processing a corresponding left input row subset 2547 of the left input row set 2541, and by further processing all of the right input row set. The full output row set 2545 can be generated by applying a UNION all operator 2652 implementing a union across all L sets of sub-output 2548, where all output rows 2546 of all sub-outputs 2548 are thus included in the output row set 2545. The output rows 2546 of a given sub-output 2548 can be generated via the join operator 2535 of the corresponding parallelized process 2555 as a stream of data blocks sent to the UNION all operator 2652.

In some embodiments, L different nodes and/or L different subsets of nodes that each include multiple nodes generate a corresponding left input row subset 2547 at a corresponding level of the query execution plan at a level below the level of nodes implementing the plurality of parallelized processes 2550.1-2550.L. For example, each parallelized process 2550 only receives the left input rows 2542 generated by its own one or more child nodes, where each of these child nodes only sends its output data blocks to one parent. The left input row set 2541 can otherwise be segregated into the set of left input row subsets 2547.1-2547.L, each designated for a corresponding one of the set of parallelized processes 2550.1-2550.L. The plurality of left input row subsets 2547.1-2547.L can be mutually exclusive and collectively exhaustive with respect to the left input row set 2541, where each left input row 2542 is received and processed by exactly one parallelized process 2550.

In some embodiments, the right input row set 2543 is generated via another set of nodes that is the same as, overlapping with, and/or distinct from the set of nodes that generate the left input row subsets 2547.1-2547.L. For example, similar to the nodes generating left input row subsets 2547, L different nodes and/or L different subsets of nodes that each include multiple nodes generate a corresponding subset of right input rows, where these subsets are mutually exclusive and collectively exhaustive with respect to the right input row set 2543. Unlike the left input rows, all right input rows 2544 can be received by all parallelized processes 2550.1, for example, based on each node of this other set of nodes sending its output data blocks to all L nodes implementing the L parallelized processes 2550, rather than a single parent. Alternatively, the right input rows 2544 generated by a given node can be sent by the node to one parent implementing a corresponding one of the plurality of parallelized processes 2550.1-2550.L, where the L nodes perform a shuffle and/or broadcast process to share received rows of the right input row set 2543 with one another via a shuffle network 2480 to facilitate all L nodes receiving all of the right input rows 2544. Each right input row 2544 is otherwise received and processed by every parallelized process 2550.

This mechanism can be employed for correctly implementing inner joins and/or left outer joins. In some embodiments, further adaptation of this join process 2530 is required to facilitate performance of full outer joins and/or right outer joins, as a given parallel process cannot ascertain whether a given right row matches with a left row of some or the left input row subset, or should be padded with nulls based on not matching with any left rows.

In some embodiments, to implement a right outer join, the right and left input rows of a right outer join are designated in reverse, enabling the right outer join to be correctly generated based on instead segregating the right input rows of the right outer join across all parallelized processes 2550, and instead processing all left input rows of the right outer join by all parallelized processes 2550.

The left input row set that is segregated across all parallelized processes 2550 vs. the right input row set processed via every parallelized processes 2550 can be selected, for example, based on an optimization process performed when generating the query operator execution flow 2517. For example, for a join specified as being performed upon two sets of input rows, while the input row set segregated amongst different parallelized processes 2550 and the input row set processed via every parallelized processes 2550 could be interchangeably selected, an intelligent selection is employed to optimize processing via the parallelized processes. For example, the input row set that is estimated and/or known to require smaller memory space due to column value types and/or number of input rows meeting the respective parameters is optionally designated as the right input row set 2543, and the larger input row set that is estimated and/or known to require larger memory space is designated as the left input row set 2541, for example, to reduce the full set of right input rows required to be processed by a given parallelized process. In some cases, this optimization is performed even in the case of a left outer join or right outer join, where, if the right hand side designated in the query expression is in fact estimated to be larger than the left hand side, the “left” input row set 2541 that is segregated across all parallelized processes 2550 is selected to instead correspond to the right hand side designated by the query expression, and the “right” input row set 2543 that is segregated across all parallelized processes 2550 is selected to instead correspond to the left hand side designated by the query expression. In other embodiments, the vice versa scenario is applied, where the larger row set is designated as the right input row set 2543 processed by every parallelized process, and where the smaller row set is designated as the left input row set 2541 segregated into subsets each for processing by only one parallelized process.

FIG. 25C illustrates an embodiment of a query execution module 2504 executing a join operator 2535. The embodiment of implementing the join operator 2535 of FIG. 25C can be utilized to implement the join process 2530 of FIG. 25A and/or can be utilized to implement the join operator 2535 executed via each of a set of parallelized processes 2550 of FIG. 25B.

The join operator can process all right input rows 2544.1-2544.N of a right input row set 2543, and can process some or all left input rows 2542, such as only left input rows of a corresponding left input row subset 2547. The right input rows 2544 and/or left input rows can be received as one or more streams of data blocks.

A plurality of left input rows 2542 can have a respective plurality of columns each having its own column value. One or more of these column values can be implemented as left output values 2561, designated for output in output rows 2546, where these left output values 2561, if outputted, are padded with nulls or combined with corresponding right rows when matching condition 2519 is met. One or more of these column values can be implemented as left match values 2562, designated for use in determining whether the given row matches with one or more right input rows. These left match values 2562 can be distinct columns from the columns that include left output values 2561, where these columns are utilized to identify matches only as required by the matching condition 2519, but are not to be emitted as output in output rows 2546. Alternatively, some or all of these left match values 2562 can same columns as one or more columns that include left output values 2561, where these columns are utilized to not only identify matches as required by the matching condition 2519, but are further emitted as output in output rows 2546.

In some cases, the left input rows 2542 utilize a single column whose values implement both the left output values 2561 and the left match values 2562. In other cases, the left input rows 2542 can utilize multiple columns, where a first subset of these columns implement one or more left output values 2561, where a second subset of these columns implement one or more left match values 2562, and where the first subset and the second subset are optionally equivalent, optionally have a non-null intersection and/or a non-null difference, and/or optionally are mutually exclusive. Different columns of the left input rows can optionally be received and processed in different column streams, for example, via a distinct set of processes operating in parallel with or without coordination.

Similarly to the left input rows, the plurality of right input rows 2544 can have a respective plurality of columns each having its own column value. One or more of these column values can be implemented as right output values 2563, designated for output in output rows 2546, where these left output values 2561, if outputted, are padded with nulls or combined with corresponding left rows when matching condition 2519 is met. One or more of these column values can be implemented as left match values 2564, designated for use in determining whether the given row matches with one or more left input rows. These right match values 2564 can be distinct columns from the columns that include right output values 2563, where these columns are utilized to identify matches only as required by the matching condition 2519, but are not to be emitted as output in output rows 2546. Alternatively, some or all of these right match values 2564 can be implemented via same columns as one or more columns that include left output values 2561, where these columns are utilized to not only identify matches as required by the matching condition 2519, but are further emitted as output in output rows 2546.

In some cases, the right input rows 2544 utilize a single column whose values implement both the left output values 2561 and the left match values 2564. In other cases, the right input rows 2544 can utilize multiple columns, where a first subset of these columns implement one or more right output values 2563, where a second subset of these columns implement one or more right match values 2564, and where the first subset and the second subset are optionally equivalent, optionally have a non-null intersection and/or a non-null difference, and/or optionally are mutually exclusive. Different columns of the right input rows can optionally be received and processed in different column streams, for example, via a distinct set of processes operating in parallel with or without coordination.

Some or all of the set of columns of the left input rows can be the same as or distinct from some or all of the set of columns of the right input rows. For example, the left input rows and right input rows come from different tables, and include different columns of different tables. As another example, the left input rows and right input rows come from different tables each having a column with shared information, such as a particular type of data relating the different tables, where this column in a first table from which the left input rows are retrieved is used as the left match value 2562, and where this column in a second table from which the right input rows are retrieved is used as the right match value 2564. As another example, the left input rows and right input rows come from a same table, for example, where the left input row set 2541 and right input row set 2543 are optionally equivalent sets of rows upon which a self-join is performed.

The join operator 2535 can utilize a hash map 2555 generated from the right input row set 2543, mapping right match values 2564 to respective right output values 2563. For example, the raw right match values 2564 and/or other values generated from, hashed from, and/or determined based on the raw right match values 2564, are stored as keys of the hash map. In the case where the right match value 2564 for a given right input row includes multiple values of multiple columns, the key can optionally be generated from and/or can otherwise denote the given set of values.

In some embodiments, the join operator 2535 be implemented as a hash join, and/or the join operator 2535 can utilize the hash map 2555 generated from the right input row set 2543 based on being implemented as a hash join.

The number of entries M of the hash map 2555 is optionally strictly less than the number of right input rows N based on one or more right input rows 2544 having a same right match value 2564 and/or otherwise mapping to the same key generated from their right match values. These right match values 2564 can thus be mapped to multiple corresponding right output values 2563 of multiple corresponding right input rows 2544. The number of entries M of the hash map 2555 is optionally equal to N in other cases based on no pairs of right input rows 2544 sharing a same right match value 2564 and/or otherwise not mapping to the same key generated from their right match values.

The join operator 2535 can generate this hash map 2555 from the right input row set 2543 via a hash map generator module 2549. Alternatively, the join operator can receive this hash map and/or access this hash map in memory. In embodiments where multiple parallelized processes 2550 are employed, each parallelized processes 2550 optionally generates its own hash map 2555 from the full set of right input rows 2544 of right input row set 2543. Alternatively, as the hash map 2555 is equivalent for all parallelized processes 2550, the hash map 2555 is generated once, and is then sent to all parallelized processes and/or is then stored in memory accessible by all parallelized processes.

The join operator 2535 can implement a matching row determination module 2558 to utilize this hash map 2555 to determine whether a given left input row 2542 matches with a given right input row 2543 as defined by matching condition 2519. For example, the matching condition 2519 requires equality of the column that includes left match values 2562 with the column that includes right match values 2564, or indicates another required relation between one or more columns that includes one or more corresponding left match values 2562 with one or more columns that include one or more right match values 2564. For a given incoming left input row 2542.i, the matching row determination module 2558 can access hash map 2555 to determine whether this given left input row's left match value 2562 matches with any of the right match values 2564, for example, based on the left match value being equal to and/or hashing to a given key and/or otherwise being determined to match with this key as required by matching condition 2519. In the case where a match is identified as a right input row 2544.k, the right output value 2563 is retrieved and/or otherwise determined based on the hash map 2555, and the respective output row 2546 is generated to include the a new row generated to include both the one or more left output values 2561.i of the left input row 2542.i, as well as the right output values 2563.k of the identified matching right input row 2544.k.

In this example, a first output value includes left output value 2561.1 and right output value 2563.41 based on the left match value 2562.1 of left input row 2542.1 being determined to be equal to, or otherwise match with as defined by the matching condition 2519, the right match value 2564.41 of the right input row 2542.41. Similarly, a second output value includes left output value 2561.2 and right output value 2563.23 based on the left match value 2562.2 of left input row 2542.2 being determined to be equal to, or otherwise match with as defined by the matching condition 2519, the right match value 2564.23 of the right input row 2542.23.

While not illustrated, in some cases, one or left match values 2562 of one or more left input rows 2542 are determined match with no right match values 2564 of any right input rows 2544, for example, based on matching row determination module 2558 searching the hash map for these raw and/or processed left match values 2562 and determining no key is included in the hash map, or otherwise determining no right match value 2564 is equal to, or otherwise matches with as defined by the matching condition 2519, the given left match value 2562. The respective left output values of these left input rows 2542 can be padded with null values in output rows 2546, for example, in the case where the join type is a full outer join or a left outer join. Alternatively, the respective left output values of these left input rows 2542 are not emitted in respective output rows 2546, for example, in the case where the join type is an inner join or a right outer join.

While not illustrated, in some cases, one or left match values 2562 of one or more left input rows 2542 are determined match with right match values 2564 of multiple right input rows 2544, for example, based on matching row determination module 2558 searching the hash map for these raw and/or processed left match values 2562 and determining a key is included in the hash map 2555 that maps to multiple right output values 2563 of multiple right input rows 2544. The respective left output values of these left input rows 2542 can be emitted in multiple corresponding output rows 2546, where each of these multiple corresponding output rows 2546 includes the right output values 2563 of a given one of the multiple right input rows 2544. For example, if the left match values 2562 of a given left input rows 2542 matches with right match values 2564 of three right input rows 2544, the left match values 2562 is emitted in three output rows 2546, each including the respective one or more right output values of a given one of the three right input rows 2544.

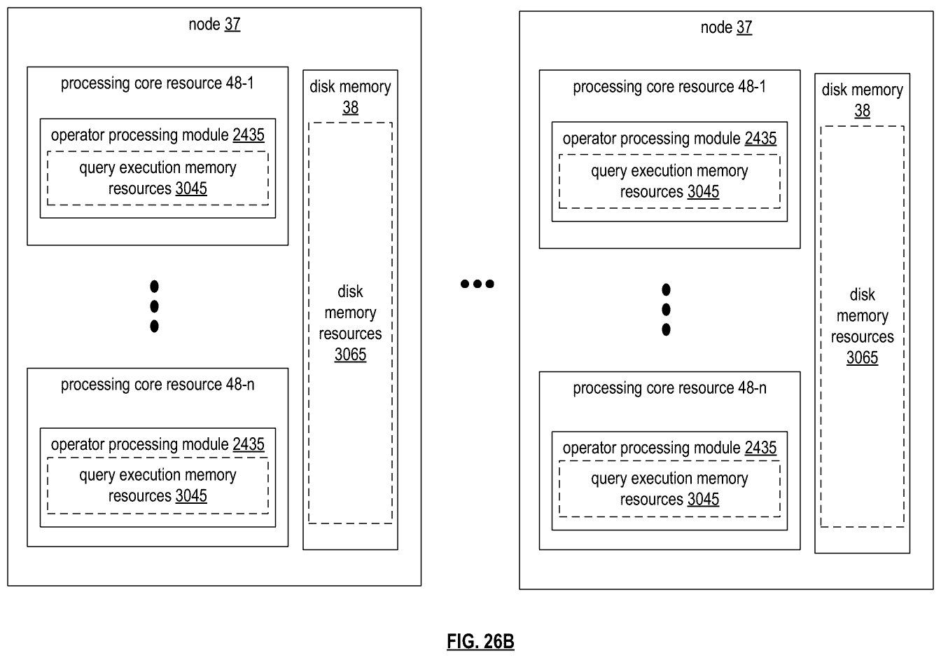

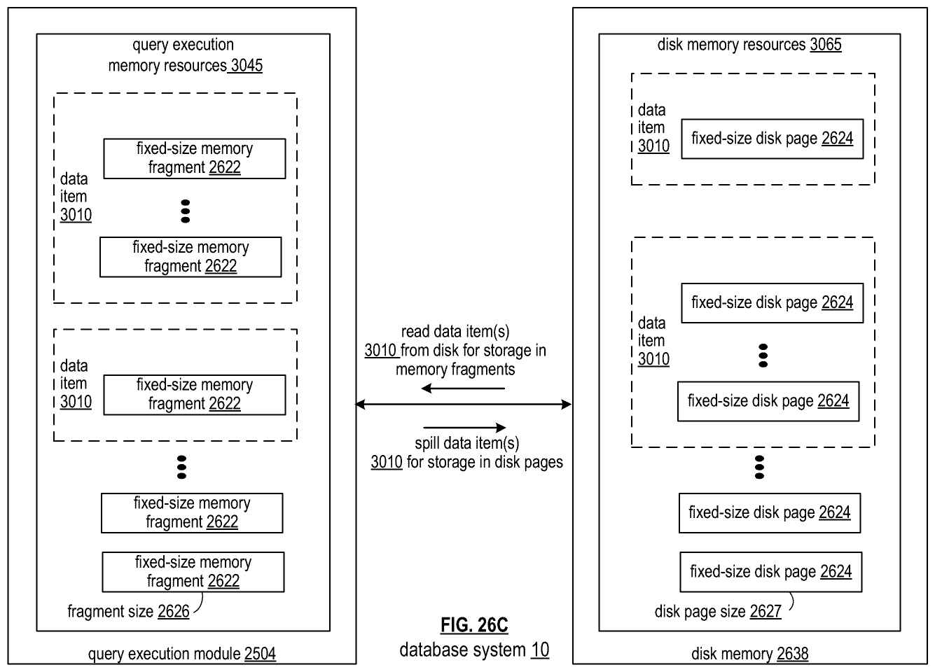

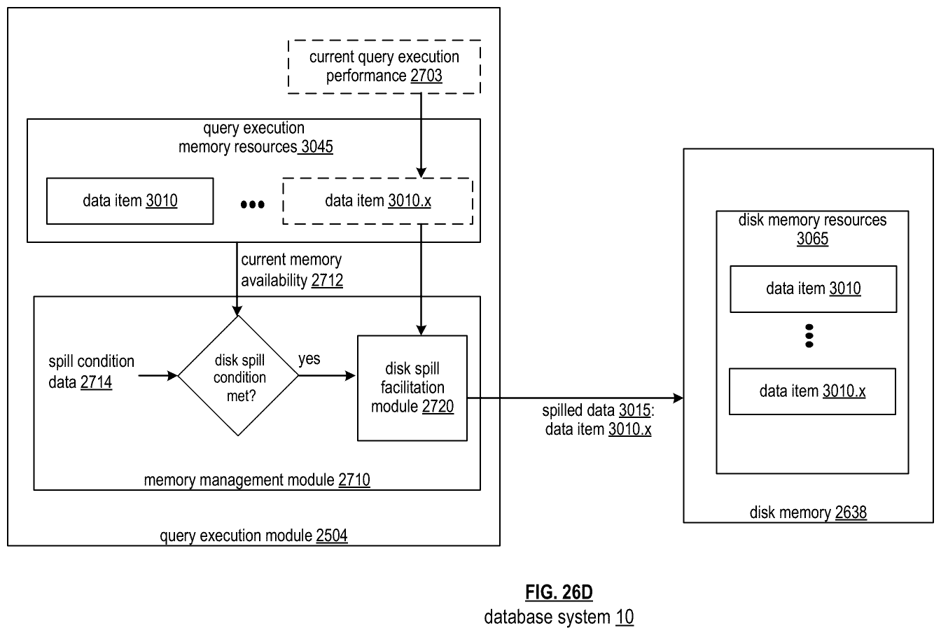

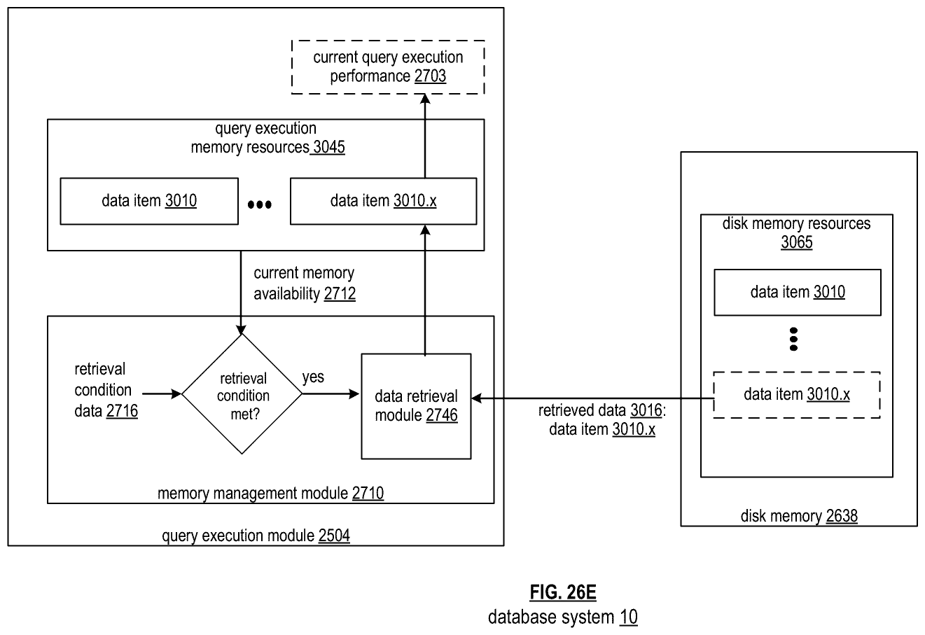

While not illustrated, in some cases, after processing the left input rows, one or more or right match values 2562 of one or more right input rows 2544 are determined not to have matched with any left match values 2562 of any of the received left input rows 2542, for example, based on matching row determination module 2558 never accessing these entries having these keys in the hash map when identifying matches for the left input rows. For example, execution of the join operator 2535 implementing a full outer join or a right join includes tracking the right input rows 2544 having matches, and all other remaining rows of the hash map are determined to not have had matches, and thus never had their output values 2563 emitted. In the case of a full outer join or a right join, the output values 2563 of these remaining, unmatched rows can be emitted as output rows 2546 padded with null values. An example of implementing this functionality is discussed in further detail in conjunction with FIGS. 26C-26D.

FIG. 26A illustrates an embodiment of a query execution module 2504 that executes queries utilizing its own query execution memory resources 3045. As needed, the query execution module 2504 spills data items to at least one corresponding disk memory 2638 during query executions. These data items can later be read for processing via query execution memory resources 3045 in conjunction with query execution. Some or all features and/or functionality of the query execution module 2504 of FIG. 26A can implement the query execution module 2504 of FIG. 24F and/or any other embodiment of query execution module 2504 and/or performance of query execution described herein.

The query execution module 2504 processing module can be operable to perform operator executions of operators 2520 and/or to store one or more input data sets 2522 of data blocks pending processing via by utilizing its query execution memory resources 3045. The operator processing module can otherwise execute queries via a plurality of operator executions of operators of the corresponding query operator execution flows 2517 by utilizing these query execution memory resources 3045.

The query execution memory resources 3045 can include a threshold amount of memory capacity that can be utilized for query execution by the query execution module 2504, at any given time. In some cases, during query execution, these memory resources are exhausted where additional memory is required for further execution of the query that is not available via query execution memory resources 3045, for example, due to the memory capacity of the internal query execution memory resources 3045 being reached via the current state of executing one or more query operator execution flows of one or more queries. For example: output is generated via an operator execution causing query execution memory resources 3045 to be low and/or fully exhausted; new pending data blocks are received causing query execution memory resources 3045 to be low and/or fully exhausted; a data structure, such as a hash map 2555 for performing hash joins, is generated and consumes query execution memory resources 3045 causing query execution memory resources 3045 to be low and/or fully exhausted; and/or other combinations of tasks and/or data being performed and/or processed during query execution at a given time consumes at least a threshold amount of the query execution memory resources 3045.

In these cases, one or more data items 3010 of corresponding query can be spilled to disk. Data items 3010 can include some or all operator state info for one or more corresponding operators in the query operator execution flow. For example, newly generated output, data blocks pending processing, and/or a data structure such as a hash map 2555 of a corresponding join such as a hash join, some or all of the corresponding query operator execution flow 2517, such as some or all data blocks outputted by operators 2520 and/or already included in operator queues 2522, or other data items 3010, are spilled to disk if there are not enough available portions of query execution memory resources 3045 for storing these data items. This can include transferring and/or storing these data items 3010 in disk memory resources 3065 of at least one disk memory 2638. Disk memory resources 3065 of disk memory 2638 can be accessed to perform the remainder of operator executions at a later time for performance the remainder of operator executions to facilitate completion of the query's execution.

Spilling to disk can result in slower execution of the corresponding query due to slower access and/or processing of data items 3010 in disk memory 38. Thus, in most cases as discussed herein, it can be favorable to execute queries via query execution memory resources 3045 when possible and it can be favorable to prevent executing queries from spilling to disk, when possible. Furthermore, the amount of disk memory resources 3065 available for data spills can be limited, so it can be further favorable to limit the amount of data spilled to disk.

FIG. 26B illustrates an embodiment of a plurality of nodes of a query execution module 2504 that each implement their own query execution memory resources 3045 and their own disk memory resources 3065. For example, the plurality of nodes of FIG. 26B collectively execute one or more given queries via participation in a query execution plan 2405. Some or all features and/or functionality of the query execution module 2504 of FIG. 26B can implement the query execution module of FIG. 26A and/or any other embodiment of the query execution module 2504 described herein.

The query execution memory resources 3045 of a given node can be implemented via some or all features and/or functionality of the query execution memory resources 3045 of FIG. 26A and/or any embodiment of query execution memory resources 3045 described herein. The disk memory resources 3065 of a given node can be implemented via some or all features and/or functionality of the disk memory resources 3065 of FIG. 26A and/or any embodiment of disk memory resources 3065 described herein. A given node can implement the spilling to disk and/or the reading from disk of FIG. 26A, and/or any other embodiment of spilling to disk or reading from disk described herein.

Some or all features and/or functionality of a given node 37 of FIG. 26B can be utilized to implement some or all nodes 37 of some or all computing devices 18 of the database system 10 described herein. A given node 37 can include one or more processing core resources 48-1-48-n as discussed previously, where each processing core resource 48 optionally executes queries by implementing its own query processing module 2435, such as embodiments of the query processing module 2435 discussed in conjunction with FIGS. 24A-24D.

Each query processing module 2435 can be operable to execute queries by utilizing its own query execution memory resources 3045. For example, the query execution memory resources 3045 can be implemented by utilizing cache memory 45 of the corresponding processing core resource 48 and/or by utilizing other memory of the processing core resource 48 that is utilized by its processing module 44. In some cases, the query execution memory resources 3045 are shared by an operator scheduling module and/or other processing modules of the corresponding processing core resource 48 to facilitate performance of other functionality of the processing core resource 48 discussed herein.

The query execution memory resources 3045 can include a threshold amount of memory capacity that can be utilized for query execution by the query processing module 2435 of the given processing core resource 48 and/or given node 37, and/or other operations of the processing core resource and/or given node, at any given time. The query execution memory resources 3045 can store data items 3010 utilized by the node to execute queries.

Individual nodes can spill various data items 3010 to their own disk memory during query executions as needed, for example, based on the individual node's query execution memory resources 3045 comparing unfavorably to low memory criteria, having availability lower than or equal to a low memory threshold, otherwise becoming unavailable for further processing of its data items, and/or other reasons. Individual nodes can read these data items from their own disk memory, for example, based on the individual node's query execution memory resources 3045 comparing favorably to low memory criteria, having availability greater than a low memory threshold, otherwise becoming available for further processing of data items, and/or other reasons. This can include transferring and/or storing data items in disk memory 38, such as memory device 42 of the particular processing core resource 48, and/or other disk memory accessible by the node 37. For example, after a given data item to be processed in conjunction with execution of a given query is spilled to a node's disk memory by a given node when query execution memory resources 3045 are low and/or unavailable, this given node later reads the given data item from disk memory for processing in conjunction with the given query when query execution memory resources 3045 are no longer low and/or are again available.

FIG. 26C illustrates an embodiment of a database system 10 where query execution memory resources 3045 store various data items 3010 via a plurality of fixed-size memory fragments 2622, and/or where disk memory resources 3065 store various data items 3010 via a plurality of fixed-size disk pages 2624. Some or all features and/or functionality of the query execution memory resources 3045 and/or disk memory resources 3065 of FIG. 26C can implement the query execution memory resources 3045 and/or disk memory resources 3065 of FIGS. 26A and/or 26B, and/or any other embodiments of query execution memory resources 3045 and/or disk memory resources 3065 described herein.

In some embodiments, data items 3010 that are processed and/or spilled via query execution module 2504 and/or a given node 37 are a portion of memory made up of one or more fixed-size fragment each having the same fragment size 2626. For example, each fixed size fragment can have a fixed size of 128 KiB, or any other fixed size. The fragment size can correspond to smallest increment of memory allocation. Thus, in some cases, a given data item only consumes a fraction of a single fragment, where this single fragment is optionally only utilized for this given data item and not any other data items, despite having extra space not being filled, as this is the smallest allocatable memory of query execution memory resources 3045. Other data items can be larger and consist of more than one data fragment.

Data can be spilled to an underlying store that manages the disk memory resources 3065 as a collection of fixed-size pages each having the same disk page size 2627. For example, each fixed-size page can have a fixed size of 8-128 KiB. Similar to fragments, a page can correspond to the smallest increment of disk allocation, and/or all writes are rounded up to the nearest page.

FIG. 26D illustrates an embodiment of a memory management module 2710 implemented to determine whether to spill to disk as incoming data items 3010 are generated and processed during query execution. The memory management module 2710 of FIG. 26D can be implemented via a query execution module 2504 to implement the spilling to disk of FIG. 26A. As a particular example, the memory management module 2710 of FIG. 26D can be implemented via one or more individual nodes 37 of FIG. 26B to implement spilling to disk by individual nodes 37 of a query execution module 2504.

The memory management module 2710 can determine whether a disk spill condition is met for a given incoming data item 3010.x generated and/or received during current query execution performance 2703 based on current memory availability 2712 of query execution memory resources 3045 and/or based on disk spill condition data 2714, such as a threshold memory availability, threshold memory utilization, and/or other predetermined and/or dynamic conditions dictating that a disk spill be performed for the incoming data item. In particular, the disk spill condition can be determined to be met based on the current memory availability 2712 comparing unfavorably to the disk spill condition.

The disk spill condition data 2714 can indicate data be spilled when a low memory condition is met. For example, when memory availability 2712 is lower than a threshold minimum memory availability of the disk spill condition data 2714, the disk spill is facilitated for the given data item, where the given data item is stored in query execution memory resources 3045 when memory availability 2712 is greater than or equal to this threshold minimum memory availability. As another example, when memory availability 2712 is lower than an amount of memory required to store the incoming data item 3010.x, the disk spill is facilitated for the given data item, where the given data item is stored in query execution memory resources 3045 when memory availability 2712 indicates enough memory is available to be allocated to store the incoming data item.

When a disk spill condition of disk spill condition data 2714 is determined to be met, a disk spill facilitation module 2720 can be implemented to facilitate transfer of corresponding spilled data 3015 for the incoming data item in disk memory resources 3065. This can include sending the data stored in the one or more fixed-size memory fragments 2622 for storage in a set of fixed-size disk pages 2624. This can further include freeing these fixed-size memory fragments 2622 for allocation and use to store other data items generated in subsequent steps of the query execution.

FIG. 26E illustrates an embodiment of a memory management module 2710 that implements a data retrieval module 2746 to read previously spilled data back to query execution memory resources 3045 for further processing in accordance with the query. As a particular example, data item 3010.x is spilled at a first time during query execution as illustrated in FIG. 26D, and is later read back to back to query execution memory resources 3045 for further processing in accordance with the query at a second time during query execution as illustrated in FIG. 26E. The memory management module 2710 of FIG. 26E can be implemented via a query execution module 2504 to implement the reading of data from disk of FIG. 26A. As a particular example, the memory management module 2710 of FIG. 26E can be implemented via one or more individual nodes 37 of FIG. 26B to implement reading of data from disk by individual nodes 37 of a query execution module 2504.

The memory management module 2710 can determine whether a retrieval condition is met for based on current memory availability 2712 of query execution memory resources 3045 and/or based on retrieval condition data 2716, such as a threshold memory availability, threshold memory utilization, query progress, and/or other predetermined and/or dynamic conditions dictating that some or all data previously spilled to disk be retrieved for processing.

The spill condition data 2714 can indicate data be spilled when a low memory condition is no longer met. For example, when memory availability 2712 is greater than or equal to threshold minimum memory availability of the disk spill condition data 2714, the retrieval is facilitated for at least one given data item. As another example, when a second threshold minimum memory availability of the retrieval condition data that indicates a higher, or otherwise different, minimum memory favorability than the threshold minimum memory availability of the disk spill condition data 2714, the retrieval is facilitated for at least one given data item. As another example, when memory availability 2712 has availability for storing a given data item with at least a threshold buffer after storing the given data item, the given data item is retrieved. As a particular example, at least a number of fixed-sized memory fragments corresponding to a size of a corresponding data item 3010 must be available for storing the corresponding data item. Given data items retrieved at a given time can be based on their size, an ordering for processing these data items in conjunction with continuing query execution, or other factors.

When a retrieval condition of disk spill condition data 2714 is determined to be met, a data retrieval module 2746 can be implemented to facilitate retrieving of a given data item 3010 as retrieved data 3016, for example, based on sending a corresponding retrieval request. Performing this retrieval of data item 3010, for example, via sending of a corresponding retrieval request, can include utilizing lookup data and/or other metadata tracked for data items spilled to disk to identify the location of the data item in memory. Performing this retrieval of data item 3010 can include first allocating memory, such as one or more memory fragments 2622 for the data item to be retrieved in query execution memory resources 3045, and/or storing the retrieved data item 3010 in this allocated memory.

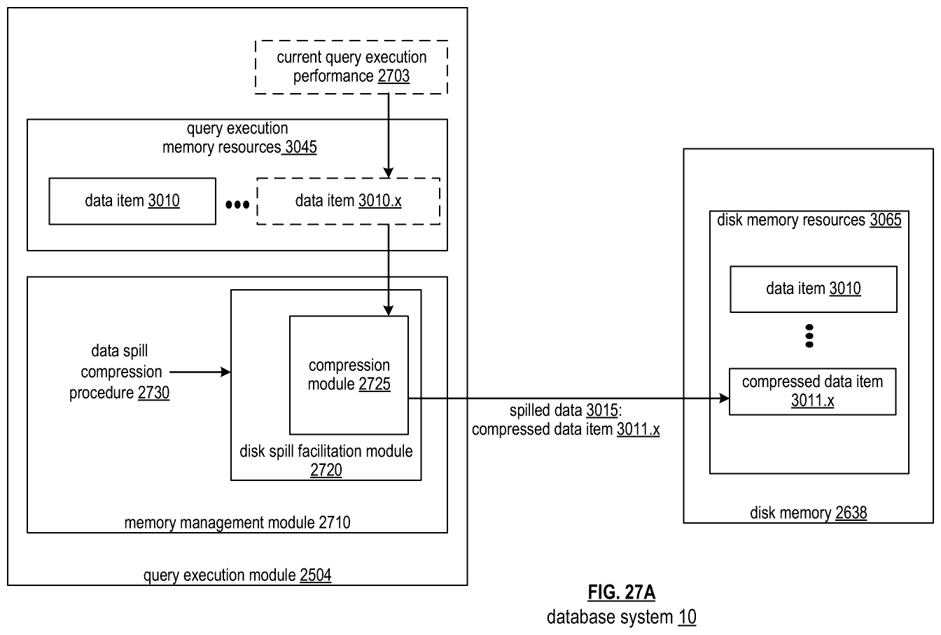

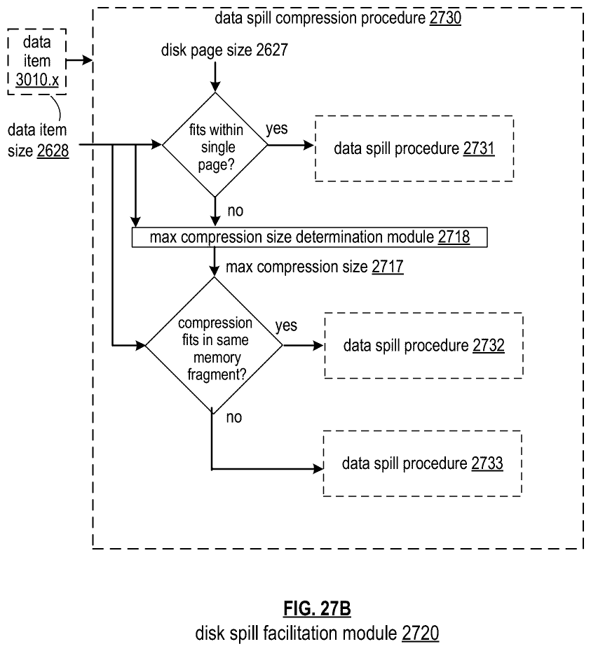

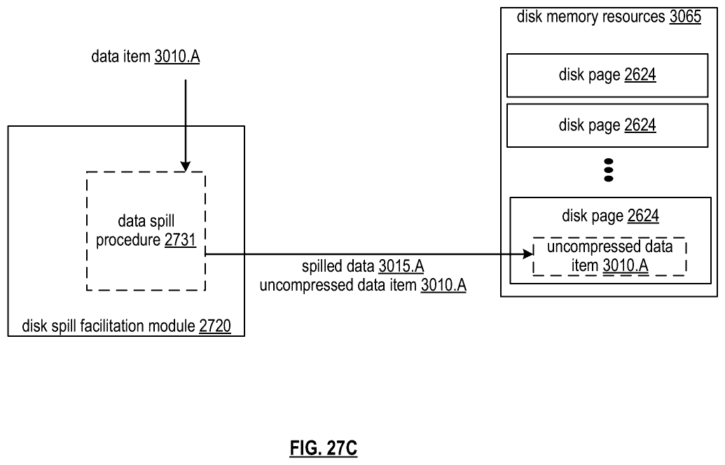

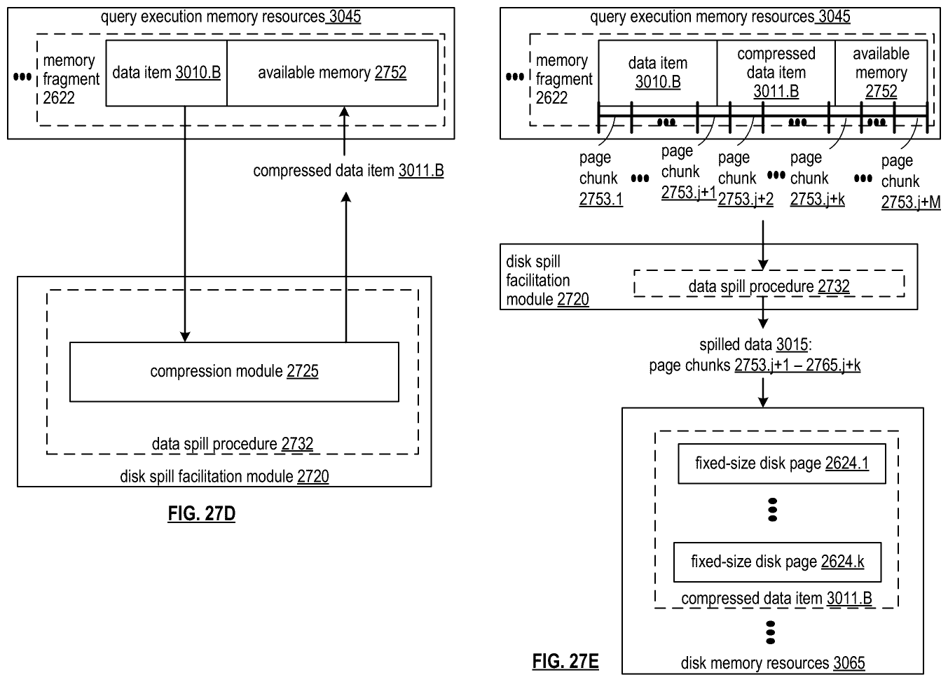

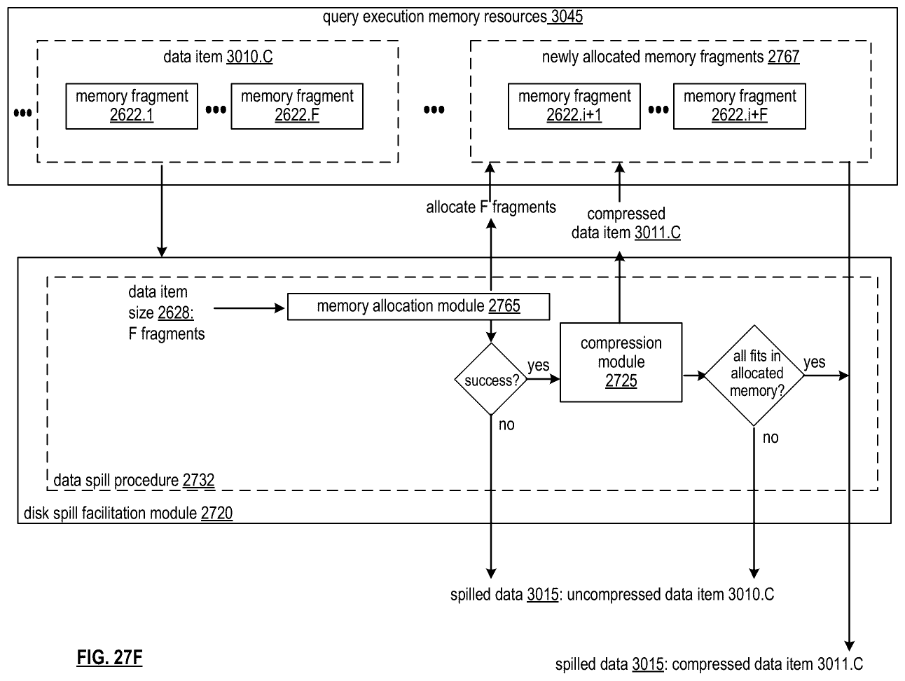

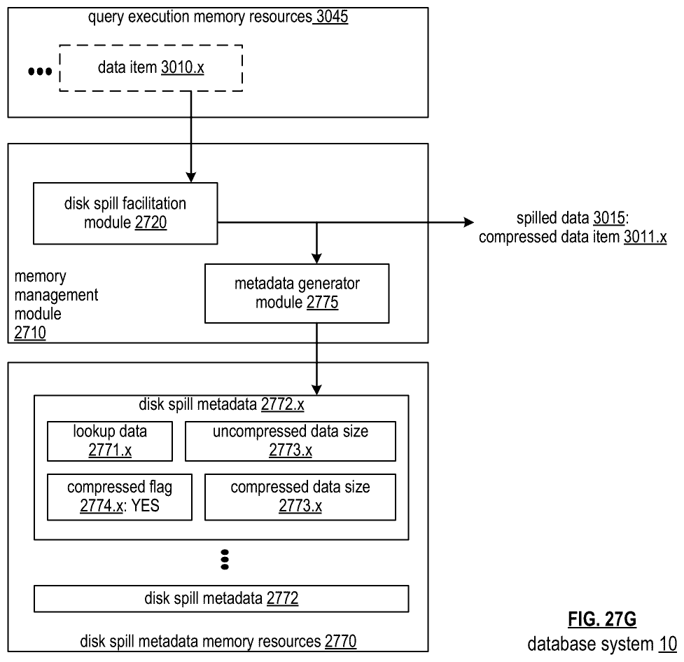

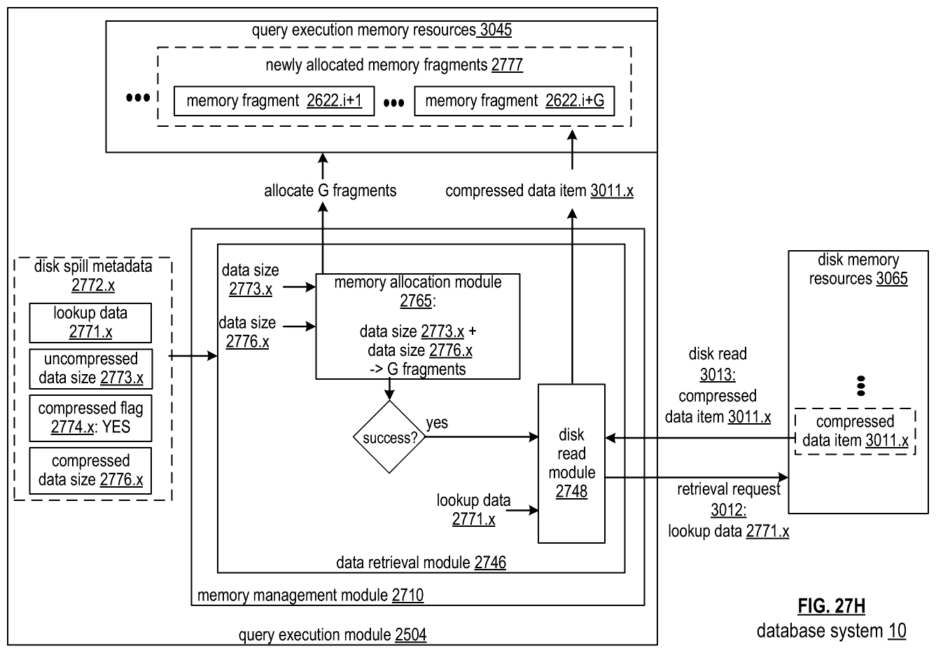

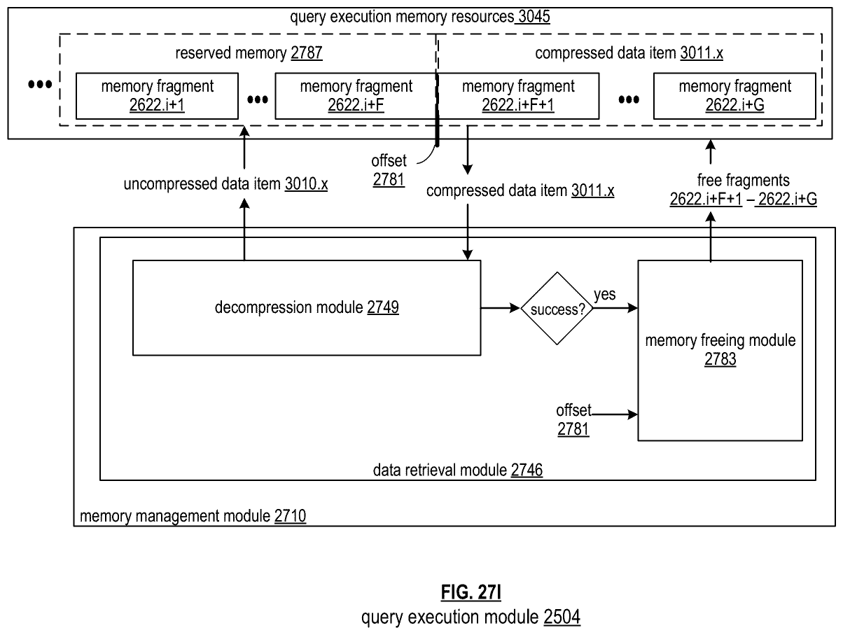

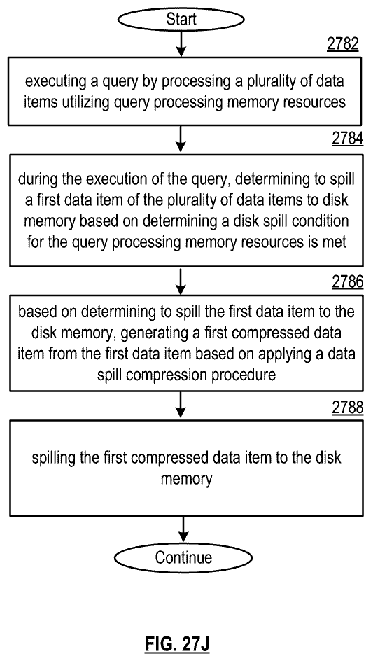

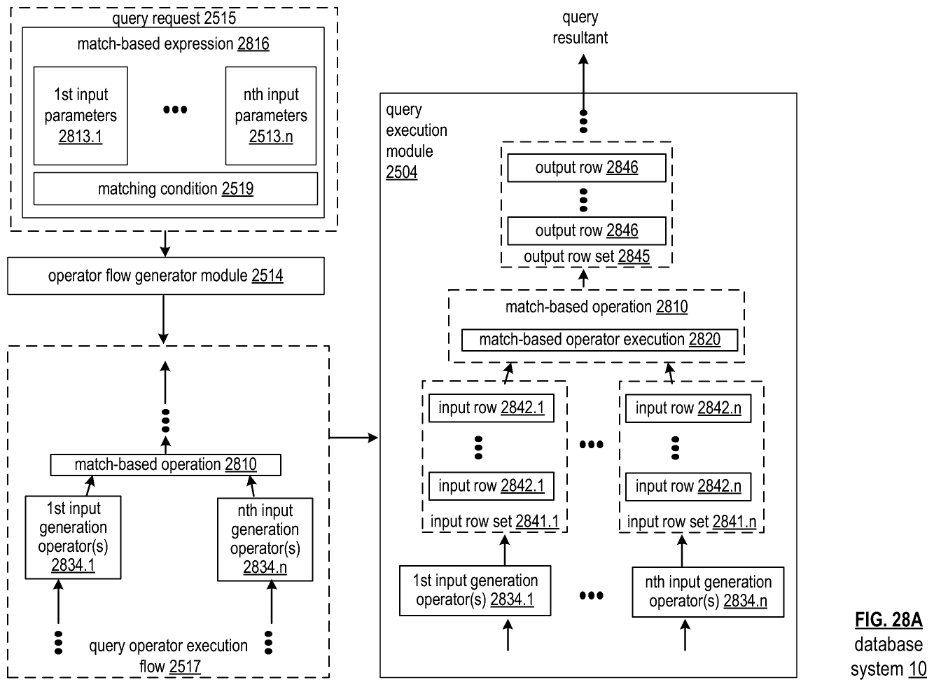

FIGS. 27A-27I illustrate embodiments of a database system 10 that spills data by first compressing this data when possible. Some or all features and/or functionality of spilling data as discussed in conjunction with FIGS. 27A-27I can be utilized to implement the spilling of data of FIGS. 26A-26E. Some or all and/or functionality of FIGS. 27A-27I can implement the database system 10 of FIG. 1 and/or any other embodiment of a database system described herein.

As discussed in conjunction with FIGS. 26A-26E, in order to process queries that require more memory than available, the system may need to spill certain portions of its memory to disk (typically pending data blocks and/or hash join structures), reading that data back as needed to process the query. In some cases, not enough disk space is available to hold the amount of spill needed for a query to succeed, resulting in that query failing with an out-of-memory error. In order to more efficiently utilize the disk space available for spill, data can be compressed before being written to disk and/or can be decompressed when read back for query processing. Furthermore, spilling can be triggered by a low memory condition or other condition of disk spill condition data 2714, for example, on a given node 37, so it can be important to minimize new memory allocations when possible when spilling—these are more likely than usual to fail and can exacerbate memory pressure.

FIG. 27A illustrates an example of a disk spill facilitation module 2720 that implements a compression module 2725 operable to compress an incoming data item 3010 to be spilled, for example, based on determining to spill the data item as discussed in conjunction with FIG. 26C. Some or all features and/or functionality of the data spill facilitation module 2720 of FIG. 27A can implement the data spill facilitation module 2720 of FIG. 26D. Some or all features and/or functionality of spilling data of FIG. 27A can implement spilling data of FIG. 26A. Some or all features and/or functionality of spilling data of FIG. 27A can be implemented via some or all individual nodes 37 implementing query execution module 2504 as discussed in conjunction with FIG. 26B.

The incoming data item 3010 can be compressed into a compressed data item 3011 that is spilled as spilled data 3015 for storage in disk memory resources 3065 by applying the compression module 2725, for example, that implements a corresponding compression function and/or compression scheme. The compression function utilized to compress incoming data item 3010 can correspond to a lossless compression algorithm, where the data item 3010 can be guaranteed to be fully reproducible when decompressed utilizing a corresponding decompression algorithm.

Compressing the data item 3010 into the compressed data item can be performed based on applying a corresponding data spill compression procedure 2730, for example, indicated in corresponding predetermined data spill compression procedure data implemented by the data spill facilitation module 2720. The data spill compression procedure 2730 can be implemented by a disk spill facilitation module 2720 to deterministically identify whether and/or how data be compressed for spilling to disk. For example, some data items are compressed and others are not based on conditions outlined in the data spill compression procedure 2730.

FIG. 27B illustrates an example embodiment of a data spill compression procedure 2730 implemented by a disk spill facilitation module 2720. Some or all features and/or functionality of the disk spill facilitation module 2720 and/or corresponding spilling of data can be implemented by the disk spill facilitation module 2720 of FIG. 27A and/or FIG. 26D. Some or all features and/or functionality of spilling data of FIG. 27B can implement spilling data of FIG. 26A. Some or all features and/or functionality of spilling data of FIG. 27B can be implemented via some or all individual nodes 37 implementing query execution module 2504 as discussed in conjunction with FIG. 26B.

When a data item is spilled, the system can first determine whether the size of the data item is less than or equal to the size of a disk page. This can include comparing data item size 2628 of the given data item 3010 to the disk page size 2627 of the fixed-size disk pages 2624 of FIG. 26C. If it fits within a single page, then no compression is necessary and the data can be spilled “normally” in its uncompressed form without being compressed. In particular, even if this data was compressed, it would still consume one page of disk memory, as the disk memory pages are the smallest allocatable portion of disk memory. This case can correspond to performance of data spill procedure 2731 of FIG. 27B. An example of processing a data item via data spill procedure 2731 is illustrated in FIG. 27C.

If the data item size is greater than the size of a page, the system can determine to attempt compression of the data item to attempt to reduce the number of pages required to store the data item. Proceeding with compressing of the data item can optionally be accomplished via multiple means depending on factors such as size of the incoming data item, size of the data when compressed, and/or size of memory fragments.

When the system determines to attempt compression of the data item, the system can next determine the maximum compressed size 2717 of the data item, for example, by applying a maximum compression size determination module 2718. If the incoming memory fragment is large enough to hold both the data item and its compressed representation, the data item can be compressed into the unused portion of its fragment. The fragment can then be chunked into multiple pages, and only the portion of the fragment corresponding to pages holding some amount of compressed data are spilled to disk. Note that in this case, the fragment will always consist of multiple pages of data—otherwise the data item would have been stored in a single page in its uncompressed form. In some embodiments, the maximum compressed size is always larger than the data item, and this case of including the compressed data in the given fragment only applies to single-fragment streams where the data item consumes less than half of the fragment. This case can correspond to performance of data spill procedure 2732 of FIG. 27B. An example of processing a data item via data spill procedure 2732 is illustrated in FIGS. 27D-27E.

If the incoming memory fragment is not large enough to hold both the data item and its compressed representation, the system can next attempt to allocate one or more fragments to match the size of the incoming data. If this fails, data is spilled uncompressed. If this succeeds, the data item can be compressed into the allocated memory. If the compressed data cannot fit into the allocated memory, then the uncompressed data is spilled. Otherwise, the resulting compressed data is spilled. This case can correspond to performance of data spill procedure 2733 of FIG. 27B An example of processing a data item via data spill procedure 2733 is illustrated in FIG. 27E. In some cases, if the given data item consumes multiple memory fragments, the maximum compressed size 2717 of the data item is not determined and/or no

FIG. 27C illustrates an example of performing a first type of data spill procedure 2731, for example, based on selecting this procedure as illustrated in FIG. 27B for performance upon incoming data item 3010.A. Based on the incoming data item 3010.A being smaller than disk page size 2627, the data item is uncompressed when spilled as spilled data 3015.A and is stored in a single fixed-size disk page 2624 of disk memory resources 3065. Some or all features and/or functionality of performing a data spill as illustrated in FIG. 27C can implement the data spill procedure 2731 of FIG. 27B and/or any other data spilling described herein.

FIGS. 27D-27E illustrate an example of performing a second type of data spill procedure 2732, for example, based on selecting this procedure as illustrated in FIG. 27B for performance upon incoming data item 3010.B. For example, this data spill procedure 2732 can be performed based on the incoming data item 3010.B being larger than disk page size 2627, while also being stored within a memory fragment having enough available to also store corresponding compressed data. The data item can first be compressed and stored within available memory 2752 of a corresponding memory fragment 2622 as compressed data item 3011 as illustrated in FIG. 27D. The corresponding memory fragment can be partitioned into M page chunks 2753.1-2753.M each having disk page size 2627, where only the k page chunks 2753.j+1-2753.j+k that include portions of compressed data item 3011.B are spilled as spilled data 3015.B and are stored in K corresponding fixed-size disk pages 2624.1-2624.k of disk memory resources 3065 as illustrated in FIG. 27E. For example, a given memory fragment can always be split into exactly M disk pages based on the memory fragment and disk pages being of fixed size, and/or further based on the fragment size 2626 being an integer multiple of disk page size 2627. In some cases, the first of these page chunks spilled to memory is truncated and/or modified to remove the portion of its data that includes the uncompressed data and/or the start of the compressed data in the corresponding page is denoted. Some or all features and/or functionality of performing a data spill as illustrated in FIG. 27D-27E can implement the data spill procedure 2732 of FIG. 27B and/or any other data spilling described herein.

FIG. 27F illustrates an example of performing a third type of data spill procedure 2733, for example, based on selecting this procedure as illustrated in FIG. 27B for performance upon incoming data item 3010.C. Some or all features and/or functionality of performing a data spill as illustrated in FIG. 27F can implement the data spill procedure 2731 of FIG. 27B and/or any other data spilling described herein.

Based on the incoming data item 3010.C not having room in a single respective memory fragment for compressed data, a memory allocation module 2765 attempts to allocate a number of memory fragments for the compressed data item based on size of the incoming data item 3010. For example, the same number of memory fragments F storing the uncompressed data item are allocated to store the compressed data of this data item.

In other embodiments, a smaller number of memory fragments than the number of fragments storing the uncompressed data item are allocated to store the compressed data of this data item, where this smaller number is based on an estimated and/or known number of fragments required, and/or is based on an amount of memory available that can be allocated to attempt to perform this compression.

If the memory allocation of the new fragments for the compressed data fails, no compression is performed, and the uncompressed data item 3010.C is spilled to disk. If the memory allocation of the new fragments for the compressed data succeeds, compression module 2725 is implemented to generate compressed data 3011 for storage within the set of F newly allocated memory fragments 2767 that includes fixed-size memory fragments 2622.i+1-2622.i+F.

If all of the compressed data fits into this set of F newly allocated memory fragments 2767, the resulting compressed data 3011.C is spilled to disk. This can include sending only full fragments, such as all F fragments, or only a proper subset of the F fragments that include compressed data 3011.C. This can alternatively or additionally include sending only a proper subset of page chunks 2753 from one or more given fragments that include the compressed data 3011.C, for example, in a similar fashion as discussed in conjunction with FIG. 27E. Once spilled, the newly allocated memory fragments 2767 can be freed to again be available for reallocation for other data items in the query execution as the compressed data item is no longer necessary.

If not all of the compressed data fits into this set of F newly allocated memory fragments, the uncompressed data item 3010.C is spilled to disk. These newly allocated memory fragments 2767 can be freed to again be available for reallocation for other data items in the query execution as the compressed data is not necessary.

FIG. 27G illustrates an embodiment of a memory management module 2710 that implements a metadata generator module 2775 to generate disk spill metadata 2772 for storage in disk spill metadata memory resources 2770 as corresponding spilled data 3015 for corresponding data items 3010 spilled over time. Some or all features and/or functionality of FIG. 27G can implement the memory management module 2710 of FIG. 27A and/or can implement the spilling to disk of FIG. 26A and/or any other embodiment of spilling to disk described herein. Some or all features and/or functionality of FIG. 27G can be implemented via some or all individual nodes 37 implementing query execution module 2504 as discussed in conjunction with FIG. 26B.

In some embodiments, a small amount of tracking metadata can be kept in memory, such as disk spill metadata memory resources 2770, to enable lookup of specific data items spilled to disk. Whenever compressed data is spilled, in-memory metadata can be updated to indicate that this data item was compressed, along with its compressed size. In some embodiments, in every case including when the data is not compressed, this metadata contains the uncompressed size of the data item along with a lookup handle.

This collection of disk spill metadata 2772 can be stored and/or accessed via disk memory resources 3065, for example, where disk spill metadata memory resources 2770 are implement via a set of fixed-size disk pages 2624 or other resources of disk memory resources 3065. This collection of disk spill metadata 2772 can alternatively or additionally be stored and/or accessed via query execution memory resources 3045, for example, where disk spill metadata memory resources 2770 are implement via fixed-size memory fragments 2622 or other resources of query execution memory resources 3045.

Disk spill metadata 2772 for each given data item spilled to disk, whether compressed or not compressed, can indicate lookup data 2771, such as a memory address, pointer, or other information utilized to locate the corresponding data in disk memory resources 3065. Disk spill metadata 2772 for each given data item spilled to disk, whether compressed or not compressed, can indicate an uncompressed data size 2773, such as a number of memory fragments 2622, number of disk pages 2624, number of data bits and/or data bytes, or other metric for size of data and/or amount of memory it consumes in storage in its uncompressed form.

Disk spill metadata 2772 can further indicate when a given data item is compressed. For example, disk spill metadata 2772 for each given data item spilled to disk, whether compressed or not compressed, can indicate a compressed flag 2774, such as a binary value or other indication of whether or not the given data item was compressed. When a data item 3010 was spilled as a compressed data item 3011, such as when the compressed flag 2774 indicates compression of the data item, the corresponding disk spill metadata 2772 can further indicate a compressed data size 2776.x, such as a number of memory fragments 2622, number of disk pages 2624, number of data bits and/or data bytes, or other metric for size of data and/or amount of memory it consumes in storage in its compressed form. In this example, the given data item 3010.x is spilled as compressed data item 3011.x, and compressed flag 2774 indicates this data item 3010.x was compressed and has a compressed data size 2776.x.

FIGS. 27H and 27I illustrate embodiment of a memory management module 2710 that implements a data retrieval module 2746 to read previously spilled data that was compressed as a compressed data item, for example, as discussed in conjunction with some or all features of FIGS. 27A-27G where spilling to disk includes compressing data items. Some or all features and/or functionality of FIG. 27H can implement the memory management module 2710 of FIG. 27A and/or can implement the reading of data of FIG. 26A, 26E, and/or any other embodiment of retrieving data previously spilling to disk described herein. Some or all features and/or functionality of reading data of FIGS. 27H and/or 27I can be implemented via some or all individual nodes 37 implementing query execution module 2504 as discussed in conjunction with FIG. 26B.

When reading a spilled data from disk, the system can first determine whether the spilled data item was compressed. If not, it is read “normally” in its uncompressed form for processing directly, as no decompression is necessary. If the data was compressed, the system can attempt to allocate one or more memory fragments with total size large enough to hold the sum of the compressed and uncompressed data item. If this allocation fails, the read from spill cannot proceed and can be tried again later. If this allocation succeeds, the compressed data can be read from disk into the upper part of the allocated memory, offset by the uncompressed data size. The compressed data can then be decompressed into the lower part of the allocated memory. The allocated fragments are truncated to hold only the uncompressed data, where this uncompressed result is returned for further query processing.

In the example of FIG. 27H, a given data item 3010.x is retrieved utilizing its disk spill metadata 2772.x. For example, this given data item 3010.x corresponds to the example data item 3010.x compressed and spilled to disk in the example of FIG. 27G.

Memory allocation module 2765 can first allocate memory fragments for both retrieving and decompressing the given data item 3010.x. This can include accessing this data item's disk spill metadata 2772.x. Based on the disk spill metadata 2772.x denoting that this data item 3010.x was compressed, the amount of data is allocated to accommodate both the size of the compressed data for decompression, and also the size of the resulting decompressed data. In this example, G memory fragments are allocated based on the uncompressed data size 2773.x and the compressed data size 2776.x as newly allocated memory fragments 2777.

As a particular example, a minimum number of memory fragments that can accommodate the sum of the uncompressed data size 2773.x and the compressed data size 2776.x are allocated as the G memory fragments, as the compressed data item 3011 requires storage via memory resources for processing to render recovery of the uncompressed data item 3010. Alternatively or in addition, the compressed data item 3011 and uncompressed data item 3010 are to be stored in distinct sets of memory fragments, where a minimum number of memory fragments that can accommodate the uncompressed data size 2773.x is determined and where a minimum number of memory fragments that can accommodate the compressed data size 2776.x is determined, where the G memory fragments corresponds to the sum of these two minimum numbers, which is optionally one greater than the number of memory fragments that would be required if a memory fragment shared portions of both the compressed and uncompressed data.

If this required number of memory fragments cannot be allocated, the retrieval is abandoned and reattempted at a later time. The system can optionally save this required number of data fragments G, where the recovery is reattempted once this number of data fragments is available and/or once this number of data fragments with an additional buffer is available.

In other cases where a given data item is denoted as not having been compressed, for example, via the compressed flag 2774 in its disk spill metadata 2772 or other information in its disk spill metadata 2772, only the number of data fragments required to accommodate its uncompressed form, as denoted by its uncompressed data size, are allocated.

If the G memory fragments are successfully allocated, a disk read module 2748 can be implemented to perform a disk read of the compressed data 3011.x from disk memory resources. This can include sending a retrieval request 3012 indicating the lookup data 2771.x for the given data item accessed in this given data item's spill disk metadata 2772.x. Disk read 3013.x can include the compressed data item 3011.x accordingly, and this compressed data item can be stored in newly allocated memory fragments 2777 for decompression.

As illustrated in the example of FIG. 27I, the compressed data item 3011.x can be stored in these newly allocated memory fragments 2777 in accordance with an offset applied based on compressed data size 2776.x. The remaining, prior memory, such as memory in a given fragment or across multiple fragments, can be considered reserved memory 2787 reserved for storing the uncompressed data once recovered. The size of reserved memory 2787 can correspond to the exact size and/or exact number of fragments of uncompressed data size 2773.x based on utilizing this information in the disk spill metadata 2772.x to apply offset 3011.x appropriately.

In some embodiments, offset can be rounded to full memory fragments 2622, where the compressed data item starts at a new data fragment, and where the compressed data item In other embodiments, this offset is optionally denoted within a data fragment, where the compressed data item starts mid-fragment, and ultimately shares this memory fragment with the uncompressed data item once decompressed. In this example, the first F data fragments are reserved for uncompressed data item 3010.x based on having an uncompressed data size 2773.x requiring F data fragments, where the offset denotes compressed data item 3011.x starts at memory fragment 2622.i+F+1.

A decompression module 2749 can be implemented to decompress the compressed data item 3011.x based on accessing and processing compressed data item 3011.x in query execution memory resources 3045. This can include applying a decompression and/or algorithm corresponding to the compression algorithm and/or otherwise recovering the original data item 3010.x. This recovered data item 3010.x is stored in reserved memory 2787, starting from the start of the newly allocated memory fragments 2777.

If the decompression is successful and the resulting uncompressed data item 3010 is again stored for subsequent processing, a memory freeing module 2783 can be implemented to free the memory storing compressed data item 3011.x, as the data item in compressed form is no longer required, to free memory for other data as the query continues to be processed. This can include a memory freeing request denoting the corresponding fragments 2622.i+F+1-2622.i+G to free only this memory, based on offset 2781, and/or can include otherwise freeing and/or truncating the data starting at offset 2781.

FIG. 27J illustrates a method for execution by at least one processing module and/or at least one memory module of a database system 10, such as via memory management module 2710. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 27J. In particular, a node 37 can utilize their own memory management module 2710, their own query execution memory resources 3045, and/or their own disk memory resources 3065 to execute some or all of the steps of FIG. 27J, where multiple nodes 37 implement their own query processing modules 2435 to independently execute the steps of FIG. 27J for example, to facilitate execution of a query as participants in a query execution plan 2405. Some or all of the steps of FIG. 27J can optionally be performed by any other processing module of the database system 10. Some or all of the steps of FIG. 27J can be performed to implement some or all of the functionality of the database system 10 as described in conjunction with FIGS. 27A-27I, for example, by implementing some or all of the functionality of the memory management module 2710. Some or all of the steps of FIG. 27J can be performed to implement some or all of the functionality regarding execution of a query via the plurality of nodes in the query execution plan 2405 as described in conjunction with some or all of FIGS. 24A-25C. Some or all of the steps of FIG. 27J can be performed to implement some or all of the functionality regarding spilling data to disk or reading data from disk as described in conjunction with some or all of FIGS. 26A-26E. Some or all steps of FIG. 27J can be performed by database system 10 in accordance with other embodiments of the database system 10 and/or nodes 37 discussed herein. Some or all steps of FIG. 27J can be performed in conjunction with one or more steps of any other method described herein.

Step 2782 includes executing a query by processing a plurality of data items utilizing query execution memory resources. Step 2784 includes, during the execution of the query, determining to spill a first data item of the plurality of data items to disk memory. In various example, determining to spill the first data item of the plurality of data items to disk memory is based on determining a disk spill condition for the query execution memory resources is met, for example, based on disk spill condition data 2714 and/or current memory availability 2712. In various examples, the disk spill condition being met can correspond to a low memory condition being met.

Step 2786 includes, based on determining to spill the first data item to the disk memory, generating a first compressed data item from the first data item based on applying a data spill compression procedure, such as data spill compression procedure 2730. In various examples, this can include compressing the data item based on applying data spill procedure 2732 or data spill procedure 2733. In various examples, this can include selecting between applying data spill procedure 2731, data spill procedure 2732, or data spill procedure 2733.

Step 2788 can include spilling the first compressed data item to the disk memory, for example, based on generating the first compressed data item. In various examples, the first compressed data item is generated and stored in query execution memory resources before being spilled to disk memory.

In various examples, steps 2784, 2786, and/or 2788 are performed during execution of the query performed in step 2782, after initiating this execution of the query in the beginning of step 2782.

In various examples, the disk memory can be distinct from the query execution memory resources. In various examples, the query execution memory resources are implemented via query execution memory resources 3045 of query processing module 2435 of at least one node 37 and/or of query execution module 2504 of the database system 10. In various examples, the disk memory is implemented via disk memory resources 3065 of disk memory 38 of at least one node and/or other disk memory 2638 of the database system 10.

In various examples, applying the data spill compression procedure to the first data item includes determining whether to compress the first data item based on applying the data spill compression procedure. In various examples, the first compressed data item is generated from the first data item based on determining to compress the first data item. In various examples, the method further includes, during the execution of the query, determining to spill a second data item of the plurality of data items to the disk memory. In various examples, the method further includes, based on determining to spill the second data item to the disk memory, determining whether to compress the second data item based on applying the data spill compression procedure. In various examples, the method further includes spilling the second data item to the disk memory in an uncompressed form based on determining to not compress the second data item. In various examples, the second data item is spilled in accordance with disk spill procedure 2731.

In various examples, applying the data spill compression procedure includes determining whether to compress data items based on data item size and a fixed disk page size of disk pages, such as fixed-size disk pages 2624, of the disk memory. In various examples, determining to compress the first data item is based on a first data item size of the first data item being greater than the fixed disk page size, and determining to not compress the second data item is based on a data item size of the second data item being less than or equal to the fixed disk page size.

In various examples, the first data item is included in a first fixed-sized memory fragment having a fixed memory fragment size. In various examples, generating the first compressed data item from the first data item based on applying the data spill compression procedure includes: determining a first data item size of the first data item and/or determining a maximum compression size of the first data item. In various examples, generating the first compressed data item from the first data item based on applying the data spill compression procedure further includes: determining, based on the maximum compression size, the first data item size, and the fixed memory fragment size to either store the first compressed data item within an unused portion of the first fixed-sized memory fragment, or to allocate at least one additional fixed-sized memory fragment for storing the first compressed data item. In various examples, generating the first compressed data item from the first data item based on applying the data spill compression procedure further includes determining to perform either the disk spill procedure 2732 or the disk spill procedure 2733.

In various examples, generating the first compressed data item from the first data item based on applying the data spill compression procedure further includes determining to store the first compressed data item within an unused portion of the first fixed-sized memory fragment based on a sum of the maximum compression size and the first data item size being less than or equal to the fixed memory fragment size. In various examples, generating the first compressed data item from the first data item based on applying the data spill compression procedure further includes generating the first compressed data item within an unused portion of the first fixed-sized memory fragment. In various examples, generating the first compressed data item from the first data item includes performing disk spill procedure 2732.

In various examples, generating the first compressed data item from the first data item based on applying the data spill compression procedure further includes segregating the first fixed-sized memory fragment into a set of fixed-sized page chunks, such as a set of page chunks 2753, after generating the first compressed data item within the unused portion of the first fixed-sized memory fragment. In various examples, generating the first compressed data item from the first data item based on applying the data spill compression procedure further includes identifying a proper subset of the set of fixed-sized pages storing portions of the first compressed data item, and/or only spilling the proper subset of the set of fixed-sized pages to disk for storage in corresponding fixed-sized disk pages, such as fixed-sized disk pages 2624, of the disk memory.

In various examples, generating the first compressed data item from the first data item based on applying the data spill compression procedure further includes determining to allocate at least one additional fixed-sized memory fragment for storing the first compressed data item based on a sum of the maximum compression size and the first data item size being greater than the fixed memory fragment size. In various examples, generating the first compressed data item from the first data item based on applying the data spill compression procedure further includes allocating the at least one additional fixed-sized memory fragment; and/or generating the first compressed data item within the at least one additional fixed-sized memory fragment.

In various examples, the method further includes, during the execution of the query, determining to spill a second data item of the plurality of data items to the disk memory. In various examples, the method further includes, based on determining to spill the second data item to the disk memory, determining to compress the second data item into a second compressed data item and determining to allocate at least one second additional fixed-sized memory fragment for storing the second compressed data item based on applying the data spill compression procedure. In various examples, the method further includes attempting to allocate the at least one second additional fixed-sized memory fragment, and forgoing compression of the second data item, where the method further includes instead spilling the second data item to the disk memory in an uncompressed form based on a failure in allocating the at least one at second additional fixed-sized memory fragment.

In various examples, the method further includes, during the execution of the query, determining to spill a second data item of the plurality of data items to the disk memory. In various examples, the method further includes, based on applying the data spill compression procedure, determining to compress the second data item into a second compressed data item and determining allocate at least one second additional fixed-sized memory fragment for storing the second compressed data item based on applying the data spill compression procedure. In various examples, the method further includes allocating the at least one second additional fixed-sized memory fragment. In various examples, the method further includes determining the second compressed data item cannot fit within the at least one additional fixed-sized memory fragment, and forgoing spilling the second data item to disk as the second compressed data item, where the method further includes instead spilling the second data item to the disk memory in an uncompressed form based on determining the second compressed data item cannot fit within the at least one additional fixed-sized memory fragment.

In various examples, the first compressed data item is spilled to the disk memory by applying the data spill compression procedure during a first temporal period during execution of the query, further comprising, in a second temporal period and after the first temporal period: reading the first compressed data item from the disk memory; regenerating the first data item based on decompressing the first compressed data item; and/or processing the first data item to continue the execution of the query based on regenerating the first data item. In various examples, the second temporal period is also during execution of the query.

In various examples, the method further includes, during the second temporal period: determining a minimum memory size for decompression based on an uncompressed size of the first data item and a compressed size of the first compressed data item; allocating memory of the query execution memory resources having the minimum memory size; and/or storing the first compressed data item read from disk in a first portion of the allocated memory. In various examples, regenerating the first data item includes processing the first compressed data item in the allocated memory and regenerating the first data item in a second portion of the allocated memory.

In various examples, determining the minimum memory size for decompression includes determining a sum of the uncompressed size of the first data item and the compressed size of the first compressed data item. In various examples, determining the minimum memory size for decompression include determining a minimum number of fixed-size memory fragments required to store both the uncompressed size and the compressed size, where the minimum memory size is this minimum number of fixed-size memory fragments. In various examples, determining the minimum memory size for decompression include determining a minimum number of fixed-size memory fragments required to store the uncompressed size and determining a minimum number of fixed-size memory fragments required to store the compressed size, where the minimum memory size is the sum of these two minimum numbers of fixed-size memory fragments.

In various examples, the method further includes identifying the first portion of the allocated memory based on applying an offset of the uncompressed size of the first data item. In various examples, the first compressed data item read from disk is stored in the first portion of the allocated memory by applying the offset. In various embodiments, the method further includes truncating and/or freeing the first portion of the allocated memory size after the first data item is regenerated in the second portion of the allocated memory.

In various examples, the allocated memory includes at least one fixed-size memory fragment. In various examples, the method further includes identifying the first portion of the allocated memory in the at least one fixed-size memory fragment based on applying an offset of the uncompressed size of the first data item; and/or truncating the at least one fixed-size memory fragment to remove the first portion of the allocated memory after first data item is regenerated in the second portion of the allocated memory.

In various examples, in a third temporal period after the first temporal period and prior to the second temporal period, the method further includes: determining the minimum memory size for decompression based on the uncompressed size of the first data item and the compressed size of the first compressed data item; attempting to allocate the memory of the query execution memory resources having the minimum memory size; and/or foregoing performance of the reading the first compressed data item from disk during the third temporal period based on a failure in allocating the memory during the third temporal period. In various examples, the memory is allocated in the second temporal period based on retrying the allocation of the memory in the second temporal period due to failure of allocating the memory in the third temporal period.

In various examples, the method further includes generating metadata for the first data item during the first temporal period based on spilling the first compressed data item. In various examples, the metadata indicates: the compressed size of the first compressed data item; the uncompressed size of the first data item; and/or lookup data for the first data item in disk memory. In various examples, the method further includes accessing the metadata in the second temporal period. In various examples, the first compressed data item is read from the disk memory based on the lookup data indicated in the metadata. In various examples, determining the minimum memory size for decompression is based on the compressed size and the uncompressed size indicated in the metadata. In various examples, the additional memory of the query execution memory resources to include only memory to accommodate both compressed size and the uncompressed size based on the metadata indicating the first data item was compressed when spilled to disk.

In various examples, the method further includes, during the execution of the query: determining to spill a second data item of the plurality of data items to the disk memory; spilling the second data item to the disk memory in an uncompressed form; and/or generating second metadata for the second data item based spilling the second data item. In various examples, the second metadata indicates: a second uncompressed size of the second data item; and second lookup data for the second data item in disk memory. In various examples, the method further includes allocating additional memory of the query execution memory resources having the second uncompressed size based on accessing the second metadata; reading the second data item from the disk memory into the additional memory by utilizing the second lookup data based on accessing the second metadata; and/or processing the second data item in the additional memory to continue the execution of the query. In various examples, the additional memory of the query execution memory resources to include only memory for the second uncompressed size based on the second metadata indicating the second data item was not compressed when spilled to disk.

In various examples, the query execution memory resources are dispersed across a plurality of nodes collectively executing the query in accordance with a query execution plan. A first node of the plurality of nodes has a first subset of the query execution memory resources, and the first node determines to spill the first data item to the disk memory based on determining the disk spill condition for the first subset of the query execution memory resources on the first node is met. In various examples, the first node generates the first compressed data item from the first data item based on applying the data spill compression procedure, and the first node spills the first compressed data item to the disk memory.

In various examples, a second node of the plurality of nodes has a second subset of the query execution memory resources, and the second node determines to spill a second data item to the disk memory based on determining the disk spill condition for the second subset of the query execution memory resources on the second node is met. In various examples, the second node generates a second compressed data item from the second data item based on applying the data spill compression procedure, and the second node spills the first compressed data item to the disk memory.

In various examples, the disk memory is implemented via a plurality of disk memories dispersed across the plurality of nodes. In various examples, the first node spills the first compressed data item to its own disk memory, and the second node spills the second compressed data item to its own disk memory.

In various examples, the first node receives a plurality of data blocks from at least one child node for processing by the first node to facilitate generation of output data blocks by the first node during execution of the query. In various examples, the first data item includes at least one of the plurality of data blocks pending the processing by the first node.

In various examples, the first data item includes a hash join structure utilized to perform a join operation in conjunction with execution of the query.

In various embodiments, any one of more of the various examples listed above are implemented in conjunction with performing some or all steps of FIG. 27J. In various embodiments, any set of the various examples listed above can implemented in tandem, for example, in conjunction with performing some or all steps of FIG. 27J.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 27J described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 27J, for example, in conjunction with further implementing any one or more of the various examples described above.

In various embodiments, the operational instructions, when executed by the at least one processor, cause the database system to: execute a query by processing a plurality of data items utilizing query processing memory resources; during the execution of the query, determine to spill a first data item of the plurality of data items to disk memory based on determining a disk spill condition for the query processing memory resources is met, wherein the disk memory is distinct from the query processing memory resources; based on determining to spill the first data item to the disk memory, generate a first compressed data item from the first data item based on applying a data spill compression procedure; and/or spill the first compressed data item to the disk memory based on generating the first compressed data item.

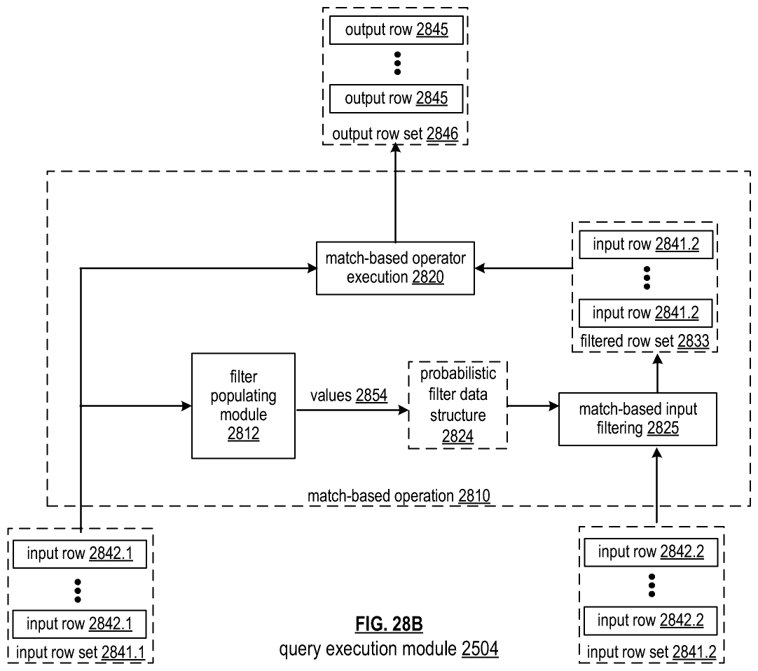

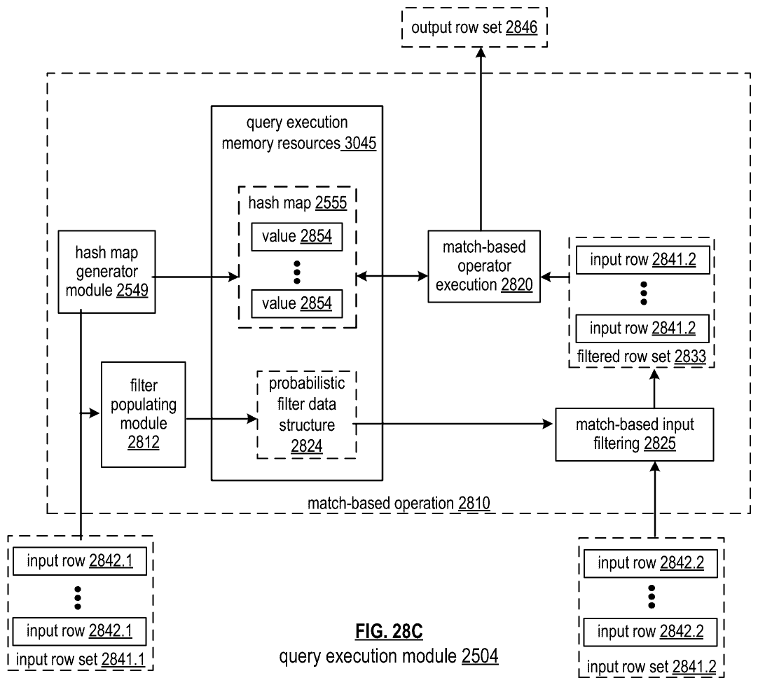

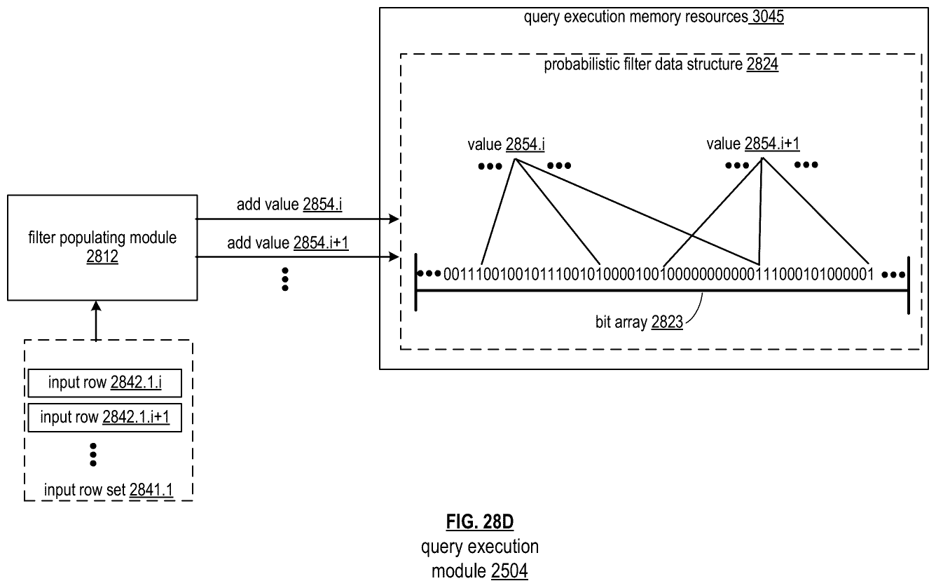

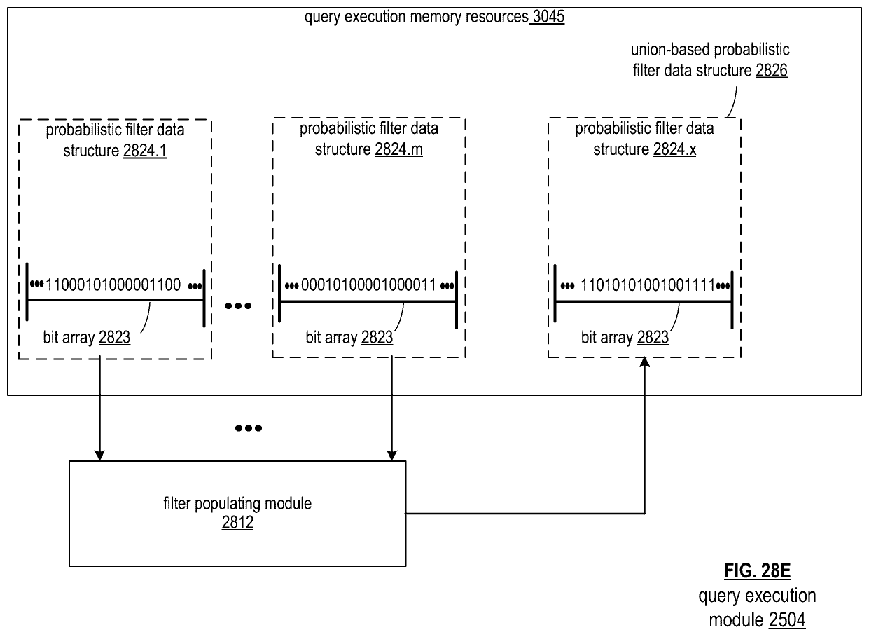

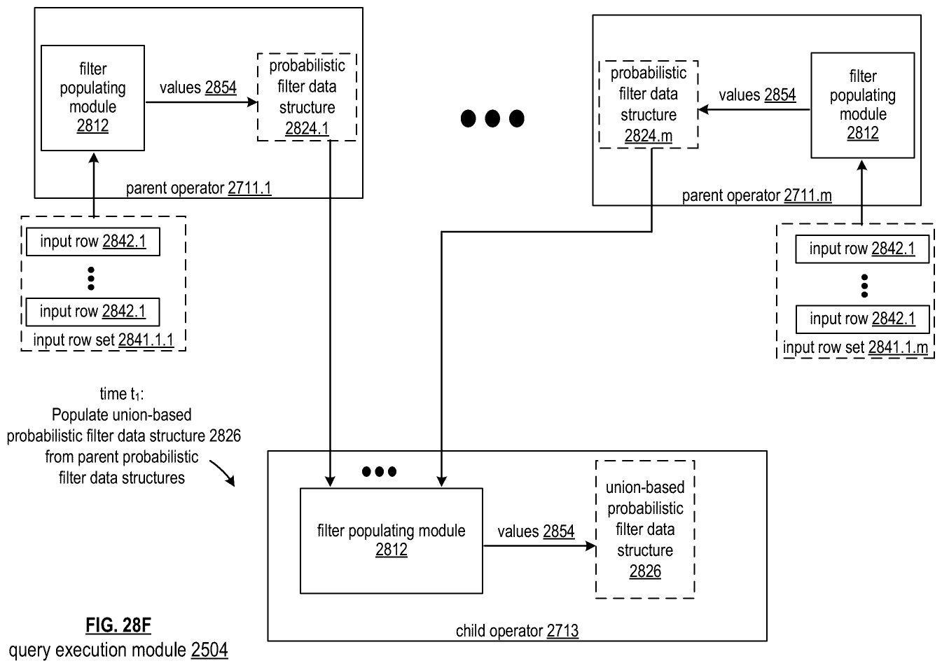

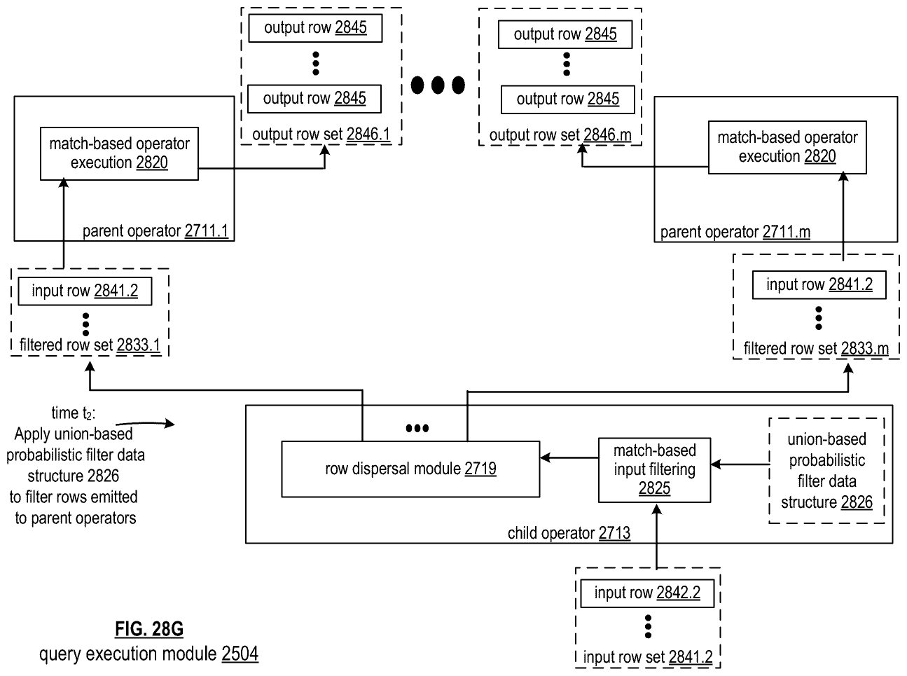

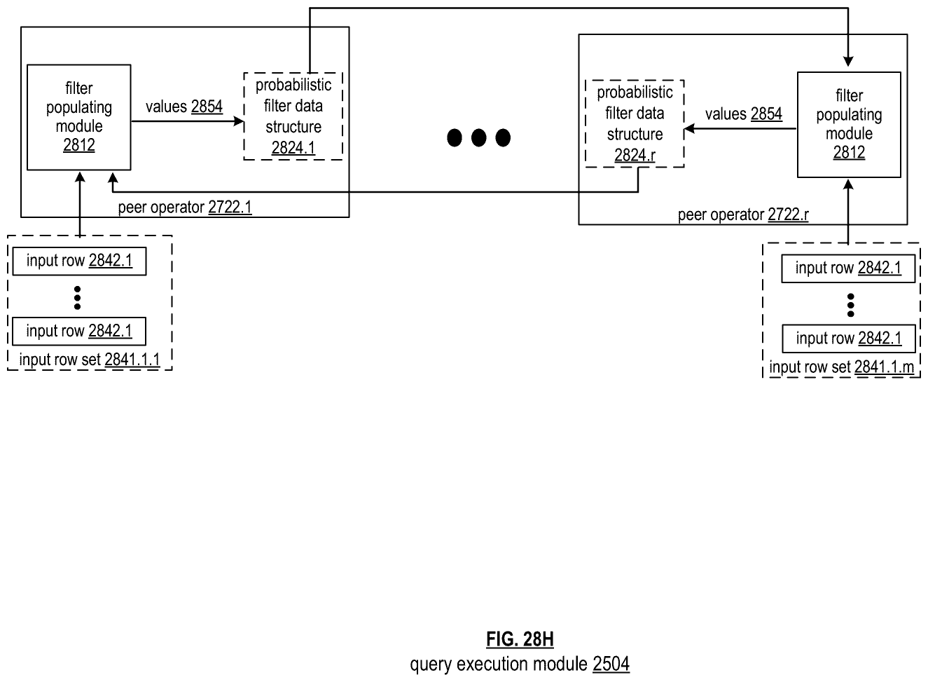

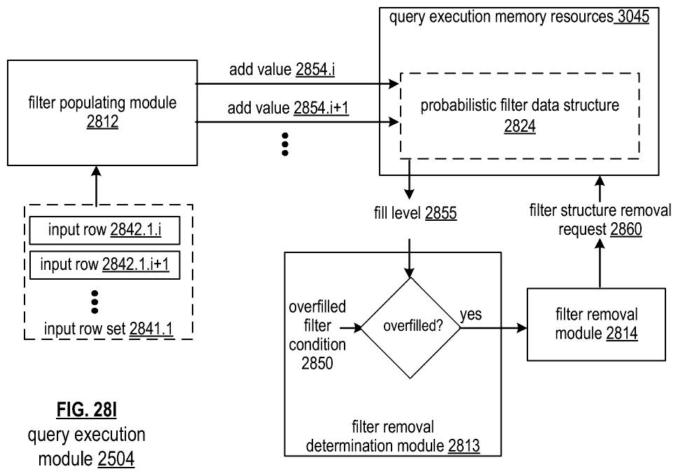

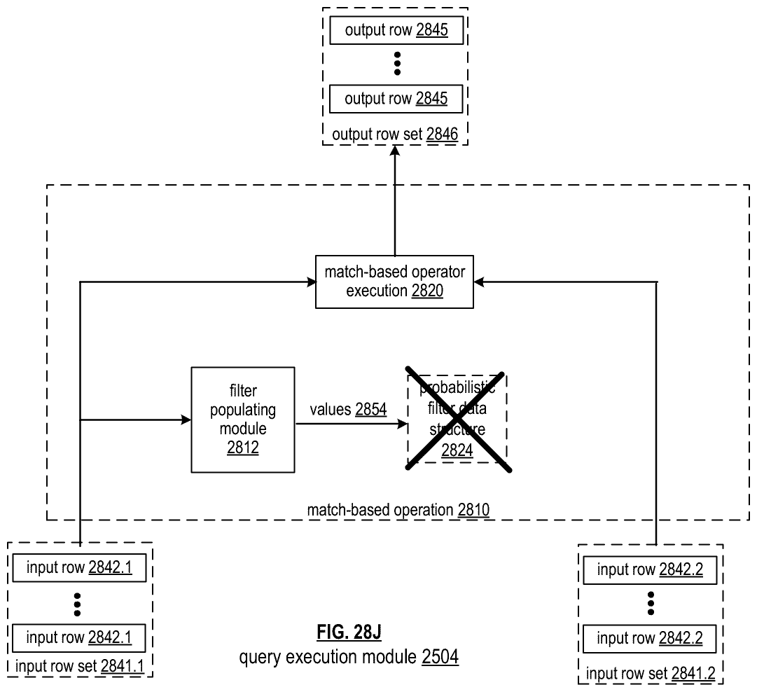

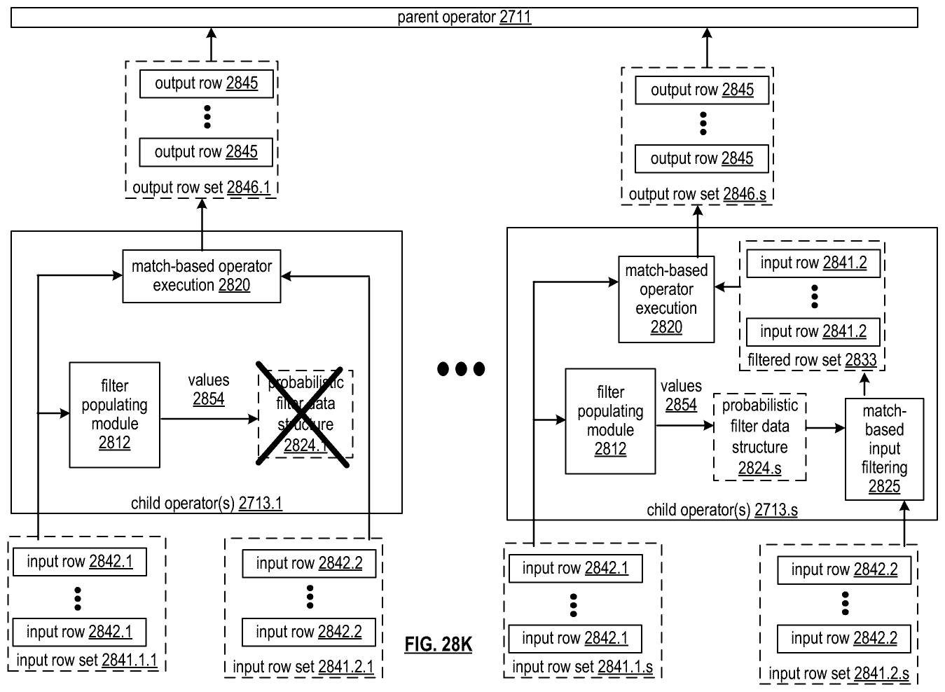

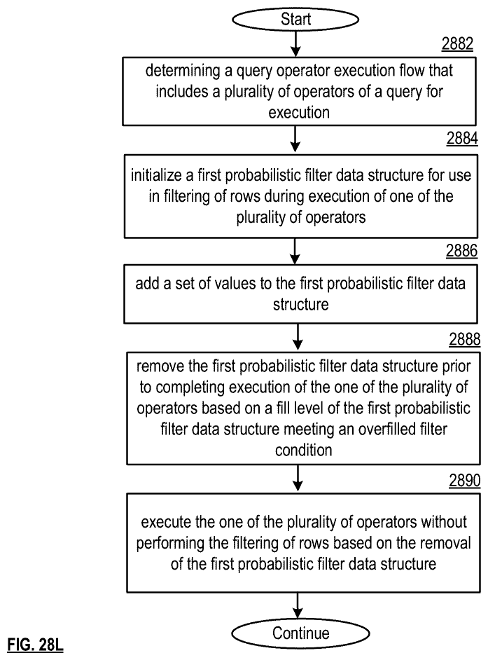

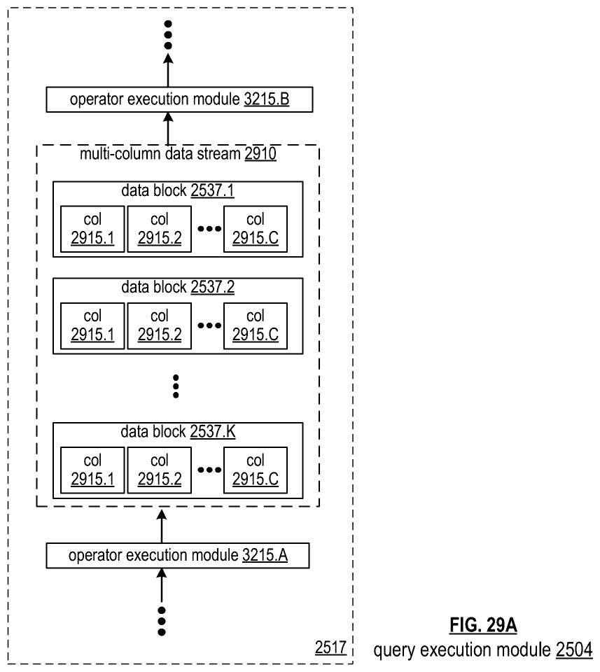

FIGS. 28A-28K present embodiments of a database system 10 that builds probabilistic filter data structures 2824 for use when executing queries, and optionally removes some or all probabilistic filter data structures when an overfilled filter condition is met. Some or all features and/or functionality of query execution as discussed in conjunction with FIGS. 28A-28K can be utilized to implement the query execution of FIGS. 24A-25C. Some or all and/or functionality of FIGS. 28A-28K can implement the database system 10 of FIG. 1 and/or any other embodiment of a database system described herein.

FIG. 28A illustrates an embodiment of a database system 10 that executes queries for query requests 2515 that include a match-based expression 2816 by executing a corresponding match-based operation 2810 upon two or more input row sets 2841.1-2841.n to identify rows from different sets satisfying a corresponding matching condition 2519 and output a corresponding output row set 2845 via execution of one or more match-based operator executions 2820, which can be implemented via execution of a corresponding operator 2520. Some or all features and/or functionality of the database system 10 of FIG. 28A can implement the database system 10 of FIGS. 24F-241 and/or any other embodiment of query execution described herein.

One type of match-based expression 2816 can correspond to a join expression 2516, where some or all features and/or functionality of the join process 2530 of FIGS. 25A-25C implements match-based operation 2810 of FIG. 28A. For example, the join process 2530 is implemented as a hash join that implements a hash map 2555 as discussed in conjunction with FIG. 25C. The input row sets 2841.1-2841.n inputted to the match-based operation 2810 can be implemented as right input row set 2543 and left input row set 2541.

As another example, the match-based operation 2810 can be implemented a multi-join, for example, where multiple hash joins and/or other joins are executed, for example, via multiple join process 2530 of FIGS. 25A-25C, such as multiple hash joins. The input row sets 2841.1-2841.n inputted to the match-based operation 2810 can be implemented as right input row sets 2543 and left input row sets 2541 of the respective joins. The input row sets 2841.1-2841.n inputted to the match-based operation 2810 can each be generated via a corresponding one of a set of input generation operators 2834.1-2834.n. For example, input generation operators 2834 are implemented as left input generation operators 2636 and/or right input generation operators 2634.

Another type of match-based expression 2816 can correspond to an intersection expression, such as one or more AND expressions, where the match-based operation 2810 is implemented to output only input rows having values one or more specified columns included in each incoming input row set 2841.

Matching condition 2519 can require equality and/or can denote another required Boolean expression that much hold true for corresponding relations between incoming rows, such as any other matching condition 2519 described previously with respect to join expressions. Output rows can include column values taken from matching rows in different input row sets 2841, for example, when implementing a join, or can correspond to column values of rows taken from only one input set, for example, in the case of an intersection, based on the column values of these rows being included in every input row set 2841.

FIG. 28B illustrates an embodiment of a query execution module 2504 executing a match-based operation 2810 by utilizing a probabilistic filter data structure 2824. Some or all features and/or functionality of executing the match-based operation 2810 of FIG. 28B can be implemented to execute the match-based operation 2810 of FIG. 28A, the join process 2530 of FIGS. 25A-25C, and/or any other embodiment of match-based operation 2810 described herein.

Some query operations, such as match-based operations including hash joins, multi-joins, and/or intersects, can generate probabilistic filter data structures 2824, such as bloom filters, for their smaller children so that operators lower in the query operator execution flow tree may filter rows that will not have a match via the match-based operation, such as the join and/or intersection, earlier than the actual join and/or intersect. For example, queries having many joins can be executed via over 50 GB of memory, such as query execution memory resources 3045, in queries, where bloom filters or other probabilistic filter data structures 2824 consume portions of this memory during execution.

In the example of FIG. 28B, for two sets of input rows sets 2841.1 and 2842.2, pairs of rows meeting matching condition 2519 of the corresponding match-based expression 2816 can be identified via a match-based operator execution 2820 of one or more corresponding operators 2520, such as execution of a join operator or an intersection operator.

To reduce the number of comparisons necessary when executing this corresponding operators 2520, such as the join operator or the intersection operator, a probabilistic filter data structure 2824 can be generated via a filter populating module 2812 from one input row set 2841.1, such as right match values 2564 of the right input row set 2543 of FIG. 25C when the match-based operation 2810 is implemented as a hash join, and/or such as the smaller of the two incoming input rows. Values 2854 of each input row 2842.1 of input row set 2841.1, such as values of the column to be matched with the input row set 2841.2, such as right match values 2564, can be added to the probabilistic filter data structure 2824 accordingly. In some embodiments, the probabilistic filter data structure 2824 is implemented as a bloom filter, for example, where a bit array is populated with ones for sets of entries correspond to a hash value for one or more corresponding column values of the input rows set 2841.1, such as the column values to be matched with values of input rows set 2841.2. The probabilistic filter data structure 2824 can alternatively be implemented as any other type of probabilistic filter data structure.

Match-based input filtering 2825 can be performed by utilizing probabilistic filter data structure 2824. In some embodiments, this filtering is only performed after all of input row set 2841.1 has been processed via filter populating module 2812 with all respective values indicated in the probabilistic filter data structure 2824 to induce maximal filtering of input row set 2841.2. The filtering can include identifying whether incoming values of one or more columns to be matched with that of input row set 2841.1 are either definitely not included in input row set 2841.1 or are possibly included in input row set 2841.1 based on accessing the corresponding probabilistic filter data structure 2824, and/or based on the probabilistic filter data structure 2824 being probabilistic by nature. The match-based input filtering 2825 can output a filtered row set 2833 that includes only the rows determined to be possibly included in input row set 2841.1, where the match-based operator execution 2820 is performed upon only the filtered row set 2833, which can improve execution efficiency as the match-based operator execution 2820 is not performed on incoming input rows 2842.2 that have already been determined to not have matches with any input rows 2842.1.

The filtered row set 2833 can be a proper subset of the input row set 2841.2, having strictly less rows than the input row set 2841.2 for processing via the match-based operator execution 2820 due to one or more rows being filtered out. Note that in some cases, no rows are filtered out, where the filtered row set 2833 is equivalent to the input row set 2841.2.

In embodiments where the probabilistic filter data structure 2824 is implemented as a bloom filter, for example, where a bit array has been populated with ones for sets of entries correspond to hash values for corresponding column values of all rows in input rows set 2841.1, the column values of input rows sets 2841.2 to be matched with values of input rows set 2841.1 can be hashed to identify the given set of index values for a corresponding set of entries of the bit array, where if this set of entries is not populated with all ones, the value for the corresponding input row set is guaranteed to not be included in input rows set 2841.1 and thus no match will exist, where this given row can thus be filtered out early. If this set of entries is populated with all ones, the value for the corresponding input row set is possibly included in input rows set 2841.1, and should thus not be filtered out, where whether or not a match exists is definitively determined via match-based operator execution 2820.

FIG. 28C illustrates an embodiment of a query execution module 2504 executing a match-based operation 2810 via storing both a probabilistic filter data structure 2824 and a hash map 2555 in query execution memory resources 3045. Some or all features and/or functionality of executing the match-based operation 2810 of FIG. 28C can be implemented to execute the match-based operation 2810 of FIG. 28B and/or any other embodiment of match-based operation 2810 described herein.

A hash map generator module 2549 can be implemented to generate a hash map 2555 storing values 2854 in query execution memory resources 3045 for access when performing match-based operator executions 2820. For example, the hash map 2555 is implemented via some or all features and/or functionality of hash map 2555 of FIGS. 25A-25C, for example, when match-based operation 2810 is implemented as a join operation. A hash map can alternatively or additionally be generated in a same or similar fashion when match-based operation 2810 is implemented as an intersect operation, for example, where one set of input is processed to populate a hash map, and where matches are identified for the other set of input based on whether corresponding rows have values in the hash map 2555 or not. The hash function utilized to generate values populating hash map 2555, for example, as keys of the hash map, can have a low and/or essentially zero-probability of collisions to guarantee query correctness when implementing the match-based operator executions 2820.

The query execution memory resources 3045 can be implemented via some or all features and/or functionality of query execution memory resources 3045 of FIGS. 27A-27J. For example, memory fragments and/or other memory resources of query execution memory resources 3045 are allocated to implement a given hash map 2555.

The probabilistic filter data structure 2824 can be initialized and implemented within query execution memory resources 3045. In some embodiments, memory fragments and/or other memory resources of query execution memory resources 3045 are allocated to implement a given probabilistic filter data structure 2824. These resources can be separate from the corresponding hash map 2555, and can optionally consume substantially less memory than the corresponding hash map 2555. The hash function utilized to generate values populating hash map 2555 can be the same or different hash function applied to identify sets of indexes of the bit array of probabilistic filter data structure 2824.

The processing gain included by lessening the number of input rows 2841.2 to be processed by match-based operator execution 2820 to can be significant, for example, based on the processing and/or memory resources required to perform match-based operator execution 2820 for each input row 2841.2 being substantial, and/or justifying the processing and/or memory cost of utilizing the probabilistic filter data structure 2824, such as the memory resources allocated for storing the probabilistic filter data structure 2824, the processing cost required to populate the probabilistic filter data structure 2824 via filter populating module 2812, and/or the processing cost required to perform match-based input filtering 2825.

As a probabilistic filter, a bloom filter or other probabilistic filter data structure 2824 is not as likely to filter anything as it becomes full. Thus, the probabilistic filter data structure 2824 may not be worth its consumption of memory resources as it becomes fuller than a certain threshold, as it will not be performing substantial/any filtering to warrant its use of memory resources. Identifying and handling such “overfilling” of probabilistic filter data structure 2824 is discussed in conjunction with FIGS. 28I-28K.

As used herein, the increasing of size of a given probabilistic filter data structure 2824 and/or a probabilistic filter data structure 2824 becoming “overfilled” does not necessarily result in increase of memory resources consumed by the given probabilistic filter data structure. The “increasing of size” of a given probabilistic filter data structure 2824 can correspond to an increase in the number of values added to and indicated by the given probabilistic filter data structure 2824, but not an increase in memory utilization. For example, the given probabilistic filter data structure 2824 is initialized in memory via allocation of a fixed amount of memory resources for this given probabilistic filter data structure. As values are added to this given probabilistic filter data structure, its storage size remains the same, but entries in memory can be changed to indicate the addition of new values deemed to be present. However, this increasing of values indicated, despite not increasing memory consumption, can be unfavorable based on properties of the given probabilistic filter data structure 2824 resulting in a higher rate of false positive matches that are not filtered out, rendering the probabilistic filter data structure 2824 in filtering out non-matching rows early.

In particular, consider the example where the probabilistic filter data structure 2824 is implemented as a bloom filter having a bit array of ones and zeros, where all entries are initialized with entries of zero, and where a particular set of entries of the bloom filter are set to one to denote a corresponding value being added, for example, corresponding to a hash value for a given one or more column values of a given row. Thus, as more values are added, more entries are flipped from zero to one. Filtering out rows can be based on determining whether the corresponding value is guaranteed to not exist in the bloom filter, based on the hash of the value as denoted by the particular set of entries not having all of its entries with values of one, where a match is possible, but not guaranteed, when all of these values are set as one. Thus, as higher proportions of bits in the bit array of the bloom filter are set to one, approaching and/or reaching all bits in the bit array being set to one as more values are added, a number and/or proportion of false positive matches that are thus not filtered out when applying the bloom filter also increases, where the bloom filter ultimately filters out no rows or very few rows once overfilled. Note that in other embodiments, rather than utilizing a bit array of ones and zeros, other binary values, integer values, and/or other values can be denoted in a corresponding array to denote whether or not a corresponding entry has been included in any set of entries for any set of values added to the filter.

A probabilistic filter data structure generated during query execution for use in filtering, can increase in size during query execution, and potentially become overfilled, for various reasons. As a first example, a probabilistic filter data structure 2824 on a corresponding hash join, multi-join, intersection, or other match-based operation every time a value is added to them. As a second example, operations such as multiplexer operations below the hash join, multi-join, intersection, or other match-based operation increase in size based on applying a union to parent probabilistic filter data structures 2824 from multiple parents that have disjoint sets of hash keys in the corresponding bloom filter. As a third example, operations such as shuffle operations below these hash joins, multi-joins, intersections, and/or other match-based operations increase in size based on applying a union to probabilistic filter data structures 2824 from multiple peers that have disjoint sets of hash keys in the corresponding bloom filter. As a fourth example, operators such as tee operators increase in size based on applying a union to probabilistic filter data structure 2824 probabilistic filter data structures 2824 from multiple parent branches.

FIG. 28D illustrates an embodiment illustrating the first example of increasing in size over time as values are added. Some or all features and/or functionality of filter populating module 2812 of FIG. 28D can implement the filter populating module 2812 of FIG. 28B. Any populating of probabilistic filter data structure 2824 described herein can be implemented via some or all features and/or functionality of FIG. 28D.

As the filter populating module 2812 processes incoming input row 2842.1.i, an ith value 2854.i is added to probabilistic filter data structure 2824, for example, by setting all of the respective set of entries with a corresponding set of indexes denoted by the hash of this value 2854, or another deterministic function performed upon this value 2854, in the bit array 2823 to one, if not already having a value of one. The set of indexes and/can be a fixed number determined when generating a corresponding bloom filter, where every value is hashed to the same number of indexes, where this fixed number and/or total bit array size is optionally the same or different for different bloom filters. The hash function can be determined when generating a corresponding bloom filter, and can optionally be the same or different for different bloom filters. The fixed set of indexes can be based on a total number of indexes allocated for the bloom filter, and can all initially be set to zero before populated with any values.

As the filter populating module 2812 processes incoming input row 2842.1.i, an ith value 2854.i is added to probabilistic filter data structure 2824, for example, by setting all of the respective set of entries denoted by the hash of this value 2854.i in the bit array 2823 of a bloom filter implemented as probabilistic filter data structure 2824 to one, if not already having a value of one. In cases where all values were already one, the bit array is unchanged.

As the filter populating module 2812 processes incoming input row 2842.1.i+1, an i+1th value 2854.i+1 is added to probabilistic filter data structure 2824, for example, by setting all of the respective set of entries denoted by the hash of this value 2854.i+1 in the bit array 2823 of the bloom filter implemented as probabilistic filter data structure 2824 to one, if not already having a value of one. In this example, at least one index's value is already set to one based on this index being one of the set of indexes for the previously added input row 2842.1.i.

As more values are added over time, more and more entries in the bit array have values of one. For example, as the number of values added approaches infinity, the proportion of entries in the bit array having values of one approaches one.

FIG. 28E illustrates an embodiment illustrating a probabilistic filter data structure 2824 increasing in size over time as values are added, for example, to implement the second, third, and/or fourth example of a probabilistic filter data structure 2824 increasing in size. FIG. 28E illustrates an embodiment illustrating the first example of increasing in size over time as values are added. Some or all features and/or functionality of filter populating module 2812 of FIG. 28D can implement the filter populating module 2812 of FIG. 28B. Any populating of probabilistic filter data structure 2824 described herein can be implemented via some or all features and/or functionality of FIG. 28E.

Alternatively or additionally to being populated based on individual values being added directly as discussed in conjunction with FIG. 28D, a given probabilistic filter data structure 2824.x can be implemented as a union of two or more existing probabilistic filter data structures 2824.1-2824.m. For example, a bitwise OR can be applied to corresponding bit arrays 2823 to render a bit array of a given probabilistic filter data structure 2824.x, where the given probabilistic filter data structure 2824.x is implemented as a union-based probabilistic filter data structure 2824. Any probabilistic filter data structures 2824 described herein can be implemented as union-based probabilistic filter data structures 2824.

The union can be applied to render probabilistic filter data structure 2824.x all at once, or one at a time, where the bitwise OR is applied to probabilistic filter data structure 2824.x as new, full probabilistic data structures are added. For example, the probabilistic filter data structure 2824.x is initialized as having all zeros, and is first updated to reflect only a first probabilistic filter data structure 2824.1 in accordance with a first bitwise OR is applied to the bit array 2823 of probabilistic filter data structure 2824.x and bit array 2823 the first probabilistic filter data structure 2824.1. Later, the probabilistic filter data structure 2824.x can be further updated to reflect first probabilistic filter data structure 2824.1 and a second probabilistic filter data structure 2824.2 in accordance with a second bitwise OR is applied to the bit array 2823 of probabilistic filter data structure 2824.x, already reflecting first probabilistic filter data structure 2824.1, and bit array 2823 the second probabilistic filter data structure 2824.2. This process can be repeated as further probabilistic filter data structures 2824 are added.

In some cases, rather than a newly initialized probabilistic filter data structure 2824.x being populated with values from other probabilistic filter data structures 2824.1-2824.m, such a union can be applied based on modifying an existing probabilistic filter data structures 2824, for example, after its own values are added directly as discussed in conjunction with FIG. 28C. For example, the bit array 2823 could instead be stored in probabilistic filter data structure 2824.1 based on applying a bitwise OR to probabilistic filter data structure 2824.1 with each of the probabilistic filter data structures 2824.2-2824.m.

FIGS. 28F-28G illustrate an example of implementing a union-based probabilistic filter data structure 2826 of a child operator 2713 based on probabilistic filter data structures 2824 of parent operators 2711 to implement filtering of rows ultimately processed by parent operators to identify matches via match-based operator executions 2820. Some or all features and/or functionality of FIGS. 28E-28F can implement execution of match-based operations 2810 and/or any query executions by a query execution module 2504 described herein.

As used herein, a child operator of a given operator corresponds to an operator immediately before the given operator serially in a corresponding query operator execution flow and/or an operator from which the given operator receives input data blocks for processing in generating its own output data blocks. A given operator can have a single child operator or multiple child operators. A given operator optionally has no child operators based on being an IO operator and/or otherwise being a bottommost and/or first operator in the corresponding serialized ordering of the query operator execution flow. A child operator can implement any operator 2520 described herein.

A given operator and one or more of the given operator's child operators can be executed by a same node 37 of a given node 37. Alternatively or in addition, one or more child operators can be executed by one or more different nodes 37 from a given node 37 executing the given operator, such as a child node of the given node in a corresponding query execution plan that is participating in a level below the given node in the query execution plan.

As used herein, a parent operator of a given operator corresponds to an operator immediately after the given operator serially in a corresponding query operator execution flow, and/or an operator from which the given operator receives input data blocks for processing in generating its own output data blocks. A given operator can have a single parent operator or multiple parent operators. A given operator optionally has no parent operators based on being a topmost and/or final operator in the corresponding serialized ordering of the query operator execution flow. If a first operator is a child operator of a second operator, the second operator is thus a parent operator of the first operator. A parent operator can implement any operator 2520 described herein.

A given operator and one or more of the given operator's parent operators can be executed by a same node 37 of a given node 37. Alternatively or in addition, one or more parent operators can be executed by one or more different nodes 37 from a given node 37 executing the given operator, such as a parent node of the given node in a corresponding query execution plan that is participating in a level above the given node in the query execution plan.

As used herein, a lateral network operator of a given operator corresponds to an operator parallel with the given operator in a corresponding query operator execution flow. The set of lateral operators can optionally communicate data blocks with each other, for example, in addition to sending data to parent operators and/or receiving data from child operators. For example, a set of lateral operators are implemented as one or more broadcast operators of a broadcast operation, and/or one or more shuffle operators of a shuffle operation. For example, a set of lateral operators are implemented via corresponding plurality of parallel processes 2550, for example, of a join process or other operation, to facilitate transfer of data such as right input rows received for processing between these operators. As another example, data is optionally transferred between lateral network operators via a corresponding shuffle and/or broadcast operation, for example, to communicate right input rows of a right input row set of a join operation to ensure all operators have a full set of right input rows.

A given operator and one or more lateral network operators lateral with the given operator can be executed by a same node 37 of a given node 37. Alternatively or in addition, one or lateral network operators can be executed by one or more different nodes 37 from a given node 37 executing the given operator lateral with the one or more lateral network operators. For example, different lateral network operators are executed via different nodes 37 in a same shuffle node set 37.

In this example, child operator 2713 has multiple parent operators 2711. For example, child operator 2713 is implemented as a row dispersal operator, such as a multiplexer operator or a tee operator, operable to send some or all input rows 2841.2 from input row set 2841.2 to each respective parent operators 2711 for processing. The set of parent operators 2711.1-2711.m can be implemented as parallelized hash join operators, parallelized multi-join operators, parallelized intersection operators, and/or other operators on parallelized tracks of the query operator execution flow.

When implemented as a multiplexer operator, child operator 2713 can be operable to emit different subsets of a set of incoming rows of input row set 2841.2 to different parent operators 2711 of the set of 2711.1-2711.m for processing, where each subset of rows sent to a given parent operator 2711 is mutually exclusive from subsets of rows sent to other parents, and/or wherein the plurality of subsets of rows sent to the plurality of patent operators 2711 are collectively exhaustive with respect to the input row set 2841.2. As a particular example, child operator 2713 implements row dispersal illustrated in join process 2530 of FIG. 25B, where different join operators 2535 of different parallelized processes of the set of parallelized processes 2550.1-2550.L are implemented via different corresponding parent operators of the set of 2511.1-2511.m. Implementing child operator 2713 of FIGS. 28F and 28G as a multiplexer operator can implement the second example of increasing size of a corresponding probabilistic filter data structure 2824 described previously.

When implemented as a tee operator, child operator 2713 can be operable to emit all of a set of incoming rows of input row set 2841.2 to each different parent operator 2711 of the set of 2711.1-2711.m for processing, where each subset of rows sent to a given parent operator 2711 is equivalent to that sent to other parents, and/or wherein the plurality of subsets of rows sent to the plurality of patent operators 2711 are equivalent to the input row set 2841.2. This can be implemented when parent operators are operable to perform different operations upon the same set of input in different parallelized tracks of the query operator execution flow. For example, parent operators 2711.1-2711.m can perform different operations and/or can compare incoming rows of input row set 2841.2 to discrete subsets of input row set 2841 via match-based operator executions 2820. Implementing child operator 2713 of FIGS. 28F and 28G as a tee operator can implement the fourth example of increasing size of a corresponding probabilistic filter data structure 2824 described previously.

FIG. 28F illustrates first populating the union-based probabilistic filter data structure 2826 of a child operator 2713 at a first time t₁ based on applying a union to probabilistic data structures 2824.1-2824.m, for example, built by parent operators via their own filter populating modules 2812. These probabilistic data structures 2824.1-2824.m can be built from a corresponding one of a set of input rows 2841.1.1-2841.1.m, for example, via some or all features and/or functionality discussed in conjunction with FIG. 28D. The sets of input rows 2841.1.1-2841.1.m are optionally mutually exclusive, equivalent, have non-null intersections, have non-null differences, are each equivalent with a given input row set 2841.1 of FIG. 28B, and/or are each proper subsets of a given input row set 2841.1 of FIG. 28B. In other embodiments, these probabilistic data structures 2824.1-2824.m can be built from applying one or more unions with one or more other probabilistic data structures 2824, for example, via a shuffle operation as illustrated in FIG. 28H. The generation of union-based probabilistic filter data structure 2826 of child operator 2713 can be performed via filter populating module 2812 of child operator 2713 via some or all features and/or functionality discussed in conjunction with FIG. 28E.

FIG. 28G illustrates next applying the union-based probabilistic filter data structure 2826 of child operator 2713 at a second time t₂ after t₁ to filter rows sets sent to parent operators 2711 for processing. This can include applying the match-based input filtering 2825 of FIG. 28B to filter rows, where a row dispersal module 2719, for example, implementing a multiplexer operation or a tee operation as described previously emits filtered row sets 2833.1-2833.m to respective parent operators 2811.1-2811.m. Each filtered row set 2833 can include none of the rows filtered out via match-based input filtering 2825 via union-based probabilistic filter data structure 2826, where a union of filtered row sets 2833.1-2833.m can be a proper subset of input row set 2841.2 based on at least one row being filtered out. Filtered row sets 2833.1-2833.m can be mutually exclusive subsets of input row set 2841.2, for example, based on child operator 2713 implementing a multiplexer operator. Filtered row sets 2833.1-2833.m can alternatively be equivalent subsets of input row set 2841.2, for example, based on child operator 2713 implementing a tee operator, where each given filtered row sets 2833 includes all rows of input row set 2841.2 not filtered out by match-based input filtering 2825.

FIG. 28H illustrates an embodiment where probabilistic filter data structures 2824 of some or all of a plurality of peer operators 2722.1-2712.r are populated to reflect the values of some or all other plurality of peer operators 2722.1-2712.r. For example, the peer operators 2722.1-2712.r are lateral network operators, such as shuffle operators, for example, below a corresponding hash join operator, a corresponding multi-join operator, a corresponding intersection operator, and/or another operator. Implementing peer operators 2722 of FIG. 28H as shuffle operators can implement the third example of increasing size of a corresponding probabilistic filter data structure 2824 described previously.

As a particular example, shuffle operators can be implemented to share distinct portions of right input row sets 2543 utilized to build respective hash maps 2555 for a plurality of join operators 2535 of a corresponding plurality of parallelized processes 2550.1-2550.L of FIG. 25B, where the resulting hash maps 2555 across all join operators 2535 of this plurality of parallelized processes 2550.1-2550.L plurality of reflect all of right input row set 2543 based on implementing this shuffle operator.

Each of the probabilistic filter data structures 2824 can be first populated with values 2854 of input rows 2842.1 of a corresponding input row set 2841.1, for example, as discussed in conjunction with FIG. 28D. Next, a given peer operator 2722 sends its probabilistic filter data structures 2824 to some or all other peer operators 2722 to enable each other peer operator to perform unions to update their own probabilistic filter data structures 2824 to reflect the values of the probabilistic filter data structures 2824 of the given peer operator 2722, as well as its own values of its own corresponding input row set 2841.1. The given peer operator 2722 can further receive probabilistic filter data structures 2824 from some or all other peer operators 2722, and can perform unions upon these other probabilistic filter data structures 2824 with its existing probabilistic filter data structures 2824 to render reflection of all values from all input row sets 2841.1.1-2841.1.r. For example, after this process is performed across all peer operators 2722, all probabilistic filter data structures 2824.1-2824.r reflect values from all input row sets 2841.1.1-2841.1.r, and/or are equivalent to each other.

In some embodiments, the set of peer operators 2722.1-2712.r implement the set of parent operators 2711.1-2711.m of FIGS. 28F-28G, and/or are each serially before a corresponding parent operator 2711 in a corresponding parallelized path in conjunction with building hash map 2555 and/or otherwise enabling distribution of data prior to performance of parent operators 2711.1-2711.m, where m is equal to r. In some embodiments, the probabilistic data structures 2824.1-2824.m are optionally implemented as the probabilistic data structures 2824.1-2824.r, where the communicating of probabilistic data structures 2824.1-2824.m by parent operators 2711.1-2711.m can be performed before or after the communication of and union-ing of these probabilistic data structures 2824 as illustrated in FIG. 28H. In other embodiments, the probabilistic data structures 2824.1-2824.m of FIGS. 28F-28G are generated by different operators and/or are otherwise distinct from 2824.1-2824.r of FIG. 28H.

FIGS. 28I-28K illustrate embodiments where probabilistic filter data structures 2824 are optionally be removed during query execution when an overfilled filter condition 2850 is met. Some or all features and/or functionality of FIGS. 28I-28K can be implemented in any query executions by query execution module 2504 described herein. Any examples of probabilistic filter data structures 2824 of FIGS. 28B-28H, including union-based probabilistic filter data structures 2826, can be monitored to determine whether overfilled filter condition 2850 and/or can be removed from use in remaining query execution of a corresponding query when overfilled filter condition 2850 is determined to be met.

At any places where probabilistic filter data structures 2824, such as bloom filters, increase in size as values are added and/or as unions of other probabilistic filter data structures 2824 are applied, such as in any of the four examples described above and/or as discussed in conjunctions with the examples of any of the FIGS. 28B-28H, these probabilistic filter data structures 2824 can be removed when a corresponding overfilled filter condition is met. In particular, the overfilled filter condition can be determined to be met based on current fill level 2855 of the probabilistic filter data structure 2824 comparing unfavorably to the overfilled filter condition.

Removal of a probabilistic filter data structure 2824 can include abandoning filtering via use of the probabilistic filter data structure 2824 in subsequent portions of the query execution, for example, where match-based input filtering 2825 is foregone. Removal of a probabilistic filter data structure 2824 can further include freeing the corresponding memory resources utilized to store these probabilistic filter data structures 2824.

Determining whether the overfilled filter condition 2850 is met can include comparing the current fill level 2855 of probabilistic filter data structures 2824 to a corresponding predetermined threshold of the overfilled filter condition. The current fill level 2855 can indicate, can be an increasing function of, and/or can be otherwise based on a number of values that have been added to the corresponding probabilistic filter data structure 2824, for example, directly one at a time as discussed in conjunction with FIG. 28D, and/or via applying a union to existing probabilistic filter data structures as discussed in conjunction with FIG. 28E.

In some embodiments, the overfilled filter condition 2850 can indicate a threshold maximum number of values added to the probabilistic filter data structures 2824, where the current fill level 2855 indicates a number of values that have been added. In some embodiments, the overfilled filter condition 2850 can indicate threshold maximum number and/or proportion of array entries in a corresponding bloom filter that are set to one rather than zero, where the current fill level 2855 indicates a number and/or proportion of array entries in a corresponding bloom filter that are set to one. As a particular example, the overfilled filter condition 2850 indicates a value of 0.7, for example, denoting a maximum proportion of array entries having values of one being 0.7, where the memory resources of a corresponding bloom filter are freed when a number of values indicated causes the threshold proportion of array entries having values of one to exceed 0.7.

The overfilled filter condition can be configured based on comparing the performance cost of implementing the probabilistic filter data structure 2824 with the performance gain of implementing the probabilistic filter data structure. For example, the predetermined threshold number and/or proportion of values, and/or other predetermined threshold denoting size of a corresponding bloom filter, can be automatically generated and/or configured via user input based on an exact and/or estimated point at which, when exceeded, the performance gain of implementing the probabilistic filter data structure 2824 no longer outweighs the corresponding performance cost, and thus performance in executing the query would be improved if the corresponding probabilistic filter data structure 2824 was not used and/or its corresponding memory resources were freed for other usage in the query execution.

This performance cost of implementing the probabilistic filter data structure 2824 can be an aggregation of and/or can otherwise be based on the performance cost of building the corresponding probabilistic filter data structure, the performance cost of filtering with the corresponding probabilistic filter data structures 2824, and/or the memory cost of the storing the probabilistic filter data structure. These performance costs can be measured in past query executions, predicted and/or estimated for the given query execution automatically, determined based on user input, and/or otherwise determined. The performance gain of implementing the probabilistic filter data structure 2824 can be an aggregation of and/or can otherwise be based on the performance gain of filtering rows, such as reduction in processing and/or memory resources that would have been required to perform the corresponding matching-based operation upon these rows if not filtered via the probabilistic filter data structure. This performance gain can further be based on a known and/or estimated number and/or proportion of rows filtered out via the probabilistic filter data structure.

In some embodiments, the relative improvement of performance, such as positive difference between performance gain and performance cost, is a decreasing function of size of the filter, for example, once the filter is filled to a first threshold and/or filled to an optimal amount. For example, as additional values are added after this point, the relative performance gain only decreases, and once reaching a second threshold corresponding to the overfilled filter condition, no longer justifies the storage and use of the corresponding probabilistic filter data structure.

A given query can have one or more instances of some or all of the four examples of probabilistic filter data structures 2824 that increase in size during query execution described above. Rather than being implemented as an “all or nothing” decision, different probabilistic filter data structures 2824 are evaluated separately, where those meeting the overfilled filter condition are removed and those not meeting the overfilled filter condition are not removed. For example, consider the case of multi-joins and/or intersection where n−1 bloom filters are generated for a join and/or intersection with n children. The bloom filter on child 1 can be disabled due to being overfilled, where more selective bloom filters from some or all remaining n−2 children are maintained and used for filtering on their respective downstream operators.

The overfilled filter condition can be the same for all probabilistic filter data structures 2824. Alternatively, in some embodiments, some probabilistic filter data structures 2824 can have different overfilled filter conditions than other probabilistic filter data structures 2824, for example, having tighter and/or looser conditions for being overfilled. These differences can be configured based on the relative performance cost and/or gain determined for use of the probabilistic filter data structures 2824 for corresponding different operations, different locations in the query operator execution flow, different estimated rate of filtering and/or rate of matches in the respective operation, and/or other types of differences. The overfilled filter condition for each type can be configured automatically via user input and/or can be automatically generated by the database system 10.

In some embodiments, if the system is in a low-memory state, such as meeting a spill disk condition as discussed in conjunction with some or all of FIGS. 26A-27J, it will spill operator state info such as hash join maps to disk and use different, slower processing algorithms to complete the operator. When this situation is detected, the system can first signal that all active operators release their probabilistic filter data structures 2824. This action can prevent the need to spill operator state data to disk and improve query performance. For example, the disk spill condition is no longer met after all probabilistic filter data structures 2824 are freed, and the operator state info and/or other data items are not spilled to disk. This can be favorable in cases where it is assumed and/or determined that spilling to disk has a higher performance cost than what would be gained by bloom filtering rows.

FIG. 28I illustrates monitoring the fill level 2855 of a probabilistic filter data structure 2824 via a filter removal determination module 2813, where a filter removal module 2814 is implemented to remove this probabilistic filter data structure 2824 from query execution memory resources 3045 if the fill level 2855 of this probabilistic filter data structure 2824 meets overfilled filter condition 2850. Some or all features and/or functionality of can implement the performance of match-based operation 2810 of FIG. 28B and/or can implement any query execution by query execution module 2504 described herein.

In some embodiments, the fill level 2855 monitored as values 2854 are added over time. For example, the filter removal module 2814 is activated prior to all of input row set 2841 being processed based on fill level 2855 exceeding and/or otherwise comparing unfavorably to the overfilled filter condition 2850 prior to all values of a corresponding input set being added, where the probabilistic filter data structure 2824 is removed before the corresponding values are ever added via filter populating module 2712. In other embodiments, the fill level 2855 is only evaluated after the corresponding probabilistic filter data structure 2824 is fully populated, and the filter removal module 2814 is activated after all of input row set 2841 are processed based on fill level 2855 exceeding and/or otherwise comparing unfavorably to the overfilled filter condition 2850 after all values of a corresponding input set have been added.

While FIG. 28I illustrates increasing size of a probabilistic filter data structure 2824 via adding values one at a time, for example, as discussed in conjunction with FIG. 28D, the fill level 2855 can be assessed during and/or after applying one or more unions for two or more corresponding probabilistic filter data structures 2824, for example, as discussed in conjunction with FIG. 28F. For example, if a union is performed to increase size of a given probabilistic filter data structure 2824 that results in its fill level 2855 meeting, exceeding and/or otherwise comparing unfavorably to overfilled filter condition 2850, the given probabilistic filter data structure 2824 can be removed.

Note that in some embodiments, the union is applied only to input probabilistic filter data structures 2824 guaranteed to have fill levels 2855 below and/or otherwise comparing favorably to overfilled filter condition 2850, as these probabilistic filter data structures 2824 would have been removed themselves if their own fill levels 2855 met the overfilled filter condition 2850. In such cases where given probabilistic filter data structures 2824 is to be populated by performing a union with at least one input probabilistic filter data structures 2824 that has already been removed and/or has a fill level 2855 meeting the overfilled filter condition 2850, the given probabilistic filter data structures 2824 is optionally removed prior to performing the given union, and thus potentially never actually exceeding the fill level 2855, based on the outcome of the union being guaranteed to cause the given probabilistic filter data structures 2824 to also meet the overfilled filter condition 2850.

The filter removal module 2814 can remove the probabilistic filter data structure 2824 from query execution memory resources 3045 based on sending a filter structure removal request 2860 to query execution memory resources 3045, for example, as a request to free the corresponding memory resources, such as one or more memory fragments 2622, for other usage in the query execution. The filter removal module 2814 can alternatively or additionally be implemented to adapt and/or configure the corresponding match-based operation 2810 to not implement the match-based filtering to generate filtered row set 2833, but instead process all input rows 2842 via match-based operator execution 2820 execution.

FIG. 28J illustrates an embodiment of performing match-based operation 2810 for a match-based operation 2810 after filter removal module 2814 has removed the corresponding probabilistic filter data structure 2824. Some or all features and/or functionality of performing match-based operation 2810 of FIG. 28J can implement the performance of match-based operation 2810 and/or can implement any query execution by query execution module 2504 described herein.

As denoted by the ‘X’, the probabilistic filter data structure 2824 in this example was previously removed, for example, via filter removal module 2814 and/or based on its fill level 2855 having been determined to meet the overfilled filter condition 2850 as discussed in conjunction with FIG. 28I. Thus, some or all of the match-based input filtering 2825 that would otherwise have used this probabilistic filter structure is not performed, where the full input row set 2841.2 is processed by match-based operator execution 2820. For example, the match-based input filtering 2825 and use of a corresponding filtered row set 2833 to perform match-based operator execution 2820 as illustrated in FIG. 28B is only performed when the corresponding probabilistic filter data structure 2824 does not meet the overfilled filter condition 2850.

FIG. 28K illustrates an example where a plurality of child operators 2713.1-2713.s are implemented to each generate output row sets 2846 for processing by a corresponding parent operator 2711. Some or all features and/or functionality of the query execution module of FIG. 28K can implement any query execution described herein.

In some embodiments, each of a set of parallelized child operators 2713.1-2713.s are configured in a given query operator execution flow 2517 to implement their own probabilistic filter data structure 2824 for use in performing their own match-based input filtering 2825 to generate their own filtered row set 2833 for processing when performing their match-based operator execution 2820 to output their own output row set 2846 for processing, for example, by a common parent operator 2711, and/or different parallelized parent operators. As a particular example, the set of parallelized child operators 2713.1-2713.s are child operators of a multi-join and/or an intersection, where parent operator 2711 implements some or all of the corresponding multi-join operation and/or corresponding intersection operation.

In some embodiments, a given child operator 2713 of the set of parallelized child operators 2713.1-2713.s can optionally be implemented via a plurality of serialized operators in a same parallelized track of the query operator execution flow, where this plurality of operators in this given parallelized track collectively implements the corresponding functionality.

Each child operator's probabilistic filter data structure's fill level 2855 can be monitored via a corresponding filter removal determination module 2813 to determine whether the corresponding probabilistic filter data structure 2824 should be removed. In this example, a first proper subset of the child operators 2713.1-2713.s, which includes child operator 2713.1, removes their probabilistic filter data structure 2824 via filter removal module 2814 due to being overfilled and processes entire input row set 2841.2 via match-based operator execution 2820, for example, by performing the functionality of FIG. 28J. In this example, each of a second proper subset of the child operators 2713.1-2713.s, which includes child operator 2713.s, do not remove their probabilistic filter data structure 2824 due to not being overfilled and thus filters input row set 2841.2 via match-based input filtering 2825 to render filtered row set 2833 for processing via match-based operator execution 2820 accordingly, for example, by performing the functionality of FIG. 28B.

In other cases, all child operators 2713.1-2713.s maintain and use their probabilistic filter data structure 2824 due to none of the probabilistic filter data structures 2824 becoming overfilled. In other cases, all child operators 2713.1-2713.s remove their probabilistic filter data structure 2824 due all the of the probabilistic filter data structures 2824 becoming overfilled, and/or based on being triggered to remove all probabilistic filter data structures 2824 due to a disk spill condition or other low-memory condition being met to attempt to prevent the need to spill to disk.

FIG. 28L illustrates a method for execution by at least one processing module of a database system 10, such as via query execution module 2504 in executing one or more operators 2520, for example, when performing at least one match-based operation 2810. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 28L. In particular, a node 37 can utilize their own query execution memory resources 3045 to execute some or all of the steps of FIG. 28L, where multiple nodes 37 implement their own query processing modules 2435 to independently execute the steps of FIG. 28L for example, to facilitate execution of a query as participants in a query execution plan 2405. Some or all of the steps of FIG. 28L can optionally be performed by any other processing module of the database system 10. Some or all of the steps of FIG. 28L can be performed to implement some or all of the functionality of the database system 10 as described in conjunction with FIGS. 28A-28K, for example, by implementing some or all of the functionality of performing a match-based operation 2810 via execution of a corresponding query via query execution module 2504. Some or all of the steps of FIG. 28L can be performed to implement some or all of the functionality regarding execution of a query via the plurality of nodes in the query execution plan 2405 as described in conjunction with some or all of FIGS. 24A-25C. Some or all of the steps of FIG. 28L can be performed to implement some or all of the functionality regarding removing probabilistic filter data structures during query execution as described in conjunction with some or all of FIGS. 28A-28K. Some or all steps of FIG. 28L can be performed by database system 10 in accordance with other embodiments of the database system 10 and/or nodes 37 discussed herein. Some or all steps of FIG. 28L can be performed in conjunction with one or more steps of any other method described herein.

Step 2882 includes determining a query operator execution flow that includes a plurality of operators of a query for execution. Step 2884 includes initializing a first probabilistic filter data structure for use in filtering of rows during execution of one of the plurality of operators. Step 2886 includes adding a set of values to the first probabilistic filter data structure. Step 2888 includes removing the first probabilistic filter data structure prior to completing execution of the one of the plurality of operators based on a fill level of the first probabilistic filter data structure meeting an overfilled filter condition, for example, as a result of adding the set of values to the first probabilistic filter data structure. Step 2890 includes executing the one of the plurality of operators without performing the filtering of rows based on the removal of the first probabilistic filter data structure.

In various examples, the first probabilistic filter data structure is a bloom filter.

In various examples, the first probabilistic filter data structure is initialized in conjunction with and/or after initializing execution of the query. In various examples, the first probabilistic filter data structure can be initialized via the one of plurality of operators and/or via a different one of the plurality of operators.

In various examples, the plurality of operators of the query are executed by utilizing query execution memory resources. In various examples, storing the first probabilistic filter data structure includes allocating memory resources of the query execution memory resources for the first probabilistic filter data structure. In various examples, removing the first probabilistic filter data structure includes freeing the memory resources of the first probabilistic filter data structure.

In various examples, the first probabilistic filter data structure is distinct from and/or stored in memory resources that are distinct from at least one database table of a database accessed during the query execution, where the rows are read from the at least one database table and/or are generated based on processing rows read from the at least one database table. In various examples, the first probabilistic filter data structure is distinct from and/or stored in memory resources that are distinct from index data generated for and/or stored in conjunction with the at least one database table.

In various examples, the first probabilistic filter data structure is initialized with a plurality of entries in an unfilled condition. In various examples, a set of entries of the plurality of entries are changed from the unfilled condition to a filled condition to denote addition of the set of values. In various examples, the overfilled filter condition indicates a maximum proportion of the plurality of entries of the first probabilistic filter data structure in the filled condition, such as a maximum proportion having a value of 0.7 and/or another value. In various examples, the plurality of entries are implemented via a bit array of a bloom filter and/or the unfilled condition corresponds to a value of zero at a corresponding entry and/or the filled condition corresponds to a value of one at the corresponding entry.

In various examples, the overfilled filter condition is based on a condition where a performance cost of utilizing the first probabilistic filter data structure is greater than a performance gain of utilizing the first probabilistic filter data structure. In various examples, the performance cost of utilizing the first probabilistic filter data structure is based on: processing cost of adding further values to first probabilistic filter data structure to further build the first probabilistic filter data structure; processing cost of performing the filtering of rows by utilizing the first probabilistic filter data structure; and/or memory cost of storing the first probabilistic filter data structure. In various examples, the performance gain of utilizing the first probabilistic filter data structure is based on processing gain of processing a reduced set of rows after performing the filtering of rows by utilizing the first probabilistic filter data structure. In various examples, the processing gain is a decreasing function of a number of values in the set of values added to the first probabilistic filter data structure.

In various example, the method further includes determining a second query operator execution flow that includes a second plurality of operators of a second query for execution; initializing a second probabilistic filter data structure for use in filtering of rows during execution of one of the second plurality of operators; adding a second set of values to the second probabilistic filter data structure; and/or completing execution of the one of the second plurality of operators by utilizing the second probabilistic filter data structure to perform the filtering of rows based on not removing the second probabilistic filter data structure due to a second fill level of the second probabilistic filter data structure not meeting the overfilled filter condition. In various examples, the fill level indicates greater fill level from the second fill level based on the first set of values being greater than the second set of values. In various examples, the fill level indicates greater fill level from the second fill level despite the second set of values being greater than or equal to the first set of values, for example, based on the second set of values inducing greater overlap in entries in respective sets of entries set to the filled condition when added.

In various examples, the method further includes: initializing a plurality of probabilistic filter data structures that includes the first probabilistic filter data structure; adding values to each of the plurality of probabilistic filter data structures; and/or removing a first subset of the plurality of probabilistic filter data structures based on fill levels of each probabilistic filter data structure in the first subset meeting the overfilled filter condition.

In various examples, the first subset of the plurality of probabilistic filter data structures is a proper subset of the plurality of probabilistic filter data structures, where a second subset of the plurality of probabilistic filter data structures are not removed based on fill levels of each probabilistic filter data structure in the second subset not meeting the overfilled filter condition. In various examples, the first subset and the second subset are mutually exclusive and collectively exhaustive with respect to the plurality of probabilistic filter data structures. In various examples, the method further includes executing at least one other one of the plurality of operators by performing filtering of rows via the second subset of the plurality of probabilistic filter data structures based on the second subset of the plurality of probabilistic filter data structures not being removed.

In various examples, a join operator of the plurality of operators has a plurality of parallelized children serially before the join operator in the query operator execution flow, where each of the plurality of probabilistic filter data structures corresponds to a corresponding one of the plurality of parallelized children.

In various examples, the method further includes: initializing a plurality of probabilistic filter data structures that includes the first probabilistic filter data structure; adding values to each of the plurality of probabilistic filter data structures; and/or removing all of the plurality of probabilistic filter data structures based on a low memory condition being met.

In various examples, the plurality of probabilistic filter data structures are stored via a set of memory resources of query execution memory resources utilized to execute the query. In various examples, a disk spill condition for the query execution memory resources is met prior to the removal of the all of the plurality of probabilistic filter data structures based on the low memory condition being met. In various examples, freeing of the set of memory resources due to removal of the all of the plurality of probabilistic filter data structures causes the query execution memory resources to no longer meet the disk spill condition. In various examples, the execution of the query is completed via the query execution memory resources based on not spilling to disk due to the disk spill condition not being met.

In various examples, the one of the plurality of operators is operable to generate output based on identifying matching values across multiple input sets, where the set of values to the first probabilistic filter data structure is based on values of one of the multiple input sets.

In various examples, adding the set of values to the first probabilistic filter data structure is based on adding values for one of: a hash join operator, a multi-join operator, or an intersection operator. In various examples, the set of values added to the first probabilistic filter data structure corresponds to a set of hash values of a hash map for a hash join operator implemented serially after the one of the plurality of operators.

In various examples, adding the set of values to the first probabilistic filter data structure is based on: generating a plurality of other probabilistic filter data structures for a plurality of other operators; adding other sets of values to the plurality of other probabilistic filter data structures; and/or adding the set of values to the first probabilistic filter data structure as a union of the other sets of values included in the plurality of other probabilistic filter data structures.

In various examples, the plurality of other probabilistic filter data structures are generated for the plurality of other operators based on the plurality of other operators being implemented as a set of join operators or a set of intersection operators. In various examples, the one of the plurality of operators is implemented as a multiplexer operator operable to send different incoming rows to one of the plurality of other operators. In various examples, the set of values are added to the first probabilistic filter data structure as the union of the other sets of values included in the plurality of other probabilistic filter data structures based on the multiplexer operator being serially before the plurality of other operators in the query operator execution flow.

In various examples, the one of the plurality of operators corresponds to a shuffle operator of a plurality of peer shuffle operators in the query operator execution flow. In various examples, the plurality of peer shuffle operators are serially before a set of join operators or a set of intersection operators. In various examples, the shuffle operator is operable to send incoming rows to and receive outgoing rows from other ones of the plurality of peer shuffle operators.

In various examples, the one of the plurality of operators corresponds to a tee operator operable to send incoming rows to each of a set of different parent branches serially after the tee operator in the query operator execution flow. In various examples, each of the plurality of other probabilistic filter data structures correspond to one of the different parent branches.

In various embodiments, any one of more of the various examples listed above are implemented in conjunction with performing some or all steps of FIG. 28L. In various embodiments, any set of the various examples listed above can implemented in tandem, for example, in conjunction with performing some or all steps of FIG. 28L.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 28L described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 28L, for example, in conjunction with further implementing any one or more of the various examples described above.

In various embodiments, the operational instructions, when executed by the at least one processor, cause the database system to: determine a query operator execution flow that includes a plurality of operators of a query for execution; initialize a first probabilistic filter data structure for use in filtering of rows during execution of one of the plurality of operators; add a set of values to the first probabilistic filter data structure; remove the first probabilistic filter data structure prior to completing execution of the one of the plurality of operators based on a fill level of the first probabilistic filter data structure meeting an overfilled filter condition as a result of adding the set of values to the first probabilistic filter data structure; and/or execute the one of the plurality of operators without performing the filtering of rows based on the removal of the first probabilistic filter data structure.

FIGS. 29A-29P illustrate embodiments of a query execution module 2405 of a database system 10 that executes queries via generation, storage, and/or communication of multi-column data streams 2910. Some or all features and/or functionality of query execution module 2405 of FIGS. 29A-29P can implement any embodiment of query execution module 2405 described herein and/or any performance of query execution described herein. Some or all features and/or functionality of multi-column data streams 2910 of FIGS. 29A-29P can implement any embodiment of data blocks 2537 and/or other communication of data between operators 2520 of a query operator execution flow 2517 when executed by a query execution module 2405, for example, via a corresponding plurality of operator execution modules 3215.

The multi-column data streams 2910 of FIGS. 29A-29P can optionally be implemented instead of or in addition to the column data streams 2968 of FIGS. 25L-25M. For example, in some cases, implementing one multi-column data streams 2910 for a set of multiple columns 2915.1-2915.C instead of implementing a corresponding set of C column data streams 2968.1-2968.C can reduce memory requirements, particularly in cases where C is large (e.g. more than 100 columns, such as 300 columns) and/or where the corresponding schema 2409 is wide and/or denotes a large number of columns.

As illustrated in FIG. 29A, a single multi-column data stream 2910 emitted by a given operator execution module 3215.A can include a stream of data blocks 2537.1-2537.K that each include and/or reference values for a set of C columns 2915.1-2915.C. As illustrated in FIG. 29B, each data block 2537 can include, for each of the C columns, values for W corresponding rows, where different data blocks in the column data stream include different respective sets of W rows, for example, that are each a subset of a total set of rows to be processed. In other embodiments, different data blocks can have different numbers of rows. The subsets of rows across a plurality of data blocks 2537 of a the multi-column data stream 2910 can be mutually exclusive and collectively exhaustive with respect to the full output set of rows, for example, emitted by a corresponding operator execution module 3215 as output.

Note that the number of data blocks K included in one multi-column data stream 2910 may be far greater than, such as exactly and/or approximately a factor of C greater than and/or another function of C greater than, the number of data blocks K of FIG. 24M included in each column data stream 2968 of a corresponding set of C different columns storing values for the same set of rows and the same set of columns. Alternatively of in addition, the number of rows W included in a given data block 2537 of a multi-column data stream 2910 can be far less than, such as exactly and/or approximately a factor of C less than and/or another function of C less than, the number of rows V included in a given data block 2537 of a single column data stream 2968 of FIG. 24L. In some cases, the multi-column data stream 2910 includes only one data block, where the value of K is one.

FIG. 29C illustrates an embodiment where two different multi-column streams 2910 of FIGS. 29A and/or 29B are emitted: multi-column data stream 2910.1 is designated for a set of fixed-length columns 2911.1-2911.C1, and multi-column data stream 2910.2 is designated for a set of variable-length columns 2912.1-2912.C2. For example, fixed length columns 2911 correspond to one type of column 2915 while variable length columns 2913 correspond to another type of column 2915.

The multi-column data stream 2910.1 designated for the set of fixed-length columns 2911.1-2911.C1 can be formatted and/or implemented differently from the multi-column data stream 2910.2 designated for the set of variable-length columns 2912.1-2912.C2. For example, multi-column data stream 2910.2 designated for the set of variable-length columns 2912.1-2912.C2 can be implemented as a binary stream, where the multi-column data stream 2910.1 designated for the set of fixed-length columns 2911.1-2911.C1 is not implemented as a binary stream and/or is implemented as another type of data stream.

The use of multi-column data streams can be useful in reducing memory requirements to maintain the emitting of columns to upstream parents, for example, by operators 2520 implementing multiplexer operators, shuffle operators, or other types of operators. For example, multiple multiplexer operator instances of a multiplexer operator executed by an operator execution module, which can forward blocks without rewriting/breaking them up, and/or shuffle operators can be required to maintain in progress column streams for multiple parents/peers concurrently.

Consider the example of a 300 column schema where all of the columns are variable length, where a hash join multiplexer implementing operator 2520 executed by a corresponding operator execution module 3215 is parallelized across 64 operator instances each emitting one child's columns to 32 parent partitions. When a column data stream 2968 is implemented for each column, for example, where huge blocks are initialized for every fixed length and/or every variable length column for respective column data streams 2968 as discussed previously, the rough huge page memory to maintain in progress columns for all the instances of a single multiplexer on a single node can be fragment size (e.g. 128 KiB fragments)*#column streams (e.g. 300)*2 (e.g. base on use of binary streams for variable length columns)*number of parent partitions (e.g. 32)*#operator instances*(e.g. 64)*˜join children per mux (e.g. 0.5)*#silos per node (e.g. 2)=150 GiB on a single node. The amount of required memory can otherwise be a deterministic function of fragment size, number of column streams, fixed and/or average value size, number of fixed length columns and/or number of variable length columns, whether the column streams are binary column streams for variable length columns, number of parent partitions, number of operator instances, number of join children per multiplexer, number of silos per node, and/or other factors.

A multi-column data stream 2910 can be implemented as a single data stream that can manage the fixed length data for every column in a schema. Each of the variable length columns in the schema can also use another shared binary stream rather than having one binary stream for each column. Again considering the example of a 300 column schema where all of the columns are variable length, where a hash join multiplexer is parallelized across 64 operator instances each emitting one child's columns to 32 parent partitions, utilizing shared multi-column data streams rather than different column data streams for different columns can reduce the required memory usage to fragment size (e.g. 128 KiB fragments)*2 (e.g. based on a column stream and binary stream)*number of parent partitions (e.g. 32)*#operator instances*(e.g. 64)*˜join children per mux (e.g. 0.5)*#silos per node (e.g. 2)=0.5 GiB on a single node. In particular, the amount of required memory at a given time can be reduced by a factor of the number of columns, and/or can otherwise be reduced as a function of the number of columns, from the case where individual column data streams 2968 are implemented for each individual column.

Note that if there is 100 GiB of data passing through the operator, for example, for processing via an operator execution module 3215, then using 100 GiB of memory in some form is unavoidable. However, the memory cost of maintaining all the upstream partitions can be massively reduced. The main tradeoff of implementing multi-column data streams 2910 over single column data streams 2968 can be that there is likely be a lot fewer rows in each block.

In some embodiments, once multi-column data streams 2910 are emitted, they can be spilled to disk as pending blocks etc. if total memory usage is still too high. There are a lot more systems in place to manage memory over finalized data blocks than for massive amounts of in progress columns.

FIG. 29D-29F illustrate embodiments of memory layouts for data blocks 2537 of multi-column data streams 2910. Some or all embodiments of data blocks 2537 and/or multi-column data streams 2910 of FIGS. 29D-29F can implement the data blocks 2537 and/or multi-column data streams 2910 of FIG. 29A, and/or any other embodiments of data blocks and/or data streams described herein.

A stream holding multiple columns, such as multi-column data stream 2910, can have a memory layout that is implemented differently from that of a single-column data stream, such as column data stream 2968 of FIGS. 24L and/or 24M. As a particular example, unlike a column data stream 2968 where append fixed length values are continuously appended to data runs of contiguous memory and/or may grow the underlying huge page memory region to acquire more contiguous runs and/or fragments of memory as discussed previously, a multi-column data stream can be created via an initial layout for each column being written, and then never grows again. During initialization, the multi-column stream can grow an underlying buffer until there is enough space available for at least some set small number of rows (e.g. 5 rows). The number of rows laid out in the data block 2537 can be the maximum number of rows that are guaranteed to fit in the total number of fragments in the stream. For small queries or nearly empty blocks, this can layout more rows than necessary, but this case can be reasonably inexpensive and/or uncommon. If, when initializing the multi-column data stream, it can be automatically determined that n rows can fit on all fragments reserved, n values for the fixed length info of each column can be laid out in column major order on the available memory. One fragment can contain multiple columns and/or one column can also be spread across multiple fragments.

FIG. 29D illustrates an example of allocating memory for a data block 2537 of a multi-column data stream 2910. Some or all features and/or functionality of allocating memory of a data block 2537 can be implemented in initializing the data blocks of FIG. 29A. The data block can span a plurality of fixed-size memory fragments 2622.1-2622.Z, which can be in contiguous memory of query execution memory resources 3045. The data block can be segregated into a plurality of C contiguous sub-spans 2935, where values of a given column are written to a corresponding contiguous sub-span 2935. An initial cursor 2932 can be defined for each sub-span, for example, as an offset from the start of the data block 2537. Different contiguous sub-spans 2935 can be same or different sizes, for example, being different based on corresponding differences in data type and/or corresponding size of values for the given column. A given contiguous sub-span 2935 can be partially or entirely within a given fixed-size memory fragment 2622, where a given fixed-size memory fragment 2622 can include two or more partial and/or entire contiguous sub-span 2935. A given contiguous sub-span 2935 can span multiple fixed-size memory fragments 2622, where a full given fixed-size memory fragment 2622 is only a portion of a contiguous sub-span 2935.

The number Z of fixed-size memory fragments 2622 allocated, and/or the initial cursors 2932 for and/or size of each contiguous sub-span 2935, can be based on fixed column layout data 2927, denoting the layout of the data block and/or which portions of the data block are allocated for different columns, which can be fixed and/or remain unchanged after initialization of the data block via data block allocation module 2926. The fixed column layout data can be based on known and/or sizes of values of different columns, a minimum number of rows to be included (e.g. 5 rows), which can be determined as the maximum number of rows guaranteed to fit within a fixed number of Z of fixed-size memory fragments 2622 in the case where data blocks are fixed sized, or other information. In this example, the data block allocation module 2926 sends a data block allocation request 2929 to allocate Z fragments based on determining Z fragments be allocated for the data block.

FIG. 29E illustrates an example of writing values to the data block 2537 of FIG. 29D via a multi-column writing module 2930 implemented via a corresponding operator execution module 3215. Some or all features and/or functionality of writing values to a data block 2537 can be implemented in emitting the data blocks via operator execution module 3215.A as illustrated in FIG. 29A.

A list of writable sub-spans of contiguous regions for each column can be stored so that writing individual columns is computationally simple. A column writer, such as column writing module 2931, can be created and/or implemented for each in progress column. The column writer can optionally be implemented via a same class and/or interface, and/or can otherwise support a same interface that is implementing for writing values to single-column data streams 2968, for example, such that the two are interchangeable.

As writes are performed to write each of the values 2918.1.i-2918.C.i for a given row 2919.i, each given value 2918 can be written to the contiguous sub-span 2935 of the corresponding column at the current cursor 2932. Each current cursor 2932 can then be updated via a corresponding cursor update module 2934 based on the write length 2933 of the respective value 2918, where the next value is written from this updated location of the cursor. Note that for a given row, respective column values can be written at different times, where different cursors 2932 are independently tracked and updated over time. For example, at a given time, one cursor 2935.1 for a first column col1 has been updated 3 times based on storing the values for the first 4 rows, while another cursor 2935.3 for a third column col3 has been updated 6 times based on storing the values for the first 7 rows.

FIG. 29F illustrates an example of reading values to from a data block 2537 of FIG. 29E via a multi-column reading module 2940 implemented via a corresponding operator execution module 3215. Some or all features and/or functionality of reading values from a data block 2537 can be implemented in processing the data blocks via operator execution module 3215.B as illustrated in FIG. 29A.

Reading the columns, for example, by implementing a corresponding data stream indexer and/or data stream cursor, can similarly be implemented for multi-column data streams 2910 in a similar fashion as single-column data streams 2968, where each of a set of column reading modules 2941 reads a corresponding one of the set of columns from a data block 2537 of multi-column data stream 2910, for example, independently and/or without coordination. For example, all of a column's values are still contiguous over adjacent data runs for both multi-column data streams 2910 and single-column data streams 2968. Rather than managing a single data Stream cursor, a cursor update module 2934 can manage a separate column cursor 2932 for each column, where advancing each cursor is the same or similar as advancing a cursor for reading a given column in a corresponding single-column data stream 2968.

As reads are performed to read each of the values 2918.1.i-2918.C.i for a given row 2919.i, each given value 2918 can be read based on the current cursor 2932 for the respective column. Each current cursor 2932 can then be updated via a corresponding cursor update module 2934 based on the read length 2943 of the respective value 2918, where the next value is read from this updated location of the cursor. Note that for a given row, respective column values can be read at different times, where different cursors 2932 are independently tracked and updated over time. For example, at a given time, one cursor 2935.1 for a first column col1 has been updated 3 times based on reading the values for the first 4 rows, while another cursor 2935.3 for a third column col3 has been updated 6 times based on reading the values for the first 7 rows.

FIG. 29G illustrates an embodiment of emitting and processing data blocks 2537 of data streams 2916 by operator execution modules 3215 in executing respective operators 2520. Some or all features and/or functionality of the emitting and/or processing of data blocks 2537 by operator execution modules 3215 can implement the operator execution modules 3215 of FIG. 29A, the operator execution modules 3215 of FIG. 24J, and/or any other embodiment of the operator execution modules 3215 described herein. The data streams 2916 can be implemented as multi-column data streams 2910, column data streams 2968, and/or any other data streams of data blocks that include and/or reference values of rows for processing in operator executions of operators 2520 as described herein.

A given operator execution module 3215.A for an operator that is a child operator of the operator executed by operator execution module 3215.B can emit its output data blocks for processing by operator execution module 3215.B based on writing each of a stream of data blocks 2537.1-2537.K of data stream 2916.A to contiguous or non-contiguous memory fragments 2622 at one or more corresponding memory locations 2951 of query execution memory resources 3045, for example, as discussed in conjunction with FIGS. 29D and/or 29E.

Operator execution module 3215.A can generate these data blocks 2537.1-2537.K of data stream 2916.A in conjunction with execution of the respective operator on incoming data. This incoming data can correspond to one or more other streams of data blocks 2537 of another data stream 2916 accessed in memory resources 3025 based on being written by one or more child operator execution modules corresponding to child operators of the operator executed by operator execution module 3215.A. Alternatively or in addition, the incoming data is read from database storage 2450 and/or is read from one or more segments stored on memory drives, for example, based on the operator executed by operator execution module 3215.A being implemented as an IO operator.

The parent operator execution module 3215.B of operator execution module 3215.A can generate its own output data blocks 2537.1-2537.J of data stream 2916.B based on execution of the respective operator upon data blocks 2537.1-2537.K of data stream 2916.A. Executing the operator can include reading the values from and/or performing operations to filter, aggregate, manipulate, generate new column values from, and/or otherwise determine values that are written to data blocks 2537.1-2537.J. For example, the operator execution module 3215.B reads data blocks 2537.1-2537.K of data stream 2916.A as discussed in conjunction with FIG. 29F and/or the operator execution module 3215.B writes data blocks 2537.1-2537.J of data stream 2916.B as discussed in conjunction with FIGS. 29D and/or 29E.

In other embodiments, the operator execution module 3215.B does not read the values from these data blocks, and instead forwards these data blocks, for example, where data blocks 2537.1-2537.J include memory reference data for the data blocks 2537.1-2537.K to enable one or more parent operator modules, such as operator execution module 3215.C, to read these forwarded streams. An example of forwarding data blocks is discussed in further detail in conjunction with FIG. 29H.

In the case where operator execution module 3215.A has multiple parents, the data blocks 2537.1-2537.K of data stream 2916.A can be read, forwarded, and/or otherwise processed by each parent operator execution module 3215 independently in a same or similar fashion. Alternatively or in addition, in the case where operator execution module 3215.B has multiple children, each child's emitted set of data blocks 2537 of a respective data stream 2916 can be read, forwarded, and/or otherwise processed by operator execution module 3215.B in a same or similar fashion.

The parent operator execution module 3215.C of operator execution module 3215.B can similarly read, forward, and/or otherwise process data blocks 2537.1-2537.J of data stream 2916.B based on execution of the respective operator to render generation and emitting of its own data blocks in a similar fashion. Executing the operator can include reading the values from and/or performing operations to filter, aggregate, manipulate, generate new column values from, and/or otherwise process data blocks 2537.1-2537.J to determine values that are written to its own output data. For example, the operator execution module 3215.C reads data blocks 2537.1-2537.K of data stream 2916.A as discussed in conjunction with FIG. 29F and/or the operator execution module 3215.B writes data blocks 2537.1-2537.J of data stream 2916.B as discussed in conjunction with FIGS. 29D and/or 29E. As another example, the operator execution module 3215.C reads data blocks 2537.1-2537.K of data stream 2916.A, or data blocks of another descendent, based on having been forwarded, where corresponding memory reference information denoting the location of these data blocks is read and processed from the received data blocks data blocks 2537.1-2537.J of data stream 2916.B enable accessing the values from data blocks 2537.1-2537.K of data stream 2916.A. As another example, the operator execution module 3215.B does not read the values from these data blocks, and instead forwards these data blocks, for example, where data blocks 2537.1-2537.J include memory reference data for the data blocks 2537.1-2537.J to enable one or more parent operator modules to read these forwarded streams.

This pattern of reading and/or processing input data blocks from one or more children for use in generating output data blocks for one or more parents can continue until ultimately a final operator, such as an operator executed by a root level node, generates a query resultant, which can itself be stored as data blocks in this fashion in query execution memory resources and/or can be transmitted to a requesting entity for display and/or storage.

FIG. 29H illustrates an example where a multi-column data stream 2910 generated by one operator execution module 3215 is forwarded by another operator execution module 3215 via a multi-column forwarding and/or updating module 2950. The multi-column data stream 2910 of FIG. 29H can be implemented as the data stream 2916.A of FIG. 29G and/or the data stream 2916.B of FIG. 29H can be implemented as the data stream 2916.B of FIG. 29G.

As illustrated in the example of FIG. 29H, data block 2537.1-2537.J are generated based on forwarding 2537.1-2537.K by multi-column forwarding and/or updating module based on writing data blocks 2537.1-2537.J to include a reference to a corresponding one of the set of memory locations 2951.A.1-2959.A.K, for example, where data block 2537.B.1 indicates memory location of memory locations 2951.A.1, where data block 2537.B.2 indicates memory location of memory locations 2951.A.2, etc. For example, the value of J is equal to the value of K. This can be favorable over reading and copying all of the values 2918, particularly if the values 2918 and/or corresponding set of rows remain unchanged in the operator execution. In other embodiments where data blocks are fixed size, the value of J is far fewer than K, where multiple memory references 2952 and/or corresponding memory reference 2954 are included in the same data block 2537 based on being significantly smaller than the referenced values themselves.

FIGS. 29I-29P illustrates examples of updating columns of a multi-column data stream 2910 without rewriting its values, but by instead forwarding the data blocks as discussed in conjunction with FIG. 29H and further writing column update metadata 2956 denoting the respective updates. The multi-column forwarding and/or updating module 2950 of FIGS. 29I-29P can implement the multi-column forwarding and/or updating module 2950 of FIG. 29H. The generation of output data blocks 2537.B by operator execution module 3215.B as discussed in conjunction with FIGS. 29I-29P can implement the generation of output data blocks 2537.B via generation of output data blocks 2537.B by operator execution module 3215.B of FIG. 29G. The forwarding and updating of metadata of FIGS. 29I-29P can implement generation of and/or processing of multi-column data streams 2910 of FIG. 29A and/or any generation of and/or processing of multi-column data streams 2910 and/or other data blocks described herein.

In some embodiments, each column in a multi-column data stream is not on a separate reference part in memory, otherwise modifying the schema of a column including multi-column data stream 2910 without rewriting the multi-column data stream can be non-trivial. For example, in the case where a particular column is projected out by the respective operator, writing it out of the layout becomes nontrivial. Similarly, reordering columns without rewriting the layout is nontrivial.

To handle these cases, a view of the underlying packed layout the multi-column data stream with the desired columns available in the desired order can be created and stored in corresponding column update metadata 2956. This column update metadata 2956 required for creating this view can be generated and stored in metadata storage resources 2957, which can be implemented as a separate, heap-backed reference part from the multi-column data stream 2910 and/or can otherwise be stored separately, for example, in other portions of query execution memory resources 3045. A project/reorder operation, or any other operation modifying the set of C columns of the corresponding multi-column data stream, can thus be implemented by generating a new metadata part, discarding the old one, and/or forwarding the new metadata with all of the packed columns of multi-column data stream 2910 as is.

As illustrated in FIG. 29I, an output data block generated to indicate the updating of columns performed by executing an operator via its respective operator execution module 3215.B can include, for a given input data block 2537.A.1 stored at memory location 2951.A.1, writing a output data block 2537.B.1 that includes a memory reference 2952.1 indicating the one or more memory locations 2951.A of this given input data block 2537.A.1 to forward the given input data block 2537.A.1 without requiring reading and/or rewriting of its respective values by this operator execution. The respective update to the columns can be written as an ith version column update metadata 2956.i in memory location 2953.i of metadata storage resources 2957. The output data block 2537.B.1 can further include a memory reference 2954 that indicates the one or more memory locations 2953.i of column update metadata 2956.i the to denote the updates applied to the forwarded set of columns when processed by subsequent operators and/or when included in a query resultant. The memory reference 2952.1 can indicate memory location 2951.A.1 via a buffer reference, memory address, and/or location data denoting the location where the respective data block 2537.A.1 is stored in memory to enable later access of the data block 2537.A.1.

Note that a single column update metadata 2956.i can be generated to be applied to all incoming data blocks 2537.A.1-2537.A.K, where the same corresponding memory reference 2954 that indicates the memory location 2953.i of this column update metadata 2956.i is included in all data blocks 2537.B.1-2537.B.J.

As illustrated in FIG. 29J, original multi-column schema data 2958.0 for a multi-column data stream can be accessed and/or processed by a column update module 2955 applying a first update to the column set in accordance with column update parameters 2960, for example, based on an update to be applied based on the corresponding query expression and/or corresponding parameters for executing a corresponding operator. The first version of column update metadata 2956.1 can denote updated multi-column schema data 2958.1 that denotes a change in schema from the original multi-column schema data 2958.0, such as a change to the ordering of columns and/or a change to which columns are readable due to one or more columns being projected out.

In some embodiments, the original multi-column schema data 2958.0 can be stored as an original version of the column metadata in metadata storage resources 2957 and can be formatted in a same or similar fashion as the column update metadata 2956. The original multi-column schema data 2958.0 can be otherwise determined.

As illustrated in FIG. 29K, metadata can be further updated one or more additional times over time from the first column update metadata 2956.1 of FIG. 29J. For example, a data block 2537.B.1 forwarding a corresponding multi-column data stream 2910 via inclusion of memory reference 2952.1 denoting memory location 2951.A.1, and further denoting respective column update metadata 2956.i via inclusion of memory reference 2954.i denoting memory location 2953.i, is processed by operator execution module 3215.C for further updating of the multi-column data stream 2910 in its own corresponding data block 2537.C.1. This data block 2537.C.1 again forwards the corresponding multi-column data stream 2910 via inclusion of memory reference 2952.1 denoting memory location 2951.A.1 (or optionally denoting memory location 2951.B.1 which itself indicates memory location 2951.A.1). This data block further denotes the further update to the columns via inclusion of memory reference 2954.i+1 denoting memory location 2953.i+1 in metadata storage resources 2957 that stores newly written column update metadata 2956.i+1 written by column update module 2955, which denotes further updates from the prior column update metadata 2956.i.

FIG. 29L illustrates an example of applying example column update parameters 2960 to update multi-column schema data 2958.i indicated by column update metadata 2956.i (and/or indicated by original schema, where the value of i is zero), to multi-column schema data 2958.i+1 for inclusion in column update metadata 2956.i+1.

For each column in the original layout indicated by multi-column schema data 2958.0, the metadata part can contain the apparent index of the column at an/or a Boolean for if the column denoting whether it should be readable at all. Actual reordering can then occur when the part is loaded and when cursor is opened. This can keep reorder operators, and/or project operators projecting out and/or removing columns, computationally trivial at the cost of keeping dead memory around in the case of projects. It can be generally assumed that some other operator in the plan will soon need to rewrite blocks anyway and implicitly project the unavailable columns left in the layout. Because a data block is not guaranteed to be composed of a single packed column stream, (ex a packed column stream+a single extend col), reorder operations may also need to project columns.

Consider the example of FIG. 29L where the original multi-column schema data 2958.0 includes C columns: col1, col2, . . . colC, in this ordering as denoted by (col1, col2, . . . colC). The multi-column schema data 2958.i can indicate the ordering these columns as a set of apparent indexes 2962.1-2962.C. In this example, apparent index 2962.1 for col1 indicates the placement of col1 in the 0^{th} index position (i.e. first) via the value of 0; apparent index 2962.2 for col2 indicates the placement of col2 in the 1^{th} index position (i.e. second) via the value of 1, and apparent index 2962.C for colC indicates the placement of colC in the C−1^{th} index position (i.e. last) via the value of C−1, for example, based on no columns yet being reordered and/or based on columns col1, col2, and colC maintaining their original order in prior updates where other columns were reordered.

In this example, the column update parameters 2960 include column ordering update parameters 2961 that when applied, result in reordering of columns where the ordering of col1 and col2 is swapped. For example, the column ordering update parameters 2961 are based on the corresponding operator being implemented as a reorder operator that reorders columns. Thus, in the resulting multi-column schema data 2958.i+1, the apparent index 2962.1 for col1 indicates the placement of col1 in the 1^{th} index position (i.e. second) via the value of 1, and the apparent index 2962.2 for col2 indicates the placement of col1 in the 0^{th} index position (i.e. first) via the value of 0.

These apparent indexes 2962.1-2962.C can optionally be depicted in multi-column schema data 2958 by an array structure, where the index of the array corresponds to the original column in that position, and where the value at each index denotes the corresponding apparent index the respective column (i.e. the original column for the index in the array structure where this value is included). In this example, this array structure in multi-column schema data 2958.i+1 would include C values of [0, 1, . . . C−1], while this array structure in multi-column schema data 2958.i would include C values of [1, 0, . . . C−1] to denote the swapping of positions of col1 and col2.

Note that in other embodiments, other values can be implemented, for example, where the first position is denoted by a value of 1 in the case where zero-indexing is not applied, and/or where other predetermined values and/or different structure of multi-column schema data 2958 denote respective orderings of columns and/or respective changes to the ordering over time.

The multi-column schema data 2958 can further indicate whether each of these is readable (e.g. denoting whether it has been projected out and/or whether it should not be accessed and/or utilized further) via a set of readability flags 2964.1-2964.C. In this example, readability flags 2964.1, 2964.2, and 2964.C for col1, col2, and colC, respectively, each indicate a binary value of 1, indicating these columns are all readable, for example, based on no column being projected out yet and/or based on columns col1, col2, and colC not being projected out in prior updates where other columns were projected out. For example, a value of 0 indicates a corresponding column is not readable.

In this example, the column update parameters 2960 include column readability update parameters 2963 that when applied, result in projecting out of column colC. For example, the column readability update parameters 2963 are based on the corresponding operator being implemented as a project operator that projects columns out and/or removed columns. Thus, in the resulting multi-column schema data 2958.i+1, the apparent index 2962.1 for col1 indicates the placement of col1 in the 1^{th} index position (i.e. second) via the value of 1, and the apparent index 2962.2 for col2 indicates the placement of col1 in the 0^{th} index position (i.e. first) via the value of 0.

These apparent indexes 2962.1-2962.C can optionally be depicted in multi-column schema data 2958 by an array structure of binary values, where the index of the array corresponds to the original column in that position, and where the value at each index denotes whether the corresponding original column is readable or not. In this example, this array structure in multi-column schema data 2958.i would include C values of [1, 1, . . . 1], while this array structure in multi-column schema data 2958.i+1 would include C values of [1, 1, . . . 0] to denote the projecting out of colC. In some embodiments, once a column is projected out, it cannot be reintroduced (e.g. later multi-column schema data 2958.i+j cannot flip the readability flag 2964.C of colC back to 1).

Note that in other embodiments, other values can be implemented, for example, where the value of one instead denotes the column is not readable and where the value of zero denotes the column is readable, and/or where other predetermined values are utilized and/or different structure of multi-column schema data 2958 denotes whether columns are projected out and/or respective changes to the ordering over time.

FIGS. 29M-29N illustrates an example of how this reordering and projecting out of columns in the column update metadata 2956 forwarded with multi-column data streams 2910 can be leveraged to implement inclusion of new columns, for example, read separately, included as output of a join operation, included as output of an extend operation, and/or otherwise generated and/or received for inclusion in the set of columns.

Consider the example where the original multi-column data stream 2910 includes 3 columns: col1, col2, and col3, in this ordering as denoted by (col1, col2, col3), for example, where the respective multi-column schema data 2958.0 denotes inclusion of these three columns in this order. Suppose column col4 is generated by the operator and/or received in its own in a separate column stream, and suppose the column update parameters 2960 denote that the columns be reordered to include col4 as (col1, col2, col4, col3). The operator execution module 3215.B can accomplish this by outputting a multi-column stream 2910 as (col1, col2) with col3 projected out, the column stream for col4, and a multi-column stream 2910 as (col3) with col1 and col2 projected out.

In particular, as illustrated in FIG. 29M, one or more data blocks 2537.B.1 generated from data block 2537.A.1 can include three portions 2567.B.1.a, 2567.B.1.b, and 2567.B.1.c. An ordering of these portions can be implicit and/or indicated, to render their respective output ordered appropriately.

The first portion 2567.B.1.a can include the memory reference 2952.1 denoting memory location 2951.A to forward the multi-column data stream 2910, and further includes memory reference 2954 denoting memory location 2953.a, which stores column update metadata 2956.a generated by column update module 2955 denoting that column col3 be projected out.

The second portion 2567.B.1.b can include the column 2915.4 (col4). This can include writing the actual values of this column col4 to 2567.B.1.b for the respective rows, for example, based on the operator execution module 3215.B generating these values itself by executing an extend operator via an evaluation/equation performed upon values of other columns, such as col1, col2, and/or col3. This can alternatively or additionally include forwarding a corresponding column stream 2968 denoting column col4 as illustrated in FIG. 29N, where a reference 2952.2 is included to denote a location 2951.D.1 of a corresponding data block 2537.D.1, where this column stream was written as output of another operator execution module.

The third portion 2567.B.1.c can again include the memory reference 2952.1 denoting memory location 2951.A to forward the multi-column data stream 2910, and further includes memory reference 2954 denoting memory location 2953.c, which stores column update metadata 2956.c generated by column update module 2955 denoting that columns col1 and col2 be projected out.

Because the same underlying reference part for the multi-column data stream 2910 is utilized, this does not produce any dead memory. In other embodiments, if a block like this reaches a lateral operator and/or gather operator, additional serialization logic can be required to prevent writing the entire laid out ref part to the wire multiple times.

In some cases, operators like extend create a single column stream and forward the rest of the incoming data block by reference. A multi-column data stream 2910 can be created in this case, with the caveat that the block must prepare as many rows as are present in the source block. This can become more complicated on an operator like union all that forwards must of the input columns from its children, but may have to rewrite some of them to change them from non-nullable to nullable. Preparing these null-fixed columns can't easily be done with a multi-column data stream 2910 because reference parts on a block must be in the order they should be read. Ex [nullfixed col1, nullfixed col2, forwarded col3, nullfixed col4] cannot be represented by a single reference part for the null-fixed columns. This can be addressed by similarly utilizing the projects: a multi-column data stream 2910 can be prepared for all columns that need to be written by the operator, then the operator can immediately create a new metadata part to “project” out unwanted columns, then forward the same packed column stream multiple times. In this example, a single multi-column data stream 2910 is created for (col1, col2, col4). The data block 2537 would include [metadata projecting col4, cols<col1, col2>, forwarded col3, metadata projecting col1 and col2, cols<col4>]. For example, the multi-column data stream 2910 of FIG. 29N is optionally first created for (col1, col2, col4) by the operator execution module 3215.B and/or by a child operator execution module 3215, and/or this new multi-column data stream 2910 is then referenced in the data block accordingly illustrated in FIG. 29N.

FIG. 29O illustrates embodiments of a network serialization module 2970 of a database system 10 that implements a memory reference hash map 2972 for use when implementing message piece creation module 2975 to create serialized message pieces 2976. Some or all features and/or functionality of the network serialization module 2970 of FIG. 29O can be implemented to process data blocks 2537 of multi-column data blocks 2910 for network serialization and/or to process any other data blocks 2537 described herein.

Multi-column data streams 2910, especially when mixed with reorders or prepared in disjoint manners described previously, can produce streams of data blocks 2537 that include references to the same underlying data multiple times. Duplicate references are very cheap while processing on a local node, but require nontrivial serialization logic to prevent duplicating the underlying data when spilling blocks to disk or writing the blocks to the network. This situation is very common in Create Table As Select (CTAS) queries with hash joins because they have a column reorder operator that is directly below network serialization and directly above a hash join. The hash join generates data blocks that may have a forwarded packed column stream for the left hand side columns and another packed column stream for the right hand columns, for example, when left hand side columns are forwarded by reference when implementing the join. Rather than deduplicating these reference parts while writing to disk, network serialization can be optimized via network serialization module 2970.

In some embodiments, the forwarding of columns implements some or all features and/or functionality of row forwarding module 2610 and/or any other forwarding of rows (e.g. in conjunction with executing a join expression) and/or any other join forwarding, by U.S. Utility application Ser. No. 18/321,906, entitled “PROCESSING LEFT JOIN OPERATIONS VIA A DATABASE SYSTEM BASED ON FORWARDING INPUT”, filed May 23, 1923, which is hereby incorporated herein by reference in its entirety and made part of the present U.S. Utility Patent Application for all purposes.

The network serialization performed via network serialization module 2970 can create a message piece for every buffer reference in a data block. While preparing one or more data blocks 2537 of a stream to be serialized to the network, a hash map of buffer references and their positions in the block that have already been serialized can be maintained. If a buffer reference at index n in the block is encountered that is a duplicate of the buffer first encountered at index m, a small heap-backed message that contains the original index m, rather than the entire huge page backed buffer, can be serialized. When deserializing the message pieces we will see that message piece n is a reference to the buffer in message piece m, then we can duplicate a reference to the buffer in piece m without using significant additional memory.

As illustrated in FIG. 29O, the memory reference 2952 at a given index n of a given data block 2537 being processed, is processed via message piece creation module 2975 to access memory reference hash map 2972. In this example, an entry in the hash map indicates memory reference 2952.x based on being previously processed at index m of the same or different given data block 2537, and being added to the hash map. The corresponding message piece 2976.n denotes the serialized position 2973 for index m, based on being previously processed at index m and/or being included in the corresponding message piece 2976.m.

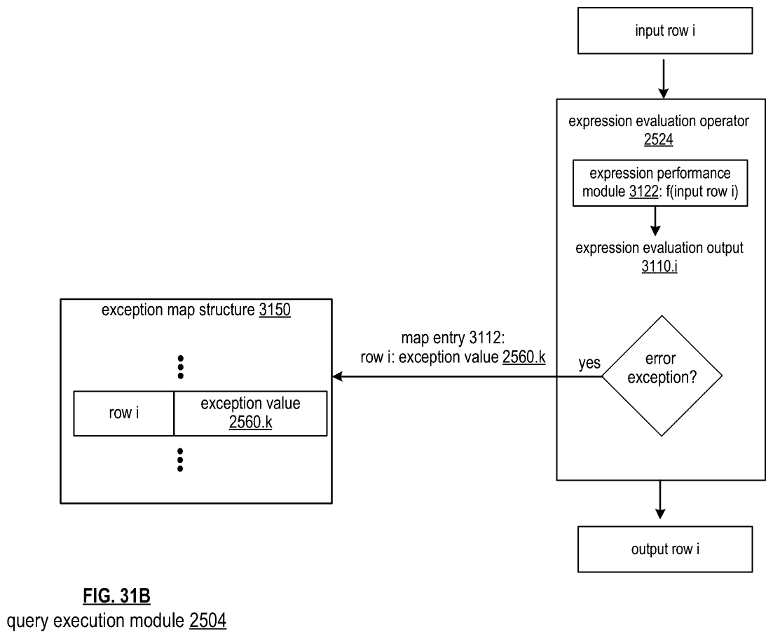

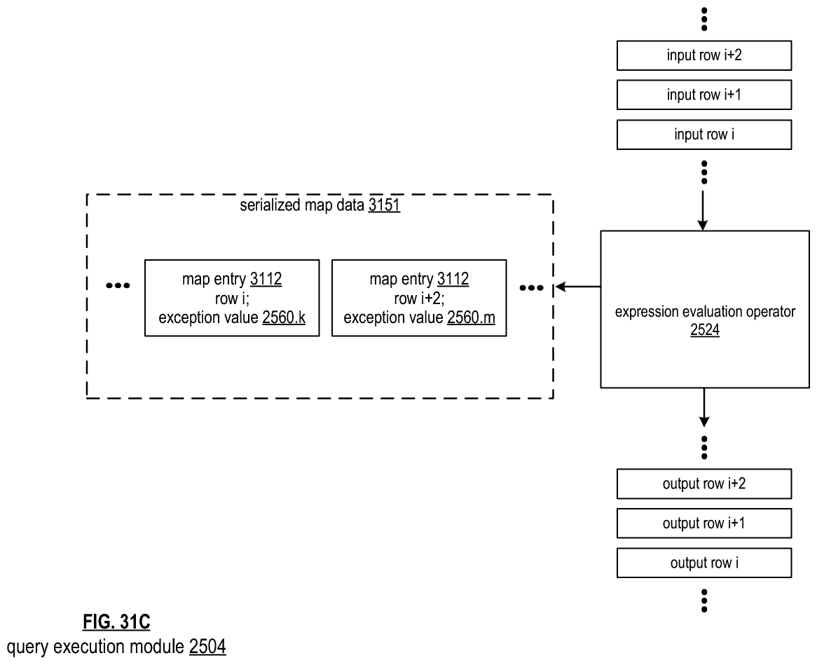

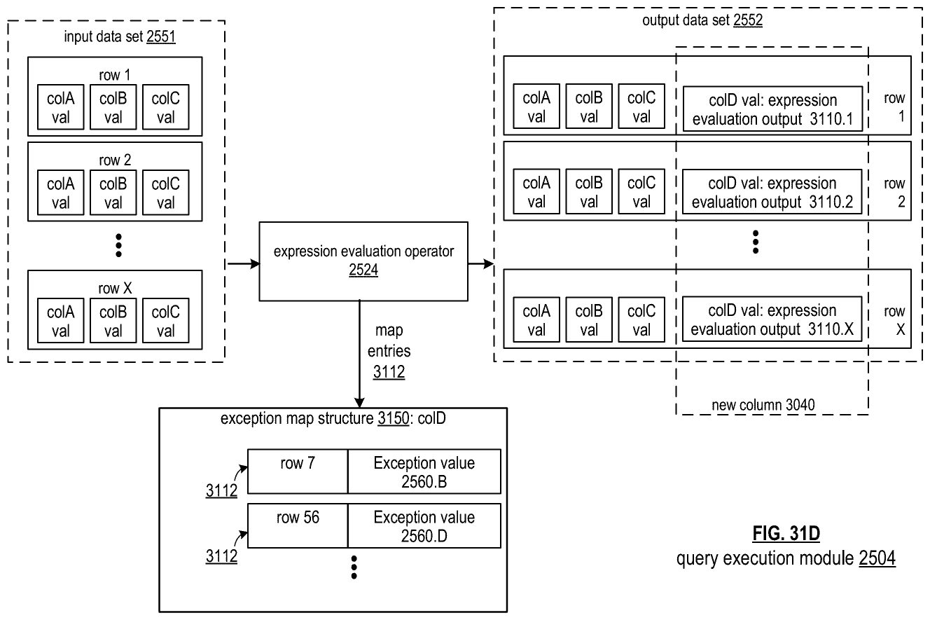

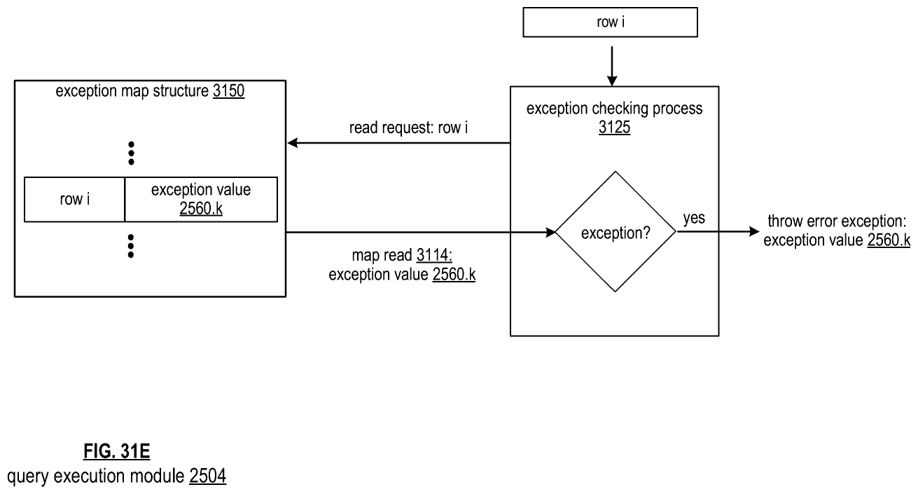

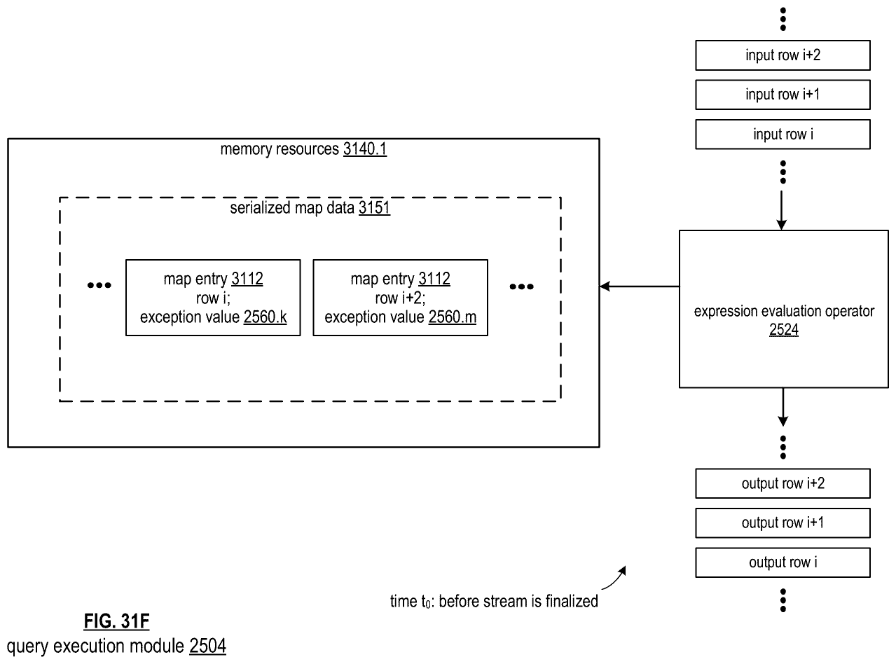

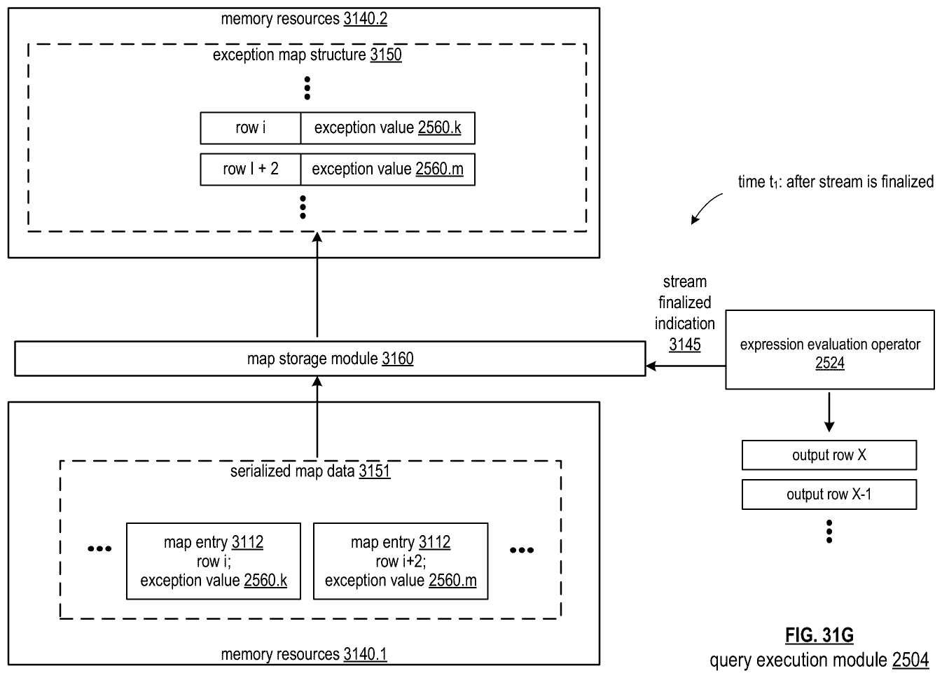

FIG. 29P illustrates embodiments of an operator execution module 3215 that implements an expression evaluation operator 2524 to generate map entries 3112 for storage in an exception map structure 3150 that is included in column update metadata 2956. The exception map structure 3150 can be later accessed to determine which rows have had exceptions thrown, if not filtered out via an operator after the operator execution module 3215 that is designated in the query expression for execution before the corresponding expression evaluation operator 2524. When an exception is thrown for a row not filtered out, the query can be aborted and/or a corresponding exception can be thrown. Some or all features and/or functionality of the operator execution module 3215 and/or the column update metadata 2956 of FIG. 29P can implement the operator execution module 3215 and/or the column update metadata 2956 of FIG. 29I and/or any other embodiment of the column update metadata 2956 and/or operator execution module 3215 described herein. Some or all features and/or functionality of the expression evaluation operator 2524, map entries 3112, and/or exception map structure 3150 can be implemented via some or all features and/or functionality of FIGS. 31A-31G.

Delayed exceptions can be stored in metadata storage resources 2957, for example, on a heap-backed metadata part. Delayed exception maps can have a variable size, so they are not easily be included in the multi-column data stream during layout. A multi-column column stream of all fixed columns is not required to have a binary stream, so the delayed exception maps also cannot conveniently be serialized in the binary stream. Delayed exception maps may be somewhat large, but they can be required to be immediately deserialized into objects in heap memory when the block is loaded regardless of where they are stored. Extremely large heap-serialized delayed exception maps can incur some deserialization cost over the network because they will require an additional copy.

FIG. 30 illustrates a method for execution by at least one processing module of a database system 10, such as via query execution module 2504 in executing one or more operators 2520, for example, when implementing multi-column data streams 2910. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 30. In particular, a node 37 can utilize their own query execution memory resources 3045 to execute some or all of the steps of FIG. 30, where multiple nodes 37 implement their own query processing modules 2435 to independently execute the steps of FIG. 30 for example, to facilitate execution of a query as participants in a query execution plan 2405. Some or all of the steps of FIG. 30 can optionally be performed by any other processing module of the database system 10. Some or all of the steps of FIG. 30 can be performed to implement some or all of the functionality of the database system 10 as described in conjunction with FIGS. 29A-29P, for example, by implementing some or all of the functionality of writing to multi-column data streams 2910, reading from multi-column data streams 2910, and/or forwarding multi-column data streams 2910 in conjunction with column update metadata, for example, via one or more operator execution modules 3215 executing operators 2520 of a corresponding query operator execution flow 2517. Some or all of the steps of FIG. 30 can be performed to implement some or all of the functionality regarding execution of a query via the plurality of nodes in the query execution plan 2405 as described in conjunction with some or all of FIGS. 24A-25C. Some or all steps of FIG. 30 can be performed by database system 10 in accordance with other embodiments of the database system 10 and/or nodes 37 discussed herein. Some or all steps of FIG. 30 can be performed in conjunction with one or more steps of any other method described herein.

Step 3082 includes determining a query operator execution flow that includes a plurality of operators for execution of a corresponding query against a database. In various examples, the query operator execution flow indicates the plurality of operators in accordance with a serialized ordering, which can include one or more parallelized tracks. In various examples, the database has a schema that includes a plurality of columns. Step 3084 includes executing the query operator execution flow in conjunction with executing the corresponding query against the database.

Performing step 3084 can include performing step 3086 and/or step 3088. Step 3086 includes generating a first plurality of data blocks of a multi-column data stream as first output of a first operator of the plurality of operators. In various examples, each data block of the multi-column data stream includes column values for each of a plurality of columns, such as some or all of the plurality of columns of the schema for one or more database tables of the database, and/or such as one or more new columns created in executing the query. Step 3088 includes processing the multi-column data stream as input of a second operator of the plurality of operators to generate a second plurality of data blocks as second output of the second operator. In various examples, the second operator is serially after the first operator in the query operator execution flow.

In various examples, generating each data block of the multi-column data stream includes initializing the each data block of the multi-column data stream by allocating memory for a number of rows to be included in the each data block. In various examples, generating each data block of the multi-column data stream further includes identifying a plurality of contiguous sub-spans of the memory allocated for the each data block, where each of the plurality of columns corresponds to a corresponding one of the plurality of contiguous sub-spans. In various examples, generating each data block of the multi-column data stream further includes writing columns values of each of a set of rows that includes the number of rows to the each data block based on, for the each column of the plurality of columns, writing the corresponding one of the plurality of contiguous sub-spans with the column value of the each column for the each of the set of rows.

In various examples, processing the each data block of the multi-column data stream includes maintaining a plurality of column cursors for the plurality of contiguous sub-spans. In various examples, each of the plurality of column cursors corresponds to a corresponding column. In various examples, each of the plurality of column cursors is advanced as each column value of the each column for each of the set of rows is read serially.

In various examples, the memory allocated for each data block includes a plurality of fixed-size memory fragments. In various examples, one memory fragment of the plurality of fixed-size memory fragments includes column values of multiple columns of the plurality of columns. In various examples, column values of one column of the plurality of columns span multiple memory fragments of the plurality of fixed-size memory fragments.

In various examples, the schema includes a plurality of fixed-length columns and further includes a plurality of variable-length columns. In various examples, the plurality of columns of the multi-column data stream correspond to the plurality of fixed-length columns, where each data block of the first plurality of data blocks includes fixed-length column values for each of the plurality of fixed-length columns. In various examples, executing the query operator execution flow in conjunction with executing the corresponding query against the database is further based on generating an additional stream of additional data blocks of an additional multi-column data stream as additional first output of the first operator, where each additional data block of the additional stream of data blocks includes variable-length column values for each of the plurality of variable-length columns. In various examples, executing the query operator execution flow in conjunction with executing the corresponding query against the database is also further based on processing each of the additional stream of data blocks of the additional multi-column data stream as input of the second operator to generate the second output of the second operator.

In various examples, the method further includes storing each of the first plurality of data blocks of the multi-column data stream in memory. In various examples, the second operator forwards the multi-column data stream in the second output by reference based on each of the second plurality of data blocks indicating at least one buffer reference to at least one corresponding one of the first plurality of data blocks stored in memory.

In various examples, processing each of the first plurality of data blocks of the multi-column data stream includes generating column update metadata for the multi-column data stream indicating at least one update to the plurality of columns included in the multi-column data stream. In various examples, the second output includes the column update metadata in conjunction with forwarding the multi-column data stream in the second output by reference. In various examples, at least one update to the plurality of columns indicated by the column update metadata is applied to the first plurality of data blocks of the multi-column data stream accessed in memory by a subsequent operator of the plurality of operators utilizing a plurality of buffer references to the first plurality of data blocks stored in memory. In various examples, the subsequent operator is serially after the second operator in the serialized ordering in conjunction with execution of the corresponding query.

In various examples, processing each of the first plurality of data blocks of the multi-column data stream further includes replacing prior column update metadata with the column update metadata. In various examples, the prior column update metadata was generated by another one of the plurality of operators serially before the second operator in the serialized ordering and serially after the first operator in the serialized ordering. In various examples, the column update metadata includes at least one change from the prior column update metadata.

In various examples, the each data block of the multi-column data stream is column-major formatted to include column values of the plurality of columns in accordance with a first ordering of the plurality of columns. In various examples, the column update metadata includes a reordering of the plurality of columns from the first ordering based on the second operator implementing a column reorder operator.

In various examples, the column update metadata includes a delayed exception map. In various examples, at least one operator between the second operator and the subsequent operator filters out at least one row. In various examples, the subsequent operator throws an exception indicated by the delayed exception map based on utilizing the delayed exception map for only rows not filtered out by the at least one operator.

In various examples, the column update metadata indicates a set of Boolean values for the plurality of columns each indicating whether a corresponding one of the plurality of columns is readable. In various examples, the at least one of the set of Boolean values indicates the corresponding one of the plurality of columns is not readable based on the second operator implementing a project operator and/or an operator that removes at least one column.

In various examples, processing each of the first plurality of data blocks of the multi-column data stream includes rewriting each of a first proper subset of the plurality of columns in a new multi-column stream, forwarding a second proper subset of the plurality of columns, and/or generating a set of multiple column update metadata for the new multi-column stream. In various examples, each one of the first proper subset of the plurality of columns is indicated as readable in exactly one of the set of multiple column update metadata and is indicated as not readable in all other ones of the set of multiple column update metadata. In various examples, processing each of the first plurality of data blocks of the multi-column data stream further includes emitting the new multi-column stream in a set of multiple instances. In various examples, each instance of the new multi-column stream is emitted in conjunction with one of the set of multiple column update metadata. In various examples, rewriting each of the first proper subset of the plurality of columns in the new multi-column stream is based on updating the first proper subset of the plurality of columns from being non-nullable to nullable.

In various examples, the method further includes serializing the second plurality of data blocks based on, for each index of a plurality of indexes in at least one of second plurality of data blocks, determining whether a buffer reference at the each index is already stored in a memory reference hash map. In various examples, when the buffer reference is not already stored in the memory reference hash map, the method further includes adding a new entry into the memory reference hash map indicating the buffer reference and the each index and/or generating a message piece for the each index that indicates the buffer reference. In various examples, when the buffer reference is already stored in the memory reference hash map, the method further includes accessing a prior index mapped to the buffer reference in the memory reference hash map; and/or generating a message piece for the each index that indicates the prior index.

In various examples, the first operator is implemented as a hash join multiplexer parallelized across a plurality of corresponding operator instances that each emit column values to a plurality of parent partitions as data blocks of the multi-column data stream. In various examples, one of the plurality of parent partitions is implemented via the second operator.

In various examples, the first operator is one of a plurality of child operators of the second operator. In various examples, the second operator processes the multi-column data stream received from the first operator in conjunction with processing at least one other multi-column data stream received from at least one other child operator of the plurality of child operators.

In various examples, the second operator is a direct parent of the first operator in the query operator execution flow, where the first output is processed directly by the second operator. In various examples, at least one addition operator is between the second operator and the first operator in the serialized ordering, where the first output is processed by at least one additional operator, and wherein the second operator processes output generated by at least one additional operator that is based on prior processing of the first output and/or that includes forwarding of the first output.

In various examples, the corresponding query is executed via a plurality of nodes in accordance with a query execution plan. In various examples, the first plurality of data blocks of the multi-column data stream is sent by a first node of the plurality of nodes executing the first operator to a second node of the plurality of nodes executing the second operator. In various examples, the second node processes the first plurality of data blocks of the multi-column data stream based on receiving the first plurality of data blocks of the multi-column data stream from the first node.

In various examples, the first node is one of a plurality of child nodes of the second node in the query execution plan. In various examples, each of the plurality of child nodes generate and/or send a corresponding multi-column data stream of a plurality of multi-column data streams. In various examples, the second node processes all of the plurality of multi-column data streams received from the plurality of child nodes.

In various embodiments, any one of more of the various examples listed above are implemented in conjunction with performing some or all steps of FIG. 30. In various embodiments, any set of the various examples listed above can implemented in tandem, for example, in conjunction with performing some or all steps of FIG. 30.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 30 described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 30, for example, in conjunction with further implementing any one or more of the various examples described above.

In various embodiments, the operational instructions, when executed by the at least one processor, cause the database system to: determine a query operator execution flow that includes a serialized ordering of a plurality of operators for execution of a corresponding query against a database having a schema that includes a plurality of columns; and/or execute the query operator execution flow in conjunction with executing the corresponding query against the database. Executing the query operator execution flow in conjunction with executing the corresponding query against the database can be based on: generating a first plurality of data blocks of a multi-column data stream as first output of a first operator of the plurality of operators, wherein each data block of the multi-column data stream includes column values for each of the plurality of columns; and/or processing the multi-column data stream as input of a second operator of the plurality of operators to generate a second plurality of data blocks as second output of the second operator, wherein the second operator is serially after the first operator in the serialized ordering. The plurality of columns can include all of a full set of columns of the schema, can be a proper subset of the full set of columns of the schema, and/or can include at least one new column not included in the full set of columns of the schema based on the at least one new column being created during execution of the query, for example, based on an expression evaluation of an extend operator.

FIGS. 31A-31G illustrate embodiments of a database system 10 that is operable to implement an exception map structure 3150 storing exception data for later access, for example, in throwing delayed exceptions. Some or all features and/or functionality of FIGS. 31A-31G can implement any embodiment of the database system 10 described herein.

The detection of, storing of, and/or throwing of delayed exceptions can be implemented via any features and/or functionality of the detection of, storing of, and/or throwing of delayed exceptions disclosed by U.S. Utility application Ser. No. 17/073,567, entitled “DELAYING EXCEPTIONS IN QUERY EXECUTION”, filed Oct. 19, 2020, which is hereby incorporated herein by reference in its entirety and made part of the present U.S. Utility Patent Application for all purposes.

Delayed exceptions can be stored as an exception map structure, such as a lookup table. In some embodiments, some or all column streams for some or all output columns have their own exception map structure denoting exceptions for the given column, for example, where the given column was generated via an expression evaluation operator 2524 such as an extend operator that is operable to generate anew column having values for each given row as a function of one or more values of other columns in the given row and/or as a function of one or more literal values.

In some embodiments, the exception map structure only stores entries denoting exception values indicating an error, where exception values indicating no error, such as exception values of zero, need not be stored in the exception map structure. This can be ideal as, in many cases, the distribution of exception values over a given column is sparse. For example, most exception code values per row will indicate no error, such as having an exception value of zero, and thus will have no place in the corresponding map. It can also be common for only a few rows in a given column to have errors while every other row has no errors. Use of an exception map structure to store exception data can improve the technology of database systems by enabling delayed exceptions to improve query efficiency as discussed previously, while further reducing memory capacity required to track the exceptions that, when applicable, need be thrown later.

In some embodiments, every time data is appended to a column, the corresponding exception is appended with it, if non-zero, if indicating an error, and/or if otherwise applicable. In some embodiments, a corresponding exception map structure can be stored in memory, such in huge page memory blocks or other memory, for example, as a serialized lookup table, until the column stream is finalized. The corresponding serialized entries of the exception map structure can then be written to disk. If the system does not have enough memory, such as enough huge page memory blocks, to store the serialized exceptions, the overflow can be written in a separate heap backed stream. Waiting until the column finalization, such as after all rows are processed via a corresponding expression evaluation operator 2524, to write all the exceptions can further improve the technology of database systems by minimizes the number of disk accesses and/or by allowing the corresponding lookup table to be stored continuously, which can improve memory and/or processing efficiency during query execution.

In particular, rather than storing exceptions as a separate column stream, which allows set operators to work by ignoring exception columns when they take a hash and/or compare rows while still storing every column in the row, the delayed exceptions can instead be stored as a separate object, such as the exception map structure and/or corresponding map entries. To implement this embodiment, each set operator's set of rows can further contain a map of column to delayed exception. When the operator is ready to emit a row, this map can be is read, and if there are any values, they can be thrown, induce a query failure, and/or can be simply transferred to the corresponding column stream.

The use of an exception map structure, for example, as presented in conjunction with FIGS. 31A-31G presents various improvements to the technology of database systems. For example, at runtime, queries that do not encounter extend-related exceptions can be minimally affected by the memory and processing costs associated with handling delayed exceptions, which can improve overall memory and processing efficiency in query execution. Furthermore, because exceptions have such a sparse distribution within a single column, the exceptions it as a map can lower memory usage. Additionally, time spent processing the exception data can be saved when utilizing an exception map structure rather than storing the exception value in each row directly. Furthermore, it can be quick and conceptually simple to discover which rows in a column stream encountered errors during creation and what the error is based on accessing the exception map structure. Finally, it can also be quick and simple to see if a column has experienced any failure at all (that is, check if the map has any values and return the first value), which can be enough to fail and abort early an entire query at checking time, for example, if exceptions for any rows with entries stored in the exception map structure are valid for throwing errors and/or rendering query aborting.

FIG. 31A presents an embodiment of implementing an exception map structure 3150 via a query execution module when executing a query based on a query expression 2511 that indicates an expression evaluation operator 2524.

When implementing delayed exception checking for an expression evaluation operator 2524, such as delayed exception throwing for generating a new value of a corresponding new column for each given row as discussed previously, the expression evaluation operator 2524 can generate map entries 3112 for storage in an exception map structure 3150, such as a lookup table or other structure. For example, the expression evaluation operator 2524 generates the map entries 3112 for storage in the exception map structure 3150, during a first temporal period as corresponding data blocks are processed by the expression evaluation operator 2524 to generate output data blocks. For a given row, a corresponding map entry 3112 can indicate whether an error was encountered when performing the expression evaluation operator for the given row, and/or can indicate the error exception value 2560 indicating the particular type of error from a set of possible errors. The corresponding map entry 3112 can optionally further indicate an identifier or other indication of the corresponding given row, and/or can otherwise map the corresponding error to the given row.

An exception checking process 3125 can be implemented later in the query operator execution flow 2517, after one or more other operators such as a filtering operator or other operators 2520. For example, some or all of these operators 2520 are indicated to be performed before the expression evaluation operator 2524 in the query expression, where the operator flow generator module 2514 generates the query operator execution flow 2517 to indicate performance of the expression evaluation operator 2524 before these operators, for example, in applying an optimization process, where the exception checking process 3125 is applied after these operators to throw exceptions correctly as discussed previously. For example, the exception checking process 3125 is implemented via a checking operator and/or a filtering operator, when operatable to check exception values for incoming rows, or other process of determining exceptions and/or errors of the corresponding expression evaluation of the expression evaluation operator 2524, for example, for only incoming rows outputted by the prior other operators 2520 following the expression evaluation operator 2524. As a particular example, at least one row outputted by the expression evaluation operator 2524 is filtered out via a filtering operator and/or other discarding of rows by one or more of these operators 2520, where corresponding exceptions for these filtered out rows are thus not checked by the exception checking process 3125.

The exception checking process 3125 can be implemented based on accessing the exception map structure 3150. For example, the exception checking process 3125 is performed in a second temporal period strictly after the first temporal period where the expression evaluation operator 2524 generated the map entries 3112 for storage in the exception map structure 3150 and/or otherwise after the exception map structure 3150 is otherwise generated and stored based on processing of all incoming rows processed by the expression evaluation operator 2524. The exception checking process 3125 can emit at least one corresponding error exception value 2560 identified via map reads 3114 to the exception map structure 3150, for example, as output for processing via further operators, to trigger aborting of the corresponding query, for display to a requesting entity that generated the query request, and/or other use. The exception checking process 3125 optionally emits no error exception values 2560, for example, based on the map reads 3114 indicating no error values were encountered for corresponding rows processed by the exception checking process 3125.

The exception checking process 3125 can optionally be implemented as a filtering operator applying an exception value check for the exception column, where exception values are instead read from map entries for the incoming rows via map reads 3114 to the exception map structure rather than being read from the corresponding new column and/or corresponding column stream for the incoming rows.

FIG. 31B illustrates an example embodiment of execution of an expression evaluation operator 2524 that writes map entries 3112 to an exception map structure 3150. Some or all features and/or functionality of the expression evaluation operator 2524 and/or exception map structure 3150 of FIG. 31B can implement the expression evaluation operator 2524 and/or exception map structure 3150 of FIG. 31A, and/or any other embodiment of the expression evaluation operator 2524 and/or exception map structure 3150 described herein.

For a given incoming row i in a stream of incoming rows, expression evaluation operator 2524 can implement an expression performance module 3122 to generate corresponding expression evaluation output 3110.i for the incoming row, for example, by performing a corresponding function of column values of the given row and/or literal values. For example, the expression evaluation output 3110 is generated as the new column value for a corresponding new column 3040 generated by the expression evaluation operator 2524 being implemented as an extend operator.

An exception value 2560 can be generated for some or all incoming rows, indicating whether an error was encountered and/or the type of error encountered. A map entry 3112 can be generated for the corresponding row i indicating a mapping of the row i to corresponding exception value 2560.k for the row. For example, exception value 2560.k is one of a plurality of possible exception values for a corresponding plurality of error types or other exception types. Alternatively, exception value 2560 can simply be implemented as a binary value and/or flag denoting whether or not an error was encountered.

In some embodiments, map entries 3112 denoting a given exception value 2560 for a given row is only generated and/or stored in exception map structure 3150 only when the corresponding exception value 2560 denotes an error. For example, map entries 3112 are not generated and/or stored for incoming rows having an exception value 2560 of zero or other value denoting no error, and/or otherwise encountering no errors when generating the expression evaluation output 3110. For example, the map entry 3112 is stored for row i based on the exception value 2560.k being non-zero and/or indicating a corresponding error and/or exception occurred in generating expression evaluation output 3110.i. Such storage of map entries for only rows encountering errors can be ideal in reducing memory resources required by the map structure 3150, particularly in cases where only a small proportion of rows encounter errors, where the number of entries in the exception map structure 3150 is thus substantially smaller than the number of incoming rows that were processed. In other embodiments, the given exception value 2560 row is generated and/or stored in exception map structure 3150 for every row with the corresponding exception value 2560, regardless of whether or not the row denotes an error.

In some embodiments, multiple exceptions can be thrown for a given row based on multiple different types of errors being encountered. Multiple corresponding exception values 2560 can optionally be mapped to a given row in the exception map structure 3150 accordingly, in a same entry or a corresponding plurality of entries.

FIG. 31C illustrates an example embodiment of execution of an expression evaluation operator 2524 that generates map entries 3112 in a stream as a corresponding plurality of incoming rows are received and processed. Some or all features and/or functionality of the execution of expression evaluation operator 2524 of FIG. 31C can implement the execution of expression evaluation operator 2524 of FIG. 31B and/or any other embodiment of the expression evaluation operator 2524 described herein.

Map entries 3112 can be emitted as a stream of serialized map data 3151 for storage in exception map structure 3150. These map entries 3112 are emitted in the order in which the rows are processed in the corresponding incoming stream of data blocks.

In this example, map entries 3112 are generated for row i and row i+2 based on these rows having corresponding exceptions denoting a corresponding error and/or exception was encountered, such as non-zero exceptions. The exception value 2560.m for row i+2 can be different from the exception value 2560.k for row i. In this example, no map entry 3112 is generated for row i+1 based on this rows having an exception value of zero and/or having no corresponding error and/or exception encountered.

FIG. 31D illustrates an example embodiment of execution of an expression evaluation operator 2524 that generates map entries 3112 of an exception map structure 3150. Some or all features and/or functionality of the execution of expression evaluation operator 2524 of FIG. 31D can implement the execution of expression evaluation operator 2524 of FIG. 31A and/or any other embodiment of the expression evaluation operator 2524 described herein.

As illustrated in this example, the exception map structure 3150 can be generated for a given column colD, For example, this given column is a new column 3040 generated to include the expression evaluation output 3110 for each given row in generating an output data set 2552, for example, emitted as a stream of output data blocks denoting corresponding output rows, from an input data set 2551, for example, received as a stream of input data blocks denoting corresponding input rows. The exception map structure 3150 is sparsely populated in this example, where map entries 3112 for row 7 and row 56 have corresponding exception values denoting the same or different errors, and where rows 1-6 and 8-55 have map entries 3112 based on no error being encountered. As a particular example, the expression evaluation operator 2524 generates expression evaluation output by dividing by a column value such as the value of colB, for example, prior to filtering out of column values with values of zero, where map entries 3112 for row 7 and row 56 are generated to both denote that a divide by zero error occurred based on the corresponding value of colB being equal to zero, and where rows 1-6 and 8-55 encounter no errors based on including non-zero values for colB.

In some embodiments, multiple exception map structures 3150 can be generated for a given query expression, where each exception map structures 3150 corresponds to exceptions for different columns, and/or can be stored in and/or can correspond to different corresponding column streams generated and processed by query execution module 2504. For example, multiple new columns are generated as expression evaluation output of multiple expression evaluation operators 2524, for example, of one or more extend operators. This can enable accessing of different exception map structures for different columns by one or more corresponding exception checking processes 3125 of the query operator execution flow 2517. Alternatively or in addition, the exception values for different columns are stored in the same exception map structures 3150, where the exception values 2560 are further mapped by column alternatively or in addition to being mapped by row.

FIG. 31E illustrates an example embodiment of an exception checking process 3125. Some or all features and/or functionality of the exception checking process 3125 of FIG. 31E can implement the exception checking process 3125 of FIG. 31A.

The exception checking process 3125 can access the map structure for given incoming rows, for example, via a corresponding read request. For example, a corresponding value of one or more column and/or other identifier of the row is utilized to access the corresponding exception value mapped to the row in the exception map structure, if applicable. The value of one or more columns and/or other identifier of the row can be implemented as a key of the corresponding exception map structure 3150, where the exception value 2560 for each entry is implemented as the corresponding value mapped to the key.

In this example, the exception checking process 3125 can reads the exception value 2560.k for row i based on denoting row i in the read. Because row i has an entry in the exception map structure indicating exception value 2560k, the corresponding exception value 2560.k is read in map read 3114. This corresponding exception value 2560.k can be thrown, for example, based on the exception checking process 3125 being implemented to delay throwing of exceptions. For example, the corresponding query execution is failed and/or otherwise aborted based on the corresponding exception value 2560.k denoting an error and/or failure type that requires aborting of the query. As another example, the corresponding exception value 2560.k is emitted in conjunction with emitting the given row in output data blocks, for example, in a corresponding column stream. As another example, the corresponding exception value 2560.k is stored and/or delivered to a requesting entity for display.

While not illustrated, the exception checking process 3125 optionally emits some or all incoming rows. For example, the exception checking process 3125 emits only incoming rows determined not to have corresponding exception values in the exception map structure indicating errors. As another example, the exception checking process 3125 emits all incoming rows, a row is emitted in conjunction with a corresponding exception values if this row has a corresponding exception values stored in the map structure 3150.

For example, as an incoming rows such as row i+1 of FIG. 31C and/or rows 1-6 of FIG. 31D are processed via exception checking process 3125 with no entries in exception map structure 3150, the map read 3114 to the map structure returns no exception value 2560 based on these rows not having entries and/or not being mapped to exception values denoting errors. In such cases, no exception is thrown, the query continues based on not being aborted, and/or the exception checking process simply emits these rows as output.

As a particular example, the exception checking process 3125 receives a stream of rows that includes rows 1-7 of FIG. 31D. Rows 1-6 are emitted by the exception checking process 3125 to proceed with query execution based on not being mapped to errors in the exception map structure. However, when row 7 is received and processed by the exception checking process 3125, the query is aborted and/or the corresponding exception value is thrown at this time based on row 7 being mapped to an exception value in the exception map structure 3150.

As another particular example, the exception checking process 3125 receives a stream of rows that includes rows 1-5, and 10-60 of FIG. 31D. For example, rows 6-10 were filtered out based on filtering operators being executed as expression evaluation operators 2524 after the expression evaluation operator 2524 is performed and before the exception checking process 3125 is performed. Rows 1-5 and 10-55 are emitted by the exception checking process 3125 to proceed with query execution based on not being mapped to errors in the exception map structure. However, when row 56 is received and processed by the exception checking process 3125, the query is aborted and/or the corresponding exception value is thrown at this time based on row 56 being mapped to an exception value in the exception map structure 3150. The exception checking process 3125 optionally does not proceed with further processing rows 57-60 based on the query having been aborted. Alternatively, these rows are processed and outputted after the exception value for row 56 is emitted.

FIGS. 31F and 31G illustrate embodiments of generating and storing map entries 3112 of the exception map structure 3150 as the expression evaluation operator 2524 processes rows. Some or all features and/or functionality of the exception map structure 3150 and/or expression evaluation operator 2524 of FIGS. 31F and/or 31G can be utilized to implement the exception map structure 3150 and/or expression evaluation operator 2524 of FIG. 31A, FIG. 31C, and/or any other embodiments of the exception map structure 3150 and/or expression evaluation operator 2524 described herein.

As illustrated in FIG. 31F, during time to, as serialized map data 3151 is generated as a stream of map entries 3112 via processing of input rows, the serialized map data 3151 can be stored in memory resources 3140.1. For example, memory resources 3140.1 are local to the query execution module 2504.

Some or all memory resources 3140.1 can optionally be implemented as huge page memory blocks, for example, of huge page memory, such as a huge page implemented as a memory page that is larger than 4 KiB, that is equal to 2 MiB and/or that is equal to 1 GiB. The huge page memory resources can optionally be implemented as one or more huge pages, such as Linux HugePages, superpages, Large Pages, or other types of huge pages. Memory resources 3140.1 can be implemented via any other type of memory. In some embodiments, if not enough huge page memory blocks or other memory blocks of memory resources 3140.1 are available to the query execution module 2504 overflow is written in a separate heap backed stream, or other separate memory resources from memory resources 3140.1.

As illustrated in FIG. 31G, during time t₁ after time to, after all serialized map data 3151 is generated as a stream of map entries 3112 via processing of all input rows, the serialized map data 3151 is written to memory resources 3140.2, for example, via a map storage module 3160. The map storage module 3160 can determine to write the map entries 3112 of serialized map data 3151 in memory resources 3140.2 based on determining the corresponding stream is finalized, for example, via a stream finalized indication 3145 generated by the expression evaluation module 2524 and/or other resources of query execution module. For example, the map entries 3112 of serialized map data 3151 is stored in memory resources 3140.2 once the corresponding column stream is finalized, once all processing of all input rows has completed, and/or once all corresponding output rows, for example, that include corresponding expression evaluation output 3110, has been generated. This finalization can be determined based on an end of file indication or other determination that all input rows have been received and/or that all output rows have been generated and emitted.

Memory resources 3140.2 can be of a different type and/or in a different location from memory resources 3140.1. For example, memory resources 3140.2 are implemented as disk memory and memory resources 3140.1 are implemented as non-disk memory, such as huge memory data blocks of huge page memory distinct from the disk memory. Waiting until the end of processing of input rows, for example, as indicated by the stream finalized indication 3145, can minimize the number of disk accesses and allow the corresponding exception map structure to be stored continuously, for example, as a lookup table.

The map storage module 3160 can optionally delete and/or write over the serialized map data 3151 in memory resources 3140.1 once all entries 3112 are confirmed to be stored in memory resources 3140.2, for example, enabling these memory resources 3140.1 to be utilized in other operator executions for the same or different query.

In some embodiments, the expression evaluation operator 2524 writes its map entries 3112 as serialized map data 3151 stored in in memory resources 3140.1, and/or otherwise does not access memory resources 3140.2 when generating map entries 3112 for storage. Alternatively or in addition, in some embodiments, the exception checking process 3125 performs its map reads 3114 based on accessing the exception map structure 3150 in memory resources 3140.2, and/or otherwise does not access memory resources 3140.1 when accessing map structure 3150 in processing incoming rows.

In some embodiments, a plurality of nodes 37 each implement the expression evaluation operator 2524 on their own stream of incoming rows, and can generate their own respective serialized map data 3151. The serialized map data 3151 of each node can be stored in respective memory resources 3140.1 of the given node, where different use each use their own memory resources 3140.1 for the serialized map data. The serialized map data 3151 of each node can be written to a common exception map structure 3150, for example, for access by a parent node of this plurality of nodes when implementing the exception checking process 3125, where a same set of memory resources 3140.2 ultimately stores the exception map structure 3150 with all map entries 3112 from all of the different serialized map data 3151 generated by the different nodes in this set of nodes.

As used herein, an “AND operator” can correspond to any operator implementing logical conjunction. As used herein, an “OR operator” can correspond to any operator implementing logical disjunction.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, a set of memory locations within a memory device or a memory section. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprising:
determining a query operator execution flow that includes a serialized ordering of a plurality of operators for execution of a corresponding query against a database having a schema that includes a plurality of columns; and
executing the query operator execution flow in conjunction with executing the corresponding query against the database based on:
generating a first plurality of data blocks of a multi-column data stream as first output of a first operator of the plurality of operators, wherein each data block of the multi-column data stream includes column values for each of the plurality of columns; and
processing the multi-column data stream as input of a second operator of the plurality of operators to generate a second plurality of data blocks as second output of the second operator, wherein the second operator is serially after the first operator in the serialized ordering.

2. The method of claim 1, wherein generating each data block of the multi-column data stream includes:
initializing the each data block of the multi-column data stream by allocating memory for a number of rows to be included in the each data block;
identifying a plurality of contiguous sub-spans of the memory allocated for the each data block, wherein each of the plurality of columns corresponds to a corresponding one of the plurality of contiguous sub-spans; and
writing columns values of each of a set of rows that includes the number of rows to the each data block based on, for each column of the plurality of columns, writing the corresponding one of the plurality of contiguous sub-spans with the column value of the each column for the each of the set of rows.

3. The method of claim 2, wherein processing the each data block of the multi-column data stream includes:
maintaining a plurality of column cursors for the plurality of contiguous sub-spans, wherein each of the plurality of column cursors corresponds to a corresponding column, and wherein the each of the plurality of column cursors is advanced as each column value of the each column for each of the set of rows is read serially.

4. The method of claim 2, wherein the memory allocated for each data block includes a plurality of fixed-size memory fragments, wherein at least one of:
one memory fragment of the plurality of fixed-size memory fragments includes column values of multiple columns of the plurality of columns; or
column values of one column of the plurality of columns span multiple memory fragments of the plurality of fixed-size memory fragments.

5. The method of claim 1, wherein the schema includes a plurality of fixed-length columns and further includes a plurality of variable-length columns, wherein the plurality of columns of the multi-column data stream correspond to the plurality of fixed-length columns, wherein each data block of the first plurality of data blocks includes fixed-length column values for each of the plurality of fixed-length columns, and wherein executing the query operator execution flow in conjunction with executing the corresponding query against the database is further based on:
generating an additional stream of additional data blocks of an additional multi-column data stream as additional first output of the first operator, wherein each additional data block of the additional stream of data blocks includes variable-length column values for each of the plurality of variable-length columns; and
processing each of the additional stream of data blocks of the additional multi-column data stream as input of the second operator to generate the second output of the second operator.

6. The method of claim 1, further comprising:
storing each of the first plurality of data blocks of the multi-column data stream in memory;
wherein the second operator forwards the multi-column data stream in the second output by reference based on each of the second plurality of data blocks indicating at least one buffer reference to at least one corresponding one of the first plurality of data blocks stored in memory.

7. The method of claim 6, wherein processing each of the first plurality of data blocks of the multi-column data stream includes:
generating column update metadata for the multi-column data stream indicating at least one update to the plurality of columns included in the multi-column data stream;
wherein the second output includes the column update metadata in conjunction with forwarding the multi-column data stream in the second output by reference, and wherein at least one update to the plurality of columns indicated by the column update metadata is applied to the first plurality of data blocks of the multi-column data stream accessed in memory by a subsequent operator of the plurality of operators utilizing a plurality of buffer references to the first plurality of data blocks stored in memory, and wherein the subsequent operator is serially after the second operator in the serialized ordering in conjunction with execution of the corresponding query.

8. The method of claim 7, wherein processing each of the first plurality of data blocks of the multi-column data stream further includes:
replacing prior column update metadata with the column update metadata, wherein the prior column update metadata was generated by another one of the plurality of operators serially before the second operator in the serialized ordering and serially after the first operator in the serialized ordering, and wherein the column update metadata includes at least one change from the prior column update metadata.

9. The method of claim 7, wherein the each data block of the multi-column data stream is column-major formatted to include column values of the plurality of columns in accordance with a first ordering of the plurality of columns, and wherein the column update metadata includes a reordering of the plurality of columns from the first ordering based on the second operator implementing a column reorder operator.

10. The method of claim 7, wherein the column update metadata includes a delayed exception map, wherein at least one operator between the second operator and the subsequent operator filters out at least one row, and wherein the subsequent operator throws an exception indicated by the delayed exception map based on utilizing the delayed exception map for only rows not filtered out by the at least one operator.

11. The method of claim 7, wherein the column update metadata indicates a set of Boolean values for the plurality of columns each indicating whether a corresponding one of the plurality of columns is readable.

12. The method of claim 11, wherein the at least one of the set of Boolean values indicates the corresponding one of the plurality of columns is not readable based on the second operator implementing a project operator.

13. The method of claim 11, wherein processing each of the first plurality of data blocks of the multi-column data stream includes:
rewriting each of a first proper subset of the plurality of columns in a new multi-column stream;
forwarding a second proper subset of the plurality of columns;
generating a set of multiple column update metadata for the new multi-column stream, wherein each one of the first proper subset of the plurality of columns is indicated as readable in exactly one of the set of multiple column update metadata and is indicated as not readable in all other ones of the set of multiple column update metadata; and
emitting the new multi-column stream in a set of multiple instances, wherein each instance of the new multi-column stream is emitted in conjunction with one of the set of multiple column update metadata.

14. The method of claim 1, further comprising:
serializing the second plurality of data blocks based on, for each index of a plurality of indexes in at least one of second plurality of data blocks:
determining whether a buffer reference at the each index is already stored in a memory reference hash map;
when the buffer reference is not already stored in the memory reference hash map:
adding a new entry into the memory reference hash map indicating the buffer reference and the each index; and
generating a message piece for the each index that indicates the buffer reference;
when the buffer reference is already stored in the memory reference hash map:
accessing a prior index mapped to the buffer reference in the memory reference hash map; and
generating a message piece for the each index that indicates the prior index.

15. The method of claim 1, wherein the first operator is implemented as a hash join multiplexer parallelized across a plurality of corresponding operator instances that each emit column values to a plurality of parent partitions as data blocks of the multi-column data stream, and wherein one of the plurality of parent partitions is implemented via the second operator.

16. The method of claim 1, wherein the first operator is one of a plurality of child operators of the second operator, and wherein the second operator processes the multi-column data stream received from the first operator in conjunction with processing at least one other multi-column data stream received from at least one other child operator of the plurality of child operators.

17. The method of claim 1, wherein the corresponding query is executed via a plurality of nodes in accordance with a query execution plan, wherein the first plurality of data blocks of the multi-column data stream is sent by a first node of the plurality of nodes executing the first operator to a second node of the plurality of nodes executing the second operator, and wherein the second node processes the first plurality of data blocks of the multi-column data stream based on receiving the first plurality of data blocks of the multi-column data stream from the first node.

18. The method of claim 17, wherein the first node is one of a plurality of child nodes of the second node in the query execution plan, wherein each of the plurality of child nodes generate and send a corresponding multi-column data stream of a plurality of multi-column data streams, and wherein the second node processes all of the plurality of multi-column data streams received from the plurality of child nodes.

19. A database system comprising:
at least one processor, and
at least one memory that stores operations instructions that, when executed by the at least one processor, causes the database system to:
determine a query operator execution flow that includes a serialized ordering of a plurality of operators for execution of a corresponding query against a database having a schema that includes a plurality of columns; and
execute the query operator execution flow in conjunction with executing the corresponding query against the database based on:
generating a first plurality of data blocks of a multi-column data stream as first output of a first operator of the plurality of operators, wherein each data block of the multi-column data stream includes column values for each of the plurality of columns; and
processing the multi-column data stream as input of a second operator of the plurality of operators to generate a second plurality of data blocks as second output of the second operator, wherein the second operator is serially after the first operator in the serialized ordering.

20. A non-transitory computer readable storage medium comprises:
at least one memory section that stores operational instructions that, when executed by at least one processing module that includes a processor and a memory, causes the at least one processing module to:
determine a query operator execution flow that includes a serialized ordering of a plurality of operators for execution of a corresponding query against a database having a schema that includes a plurality of columns; and
execute the query operator execution flow in conjunction with executing the corresponding query against the database based on:
generating a first plurality of data blocks of a multi-column data stream as first output of a first operator of the plurality of operators, wherein each data block of the multi-column data stream includes column values for each of the plurality of columns; and
processing the multi-column data stream as input of a second operator of the plurality of operators to generate a second plurality of data blocks as second output of the second operator, wherein the second operator is serially after the first operator in the serialized ordering.
